(19) United States
(12) Patent Application Publication
(10) Pub. No.: US 2004/0046787 A1
(43) Pub. Date: Mar. 11, 2004

(54) System and method for screen connector design, configuration, and runtime access

(75) Inventors: Brian L. Henry, Kirkland, WA (US); Sowmyanarayanan Srinivasan, Bellevue, WA (US); Suresh Budhiraja, Issaquah, WA (US); Stephen O. Wagener, Seattle, WA (US); Karl A. Uppiano, Ferndale, WA (US); James R. Wolniakowski, Bellingham, WA (US); Mark E. Edson, Ferndale, WA (US); Jonathan J. Coogan, Bellingham, WA (US); John R. Muehleisen, Lynnwood, WA (US); Marcia A. Ruthford, Redmond, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Attachmate Corporation, Bellevue, WA

(21) Appl. No.: 10/346,199

(22) Filed: Jan. 15, 2003

Related U.S. Application Data
(63) Continuation of application No. 10/159,095, filed on May 31, 2002, now abandoned.
(60) Provisional application No. 60/295,041, filed on Jun. 1, 2001.

(51) Int. Cl. G09G 5/00

(52) U.S. Cl. 345/744

(57) ABSTRACT

A system and method for screen connector design, configuration, and runtime access. Embodiments modify a rudimentary host application screen recording prior to runtime to better identify host screens of a host application during runtime use. Embodiments of a screen connector runtime engine allow communication and access to a host application. Embodiments screen connector recordings are designed by embodiments of a screen connector designer, which allows for customization of the rudimentary application screen recordings based upon user input. Issues are addressed related to navigation between and identification of tables. Embodiments for screen task design allow for authoring of executable tasks. Embodiments directed to screen recording verification, non-dedicated navigation recording, screen connector configuration management, context management for object-oriented programming components, and user interfaces for screen connector design, screen identification generation, screen connector configuration, and screen task design are also elaborated.

### CROSS-REFERENCE TO RELATED APPLICATION

This application claims the benefit of U.S. Provisional Patent Application No. 60/295,041 filed Jun. 1, 2001, which is incorporated by reference in its entirety.

### BACKGROUND OF THE INVENTION

1. Field of the Invention

The invention relates generally to computer applications, systems and methods, and more particularly to computer systems and methods to design customized screen connector recordings for subsequent use by distributed screen connector runtime engines and to configure distributed screen connector runtime engines that use the customized screen connector recordings to provide access by non-host based user applications to legacy host based applications.

2. Description of the Related Art

Although information technology must deal with fast paced advances, it must still deal with legacy host applications and data that have been inherited from languages, platforms, and techniques originated in an earlier computer era. Most enterprises that use computers have host applications and databases that continue to serve critical business needs. An example of such host applications are found on legacy host computer systems, such as International Business Machines (IBM) model 390 mainframe computers and accessed by asynchronous text-based terminals. Other legacy host systems include other systems from International Business Machines, and systems from Sperry-Univac, Wang, Digital Equipment Corporation, Hewlett Packard, and others.

A large portion of the computer user community no longer uses asynchronous text-based terminals, but rather uses graphical user interface (GUI) based personal computers (PCs). Some of these GUI based PCs run text-based terminal emulation programs to access the mainframe host computers. A disadvantage of the text-based terminal emulation programs is that the text-based screens furnished are not as user-friendly as a GUI based display. To address this and other issues some have turned to accessing mainframe host computers through intermediary server computers.

The GUI based PCs form network connections with the server computers, and, in turn, the server computers form network connections with the mainframe host computers. Oftentimes these server computers run screen scraping programs that translate between host application programs (written to communicate with now generally obsolete input/output devices and user interfaces) and newer user GUI interfaces so that the logic and data associated with the host application programs can continue to be used. Screen scraping is sometimes called advanced terminal emulation.

For example, a program that does screen scraping must take the data coming from the host application program running on a mainframe host computer that is formatted for the screen of a text-based terminal such as an IBM 3270 display or a Digital Equipment Corporation VT100 and reformat it for a Microsoft Windows GUI or a PC based Web browser. The program must also reformat user input from the newer user interfaces (such as a Windows GUI or a Web browser) so that the request can be handled by the host application as if it came from a user of the older device and user interface.

First generation advanced terminal emulation systems followed rigid rules for automated conversion of a collection of host application screens into a corresponding collection of GUI screens. For example, a conversion of a host screen into a GUI would typically include such mandatory conversion operations as having all host screen fields having a protected status being converted to text of a static nature. To address this lack of facility of the first generation systems, second generation advanced terminal emulation systems allow a certain degree of customization of the conversion process and resulting GUIs.

Regarding presentation systems not involving GUIs, another trend in the computer user community is to use communication devices and other processing devices that directly or indirectly communicate with computer systems such as legacy host systems. Many of these devices tend to be portable and tend to communicate over wireless means. Oftentimes these devices are not GUI based and they are also not based upon a host application screen.

Regardless of the type of non-host based user application, non-host based presentation system, and non-host based computer, communication device, or other processing device operated by a user to access and communicate with a legacy host system, a fundamental problem still remains: recognition of host application screens by non-host systems and subsequent access of the host application by the non-host based systems. Conventional approaches have furnished reasonable solutions for recognition of relatively simple host application screens by non-host systems. These conventional approaches are generally based upon rudimentary host application screen recordings that are generated by traversing through the host screens of a host application. Unfortunately, these conventional approaches have not provided reliable recognition by the non-host systems of a larger variety of host application screens, thereby limiting the potential for the host applications to be resources for the non-host based systems.

### BRIEF SUMMARY OF THE INVENTION

In an embodiment, a system includes but in not limited to: a designer user interface; a screen connector designer; a screen connector runtime engine; a connector configuration management user interface; a connector configuration management server; a screen connector runtime engine; a host computer; and a user application.

### BRIEF DESCRIPTION OF THE DRAWINGS

FIG. 1 is a schematic diagram depicting the systems and methods of the present invention directed to the design of customized screen connector recordings, configuration of screen connector runtime engines, and provision of access to host applications through screen connector runtime engines.

FIG. 1A is a flowchart illustrating an overall system process of generating customized screen connector recordings, configuring screen connector runtime engines, and providing access to host applications through screen connector runtime engines.

FIG. 2 is a schematic diagram of a computing system suitable for employing aspects of the present invention.

FIG. 3 is an interface screen from an embodiment of a designer user interface through which a user may select and track operations associated with generating a customized screen connector recording.

FIG. 3A is an interface screen showing further details of the designer user interface of FIG. 3 through which a user may select and track operations associated with generating a customized screen connector recording.

FIG. 4 is an interface screen from an embodiment of the designer user interface displaying properties relating to a rudimentary host application screen recording.

FIG. 4A is an interface screen showing further details of the designer user interface of FIG. 4 in which a screen connector recording icon has been selected.

FIG. 5 is an interface screen from an embodiment of the designer user interface displaying a first ungrouped screen icon and the screen properties of a host screen found within a rudimentary host application screen recording.

FIG. 5A is an interface screen showing further details of the designer user interface of FIG. 5 in which the first ungrouped screen icon is selected.

FIG. 6 is an interface screen from an embodiment of the designer user interface displaying an additional ungrouped screen icon as a second host screen is added to the rudimentary host application screen recording.

FIG. 6A is an interface screen showing further details of the designer user interface of FIG. 6 in which the second ungrouped screen icon is selected.

FIG. 7 is an interface screen from an embodiment of the designer user interface displaying additional screen icons as multiple additional host screens are recorded into the rudimentary host application screen recording.

FIG. 7A is an interface screen showing further details of the designer user interface of FIG. 7 in which a fifth ungrouped screen icon is selected.

FIG. 8 is an interface screen from an embodiment of the designer user interface displaying, for review by the user, icons of and properties of multiple recorded host screens.

FIG. 8A is an interface screen showing further details of a review screen selection of the designer user interface of FIG. 8 when the first ungrouped screen icon is selected.

FIG. 8B is an interface screen showing further details of a screen designer properties display area of the designer user interface of FIG. 8 when the first ungrouped screen icon is selected.

FIG. 9 is an interface screen from an embodiment of the designer user interface displaying an automated generation of a screen recognition rule for the host screen represented by the first ungrouped screen icon.

FIG. 9a is an interface screen showing further details of the designer user interface of FIG. 9.

FIG. 10 is an interface screen from an embodiment of the designer user interface after the user has elected to check for duplicate host screens in a rudimentary host application screen recording.

FIG. 10A is an interface screen showing further details of the designer user interface of FIG. 10, and in particular, a custom tree grouping display and a custom grouping host comparison display.

FIG. 11 is an interface screen from an embodiment of the designer user interface displaying an expansion of the screen grouping icons and a comparison between two host screens in a same screen collection.

FIG. 11A is an interface screen showing further details of the expansion of the custom screen grouping icons displayed in the designer user interface of FIG. 11.

FIG. 12 is an interface screen from an embodiment of the designer user interface displaying a comparison between two host screens in a same screen collection represented by the second screen grouping icon.

FIG. 12A is an interface screen showing further details of the designer user interface of FIG. 12.

FIG. 13 is an interface screen from an embodiment of the designer user interface displaying a comparison of two host screens found in two different same screen collections.

FIG. 13A is an interface screen showing further details of the designer user interface of FIG. 13.

FIG. 14 is an interface screen showing a screen regrouping confirmation request window that is displayed after a user has moved a host screen from one same screen collection to another same screen collection, which window indicates how recognition rules for each same screen collection may change.

FIG. 15 is an interface screen showing a duplicate screen alert window that is used by the screen connector designer to assist the user in identifying duplicate host screens based on recognition rules.

FIG. 16 is an interface screen showing a duplicate screen message window that is displayed at the end of the host screen regrouping process and provides information to the user on how to remove duplicate host screens.

FIG. 17 is an interface screen showing the contents of a customized screen connector recording after duplicate screens have been removed.

FIG. 17A is an interface screen showing further details of the expanded custom screen grouping tree display depicted in FIG. 17.

FIG. 18 is an interface screen showing the contents of a fields folder from the expanded custom screen grouping tree display of FIG. 17.

FIG. 18A is an interface screen showing further details of the expanded custom screen grouping tree display of FIG. 18 when a duplicates removed first screen third field is selected.

FIG. 18B is an interface screen showing further details of field property values corresponding to the selected duplicates removed first screen third field displayed in FIG. 18.

FIG. 19 is an interface screen showing additional field properties of a host screen represented by a duplicates removed first screen icon.

FIG. 19A is an interface screen showing further details of the expanded custom screen grouping tree display depicted in FIG. 19.

FIG. 19B is an interface screen showing further details of a screen designer properties display area depicted in FIG. 19.

FIG. 20 is an interface screen showing contents of duplicates removed paths folders associated with various duplicates removed screen icons of the expanded custom screen grouping tree display.

FIG. 20A is an interface screen showing further details of the custom screen grouping tree display when a first screen first path information icon is selected.

FIG. 20B is an interface screen showing further details of the screen designer properties display area depicting path properties associated with the selected first screen first path information icon of FIG. 20A.

FIG. 21 is an interface screen showing an embodiment of the designer user interface depicting a table found in one of the host screens.

FIG. 21A is an interface screen showing further details of a screen designer workflow menu and the expanded custom screen grouping tree display of FIG. 21.

FIG. 21B is an interface screen showing further details of the screen designer host screen display of FIG. 21.

FIG. 22 is a menu that allows the user to choose the type of table being shown in the screen designer host screen display.

FIG. 23 is an example of table information, displayed in the screen designer properties display area, that is associated with a window table with variable length records.

FIG. 24 is an example of table information, displayed in the screen designer properties display area, that is associated with a window table with fixed length records.

FIG. 25 is an example of table information, displayed in the screen designer properties display area, that is associated with a list table with fixed length records.

FIG. 26 is an example of table information, displayed in the screen designer properties display area, that is associated with a list table with variable length records.

FIG. 27 is an interface screen showing a verification report that contains information with respect to the testing of the customized screen connector recording against simulated runtime conditions.

FIG. 28 is an interface screen showing an embodiment of the designer user interface after a customized screen connector recording has been created and saved and after the user has chosen to define and generate a task.

FIG. 28A is an interface screen showing further details of the screen designer workflow menu and expanded custom screen grouping tree display of FIG. 28.

FIG. 28B is an interface screen showing further details of the task definition screen display and the screen designer host screen display of FIG. 28.

FIG. 29 is an interface screen showing a task being defined that contains fields from all three host screens of the exemplary customized connector screen recording.

FIG. 29A is an interface screen showing further details of the custom screen grouping tree display shown in FIG. 29, having the fields of a duplicates removed third screen fields folder expanded.

FIG. 29B is an interface screen showing further details of the task definition screen display and the screen designer properties display area of FIG. 29, in which is listed the properties of a field highlighted in the task definition screen display.

FIG. 30 is an interface screen showing a generate task menu of the designer user interface used to generate executable files associated with a specific task.

FIG. 31 is an interface screen showing an export tasks template that is displayed after a task file has been tested and the user has activated an export task selection from the screen designer workflow menu.

FIG. 32 is an interface screen displaying files of an exemplary task definition.

FIG. 33 illustrates exemplary elements of a visual based interface of an identification grammar expression builder through which the user may use identification grammar to identify host screen fields.

FIG. 33A shows further details of a grammar selection menu depicted in FIG. 33.

FIG. 34 illustrates exemplary elements of the visual based interface of the identification grammar expression builder through which the user may use identification grammar to identify tables in a host screen.

FIG. 34A shows further details of the grammar selection menu depicted in FIG. 34.

FIG. 35 illustrates exemplary elements of the visual based interface of the identification grammar expression builder through which the user may use identification grammar to identify host screens.

FIG. 35A shows further details of the grammar selection menu depicted in FIG. 35.

FIG. 36 is a schematic diagram showing details of an exemplary embodiment of the screen connector designer.

FIG. 37 is a flowchart illustrating an exemplary method followed by the screen ready discriminator of FIG. 36 to determine if a host screen is complete and not in the process of being drawn.

FIG. 38 is a flowchart illustrating an exemplary method followed by a second embodiment of the screen ready discriminator shown in FIG. 36, which uses cursor positions to determine if a host screen is complete.

FIG. 39 is a flowchart illustrating an exemplary method followed by a third embodiment of the screen ready discriminator shown in FIG. 36, which uses timer execution to determine if a host screen is complete.

FIG. 40 is a flowchart illustrating an exemplary method followed by the difference engine of FIG. 36 to compare the fields of a screen before a user has input data with the same screen fields after the user has input data.

FIG. 41 is a schematic diagram showing further details of the screen recording engine depicted in FIG. 36.

FIG. 42 is a transition diagram illustrating the process of grouping host screens into same screen collections and labeling the same screen collections with custom grouping screen identifications.

FIG. 43 is a flowchart illustrating an exemplary method followed by the recording workflow manager of FIG. 41 to generate recognition rules for groups of host screens that have been organized based on the screen contents.

FIG. 44 is a flowchart illustrating an exemplary method followed by the screen/field recorder of FIG. 41 and called by the recording workflow manager method of FIG. 43 to extract pertinent information from a recorded host screen.

FIG. 45 is a flowchart illustrating an exemplary method followed by the default screen group generator of FIG. 41 to organize host screens into same screen collections based on similar screen contents.

FIG. 46 is a flowchart illustrating an exemplary method followed by the screen grouping graphical user interface manager of FIG. 41 to allow a user to create customized same screen collections and to verify that the screen groupings are coherent.

FIG. 47 is a flowchart illustrating an exemplary method followed by the custom screen grouping editor of FIG. 41, and called by the screen grouping graphical user interface manager method of FIG. 46, to provide a graphical interface through which the user may add individual host screens to particular same screen collections.

FIG. 48 is a flowchart illustrating an exemplary method followed by the custom identification field list generator of FIG. 41 to construct a list identifying common fields of host screens in a particular same screen collection.

FIG. 49 is a flowchart illustrating an exemplary method followed by the field list to identification string generator of FIG. 41 to convert the field list generated by the method shown in FIG. 48 to a rule string used in same screen collection identification.

FIG. 50 is a flowchart illustrating an exemplary method followed by the screen identification verifier of FIG. 41, using the rule strings generated by the method shown in FIG. 49, to confirm that host screens in a same screen collection have common fields and that no two same screen collections are identical.

FIG. 51 is an exemplary list of constants, variables, and operators used in an identification grammar set.

FIG. 52 is a data table showing examples of identification grammar expressions created using identification grammar and the constants, the variables, and the operators listed in FIG. 51.

FIGS. 53, 54 and 55 illustrate a data table that contains exemplary identification grammar functions and their corresponding interpretations, result types, and manners of application.

FIG. 56 is a list of examples of how identification grammar functions of FIGS. 53-55 are used to construct identification grammar expressions.

FIG. 57 is an interface screen depicting an example of a dynamic screen from a host application that is evaluated through the use of identification grammar.

FIG. 58 is a data table showing examples of identification grammar expressions evaluated after being applied to the dynamic screen shown in FIG. 57.

FIGS. 59A and 59B are a flowchart illustrating an exemplary method followed by a graphical user interface manager through which the user may construct identification strings using identification grammar, such as depicted in FIGS. 33-35.

FIG. 60 is a flowchart illustrating an exemplary process of screen identification based on identification strings created through the freeform identification system graphical user interface manager method of FIGS. 59A and 59B.

FIG. 61 is a flowchart illustrating an exemplary process of field identification based on identification strings created through the freeform identification system graphical user interface manager method of FIGS. 59A and 59B.

FIG. 62 is a flowchart illustrating an exemplary process of table identification based on identification strings created through the freeform identification system graphical user interface manager method of FIGS. 59A and 59B.

FIG. 63 is a flowchart illustrating an exemplary process of table record identification based on identification strings created through the freeform identification system graphical user interface manager method of FIGS. 59A and 59B.

FIG. 64 is a transition diagram depicting an example of a linear screen recording, or time-ordered sequence, of host screens in a rudimentary host application screen recording.

FIG. 65 is a transition diagram depicting an example of a state map recording, or application graph sequence, of the host screens in the linear screen recording depicted in FIG. 64.

FIG. 66 is a flowchart illustrating an exemplary method followed by an application graph generator to convert a linear style recording, as shown in FIG. 64, to a state map recording, as shown in FIG. 65.

FIG. 67 is a flowchart illustrating a subroutine of the method outlined in FIG. 66 through which the application graph generator determines where a host screen should be placed in the state map recording.

FIGS. 68A and 68B are a flowchart illustrating an exemplary method followed by the application graph and screen recording verifier to ensure that a state map recording generated through the method depicted in FIG. 66 does not have dead-ends.

FIG. 69 is a tree diagram that depicts an example of the hierarchal structure of data within a customized screen connector recording.

FIGS. 70, 70A and 70b are tree diagrams that show further details of the hierarchal structure of data within the screen definition shown in FIG. 69.

FIG. 71 is a tree diagram that shows further details of the hierarchal structure of data within the table definition shown in FIG. 69.

FIG. 72 is a tree diagram that shows further details of the hierarchal structure of data within the record definition shown in FIG. 71.

FIG. 73 is a tree diagram that shows further details of the hierarchal structure of data within the field definition shown in FIG. 72.

FIG. 74 is a tree diagram that shows further details of the hierarchal structure of data within the cascaded table definition shown in FIG. 71.

FIGS. 75, 76 and 77 are tree diagrams that show further details of the hierarchal structure of data found in three different types of path information that could be included in the cascaded table definition shown in FIG. 74.

FIG. 78 is a schematic diagram showing an example of a non-dedicated navigation recording system that follows a two-tiered recording process of host screens.

FIGS. 79-83 are examples of table types that could be contained in host screens produced by a legacy host data system.

FIG. 84 is a schematic diagram of an example of cascaded tables, which tables may fall under any of the table types shown in FIGS. 79-83.

FIG. 85 is a flowchart illustrating an exemplary method followed by the table definition system shown in FIG. 36.

FIG. 86 is a flowchart illustrating a subroutine of the method outlined in FIG. 85 through which the table definition system adds a record to a table.

FIG. 87 is a flowchart illustrating a subroutine of the method outlined in FIG. 85 through which the table definition system adds a cascaded table by linking a second table to the table being defined.

FIG. 88 is a schematic diagram of an embodiment of the task designer shown in FIG. 36.

FIG. 89 is an example of an embodiment of a task data structure, created by the task designer of FIG. 88, that is comprised of multiple tables.

FIG. 90 is an example of a second embodiment of a task data structure, created by the task designer of FIG. 88, that is comprised of a single table.

FIG. 91 is an example of a third embodiment of a task data structure, created by the task designer of FIG. 88, that is comprised of linked lists.

FIGS. 92A and 92B are a flowchart illustrating an exemplary general method followed by the task designer of FIG. 88 to create an object oriented programming component and/or a markup language schema.

FIGS. 93A and 93B are a flowchart illustrating an exemplary method followed by the task designer graphical user interface shown in FIG. 88 to classify screen fields of recorded host screens.

FIG. 94 is a flowchart illustrating an exemplary method followed by the markup language creation system shown in FIG. 88 to create a document containing information that relates to a particular task.

FIGS. 95A and 95B are a flowchart illustrating an exemplary method followed by the object oriented programming component creation system shown in FIG. 88 to construct an active compiled piece of code containing information that relates to a particular task.

FIG. 96 is an interface screen from a management and control server user interface through which the user may configure or monitor screen connector runtime engines being managed by the connector configuration management server.

FIG. 96A is an interface screen showing further details of a server tree display bar and a screen connector display area of the management and control server user interface shown in FIG. 96.

FIG. 97 is an interface screen showing a new session wizard interface that is called when a user selects a new server link from the management and control server user interface of FIG. 96.

FIG. 97A is an interface screen showing further details of the input parameters required by the new session wizard interface shown in FIG. 97.

FIG. 98 is an interface screen that is displayed when the user chooses to configure a server computer by selecting a configure server branch from the server tree display bar shown in FIG. 96A.

FIG. 98A is an interface screen showing further details of system properties that may be configured by selecting a systems tab shown in FIG. 98.

FIG. 99 is an interface screen of an applet window that appears when the user elects to configure session pool parameters.

FIG. 100 is an interface screen showing a pool configuration display that appears when the user elects to configure existing or new session pools by selecting the pools tab shown in FIG. 98.

FIG. 100A is an interface screen showing further details of the pool configuration display shown in FIG. 100.

FIG. 101 is an interface screen showing a new pool wizard first page that appears when the user elects to create a new session pool.

FIG. 101A is an interface screen showing further details of the input parameters required by the new pool wizard first page shown in FIG. 101.

FIG. 102 is an interface screen showing a new pool wizard second page that allows the user to set general session pool configurations.

FIG. 102A is an interface screen showing further details of the general session pool configurations displayed in FIG. 102, including settings regarding timeouts and number of sessions.

FIG. 103 is an interface screen showing a new pool wizard third page that allows the user to enter information concerning a navigation map to be used with the selected pool.

FIG. 103A is an interface screen showing further details of the navigation map parameters and session logon parameters displayed in FIG. 103.

FIG. 104 is an interface screen showing a new pool wizard fourth page that allows the user to enter information concerning the logon configuration of a particular pool.

FIG. 104A is an interface screen showing further details of the logon configuration information relating to a single user, as shown in FIG. 104.

FIG. 105 is an interface screen of the pool configuration display showing the addition of the new session pool created through the process depicted in FIGS. 101-104.

FIG. 105A is an interface screen showing further details of the pool configuration display shown in FIG. 105.

FIG. 106 is an interface screen showing an example of the pool configuration display when the user has chosen to configure the properties of an existing pool.

FIG. 106A is an interface screen showing further details of the configurable properties associated with a selected session pool.

FIG. 107 is an interface screen of an applet window that appears when the user elects to configure the general property of an existing session pool shown in FIG. 106A.

FIG. 108 is an interface screen of an applet window that appears when the user elects to configure the connection property of an existing session pool shown in FIG. 106A.

FIG. 109 is an interface screen of an applet window that appears when the user elects to configure the navigation map property of an existing session pool shown in FIG. 106A.

FIG. 110 is an interface screen of an applet window that appears when the user elects to configure the logon property of an existing session pool, shown in FIG. 106A, for a single user.

FIG. 111 is an interface screen of an applet window that appears when the user elects to configure the logon property of an existing session pool, shown in FIG. 106A, for multiple users using a single password.

FIG. 112 is an interface screen of an applet window that appears when the user elects to configure the logon property of an existing session pool, shown in FIG. 106A, for multiple users using multiple passwords.

FIG. 113 is a schematic diagram showing the various components that are active in an embodiment of a screen connector configuration management system.

FIG. 114 is a schematic diagram showing further details of the server computer in the screen connector configuration management system shown in FIG. 113.

FIG. 115 is a schematic diagram showing further details of the connector configuration management user interface in the screen connector configuration management system shown in FIG. 113.

FIGS. 116A and 116B are a flowchart illustrating an exemplary method followed by the connector configuration management user interface depicted in FIG. 115.

FIG. 117 is a schematic diagram showing further details of the connector configuration management server in the screen connector configuration management system shown in FIG. 113.

FIG. 118 is a flowchart illustrating an exemplary method followed by the connector configuration management server depicted in FIG. 117.

FIG. 119 is a schematic diagram showing further details of the screen connector runtime engine in the screen connector configuration management system shown in FIG. 113.

FIG. 120A is a flowchart illustrating an exemplary method followed by the configuration communication agent of the screen connector runtime engine shown in FIG. 119.

FIG. 120B is a flowchart illustrating an exemplary method called during the method of FIG. 120A and executed by a property page plugin to retrieve a user interface description.

FIG. 120C is a flowchart illustrating an exemplary method called during the method of FIG. 120A and executed by a property page plugin to fill in the retrieved user interface with data.

FIG. 120D is a flowchart illustrating an exemplary method called during the method of FIG. 120A and executed by a property page plugin to return to the runtime system user modifications made to the user interface information.

FIG. 120E is a flowchart illustrating an exemplary method executed by a wizard plugin to retrieve a user interface description.

FIG. 120F is a flowchart illustrating an exemplary method executed by a wizard plugin to fill in the retrieved user interface with data.

FIG. 120G is a flowchart illustrating an exemplary method executed by a wizard plugin to return to the runtime system user modifications made to the user interface information.

FIGS. 121A and 121B are a data flow diagram depicting an initialization process of the connector configuration management system.

FIG. 121C is a data flow diagram depicting a process by which the user selects a screen connector runtime engine and retrieves the screen connector runtime engine configuration.

FIGS. 121D and 121E are a data flow diagram depicting a process by which the user selects an existing property to display from a list generated by the process of FIG. 121C.

FIG. 121F is a data flow diagram depicting a process by which the user can modify information concerning a property displayed after the user selection process shown in FIGS. 121D and 121E.

FIGS. 121G-121K are a data flow diagram depicting a process followed by the connector configuration management system when a new object wizard is invoked.

FIG. 122A is a schematic diagram of a basic architecture of the screen connector runtime system.

FIG. 122B is a schematic diagram of an embodiment of the screen connector runtime system architecture that uses an application server.

FIG. 123 is a schematic diagram of an embodiment of the screen connector runtime system architecture that uses a virtual machine.

FIG. 124 is a schematic diagram of an embodiment of the screen connector runtime system architecture with remoting.

FIG. 125 is a schematic diagram of an alternative embodiment of the screen connector runtime system architecture with remoting.

FIG. 126 is a schematic diagram depicting an embodiment of the screen connector runtime engine architecture in a layered stack representation.

FIG. 127 is a data flow schematic for the object oriented programming component and the object oriented programming interface processor shown in FIG. 126.

FIG. 128 is a flowchart illustrating an exemplary method followed the object oriented programming interface processor shown in FIG. 126.

FIG. 129 is a data flow schematic for the markup language interface processor shown in FIG. 126.

FIGS. 130A and 130B are a flowchart illustrating an exemplary method followed by the markup language interface processor shown in FIG. 126.

FIG. 131 is a flowchart illustrating an exemplary method followed by an embodiment of the task engine that does not use a task context manager.

FIG. 131A is a flowchart illustrating an exemplary method followed by an embodiment of the task engine that uses a task context manager.

FIG. 132A is a schematic diagram of an embodiment of a system for object oriented programming component context management.

FIG. 132B is a data flow diagram for task management, without task context sharing, by the system for object oriented programming component context management shown in FIG. 132A.

FIGS. 132C and 132D are a data flow diagram for task management, with task context sharing, by the system for object oriented programming component context management shown in FIG. 132A.

FIG. 132E is a flowchart illustrating an exemplary method followed by an object oriented programming component to copy a task context to another object oriented programming component.

FIG. 132F is a flowchart illustrating an exemplary method followed by an object oriented programming component to transfer a task context to another object oriented programming component.

FIG. 132G is a flowchart illustrating an exemplary method followed by an object oriented programming component to clear a task context from another object oriented programming component.

FIGS. 133A and 133B are a flowchart illustrating a method followed by an embodiment of the task engine that manages task context setup and teardown for task context re-use.

FIG. 134 is a flowchart illustrating an initialization method followed by an embodiment of the screen session manager shown in FIG. 126.

FIG. 135 is a flowchart illustrating a method followed by the screen session manager after the initialization method of FIG. 134 has been executed.

FIG. 136 is a flowchart illustrating a subroutine of the method depicted in FIG. 135 in which the screen session manager logs on a session.

FIG. 137 is a flowchart illustrating an exemplary method followed by the screen session manager, shown in FIG. 126, to allocate a screen session.

FIG. 138 is a flowchart illustrating an exemplary method followed by the screen session manager, shown in FIG. 126, to de-allocate a screen session.

FIG. 139 is a schematic diagram depicting an embodiment of a runtime table identification and navigation system along with table data.

FIGS. 140A and 140B are a flowchart illustrating an exemplary method followed by the data request processor of the runtime table identification and navigation system shown in FIG. 139.

FIG. 141 is a flowchart illustrating an exemplary method followed by a fixed records component of the record processor, shown in FIG. 139, to process data from both cascaded and non-cascaded tables.

FIG. 142 is a flowchart illustrating an exemplary method followed by the fixed records component when invoked by the method depicted in FIG. 141 to extract horizontal records.

FIG. 143 is a flowchart illustrating an exemplary method followed by the fixed records component when invoked by the method depicted in FIG. 141 to extract vertical records.

FIG. 144 is a flowchart illustrating a method followed by a fixed field processor when invoked by the method outlined in FIG. 143 to extract data from specific vertical fields stored in a screen buffer.

FIG. 145 is a flowchart illustrating a method followed by a fixed field processor when invoked by the method outlined in FIG. 143 to extract data from specific horizontal fields stored in a screen buffer.

FIG. 146 is a flowchart illustrating an exemplary method followed by a variable records component of the record processor, shown in FIG. 139, to process data from variable records in non-cascaded tables.

FIG. 147 is a data flow diagram for an embodiment of the data cache that receives and stores field data and outputs the stored field data as records.

FIG. 148 is a flowchart illustrating an exemplary method followed by the cache manager to initialize the data cache.

FIG. 149 is a flowchart illustrating an exemplary method followed by a cache data entry manager to save data to a queue, as shown in the data flow diagram of FIG. 147.

FIG. 150 is a flowchart illustrating an exemplary method followed by a data retrieval manager to output, as a single record, data stored in the queue, as shown in the data flow diagram of FIG. 147.

FIG. 151 is a flowchart illustrating an exemplary method followed by route processing when traversing multiple screen destinations.

FIG. 151A is a flowchart illustrating a method followed by route processing, when called by the method outlined in FIG. 151, to traverse a single screen destination.

FIG. 151B is a flowchart illustrating a method followed by route processing when called upon by the method shown in FIG. 151A to traverse an application graph using certain mathematical algorithms.

FIG. 152 is a table of example data used by route processing to traverse a route and retrieve desired output information.

FIG. 153 is a sample route taken by route processing using the input data shown in FIG. 152.

FIG. 154 is a flowchart illustrating an exemplary method followed by a screen recognizer when called upon by the method shown in FIG. 151 to find matching screens in a customized screen connector recording.

FIG. 155 is a schematic diagram of an embodiment of a feature identification system used to compute results based on the application of an arithmetical string to screen data.

FIG. 156 is a flowchart illustrating a general method followed by the feature identification system shown in FIG. 155.

FIG. 157 is a flowchart illustrating an exemplary method followed by the feature identification grammar function evaluator when invoked by the feature identification system method shown in FIG. 156.

FIG. 158 is a flowchart illustrating an exemplary method followed by the feature identification grammar variable evaluator when invoked by the feature identification system method shown in FIG. 156.

### DETAILED DESCRIPTION OF THE INVENTION

Embodiments of the present invention modify a rudimentary host application screen recording to become a customized screen connector recording. Modifications of the rudimentary host application screen recordings are performed prior to runtime to better identify host screens of a host application during runtime use by a screen connector runtime engine of the customized screen connector recording. The screen connector runtime engine is used by a user application for communication and access to a host application running on a legacy host system.

Embodiments of the customized screen connector recording are designed by embodiments of a screen connector designer, which allows customization of the rudimentary application screen recording based upon user input. Customization of the application screen recording includes grouping two or more host screens found in the application screen recording into a collection of host screens designated by the user as being the same host screen. The screen connector designer then compares host screen features, such as fields, of each host screen of the same screen collection to determine which host screen features are the same for each host screen in the same screen collection. These common screen features are then used during runtime to identify host screens belonging to the same screen collection. In some embodiments, the screen connector designer includes automated grouping of host screens to initially group the host screens of the application screen recording into same screen collections based upon comparisons of predefined locations, such as designated fields of the host screens.

In other embodiments, customization of the rudimentary application screen recording is performed with the use of an identification grammar to label features of host screens selected by the user for subsequent recognition of the host screens by the screen connector runtime engine. The identification grammar provides additional flexibility in describing features of the host screens to further distinguish both host screens that are observed by the user to be the same and host screens that are observed by the user to be different given particularly challenging identification issues related to the host screens.

These identification issues include aspects related to runtime use of the host application. Further embodiments of the invention are directed to solving issues related to navigation between and identification of tables that have not been successfully addressed by conventional systems. Additional embodiments of the invention involve systems and methods for screen task design that allow authoring of executable tasks including inputting and outputting of data to and from selected fields of selected screens of a customized screen connector recording. Other embodiments of the invention include systems and methods directed to screen recording verification, non-dedicated navigation recording, screen connector configuration management, context management for object-oriented programming components, and user interfaces for screen connector design, screen identification generation, screen connector configuration, and screen task design, which will be further elaborated below.

In the following description, numerous specific details are provided to understand embodiments of the invention. One skilled in the relevant art, however, will recognize that the invention can be practiced without one or more of these specific details, or with other equivalent elements and components, etc. In other instances, well-known components and elements are not shown, or not described in detail, to avoid obscuring aspects of the invention or for brevity. In other instances, the invention may still be practiced if steps of the various methods described could be combined, added to, removed, or rearranged.

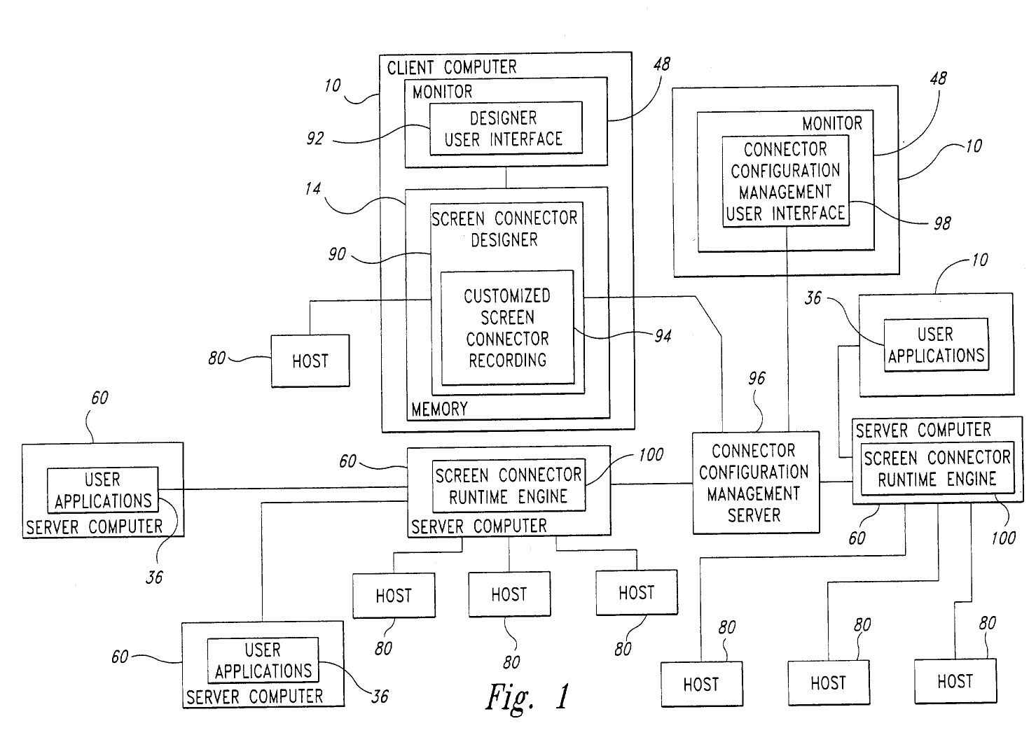

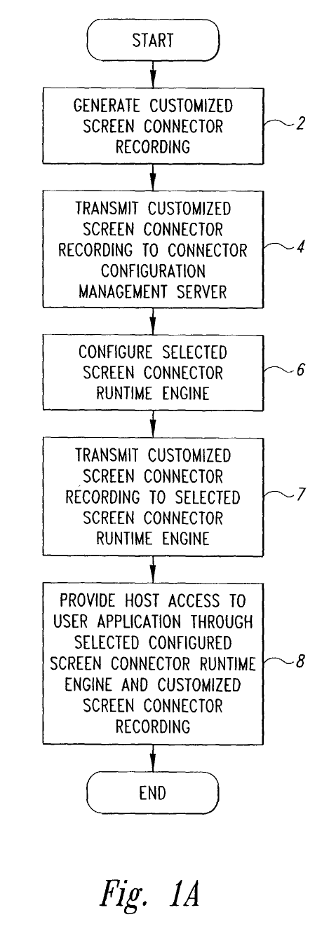

Systems and methods of the present invention directed to the design of customized screen connector recordings, configuration of screen connector runtime engines, and provision of access to host applications through screen connector runtime engines are shown in FIG. 1. A client computer 10 having memory 14, containing a screen connector designer 90, and a monitor 48, displaying a designer user interface 92, is used for generation of a customized screen connector recording 94. The generation of the customized screen connector recording 94 is based upon user input regarding a rudimentary host application screen recording previously recorded by a screen recording device of a host application found on a legacy host data system 80. The screen recording device could be found with the screen connector designer 90 or with another system not correctly associated with the screen connector designer. This generation of the customized screen connector recording 94 is summarized as step 2 of the overall system process found in FIG. 1A.

After the customized screen connector recording 94 is generated, it is transmitted over a communication network to a connector configuration management server 96 (step 4 of FIG. 1A). A connector configuration management user interface 98 running on either the same or another client computer 10 is then used in conjunction with the connector configuration management server 96 to configure a selected screen connector runtime engine 100 (step 6 of FIG. 1A) typically running on a server computer 60. The selected customized screen connector recording 94 is then transmitted over a communication network to the selected screen connector runtime engine 100 (step 7 of FIG. 1A) to subsequently provide access for one or more user applications 36 to one or more host applications found on one or more of the legacy host data systems 80 (step 8 of FIG. 1A).

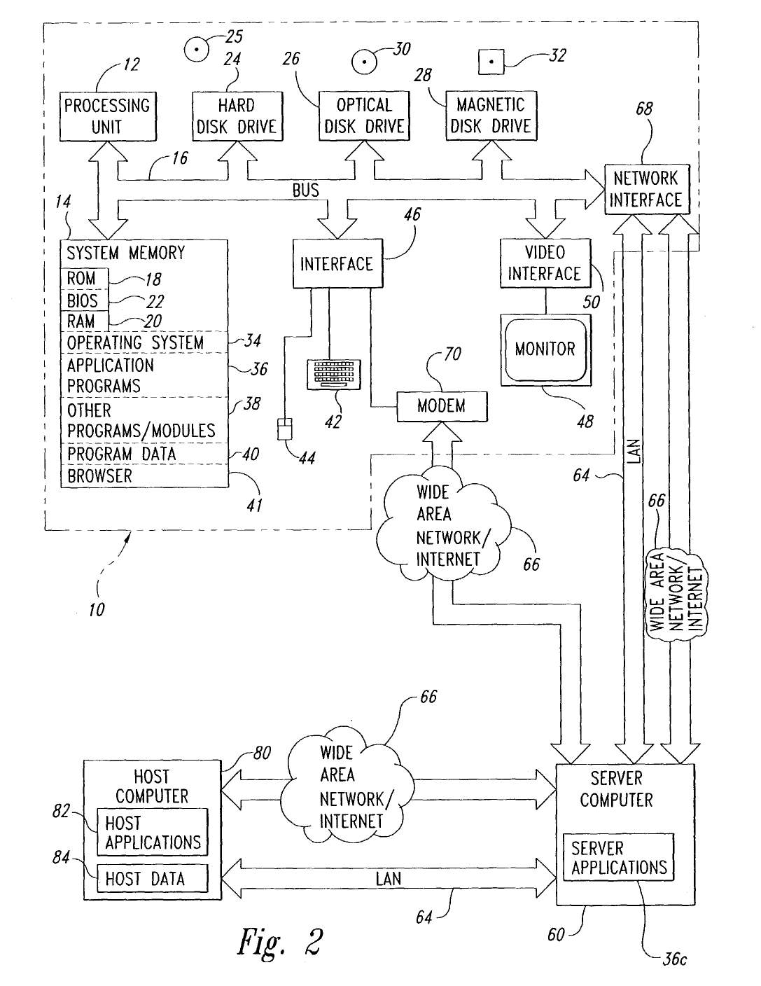

FIG. 2 and the following discussion provide a brief, general description of a suitable computing environment in which embodiments of the invention can be implemented. Although not required, embodiments of the invention will be described in the general context of computer-executable instructions, such as program application modules, objects, or macros being executed by a personal computer. Those skilled in the relevant art will appreciate that the invention can be practiced with other computer system configurations, including hand-held devices, multiprocessor systems, microprocessor-based or programmable consumer electronics, network PCs, mini computers, mainframe computers, and the like. The invention can be practiced in distributed computing environments where tasks or modules are performed by remote processing devices, which are linked through a communications network. In a distributed computing environment, program modules may be located in both local and remote memory storage devices.

Referring to FIG. 2, a conventional personal computer, referred to herein as a client computer 10, includes a processing unit 12, a system memory 14, and a system bus 16 that couples various system components including the system memory to the processing unit. The client computer 10 will at times be referred to in the singular herein, but this is not intended to limit the application of the invention to a single client computer since, in typical embodiments, there will be more than one client computer or other device involved. The processing unit 12 may be any logic processing unit, such as one or more central processing units (CPUs), digital signal processors (DSPs), application-specific integrated circuits (ASICs), etc. Unless described otherwise, the construction and operation of the various blocks shown in FIG. 2 are of conventional design. As a result, such blocks need not be described in further detail herein, as they will be understood by those skilled in the relevant art.

The system bus 16 can employ any known bus structures or architectures, including a memory bus with memory controller, a peripheral bus, and a local bus. The system memory 14 includes read-only memory (“ROM”) 18 and random access memory (“RAM”) 20. A basic input/output system (“BIOS”) 22, which can form part of the ROM 18, contains basic routines that help transfer information between elements within the client computer 10, such as during start-up.

The client computer 10 also includes a hard disk drive 24 for reading from and writing to a hard disk 25, and an optical disk drive 26 and a magnetic disk drive 28 for reading from and writing to removable optical disks 30 and magnetic disks 32, respectively. The optical disk 30 can be a CD-ROM, while the magnetic disk 32 can be a magnetic floppy disk or diskette. The hard disk drive 24, optical disk drive 26, and magnetic disk drive 28 communicate with the processing unit 12 via the bus 16. The hard disk drive 24, optical disk drive 26, and magnetic disk drive 28 may include interfaces or controllers (not shown) coupled between such drives and the bus 16, as is known by those skilled in the relevant art. The drives 24, 26, 28, and their associated computer-readable media, provide nonvolatile storage of computer readable instructions, data structures, program modules, and other data for the client computer 10. Although the depicted client computer 10 employs hard disk 25, optical disk 30, and magnetic disk 32, those skilled in the relevant art will appreciate that other types of computer-readable media that can store data accessible by a computer may be employed, such as magnetic cassettes, flash memory cards, digital video disks (“DVD”), Bernoulli cartridges, RAMs, ROMs, smart cards, etc.

Program modules can be stored in the system memory 14, such as an operating system 34, one or more application programs 36, other programs or modules 38 and program data 40. The system memory 14 also includes a browser 41 for permitting the client computer 10 to access and exchange data with sources such as web sites of the Internet, corporate intranets, or other networks as described below, as well as other server applications on server computers such as those further discussed below. The browser 41 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. Although the depicted embodiment shows the client computer 10 as a personal computer, in other embodiments, the client computer is some other computer-related device such as a personal data assistant (PDA), a cell phone, or other mobile device.

While shown in FIG. 2 as being stored in the system memory 14, the operating system 34, application programs 36, other programs/modules 38, program data 40, and browser 41 can be stored on the hard disk 25 of the hard disk drive 24, the optical disk 30 of the optical disk drive 26, and/or the magnetic disk 32 of the magnetic disk drive 28. A user can enter commands and information into the client computer 10 through input devices such as a keyboard 42 and a pointing device such as a mouse 44. Other input devices can include a microphone, joystick, game pad, scanner, etc. These and other input devices are connected to the processing unit 12 through an interface 46 such as a serial port interface that couples to the bus 16, although other interfaces such as a parallel port, a game port, a wireless interface, or a universal serial bus (“USB”) can be used. A monitor 48 or other display device is coupled to the bus 16 via a video interface 50, such as a video adapter. The client computer 10 can include other output devices, such as speakers, printers, etc.

The client computer 10 can operate in a networked environment using logical connections to one or more remote computers, such as a server computer 60. The server computer 60 can be another personal computer, a server, another type of computer, or a collection of more than one computer communicatively linked together and typically includes many or all the elements described above for the client computer 10. The server computer 60 is logically connected to one or more of the client computers 10 under any known method of permitting computers to communicate, such as through a local area network (“LAN”) 64, or a wide area network (“WAN”) or the Internet 66. Such networking environments are well known in wired and wireless enterprise-wide computer networks, intranets, extranets, and the Internet. Other embodiments include other types of communication networks, including telecommunications networks, cellular networks, paging networks, and other mobile networks.

When used in a LAN networking environment, the client computer 10 is connected to the LAN 64 through an adapter or network interface 68 (communicatively linked to the bus 16). When used in a WAN networking environment, the client computer 10 often includes a modem 70 or other device, such as the network interface 68, for establishing communications over the WAN/Internet 66. The modem 70 is shown in FIG. 2 as communicatively linked between the interface 46 and the WAN/Internet 66. In a networked environment, program modules, application programs, or data, or portions thereof, can be stored in the server computer 60. In the depicted embodiment, the client computer 10 is communicatively linked to the server computer 60 through the LAN 64 or the WAN/Internet 66 with TCP/IP middle layer network protocols; however, other similar network protocol layers are used in other embodiments. Those skilled in the relevant art will readily recognize that the network connections shown in FIG. 2 are only some examples of establishing communication links between computers, and other links may be used, including wireless links.

The server computer 60 is further communicatively linked to a legacy host data system 80 typically through the LAN 64 or the WAN/Internet 66 or other networking configuration such as a direct asynchronous connection (not shown). Other embodiments may support the server computer 60 and the legacy host data system 80 on one computer system by operating all server applications and legacy host data system on the one computer system. The legacy host data system 80 in an exemplary embodiment is an International Business Machines (IBM) 390 mainframe computer configured to support IBM 3270 type terminals. Other exemplary embodiments use other vintage host computers such as IBM AS/400 series computers, UNISYS Corporation host computers, Digital Equipment Corporation VAX host computers and VT/Asynchronous host computers as the legacy host data system 80. The legacy host data system 80 is configured to run host applications 82, such as in system memory, and store host data 84 such as business related data.

An exemplary embodiment of the invention is implemented in the Sun Microsystems Java programming language to take advantage of, among other things, the cross-platform capabilities found with the Java language. For instance, exemplary embodiments include the server computer 60 running Windows NT, Win2000, Solaris, or Linux operating systems. In exemplary embodiments, the server computer 60 runs an Apache Tomcat/Tomcat Jakarta web server, a Microsoft Internet Information Server (ISS) web server, or a BEA Weblogic web server.

Apache is a freely available Web server that is distributed under an “open source” license and runs on most UNIX-based operating systems (such as Linux, Solaris, Digital UNIX, and AIX), on other UNIX/POSIX-derived systems (such as Rhapsody, BeOs, and BS2000/OSD), on AmigaOS, and on Windows NT/95/98. Windows-based systems with Web servers from companies such as Microsoft and Netscape are alternatives, but the Apache web server seems suited for enterprises and server locations (such as universities) where UNIX-based systems are prevalent. Other embodiments use other web servers and programming languages such as C, C++, and C#.

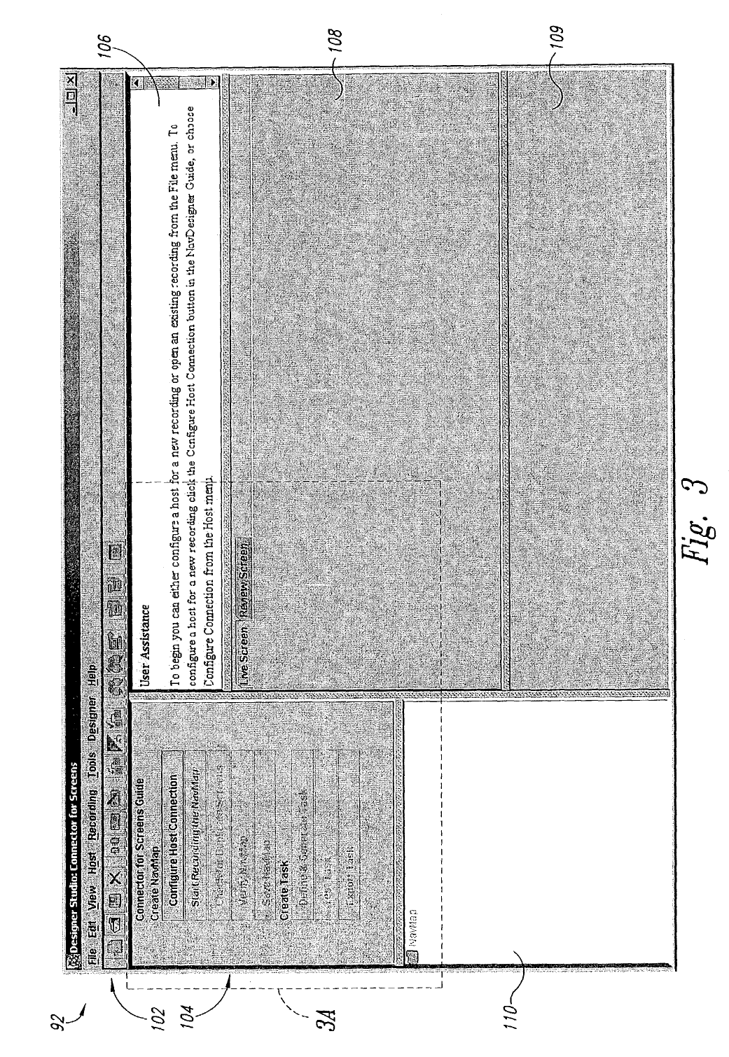

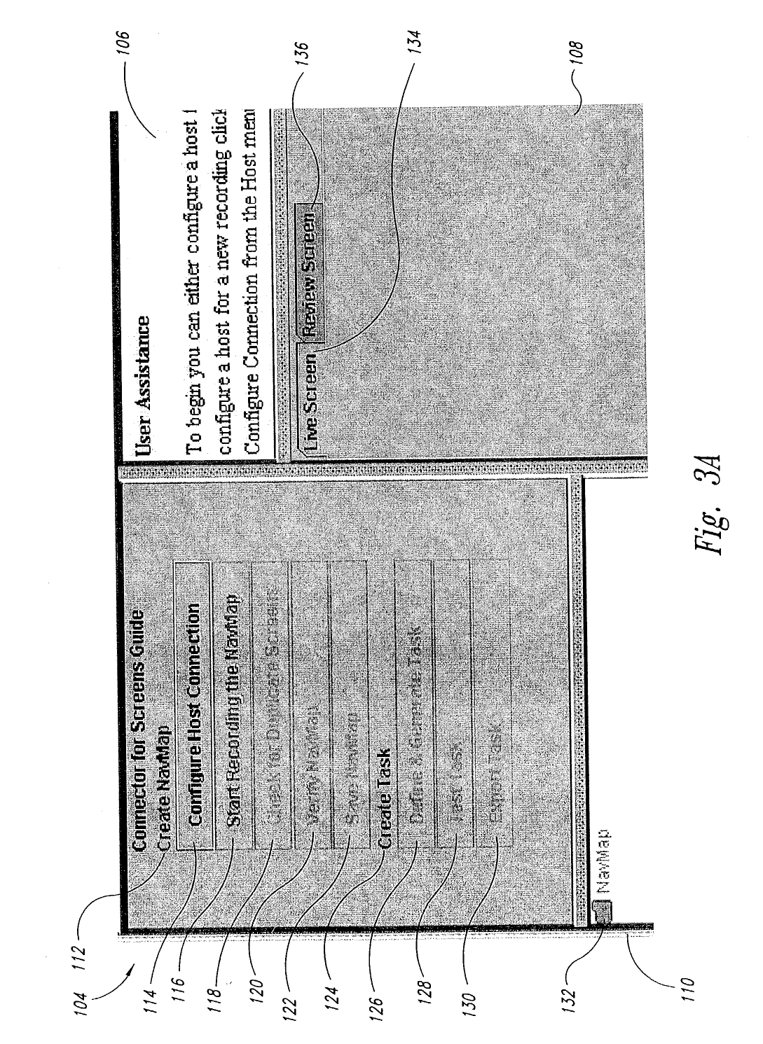

An exemplary embodiment of the screen connector designer 90 will be discussed with reference to FIG. 3, which shows an interface screen from an embodiment of the designer user interface 92. The present embodiment of the designer user interface 92 includes a screen designer toolbar 102, a screen designer workflow menu 104, a screen designer advisory window 106, a screen designer host screen display 108, a screen designer properties display area 109, and a screen designer ungrouped screens tree display 110.

The screen designer toolbar 102 contains menu selections related to file selection, editing features, display viewing, tool selection, designer features, and help selection. The screen designer workflow menu 104 provides to a user of the screen connector designer 90 selection and tracking of operations associated with generating the customized screen connector recording 94. The screen designer advisory window 106 can be used to provide structures to the user related to the various operations available for selection from the screen designer workflow menu 104. The screen designer host screen display 108 is used to display host application screens while screen recording is being performed to generate rudimentary host application screen recordings and also for review of existing rudimentary host application screen recordings and rudimentary host application screen recordings modified to become the customize screen connector recordings 94. The screen designer ungroup screens tree display shows screens of a rudimentary host application screen recording arranged in a tree structure.

The host screen designer workflow menu 104 contains a create screen connector recording section 112, which includes a configured host connection selection 114, a start recording selection 116, a check for duplicate screens selection 118, a verify screen connector recording selection 120, and a save screen connector recording selection 122. The configured host connection selection 114 is used to select tools to configure one or more communication connections between the screen connector designer 90 and one of the legacy host data systems 80 having one or more of the host applications 82 to be used to generate a rudimentary host application screen recording.

The start recording selection 116 is used to start generation of a rudimentary host application screen recording. The check for duplicate screens selection 118 is used to invoke an automated grouping of host screens from the rudimentary host application screen recording into same screen collections to generate an initial version of the customized screen connector recording 94 to be further customized as an option by the user of the screen connector designer 90. The verify screen connector recording selection 120 is used to invoke verification of the customized screen connector recording 94. After verification, the save screen connector recording selection 122 is used to save the customized screen connector recording 94.

The screen designer workflow menu 104 further includes a create task section 124 having a define and generate task selection 126, a test task selection 128, and an import task selection 130 all directed to the design of a screen task discussed further below. The screen designer host screen display 108 further includes a live screen selection 134 for viewing of a host screen currently being recorded and a review screen selection 136 for viewing of recorded host screens.

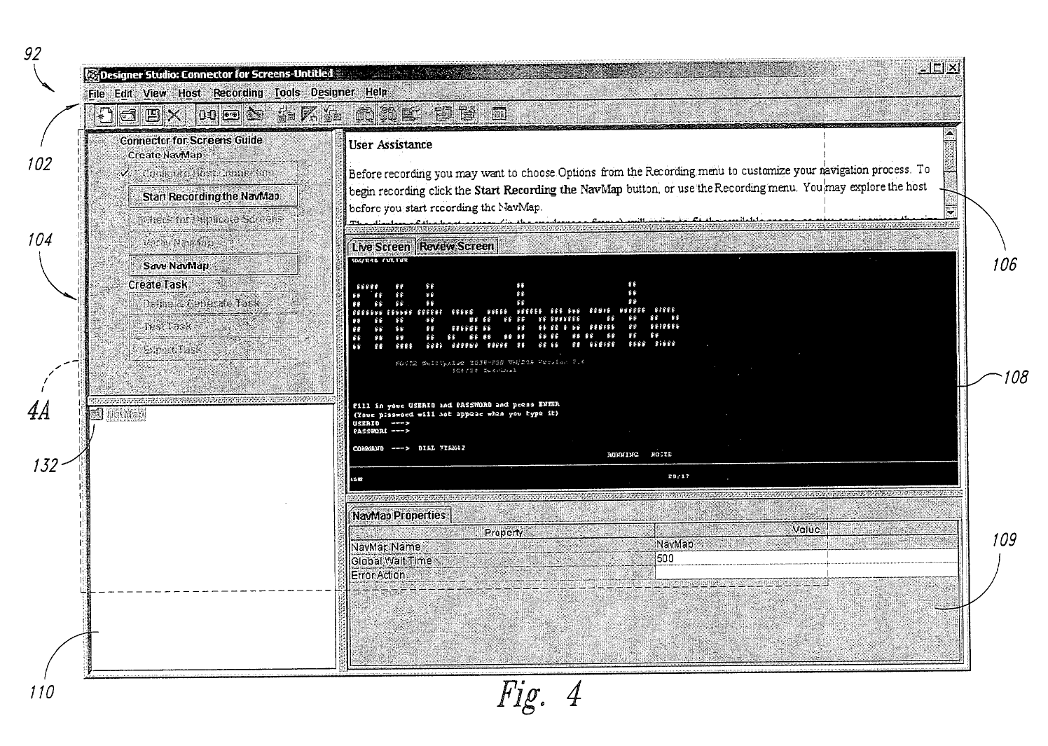

The designer user interface 92 of the screen connector designer 90 includes capabilities for displaying properties related to both rudimentary host application screen recordings and the customized screen connector recordings 94. As shown in FIG. 4, the screen designer ungrouped screens tree display 110 can contain a screen connector recording icon 132, herein used to represent a rudimentary host application screen recording. The screen designer workflow menu 104 displays a previous selection indication check mark 138 when a selection has been previously invoked. Selections of the screen designer workflow menu 104 being displayed with light text are not available for current selection.

By selecting the screen connector recording icon 132, a screen connector recording properties selection indication 140 is displayed in the screen designer properties display area 109 as shown in FIG. 4A. With the screen connector recording properties selection indication 140 being displayed, the screen designer properties display area 109 further displays a screen connector recording properties name column 142 to identify titles of particular screen connector recording properties, and a screen connector recording properties value column 144 to identify values associated with the particular screen connector recording properties. Particular screen connector recording properties can include a screen connector recording name property 146, a screen connector recording global wait time property 148, and a screen connector recording error action property 150.

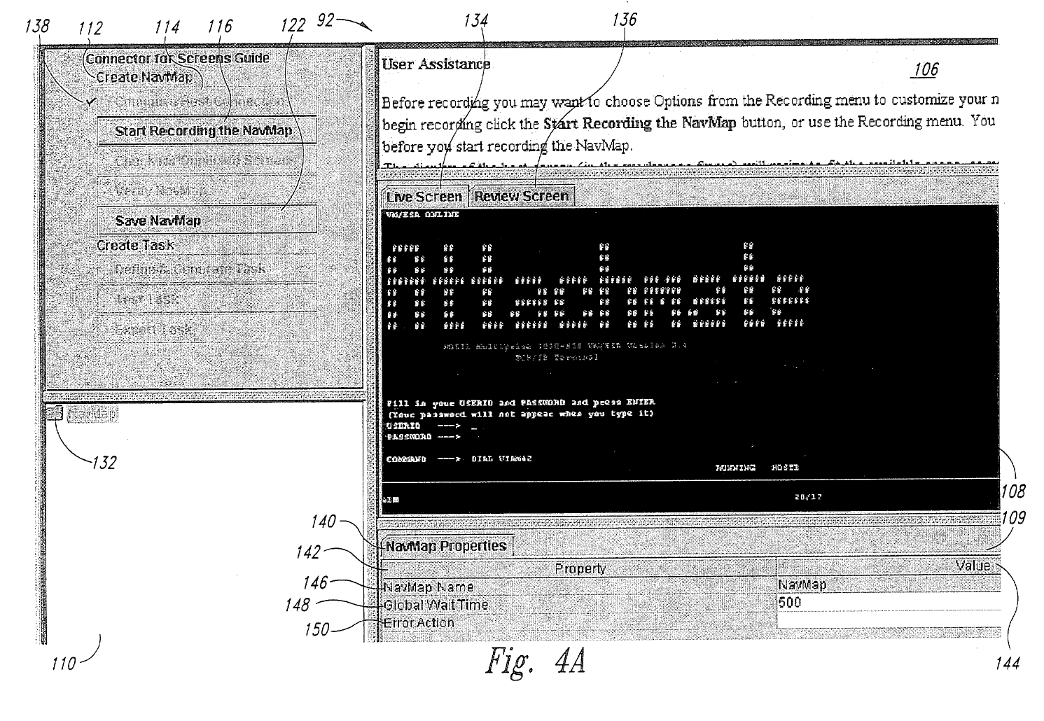

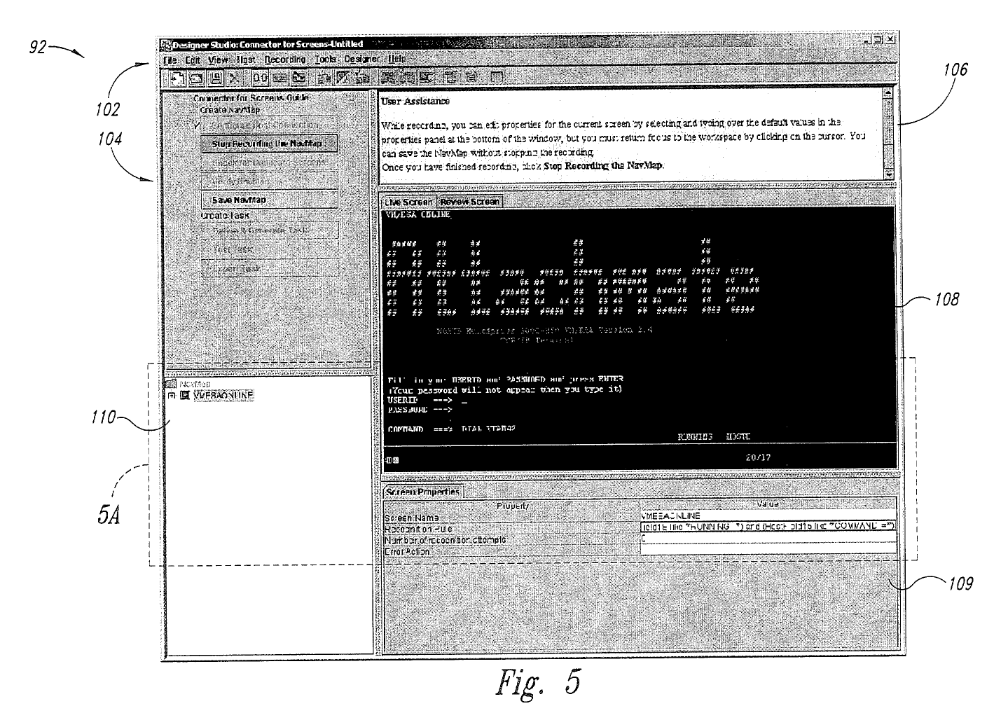

The screen designer ungrouped screens tree display 110 can also display host screens found within a particular rudimentary host application screen recording or one of the customized screen connector recordings 94 as shown generally in FIG. 5 and a more detail in FIG. 5A where a first ungrouped screen icon 152 is displayed. As shown in FIG. 5A, when the first ungrouped screen icon 152 is selected, the screen designer properties display area 109 displays a screen properties selection indication 154. Also displayed in the screen designer properties display area 109, are a screen properties name column 156 to identify titles of particular host screen properties, and a screen properties value column 158 to identify values associated with the particular host screen properties. Particular host screen properties can include a screen recognition rule property 162 used to identify the particular host screen, a screen number of recognition attempts property 164, and a screen error action property 166.

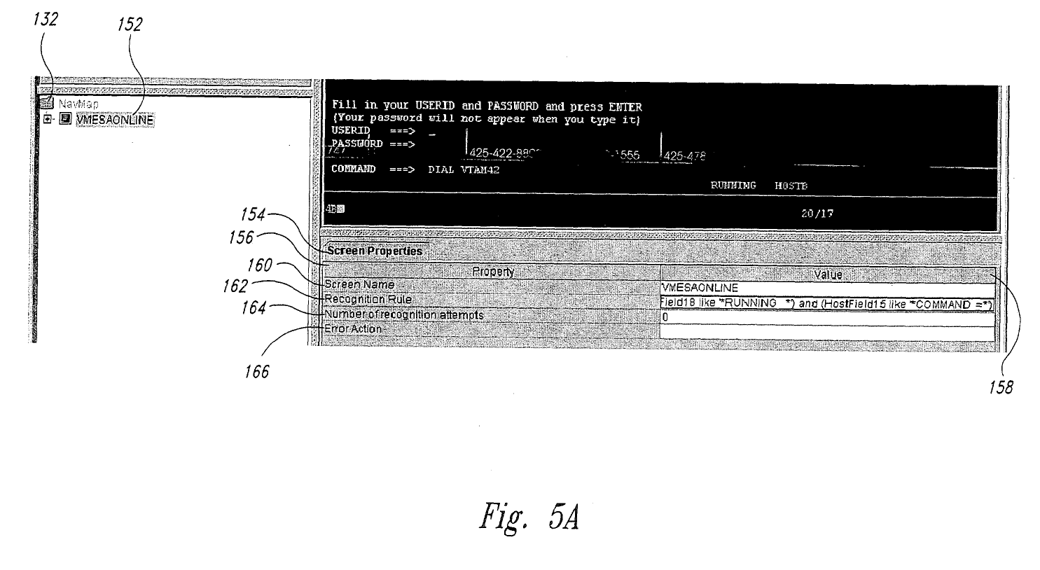

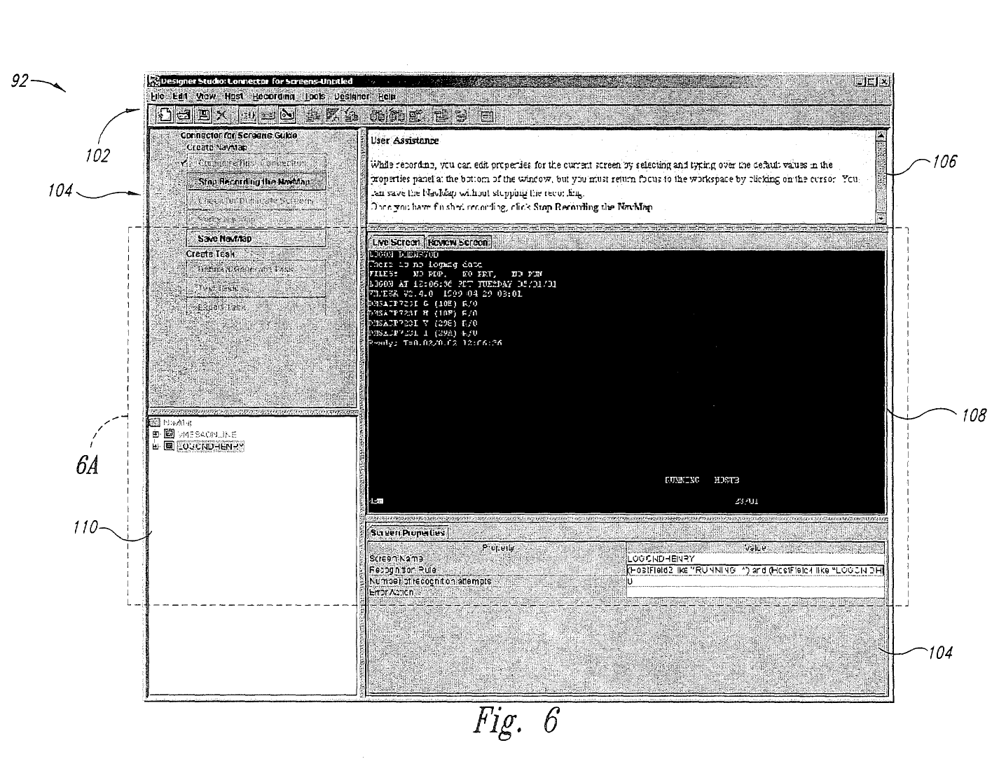

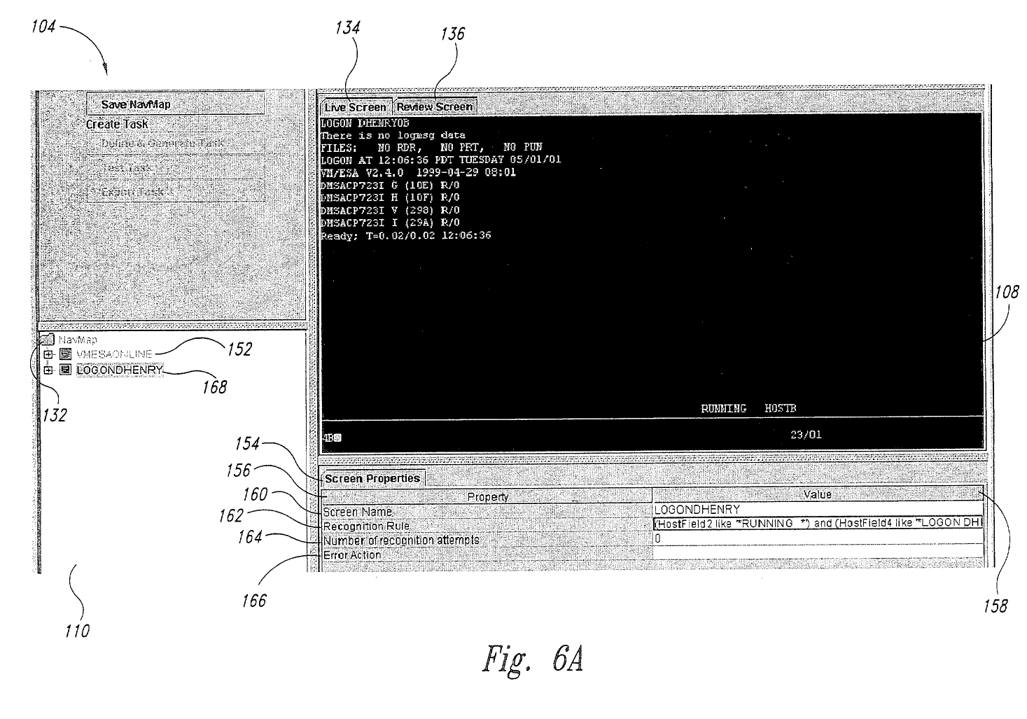

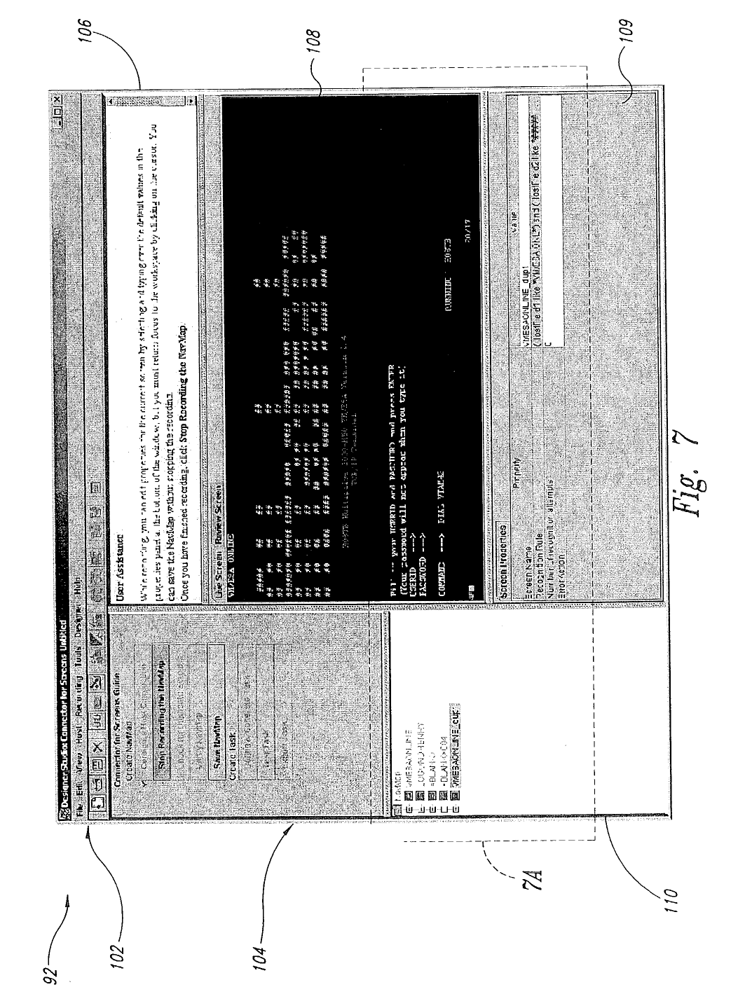

As additional host screens are recorded into the rudimentary host application screen recording, additional screen icons are displayed in the screen designer ungrouped screens tree display 110 as shown in FIG. 6, and in more detail in FIG. 6A, where a second ungrouped screen icon 168 is displayed in the screen designer ungrouped screens tree display. As the rudimentary host application screen recording is further generated by the screen connector designer 90, additional host screens are displayed on the screen designer ungrouped screens tree display 110 as shown in FIG. 7 and in more detail in FIG. 7A where a third ungrouped screen icon 170, a fourth ungrouped screen icon 172, and a fifth ungrouped screen icon 174 are shown.

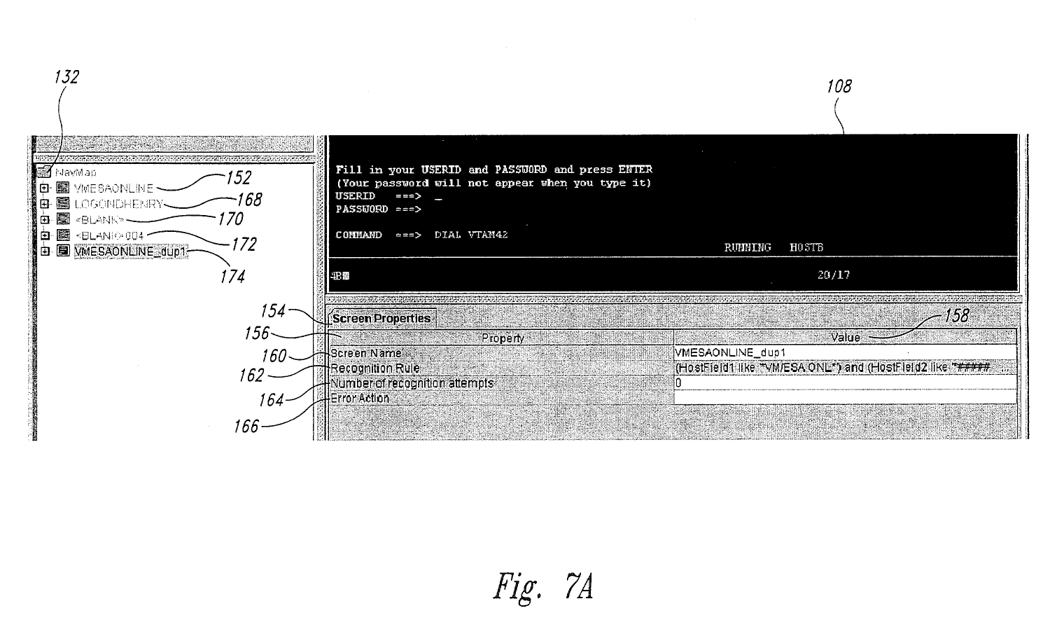

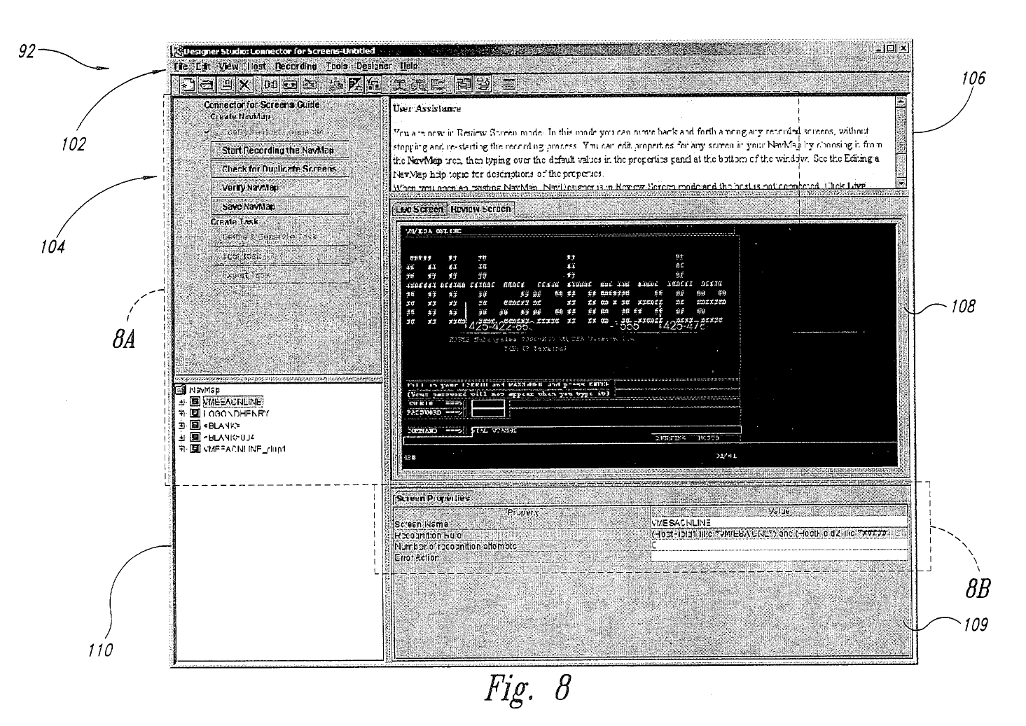

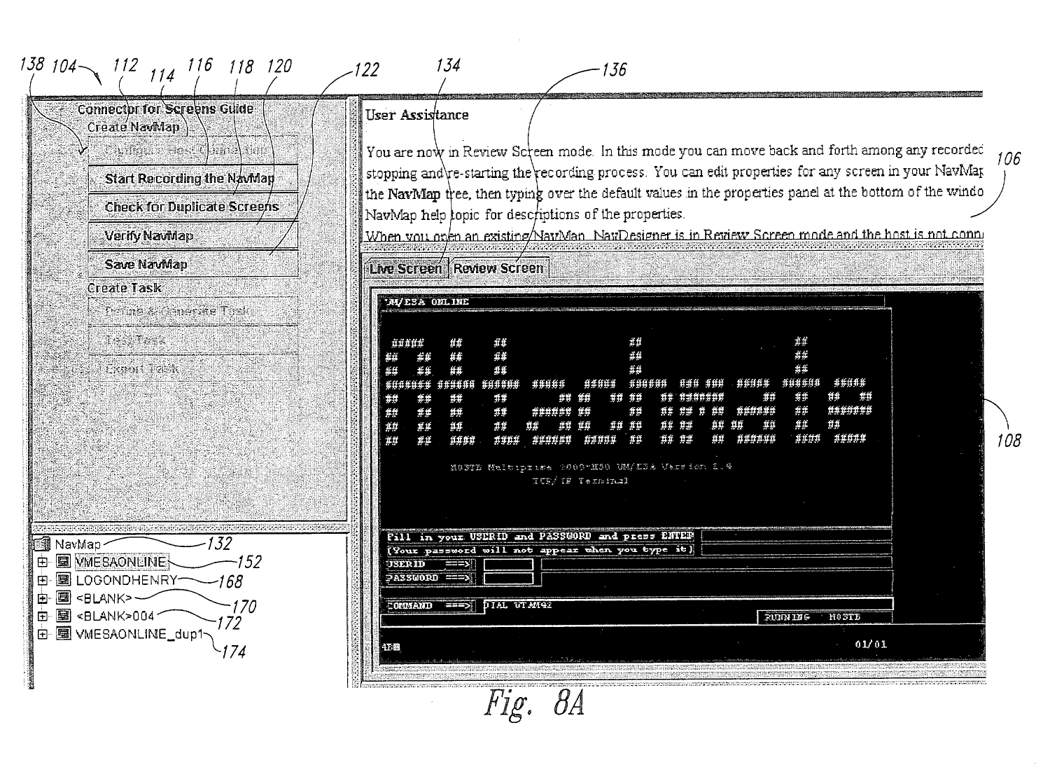

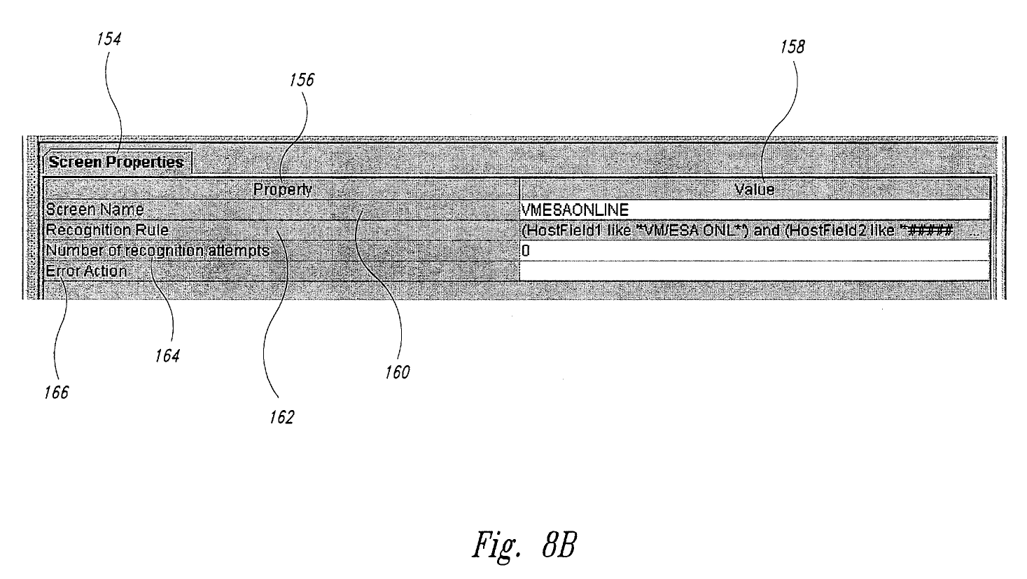

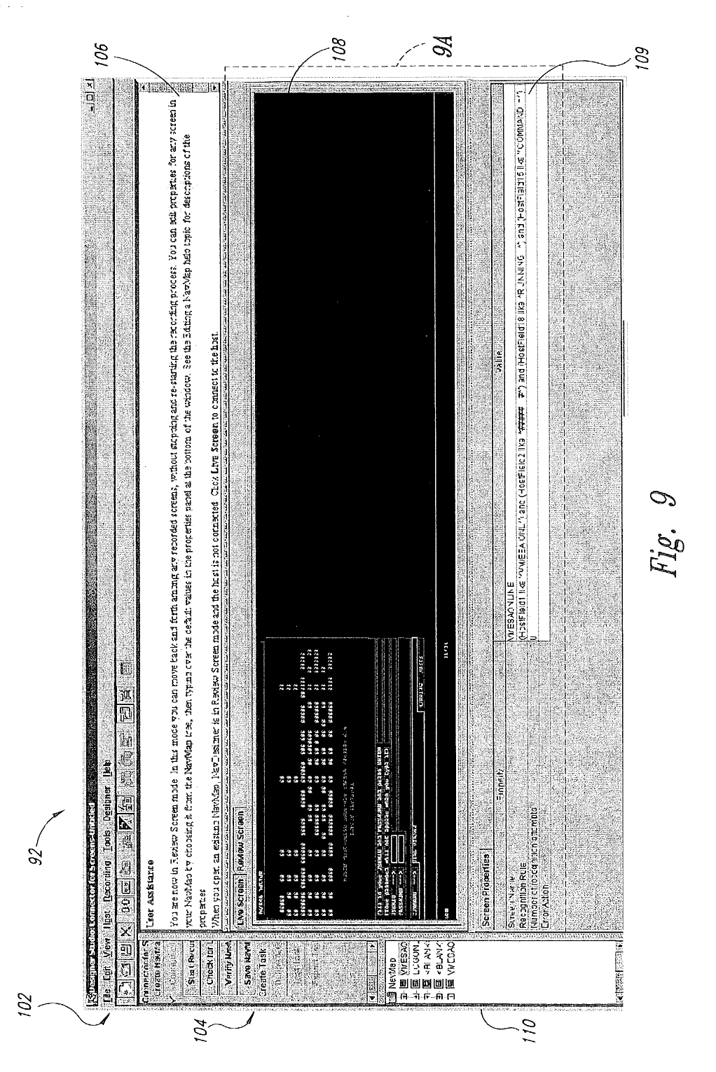

As indicated by the live screen selection 134 of the screen designer host screen display 108, the host screens displayed in the screen designer host screen display for FIGS. 4-7 are host screens currently being recorded by the screen connector designer 90. As indicated by the review screen selection 136, the host screens displayed by the screen designer host screen display 108 for FIGS. 8-9 are recorded host screens being displayed for review purposes. As shown in FIG. 8, and in more detail in FIGS. 8A and 8B, the first ungrouped screen icon 152 displayed in the screen designer ungrouped screens tree display 110 has been selected for display on the screen designer host screen display 108, with its screen properties being displayed in the screen designer properties display area 109. The screen recognition rule property 162 for the first ungrouped screen icon 152 is shown in FIG. 9A as an example of automated generation of a screen recognition rule.

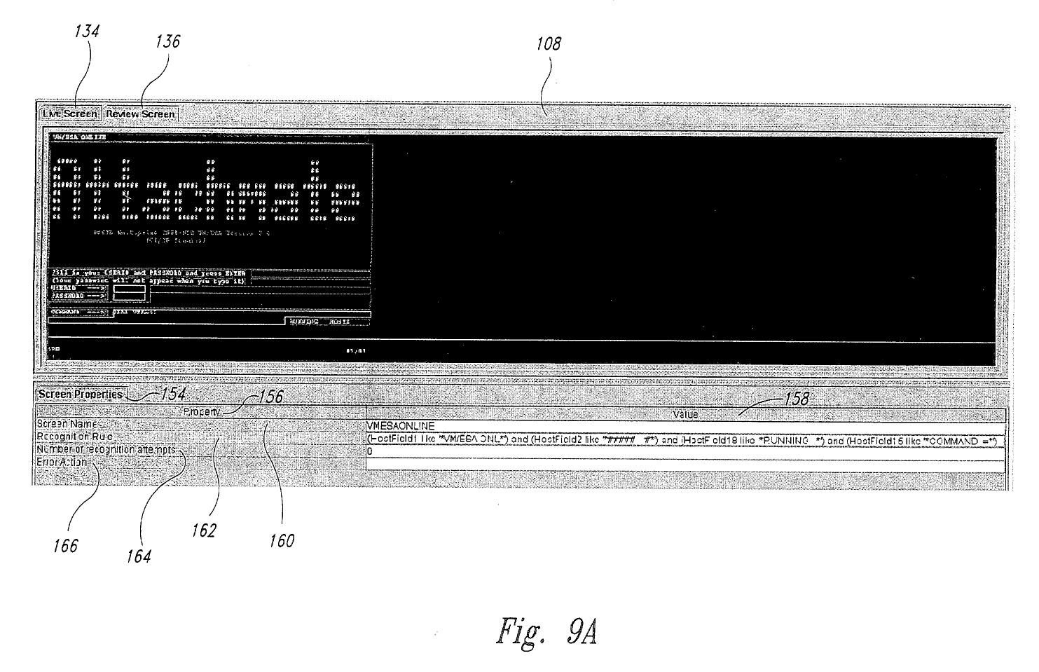

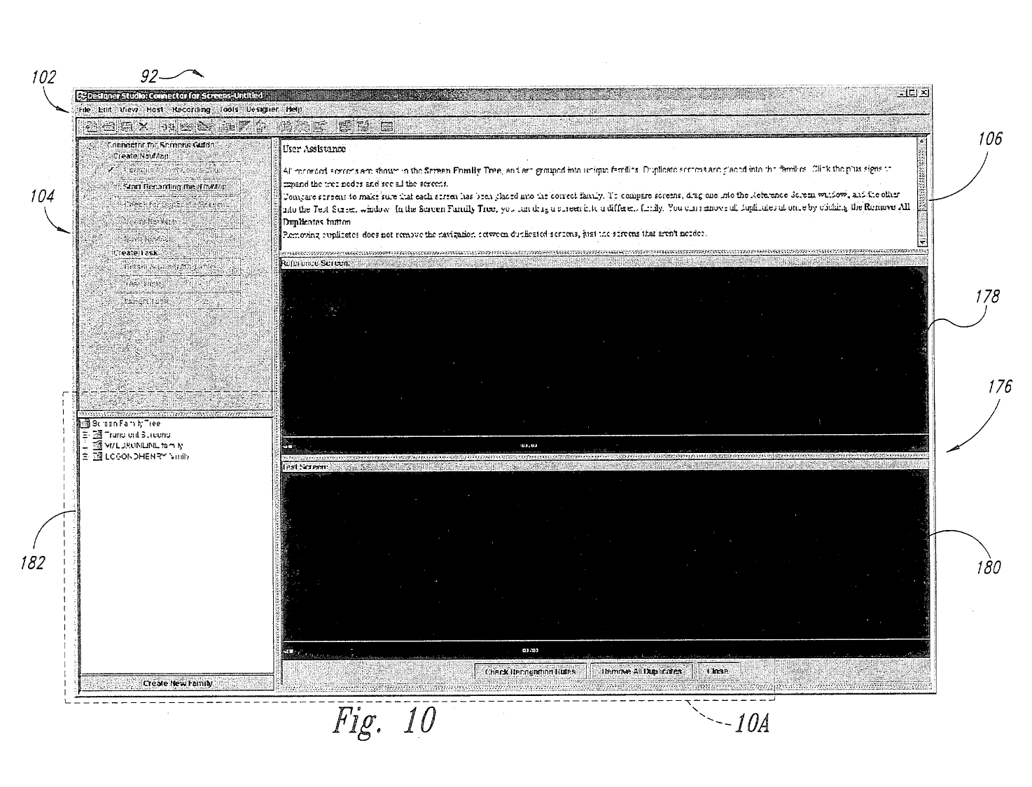

After a rudimentary host application screen recording has been generated by the screen connector designer 90, the user of the screen connector designer then selects the check for duplicate screen selection 118, which results in a screen display of the designer user interface 92, as shown for example in FIG. 10, having a custom grouping host screen comparison display 176, with a custom grouping reference host screen display 178 and a custom grouping test host screen display 180, and a custom screen grouping tree display 182. As shown in more detail in FIG. 10A, the custom screen grouping tree display 182 further includes an exemplary root screen grouping icon 184, a first screen grouping icon 186, a second screen grouping icon 188, and a third screen grouping icon 190. Since this is an example, other cases may have more or less screen grouping icons displayed on the screen grouping tree display 182. The screen grouping tree display 182 also includes a create new screen grouping selection 192. The custom grouping test host screen display 180 further includes a screen identification verifier activation selection 194 used to activate verification of screen recognition rules, a duplicate screens removal selection 196, and a custom screen grouping exit selection 198.

An expansion of the screen grouping icons 184-190 of the custom grouping test host screen display 180 is shown in FIG. 11 and in more detail in FIG. 11A, and expansion of the first screen grouping icon 186 includes a first grouped screen icon 200 and a second grouped screen icon 202, which were determined by the screen connector designer 90 as being in a same screen collection. Similarly, the second screen grouping icon 188 is expanded to show a third grouped screen icon 204 and a fourth grouped screen icon 206, and the third screen grouping icon 190 is expanded to show a fifth grouped screen icon 208. If the user of the screen connector designer 90 decides that the same screen collections associated with the first screen grouping icon 186, the second screen grouping icon 188, and the third screen grouping 190 are not correct, the regroup the grouped screen icons by moving them under different existing or newly created screen grouping icons. Creation of additional screen grouping icons is accomplished by activating the create new screen grouping selection 192.

For comparison purposes, FIGS. 11 and 11A show the custom grouping reference host screen display 178 and the custom grouping test screen display 180 displaying screens associated with the first grouped screen icon 200 and the second grouped screen icon 202, respectively. Additionally, FIGS. 12 and 12A show the custom grouping reference host screen display 178 and the custom grouping test screen display 180 displaying screens associated with the third grouped screen icon 204 and the fourth grouped screen icon 206.

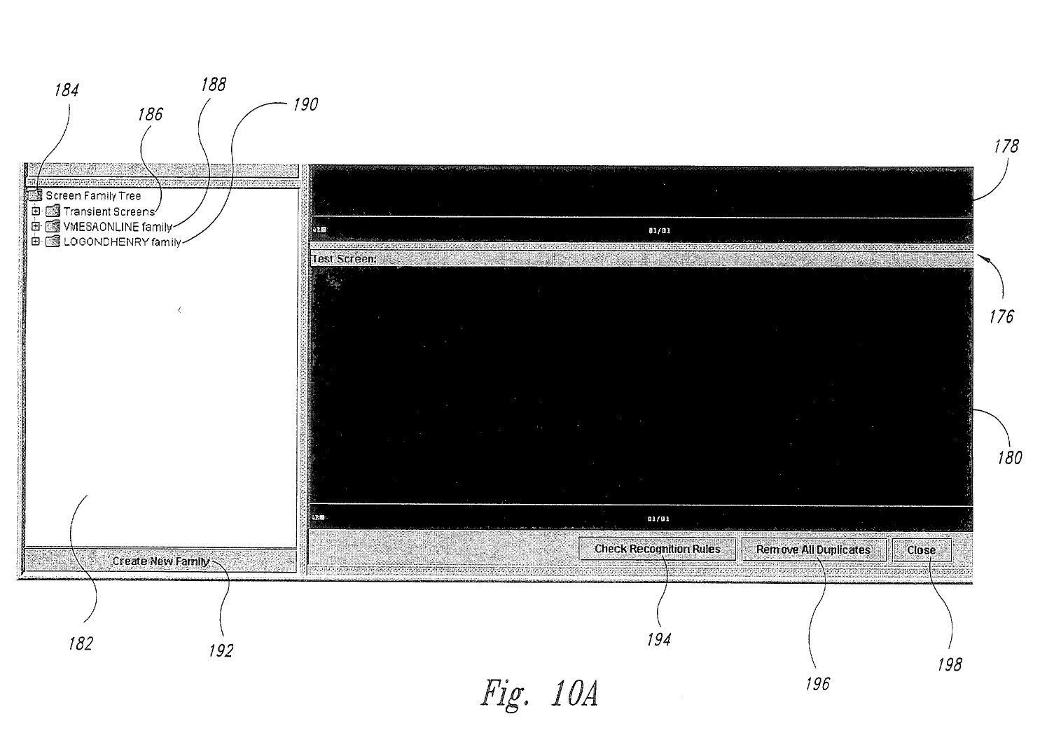

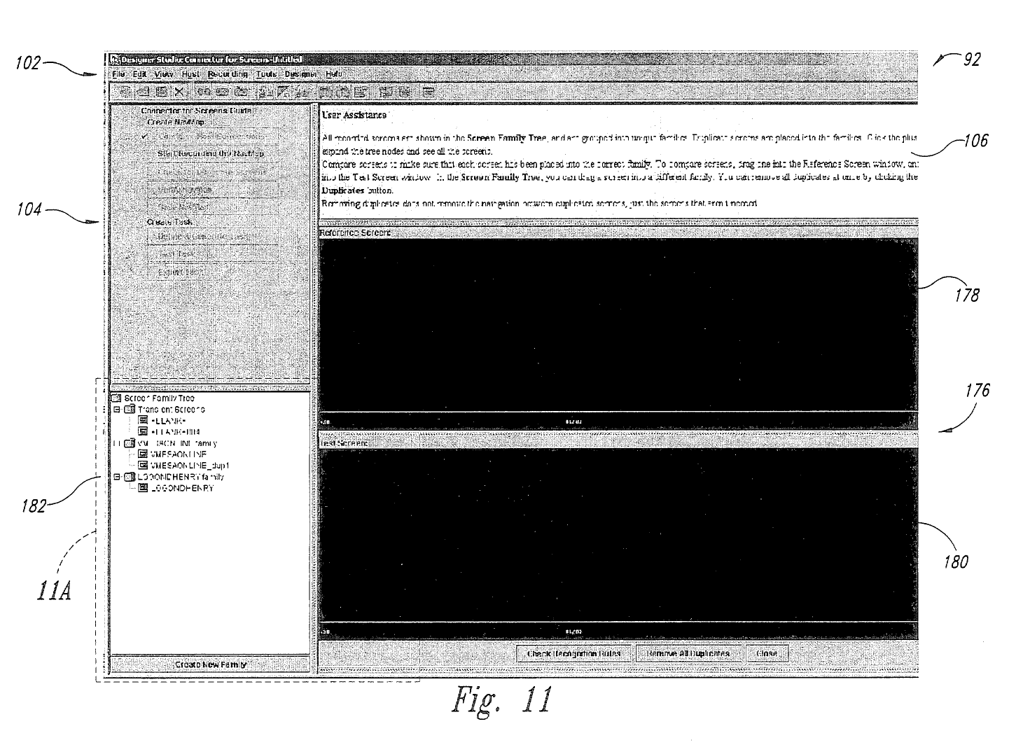

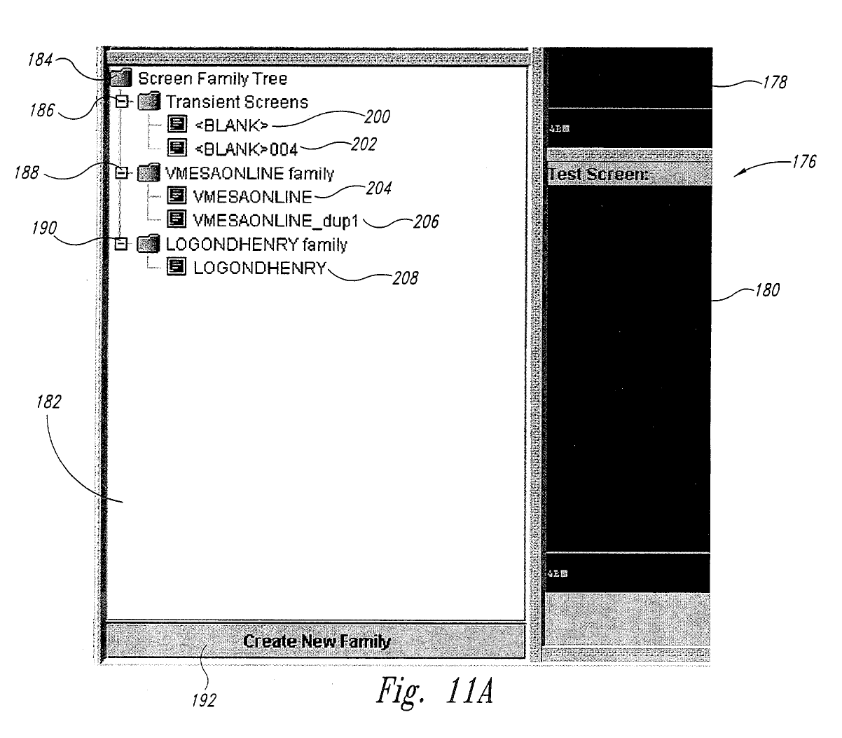

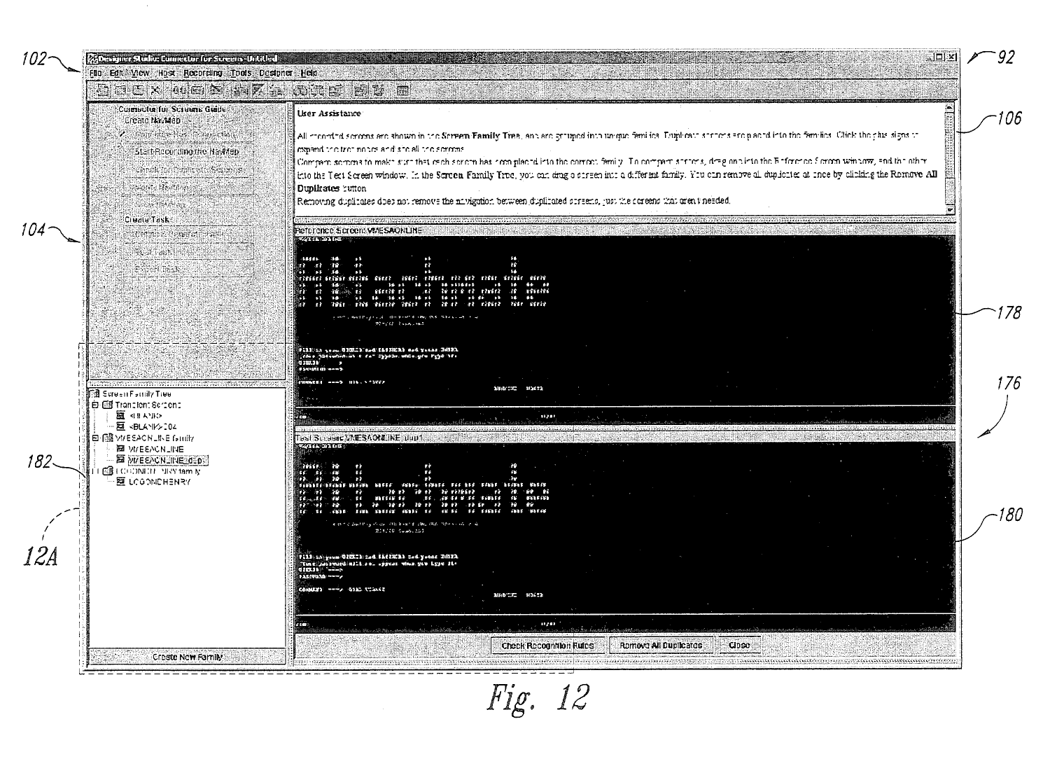

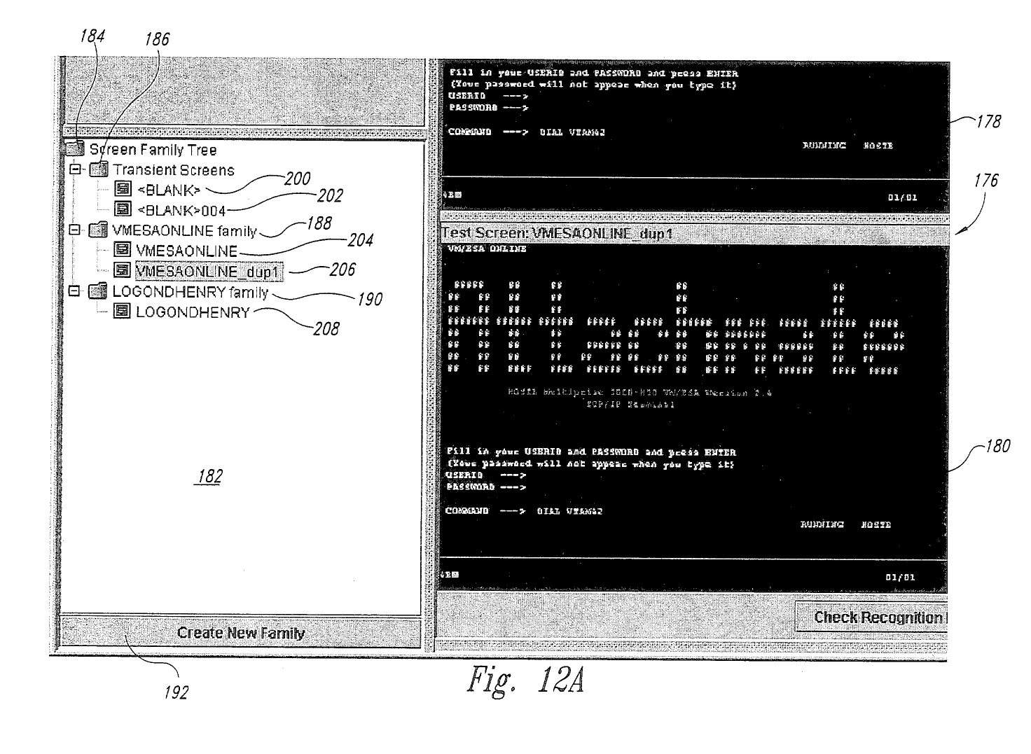

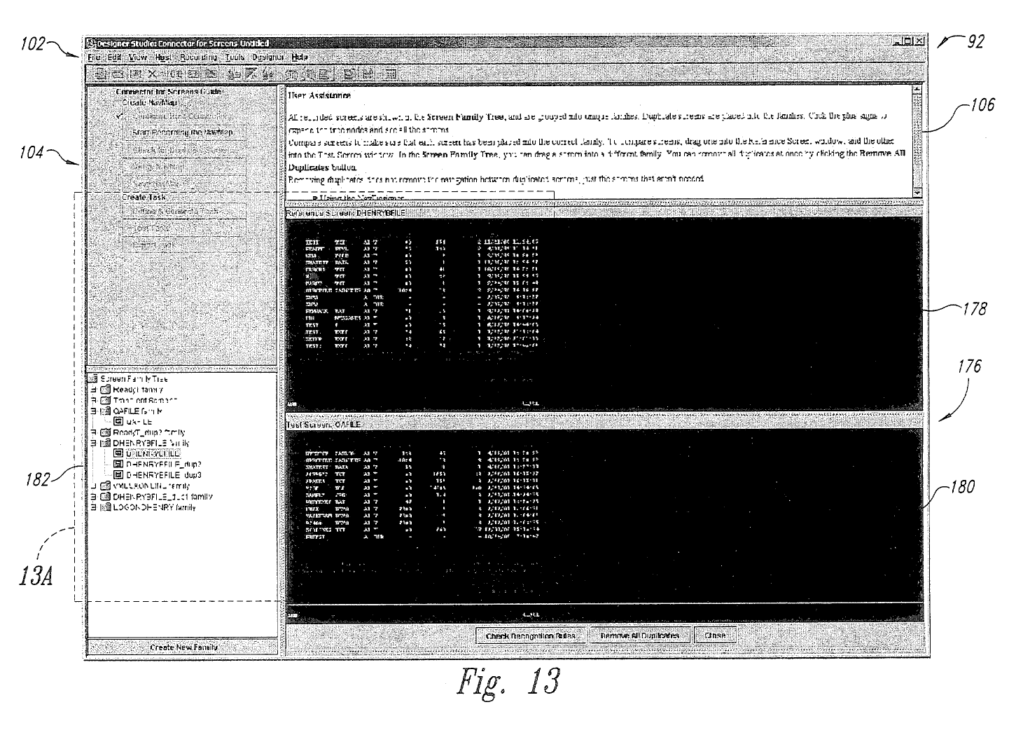

Further comparisons of other host screens associated with other grouped screen icons within other same screen collections identified by other same screen grouping icons can be performed by using the custom screen grouping host screen comparison display 176 in a similar manner. For example, in FIG. 13 and shown in more detail in FIG. 13A, such a comparison is made where a fourth screen grouping icon 210 is associated with a same screen collection containing a sixth grouped screen icon 212, a seventh grouped screen icon 214, and an eighth grouped screen icon 216, and a fifth screen grouping icon 218 is associated with a same screen collection containing a ninth grouped screen icon 220. In FIG. 13A, the custom grouping reference host screen display 178 is displaying the host screen associated with the sixth grouped screen icon 212, and the custom grouping test of screen display 180 is displaying the host screen associated with the ninth grouped screen icon 220.

As stated, by using the custom grouping host screen comparison display 176, the user of the screen connector designer 90 can determine if the host screens of a rudimentary host application screen recording have been appropriately grouped by the screen connector designer after the check for duplicate screens selection 118 has been activated by the user. If the user determines that host screens should be regrouped into different same screen collections, host screens can be regrouped by common methods such as dragging and dropping the grouped screen icons under different screen grouping icons, such as with use of the mouse 44.

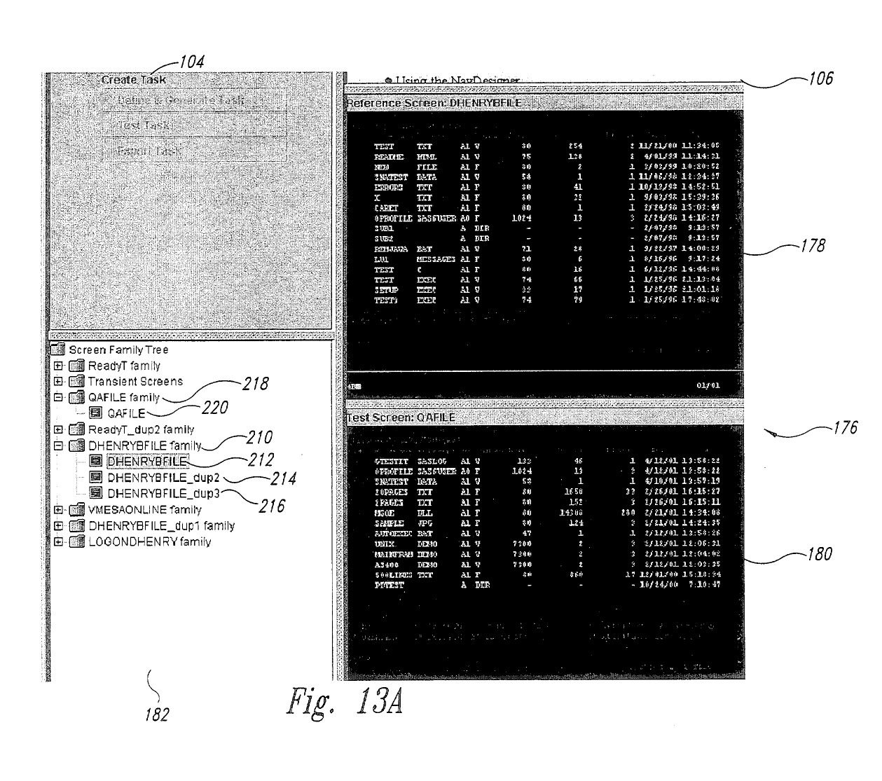

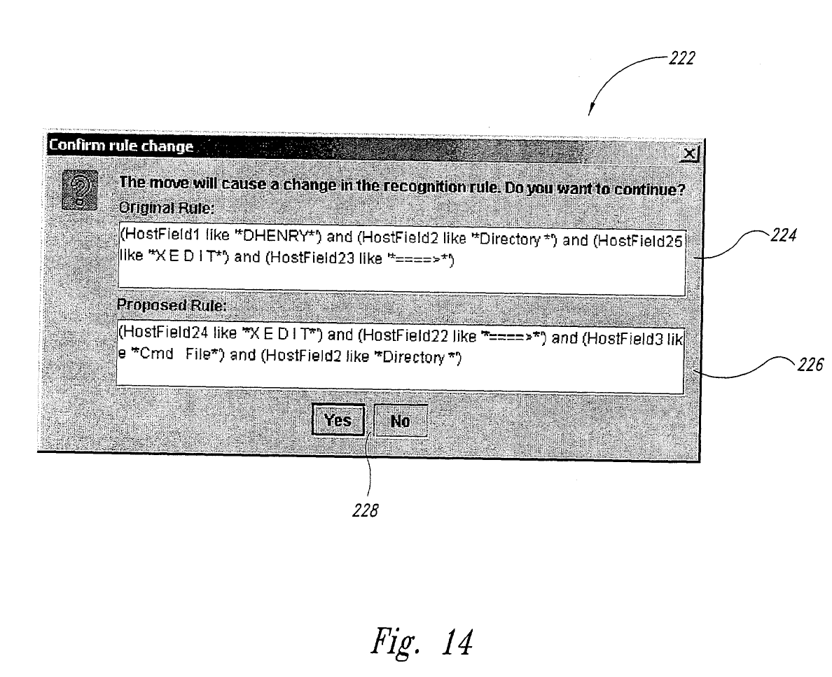

When a grouped screen icon has been moved from under a former screen grouping icon to a present screen grouping icon, the screen connector designer 90 displays on the designer user interface 92 a screen regrouping confirmation request 222, shown on FIG. 14, alerting the user how the recognition rule used to identify the host screens under the present screen grouping icon will be changed. A similar message can be posted regarding how the recognition rule associated with the host screens under the former screen grouping icon will also be changed. The screen regrouping confirmation request 222 contains an original screen identification indication field 224 showing what the associated recognition rule was before regrouping occurred and a proposed screen identification indication field 226 showing what the associated recognition rule would be after regrouping is confirmed. Regrouping is confirmed by choosing the confirmation selection 228 in an affirmative manner.

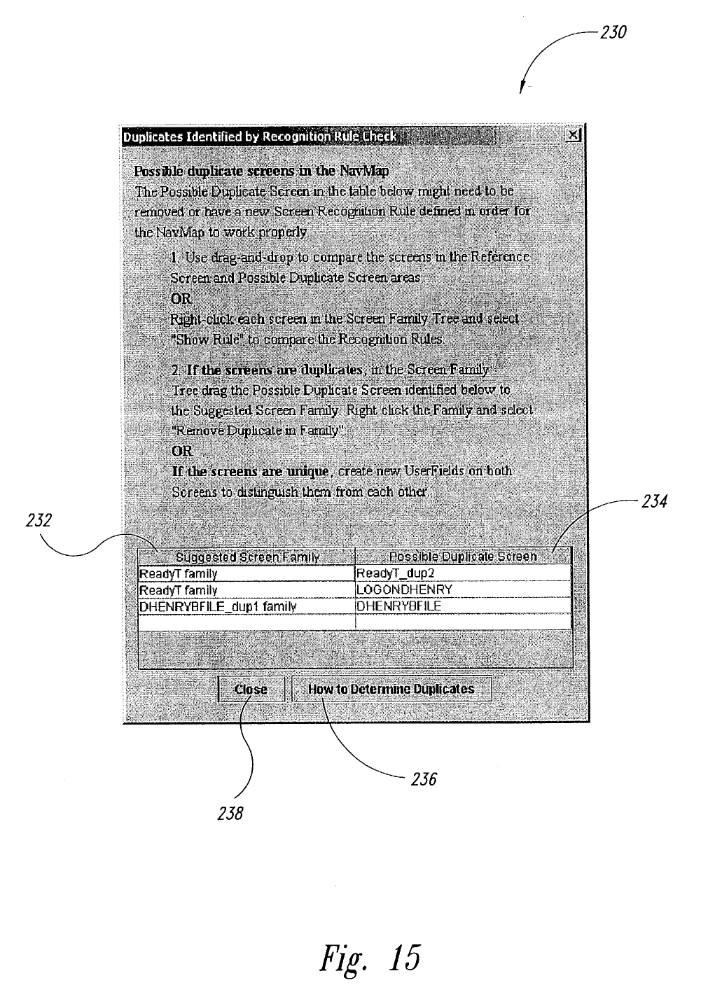

While reviewing same screen collections of host screens with the custom grouping host screen comparison display 176, the user can activate the screen connector designer 90, through the screen identification verifier activation selection 194, to further identify duplicate host screens through analysis of the recognition rules currently used to label the various host screens. The screen connector designer 90 will then display on the designer user interface 92 a duplicate screen alert 230, as shown in FIG. 15, containing a suggested screen grouping column 232 and a possible duplicate screen column 234. This duplicate screen alert 230 notifies the user that the host screens identified may be possible duplicates, according to the current recognition rules associated with the identified host screens, so that the user can either have the recognition rules modified or have the identified screens removed as being duplicates. The duplicate screen alert 230 further contains an information request 236 to assist the user with this process and a duplicate screen alert exit 238 to exit the duplicate screen alert.

At the end of this regrouping process, the screen connector designer 90 will display on the designer user interface 92 a duplicate screen message 240, as shown in FIG. 16, providing further advice to the user to double check whether the grouping of the host screens is correct and, if so, to remove the duplicate host screens by activating the duplicate screens removal selection 196. The duplicate screen message 240 provides an information request 242 for the user to further learn how to determine duplicate host screens and a close selection 244 to exit the duplicate screen message.

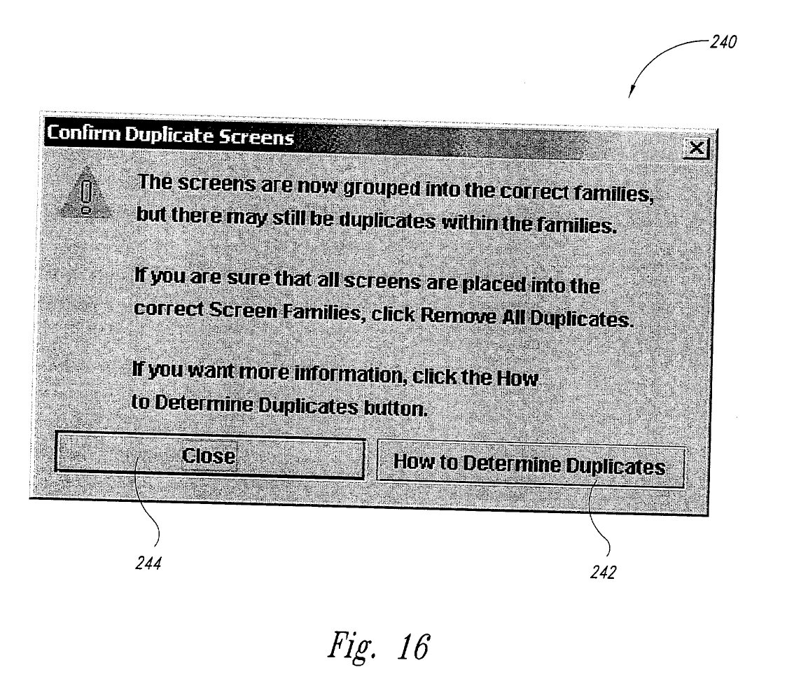

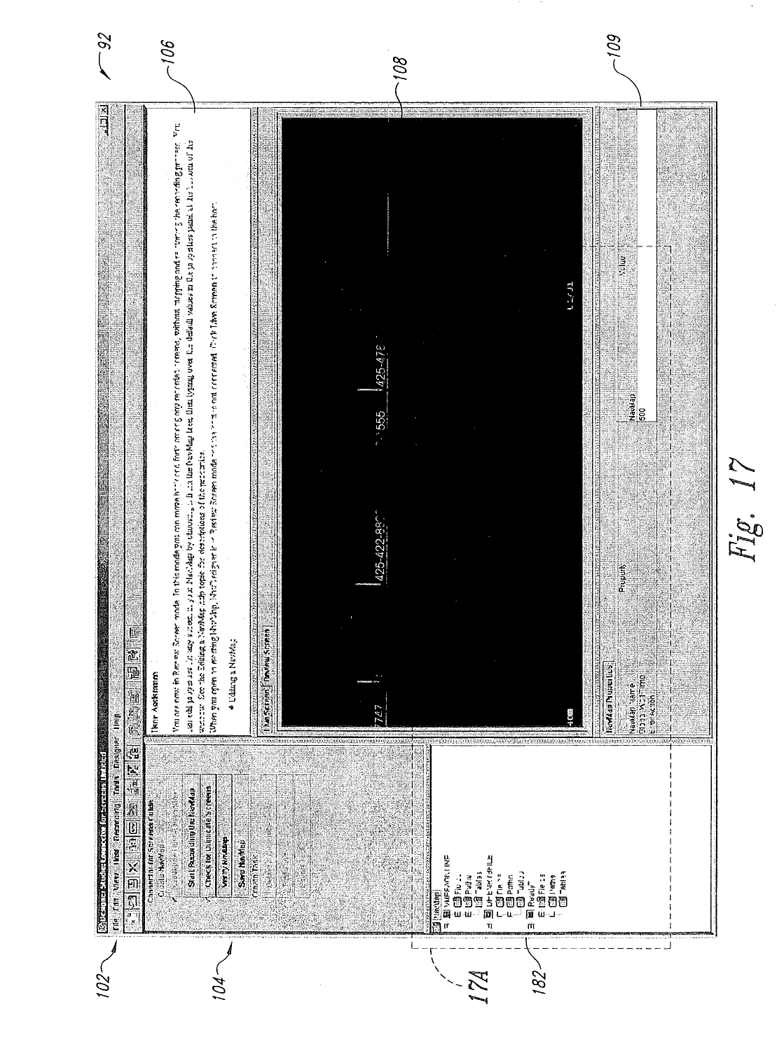

Upon activation of the duplicate screens removal selection 196, the screen connector designer 90 saves only one grouped screen icon for each screen grouping icon and removes all other grouped screen icons, which effectively reduces the group of same screen collections of host screens containing all the screens from the rudimentary host application screen recording into one group of host screens that have been determined to be different from one another. In FIG. 17, and shown in more detail in FIG. 17A, the custom screen grouping tree display 182 is expanded to show details of a duplicates removed customized screen connector recording icon 246 used to identify the resulting customized screen connector recording 94.

In this example, the customized screen connector recording 94 contains three different host screens. A first of the three different host screens is indicated on the custom screen grouping tree display 182 by a duplicates removed first screen icon 248 having a duplicates removed first screen fields folder 250, a duplicates removed first screen paths folder 252, and a duplicates removed first screen tables folder 254. A second of the three different host screens is indicated by a duplicates removed second screen icon 256 having a duplicates removed second screen fields folder 258, a duplicates removed second screen paths folder 260, and a duplicates removed second screen tables folder 262. A third of the three different host screens is indicated by the duplicates removed third screen icon 264 having a duplicates removed third screen fields folder 266, a duplicates removed third screen paths folder 268, and a duplicates removed third screen tables folder 270.

An example of contents of a fields folder is shown in FIG. 18 and in more detail in FIG. 18A where the duplicates removed first screen fields folder 250 is shown to contain fields including a duplicates removed first screen first field 272, a duplicates removed first screen second field 274, a duplicates removed first screen third field 276, a duplicates removed first screen fourth field 278, a duplicates removed first screen fifth field 280, a duplicates removed first screen sixth field 282, a duplicates removed first screen seventh field 284, and a duplicates removed first screen eighth field 286.

The duplicates removed first screen third field 276 is shown in FIG. 18A to be highlighted. As shown in FIG. 18B, a duplicates removed screen field properties selection indication 288 is displayed in the screen designer properties display area 109, which contains, in this case, field property values for the duplicates removed first screen third field 276. For this case, the screen designer properties display area 109 contains a field properties name column 290, a field properties value column 292, an associated screen name property 294, a field name property 296, a field type property 298, a field start row property 300, a field start column property 302, a field end row property 304, a field end column property 306, and a field mode property 308. In FIG. 19, and shown in more detail in FIGS. 19A and 19B, the screen designer properties display area 109 shows additional field properties including data type 310 and usage type 312.

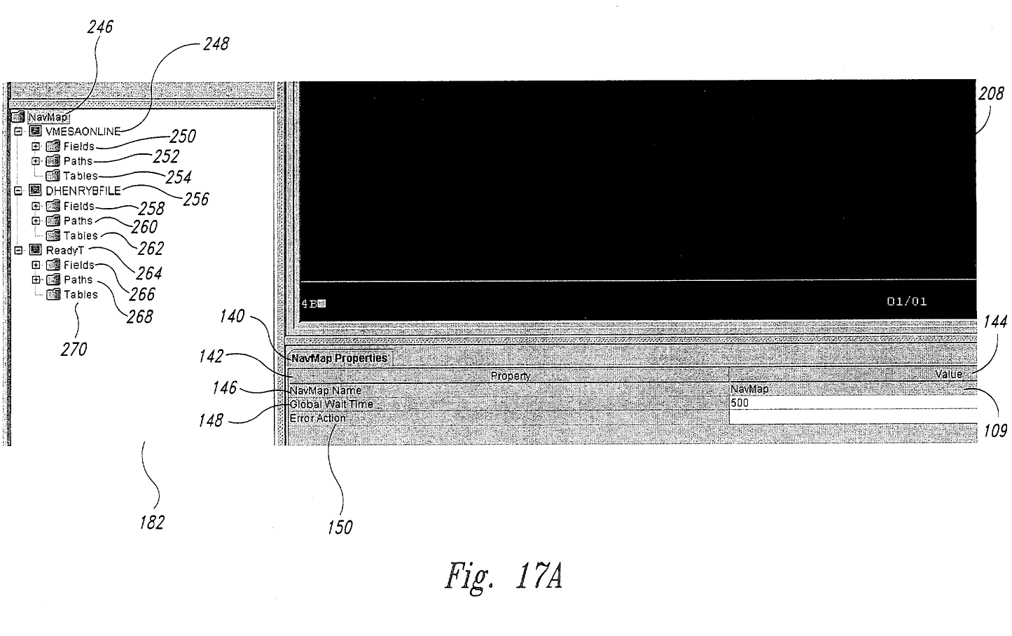

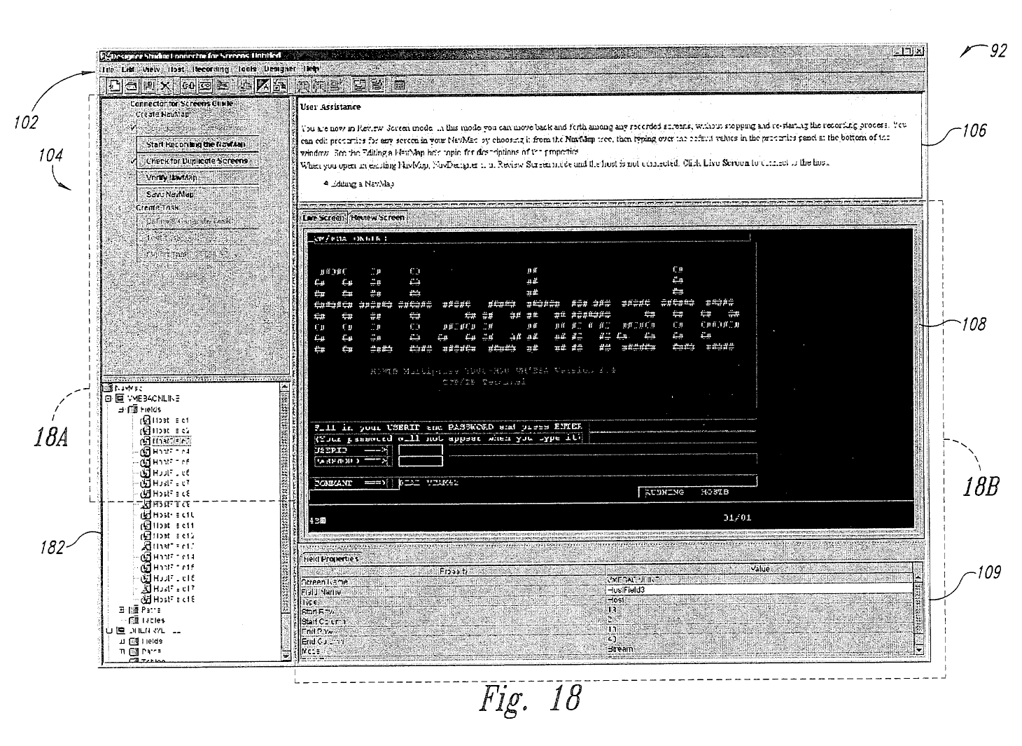

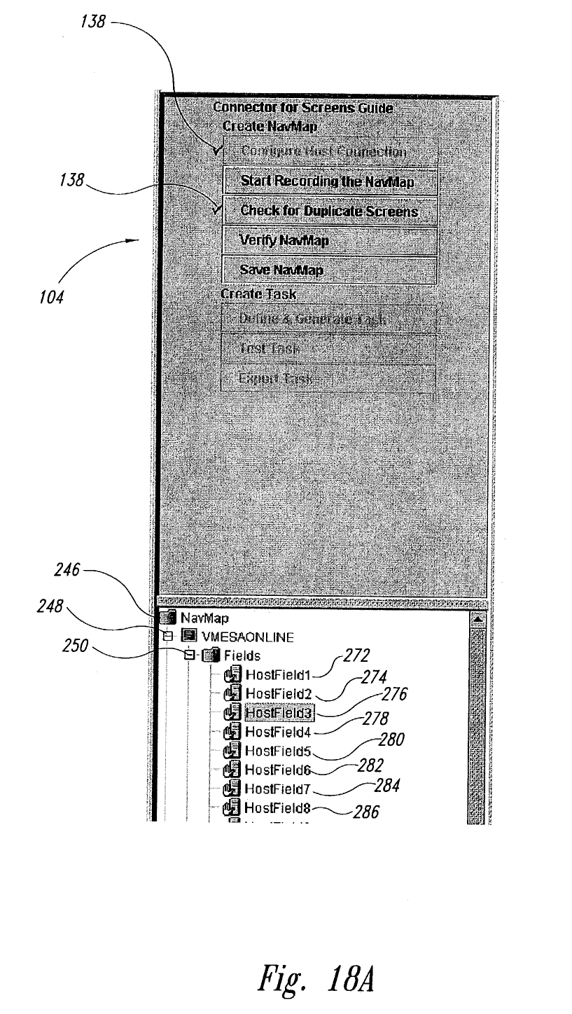

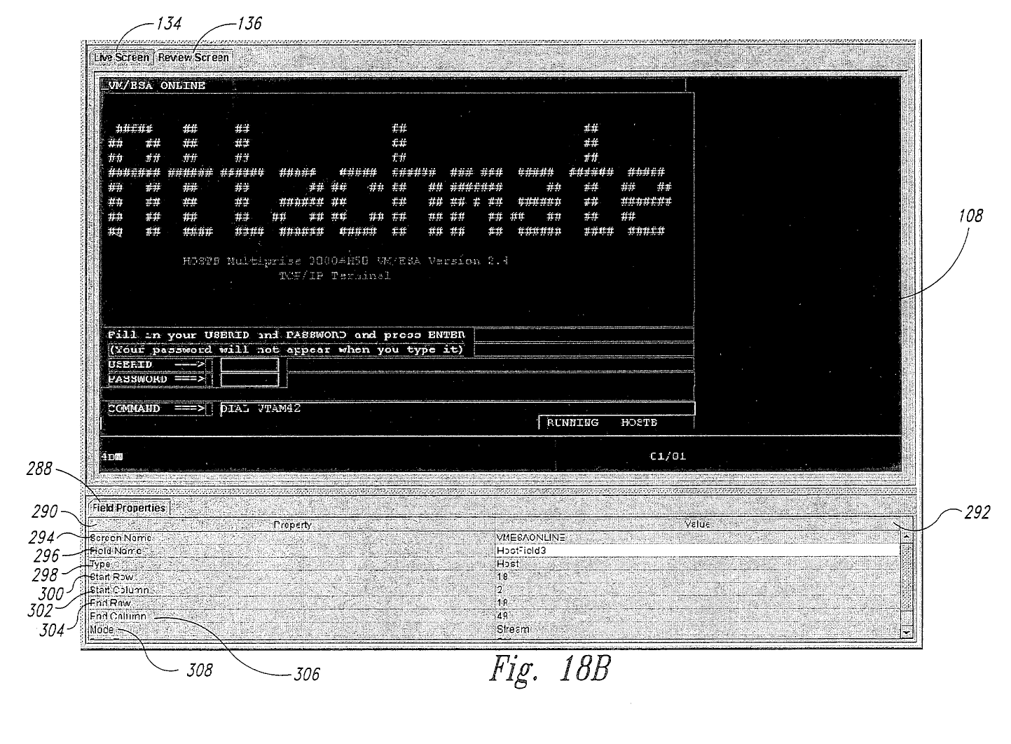

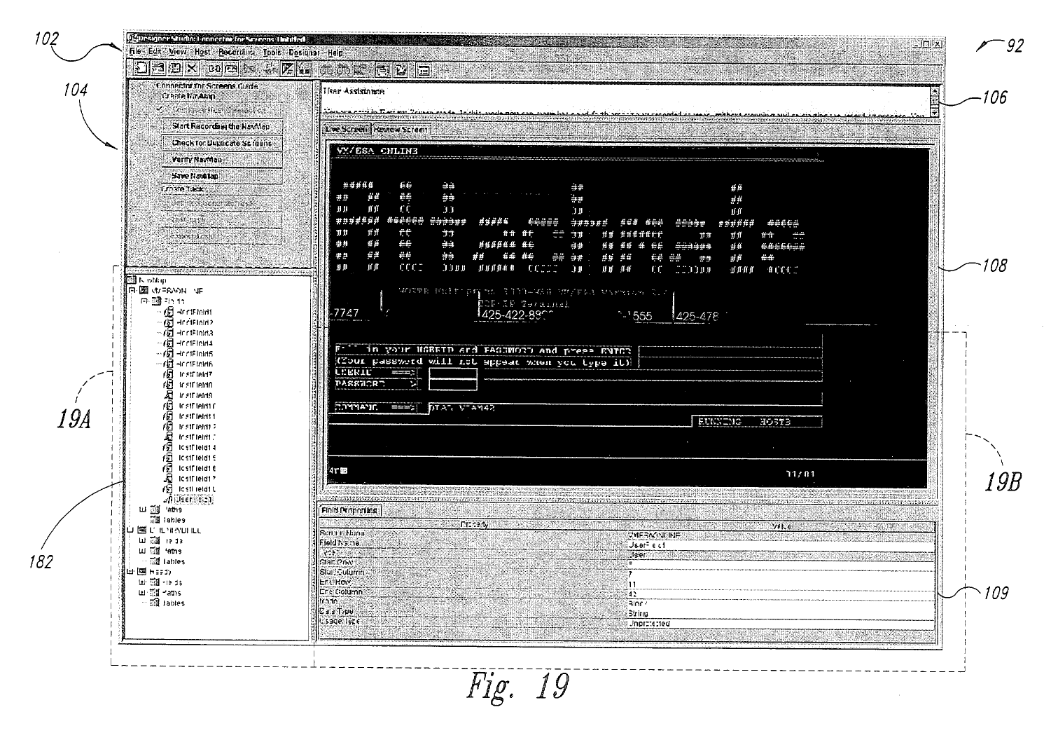

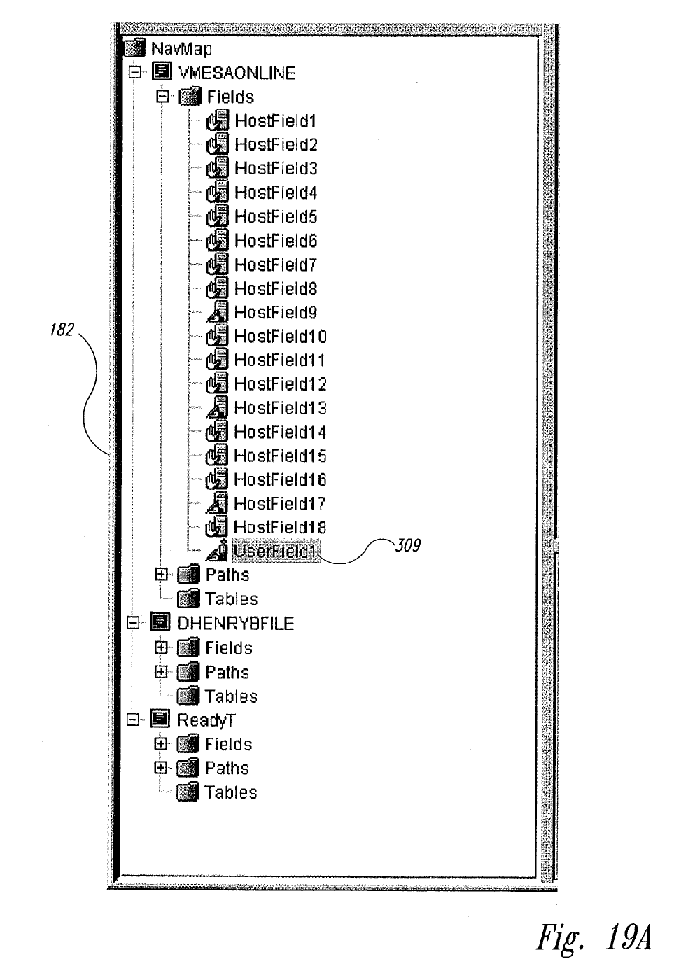

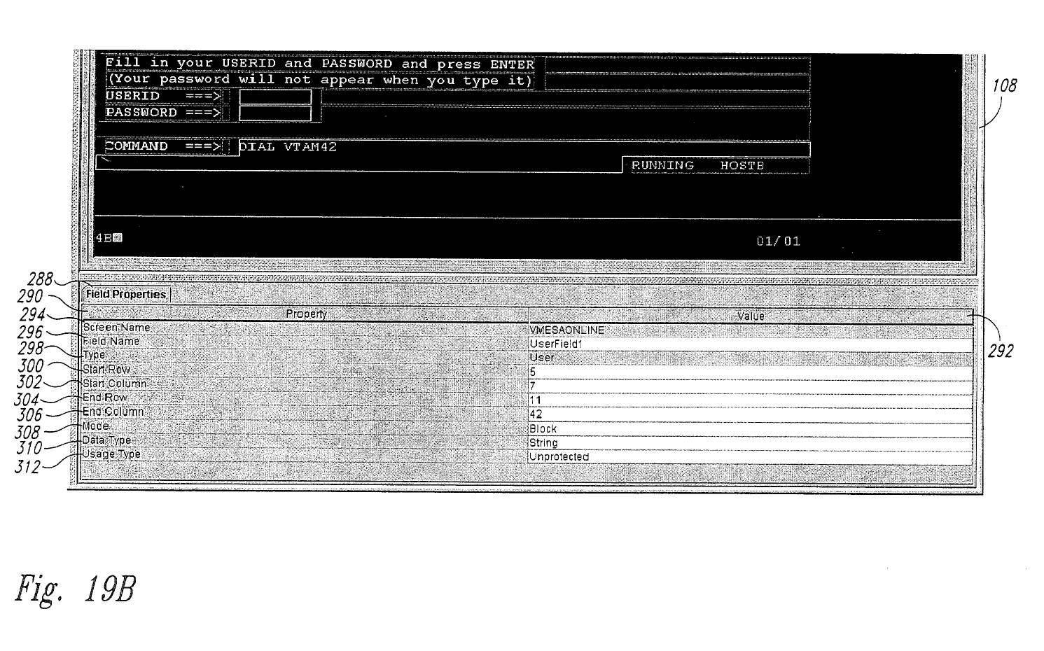

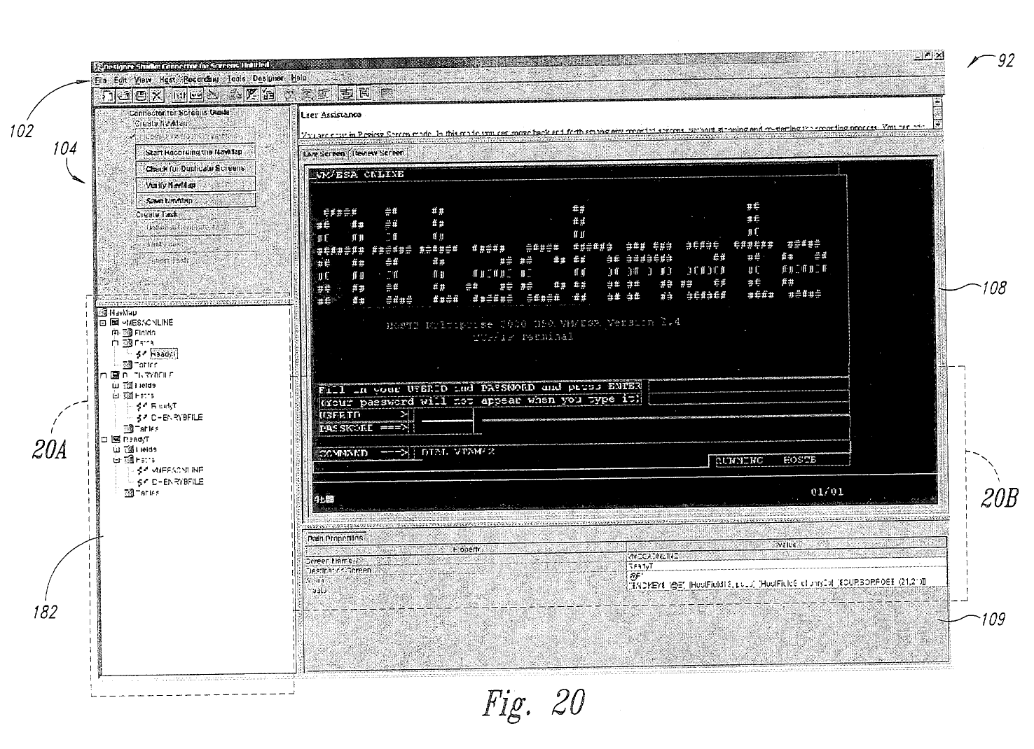

The duplicates removed paths folders contain one or more screen path information icons associated with individual paths between the duplicates removed screens. In FIG. 20, and shown in more detail in FIGS. 20A and 20B, the duplicates removed first screen paths folder 252 contains a first screen first path information icon 314 indicating a path between the host screen associated with the duplicates removed first screen icon 248 and the host screen associated with the duplicates removed third screen icon 264. The duplicates removed second screen paths folder 260 contains a second screen first path information icon 316 indicating a path between the host screen associated with the duplicates removed second screen icon 256 and the host screen associated with the duplicates removed third screen icon 264, and a second screen second path information icon 318 indicating a path between the host screen associated with the duplicates removed second screen icon 256 and the host screen associated with the duplicates removed second screen icon 256. The duplicates removed third screen paths folder 268 contains a third screen first path information icon 320 indicating a path between the host screen associated with the duplicates removed third screen icon 264 and the host screen associated with the duplicates removes first screen icon 248, and a third screen second path information icon 322 indicating a path between the host screen associated with the duplicates removed third screen icon 264 and the host screen associated with the duplicates removed second screen icon 256.

The first screen path information icon 314 is highlighted in FIG. 20A. Consequently, the screen designer properties display area 109 contains a path properties indicator 324, a property name column 326, a property value column 328, a screen name property 330, a destination screen property 332, an action property 334, and a mode property 336.

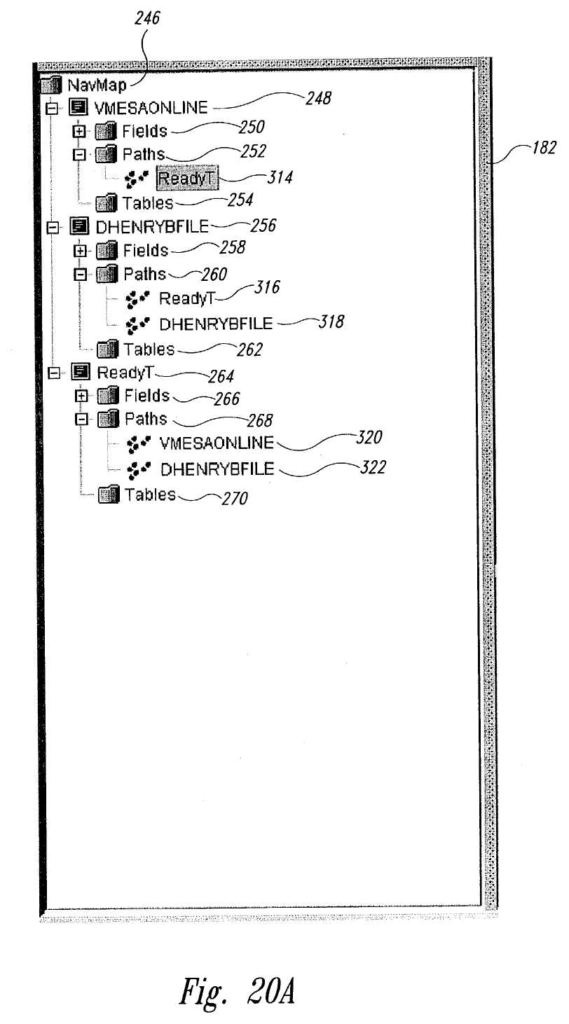

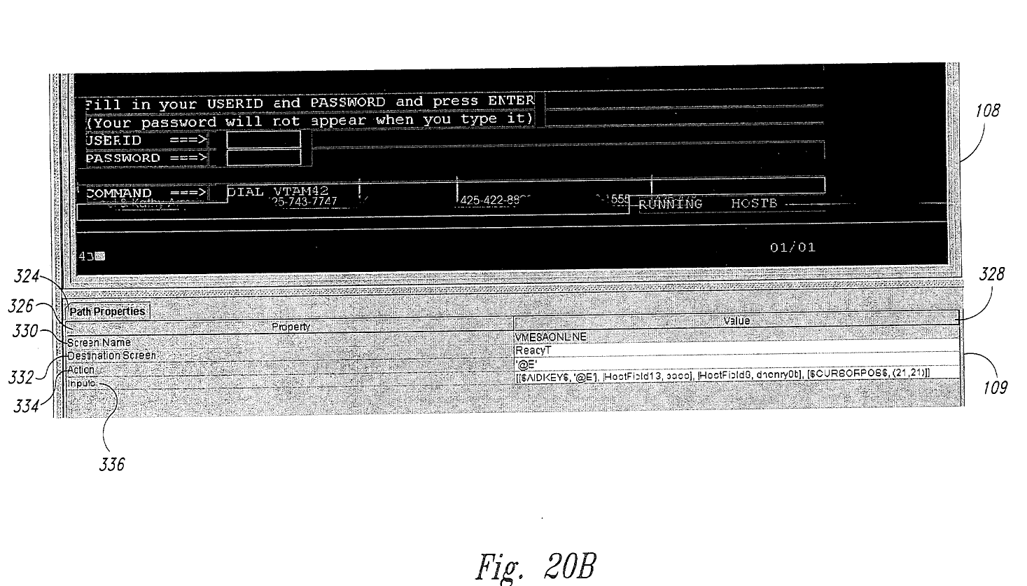

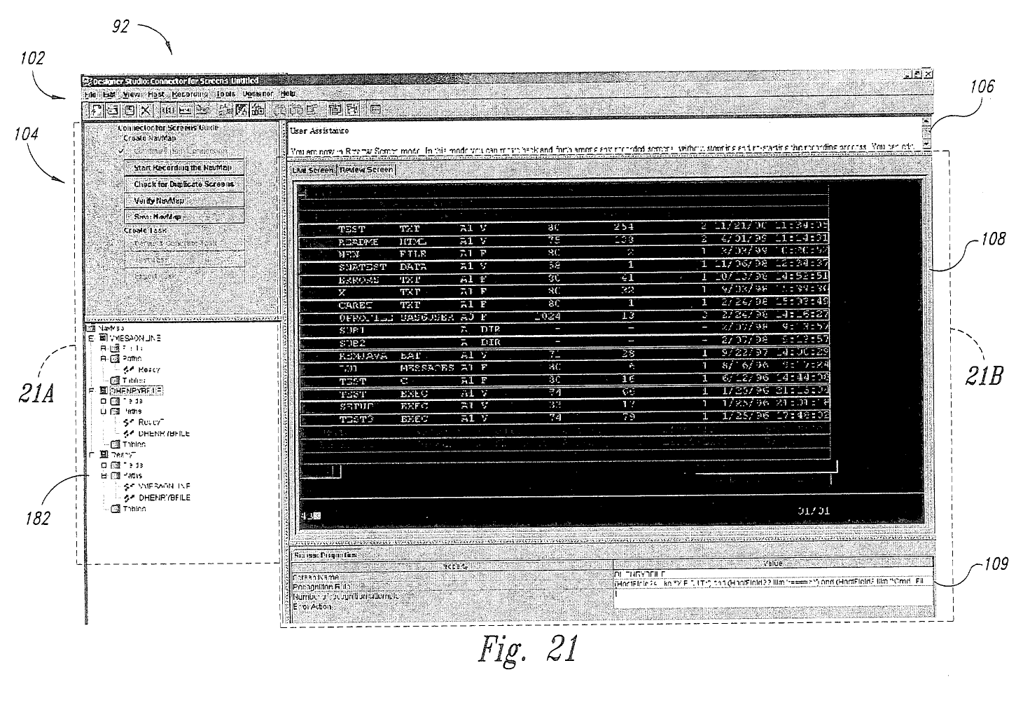

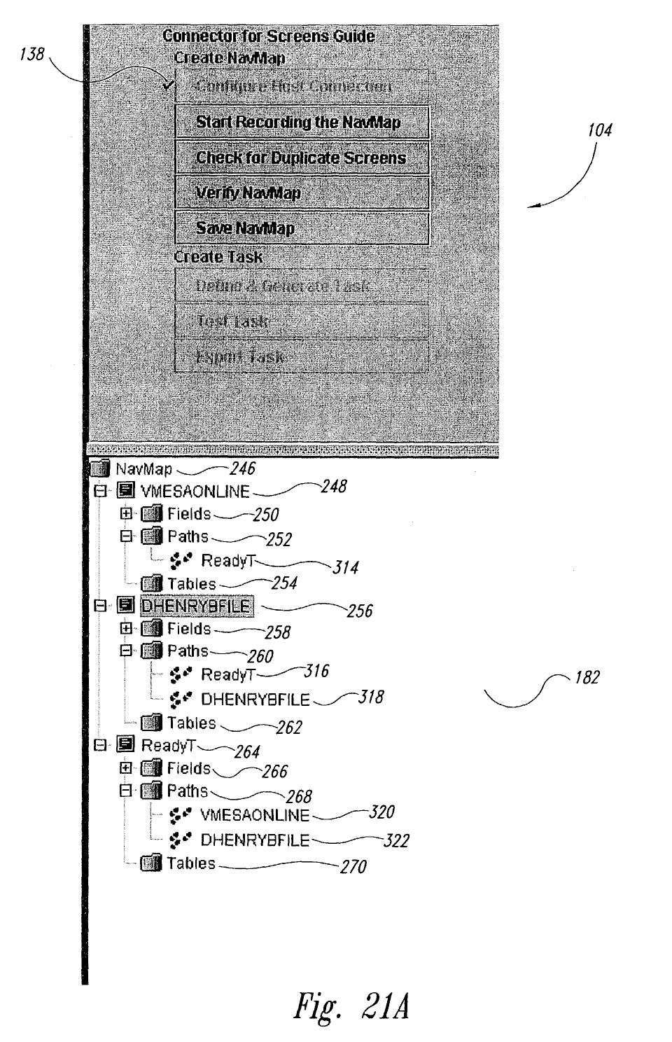

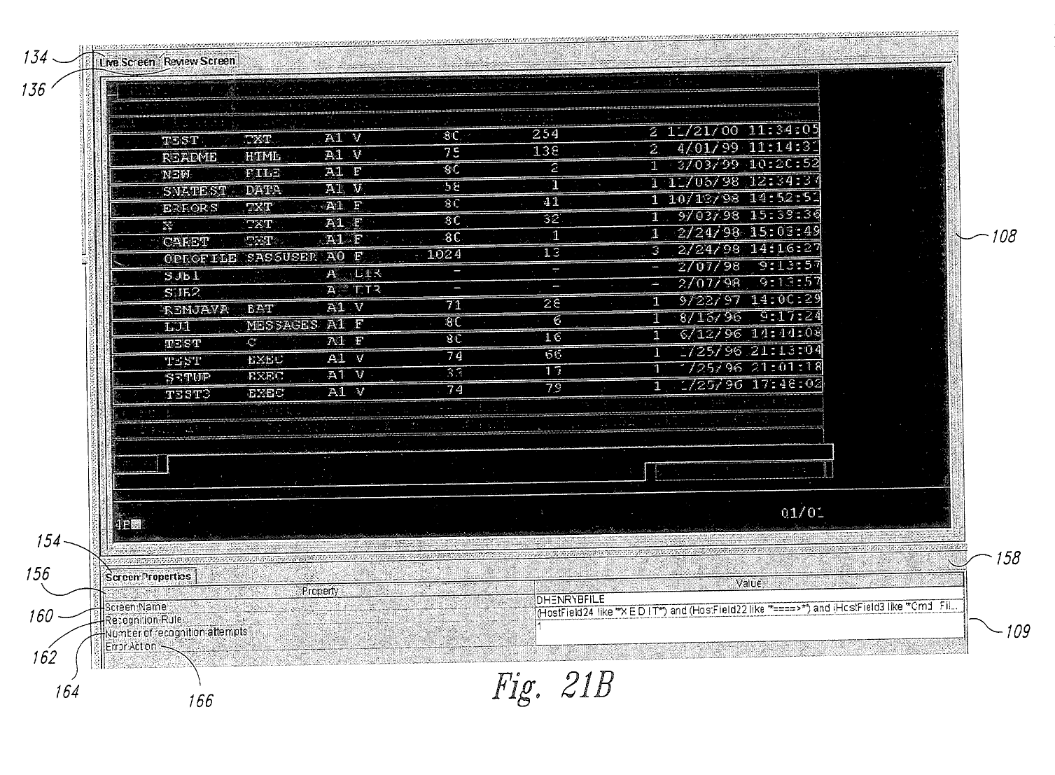

Identification and recognition of tables contained within host screens has been quite challenging for conventional systems. As shown in FIG. 21, and in more detail in FIGS. 21A and 21B, tables found in host screens can also be displayed in the designer user interface 92 of the screen connector designer 90. As shown in FIG. 21B, the screen designer host screen display 108 can amply display a table.

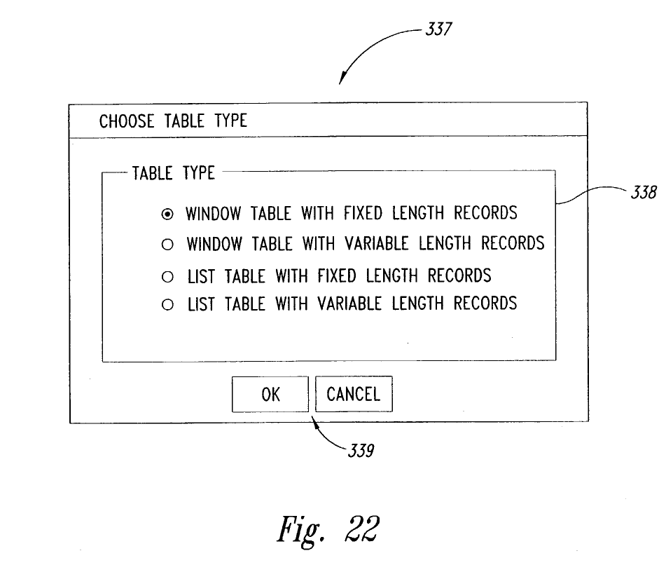

When designing the customized screen connector recording 94, the user of the screen connector designer 90 uses a choose table type menu 337 as shown in FIG. 22. The choose table type menu 337 includes a selection menu 338, which provides selections to enable the user to identify which type of table the screen designer host screen display 108 is currently displaying. Four selections are shown in the exemplary choose table type menu 337: window table with fixed length records, window table with variable length records, list table with fixed length records, and list table with variable length records. The choose table type menu 337 also includes a verification selection 339 to allow the user to either verify their selection or exit from the choose table type menu.

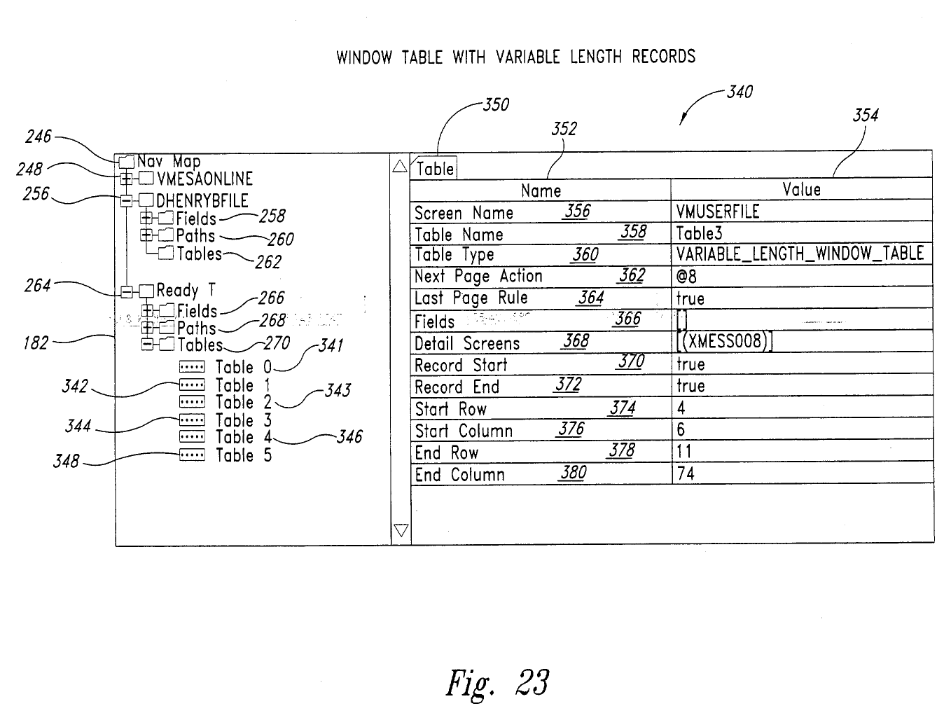

Associated table information 340 for a window table with variable length records is shown in FIG. 23. Associated table information is shown in the screen designer properties display area 109 with respect to a selected one of a group of table information icons under the duplicates removed third screen tables folder 270. A table information indicator 350 found in the screen designer properties display area 109 indicates that the nature of the property information displayed is directed to a table. In this exemplary case, the screen designer properties display area 109 includes a property name column 352, a property value column 354, a screen name property 356, a table name property 358, a table type property 360, a next page action property 362, a last page rule property 364, a fields property 366, a detail screens property 368, a record start property 370, a record end property 372, a start row property 374, a start column property 376, an end row property 378, and an end column property 380.

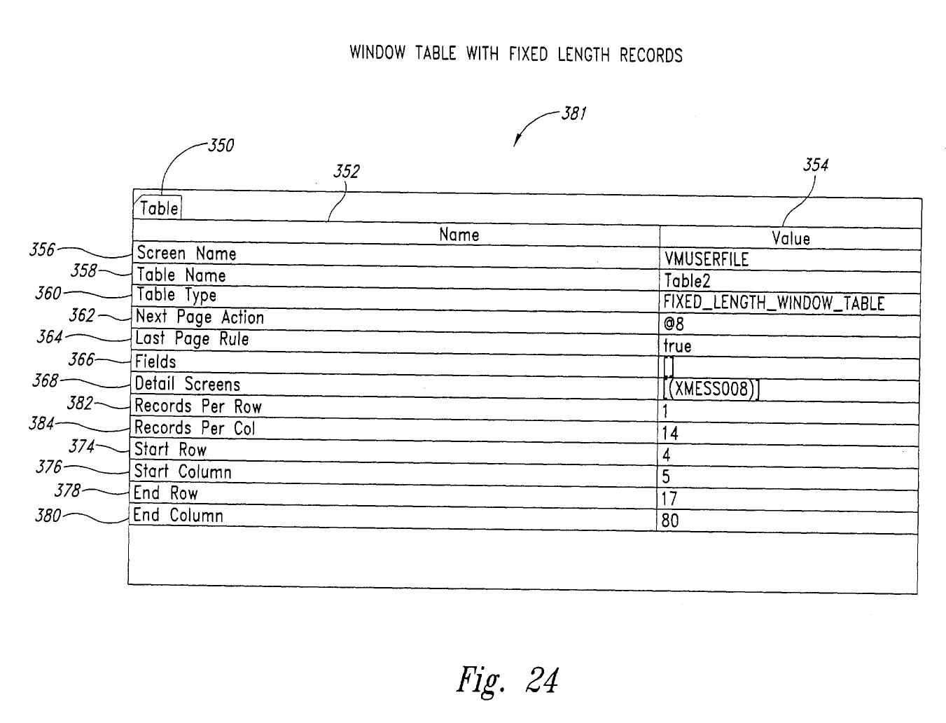

In some embodiments, for a window table with fixed length records, the screen designer properties display area 109 could contain associated table information 381 having the properties shown in FIG. 24, which includes some properties associated with a window table with variable length records and other properties including a records per row property 382, the records per column property 384, a start row property 374, a start column property 376, an end row property 378, and an end column property 380.

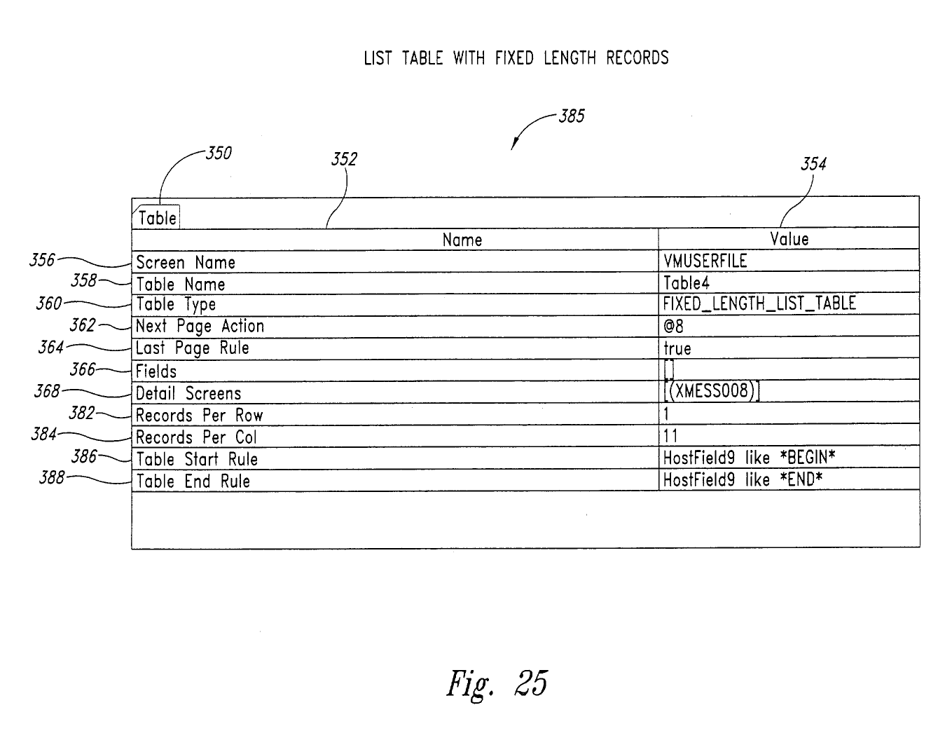

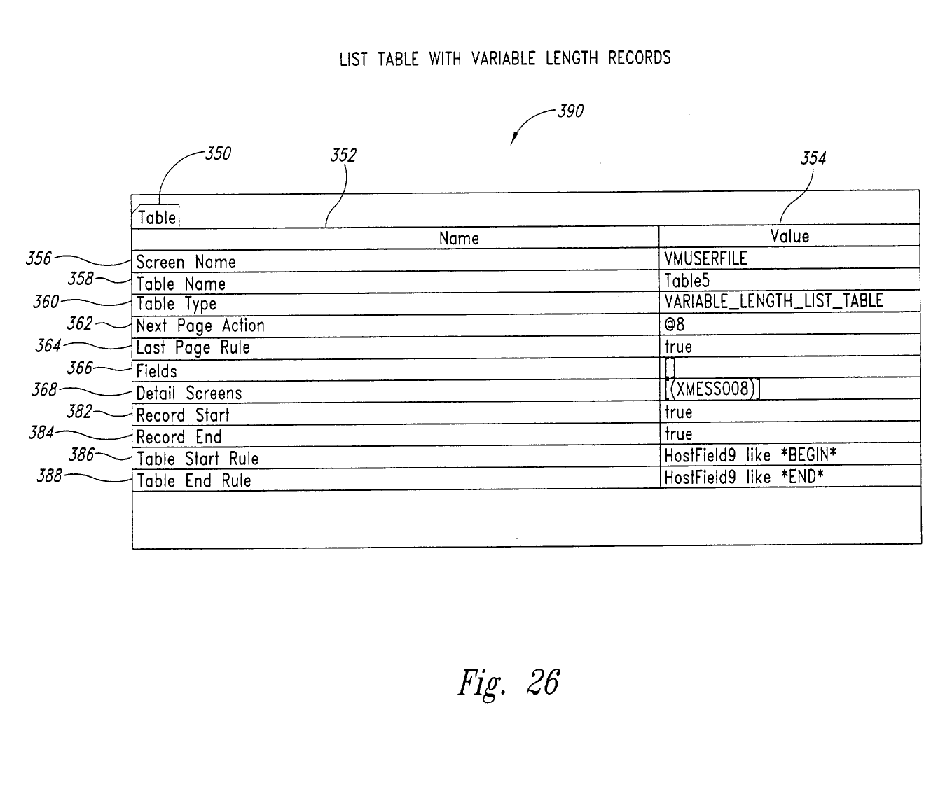

For a list table with fixed length records, associated table information 385 of an exemplary screen designer properties display area 109 could contain the properties shown in FIG. 25, which includes some properties associated with a window table with fixed length records and other properties including a table start rule 386 and a table end rule 388. For a list table with variable length records, associated table information 390 in the screen designer properties display area 109 could contain the properties shown in FIG. 26, which include at least some properties associated with fixed length records.

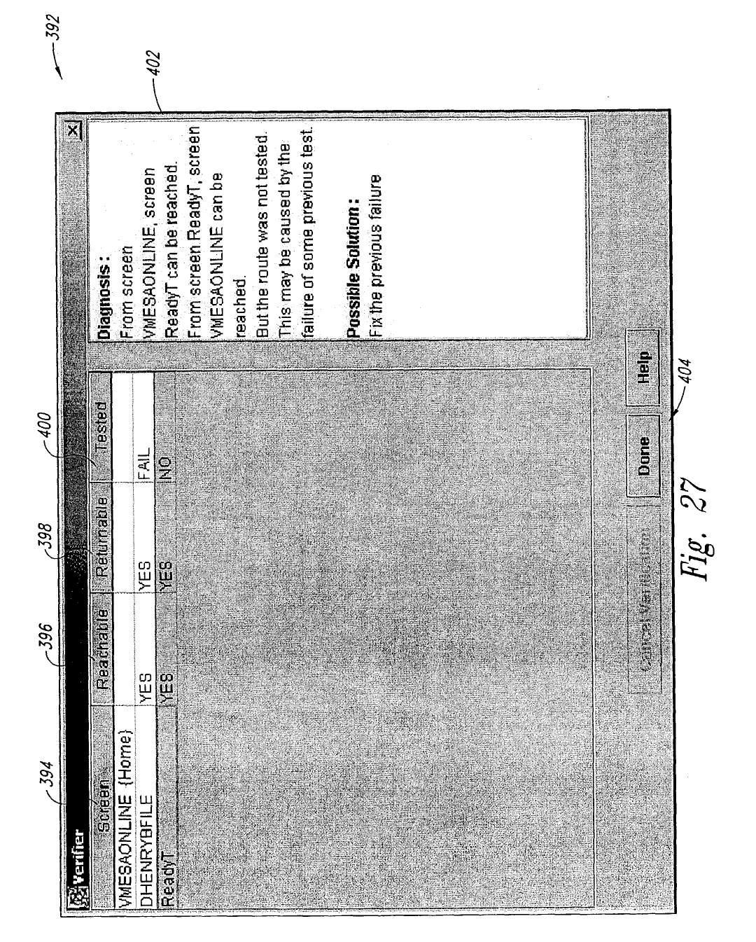

After duplicate host screens have been removed to convert the rudimentary host application screen recording into the customized screen connector recording 94, the user then activates the save screen connector recording selection 122. The customized screen connector recording is then verified with respect to runtime conditions that are part of the interaction between the screen connector runtime engine 100 and the host application 82 running on the legacy host data system 80. A verification report 392 can then be displayed on the designer user interface 92 of the screen connector designer 90 as shown in FIG. 27.

The verification report 392 includes a screen name column 394 containing names of host screens that are part of the customized screen connector recording 94, with one of the host screens designated as being the home screen for verification purposes. The verification report 392 also has columns for information related to testing of the paths between the host screens of the customized screen connector recording 94, which includes a reachable column 396 providing indications of whether identified host screens of the customized screen connector recording can be reached from the designated home host screen, a returnable column 398 providing indications of whether the designated home host screen can be reached from the other identified host screens of the customized screen connector recording, and a tested column 400 indicating whether a test has been passed, failed, or performed to determine runtime reliability. The verification report 392 contains a comment section 402 directed to the diagnosis of test results and suggested follow-up actions to be taken. The verification report 392 further includes verification report controls 404 to cancel verification testing, to conclude and exit from the verification report, and to request instructional help related to the verification report.

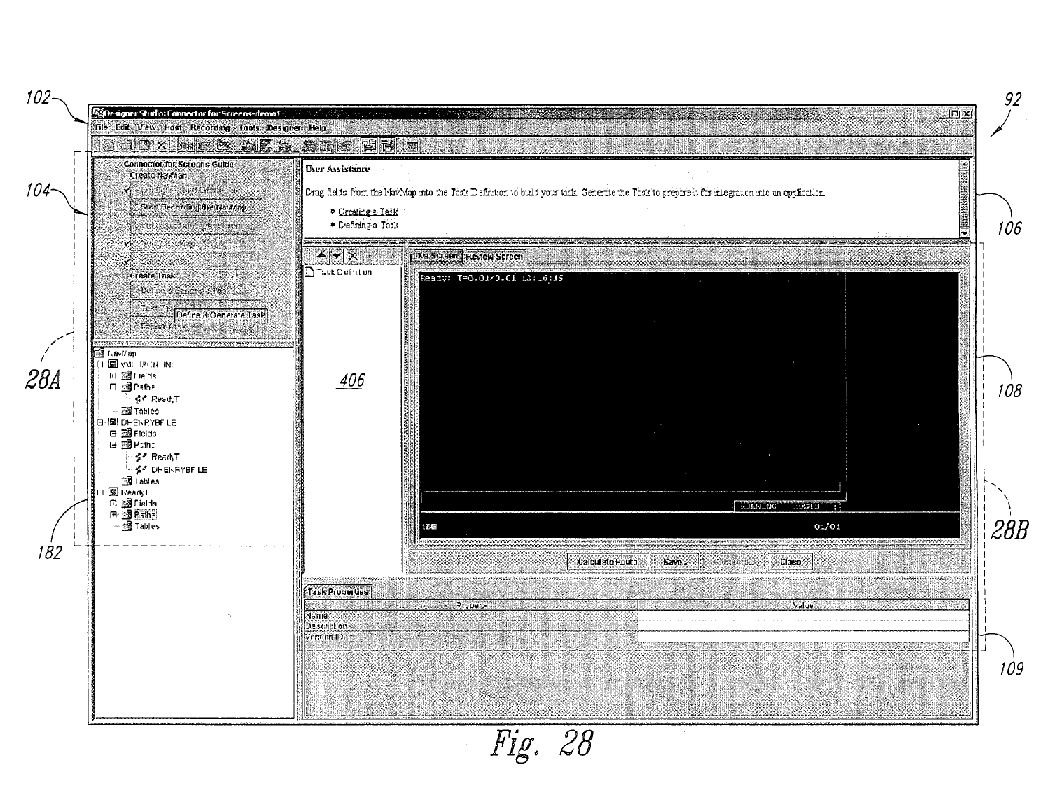

In addition to the tools and other features of the screen connector designer 90, the designer user interface 92 further includes a task definition screen display 406 used to assemble an ordered list of features, such as fields, of the host screens of the customized screen connector recording 94. For instance, an ordered list assembled in the task definition screen display 406 could include fields from the host screens of the customized screen connector recording 94 to be used to input, process, or output data. As shown in FIG. 28 and in more detail in FIG. 28A, the previous selection indication check marks 138 of the screen designer workflow menu 104 indicate that the create screen connector recording section 112 has been used to create and save the customized screen connector recording 94. At this point, the define and generate task selection 126 of the create task section 124 is activated by the user of the screen connector designer 90 to display the task definition screen display 406. FIG. 28B shows the task definition screen display 406 including a task definition root icon 408 and task controls 410, to be used if needed, for scrolling through extensive lists of host screen features, such as fields, included in larger sized tasks defined in the task definition screen display. The screen designer host screen display 108 includes controls 412 to invoke calculation of routes associated with the defined task displayed in the task definition screen display and to save the defined task.

A task properties indicator 414 alerts the user of the screen connector designer 90 that the screen designer properties display area 109 contains information regarding properties of the task identified by the task definition root icon 408. The screen designer properties display area 109 includes a property column 416, a property value column 418, a task name property 420, a task destination property 422, and a task version identification property 424.

The custom screen grouping tree display 182 shown in FIG. 29 and in more detail in FIG. 29A, has the fields of the duplicates removed third screen fields folder 266 expanded showing a third screen first field 426, a third screen second field 428, a third screen third field 430, and a third screen fourth field 432, with the third screen first field being highlighted.

The task definition screen display 406, shown in FIG. 29 and in more detail in FIG. 29B, has a task containing fields from all three of the host screens of the exemplary customized connector screen recording 94 designated either as input or output fields. The “HostField1” from the “VMESAONLINE” host screen shown in the task definition screen display 406 is highlighted so that properties are displayed in the screen designer properties display area 109 as indicated by a field properties indicator 448. The screen designer properties display area 109 further includes a property name column 450, a property value column 452, an internal field name property 454, a field type property 456, a property name property 458, a description property 460, an is multi-valued property 462, a field size property 464, a field data type property 465, and a default value property 466. In this example, the value for the internal field name property 454 is “VMESAONLINE HostField1,” which indicates that the field highlighted in the task definition screen display 406 has its properties displayed in the screen designer properties display area 109.

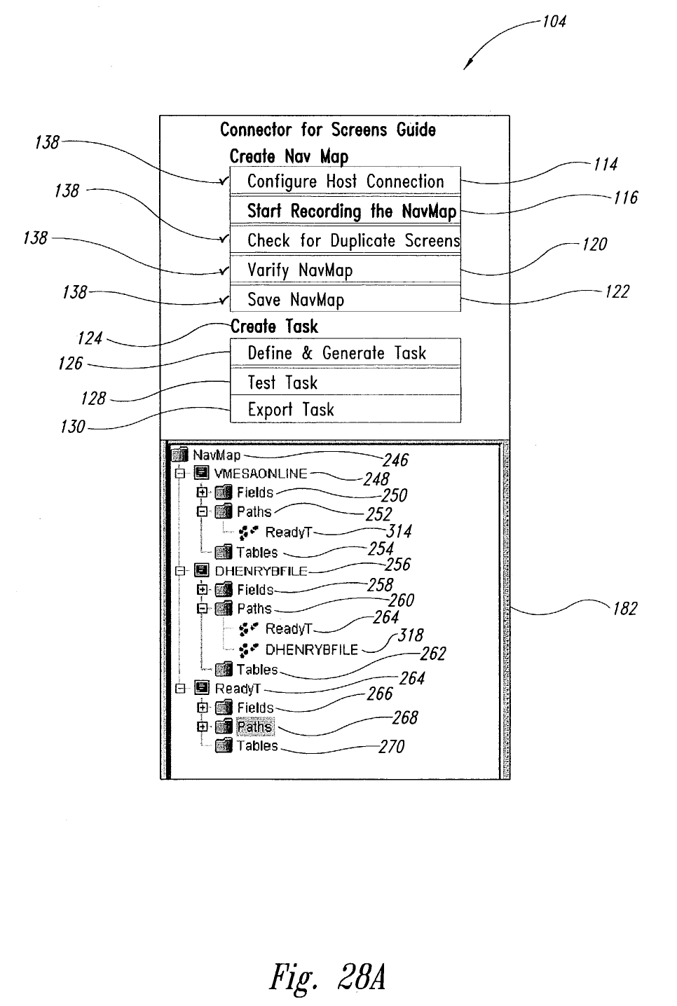

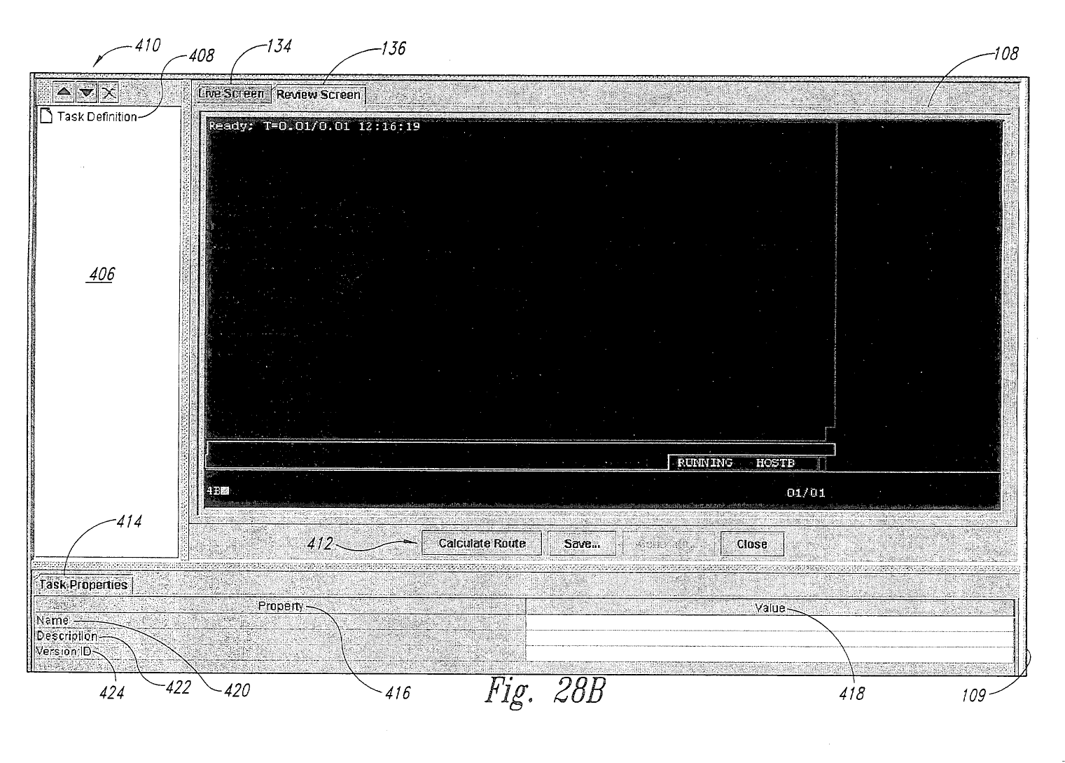

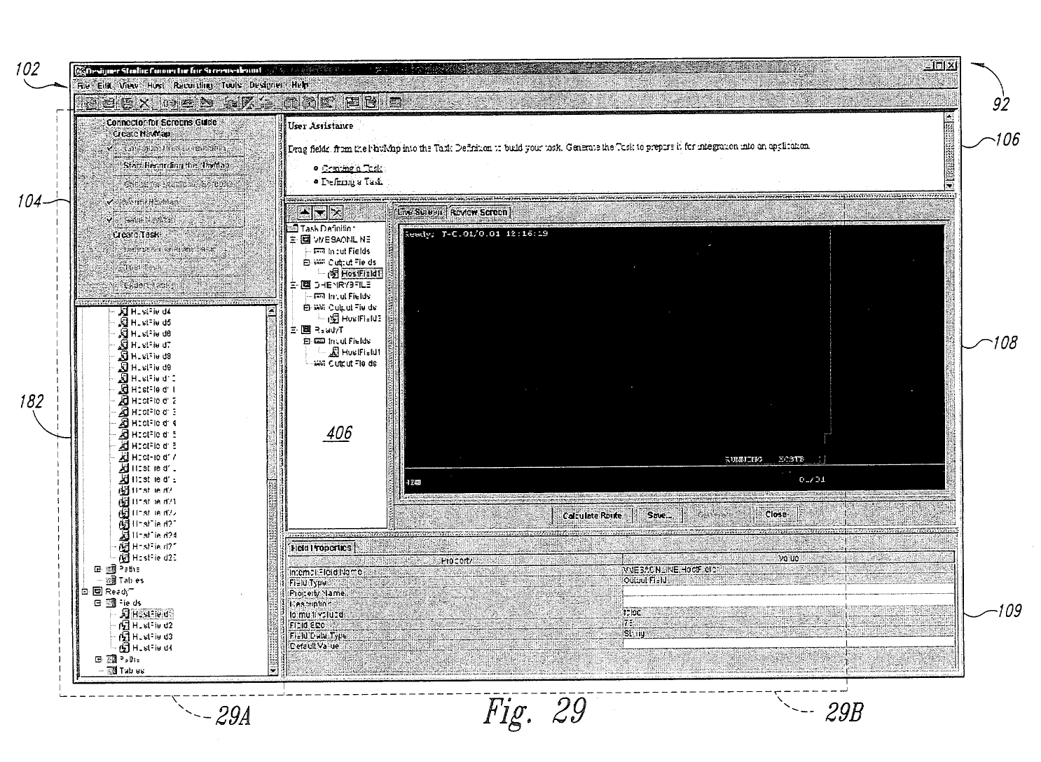

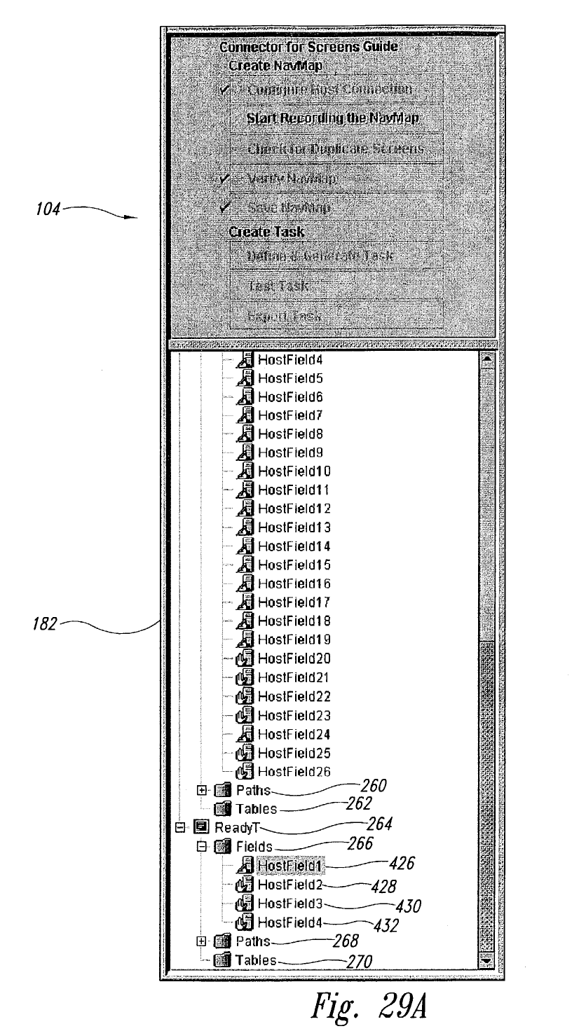

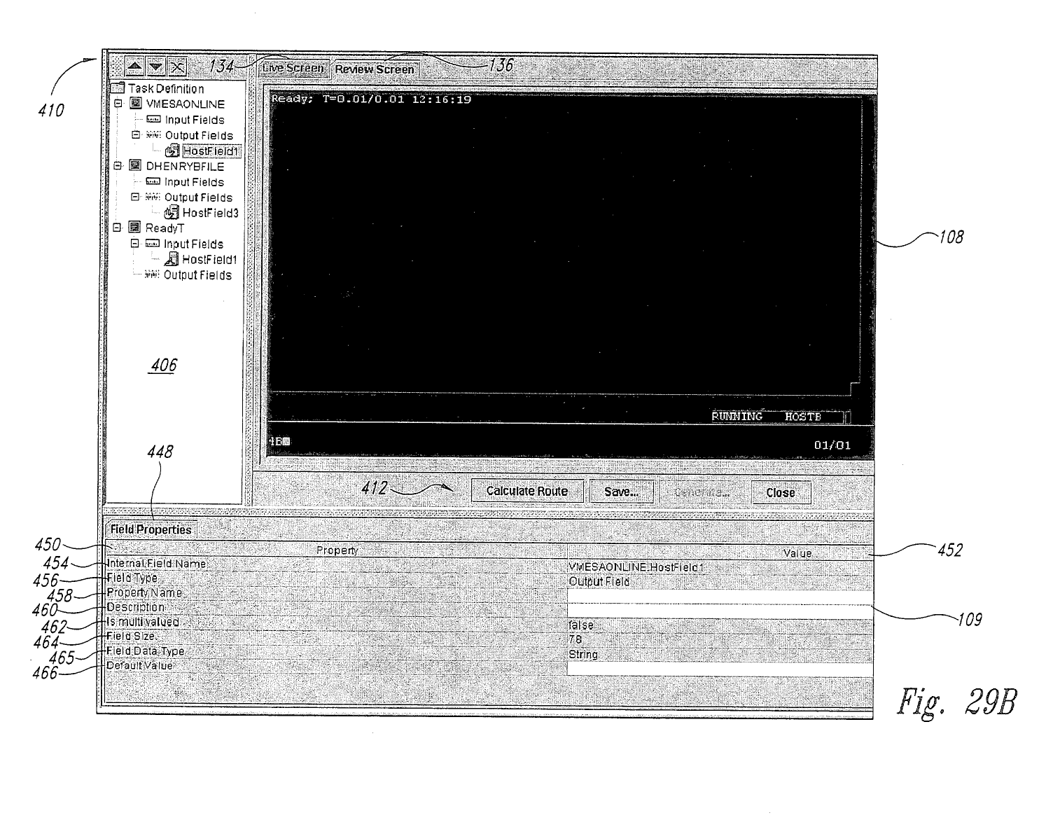

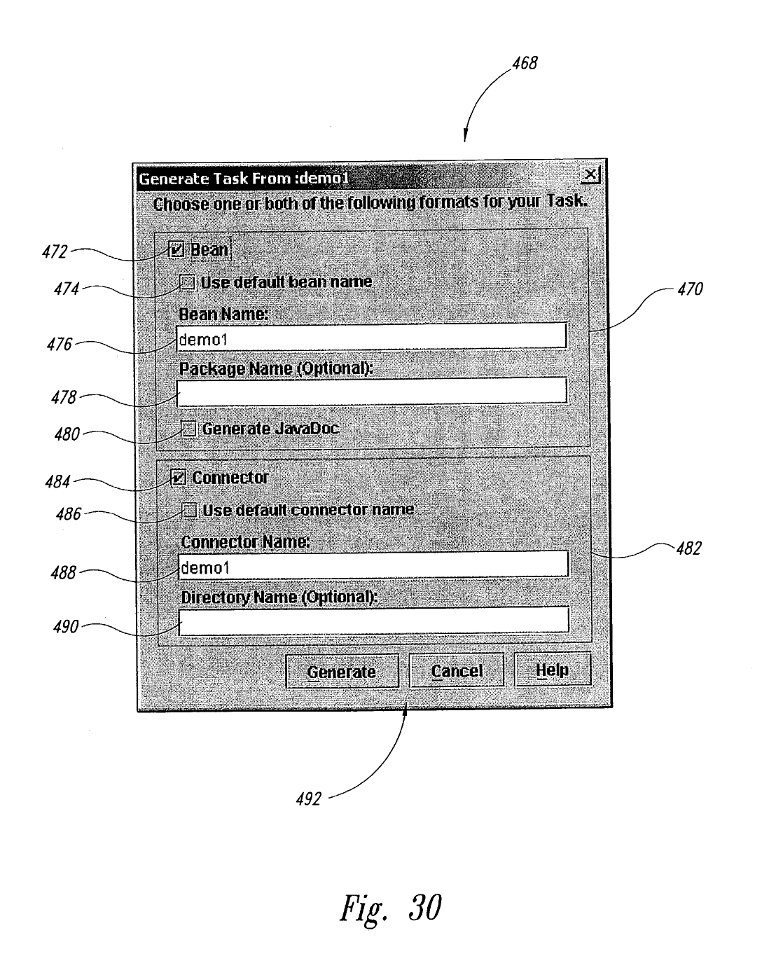

After a task is defined in the task definition screen display 406, the user of the screen connector designer 90 selects a generate task menu 468, shown in FIG. 30, of the designer user interface 92 to generate executable files associated with the task. The generate task menu 468 includes an object oriented programming component section 470 including an object oriented programming component selection 472, which would be chosen to generate, for instance, a JavaBean in the embodiment shown in FIG. 30. The object oriented programming component section 470 further includes a selection to use a default name 474 or to input a name 476 for the generated object oriented programming component, a specification field 478 to identify an optional package name for the generated object oriented programming component, and a generate documentation selection 480 to generate associated documentation such as JavaDoc as shown in the embodiment depicted in FIG. 30.

The generate task menu 468 also includes a connector section 482 having a connector selection 484 to invoke incorporation of the task defined in the task definition screen display 406 into the screen connector runtime engine 100. The connector section 482 further includes a used default connector name selection 486, a connector name input field 488, and a directory name input field 490. The generate task menu 468 also has menu controls 492 to generate task files or to cancel generation of task files.

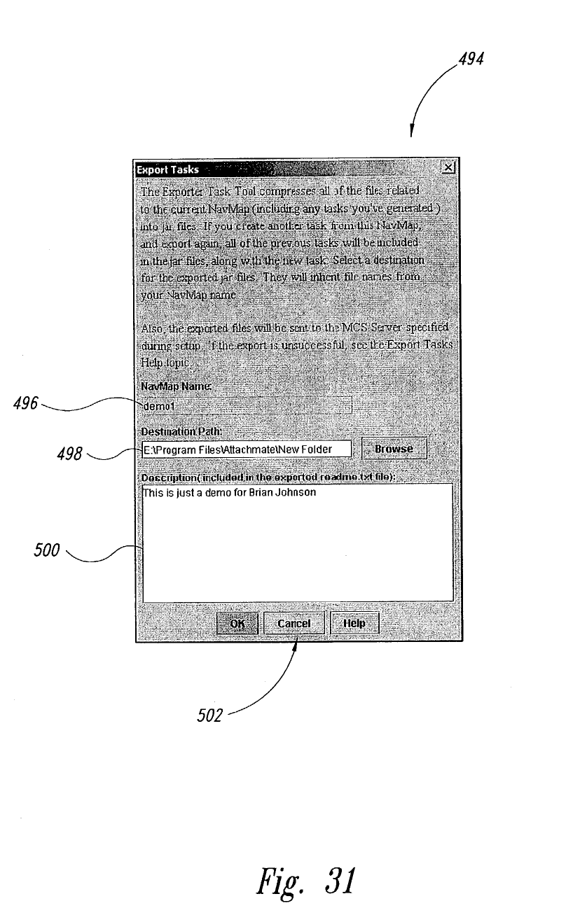

Once task files have been generated, they can be tested by activation of the test task selection 128 and subsequently exported by activation of the export task selection 130, both found on the screen designer workflow menu 104. Upon activation of the export task selection 130, an export tasks template 494 is displayed, as shown in FIG. 31, on the designer user interface 92 containing a name field 496 for the customized screen connector recording 94 associated with the exported task, a destination path field 498 identifying the task to be exported, a descriptions field 500 used to input text into a readme.txt file to be associated with the exported task, and a template control 502 used to verify or cancel the export of files associated with the task defined in the task definition screen display 406. In FIG. 32, files 506 of an exemplary task definition are displayed. In other embodiments, other types and combinations of files can be used to define tasks.

The customized screen connector recording 94 has been described in terms of automated grouping by the screen connector designer 90 of host screens of the rudimentary host application screen recording into same screen collections. The customized screen connector recording 94 has further been described in terms of refinement of this automated grouping by the user of the screen connector designer 90 based upon comparisons of host screens using the custom grouping host screen comparison display 176 to regroup the host screens as necessary.

An additional description of the customized screen connector recording 94 of the present invention relates to use of identification grammar to label features of the host screens as necessary when the automated grouping or preliminary regrouping discussed above is not sufficient to correctly label one or more host screens for subsequent identification and recognition. The identification grammar is further described below; however, the immediate discussion will first focus on how the identification grammar can be inputted through the designer user interface 92 of the screen connector designer 90 to be incorporated into the customized screen connector recording 94. A direct way of inputting identification grammar is to correctly change the recognition rule found in the screen recognition rule property 162 (shown in FIGS. 5A, 6A, 7A, 8B, 9A, and 21B).

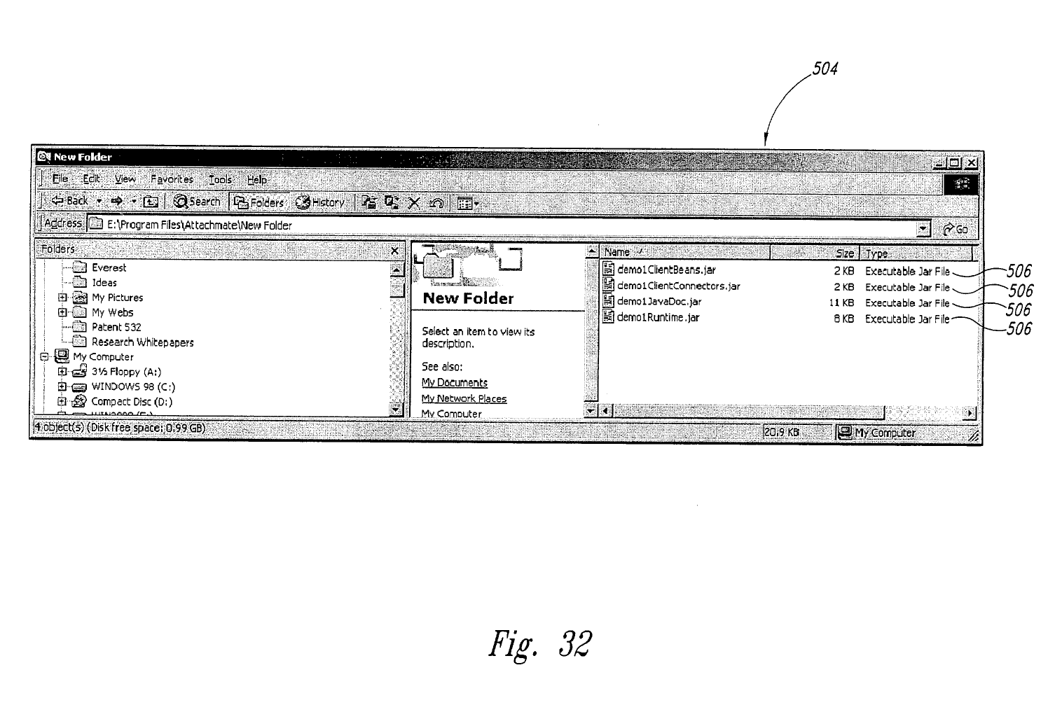

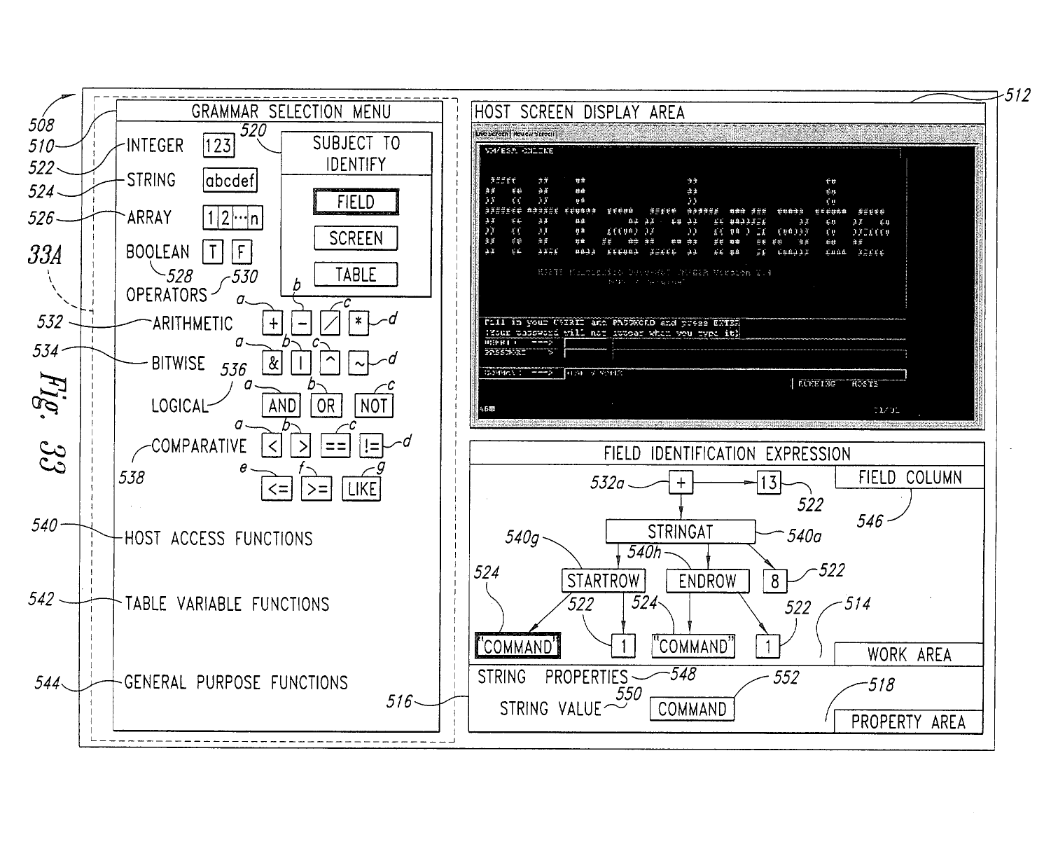

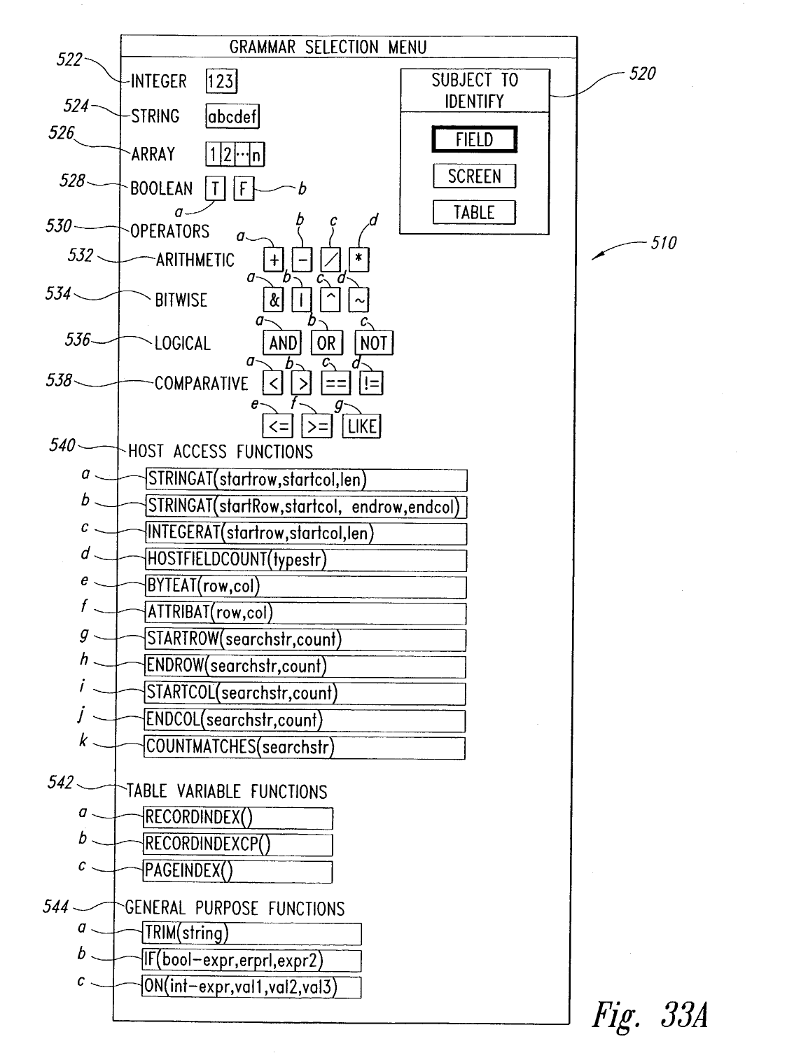

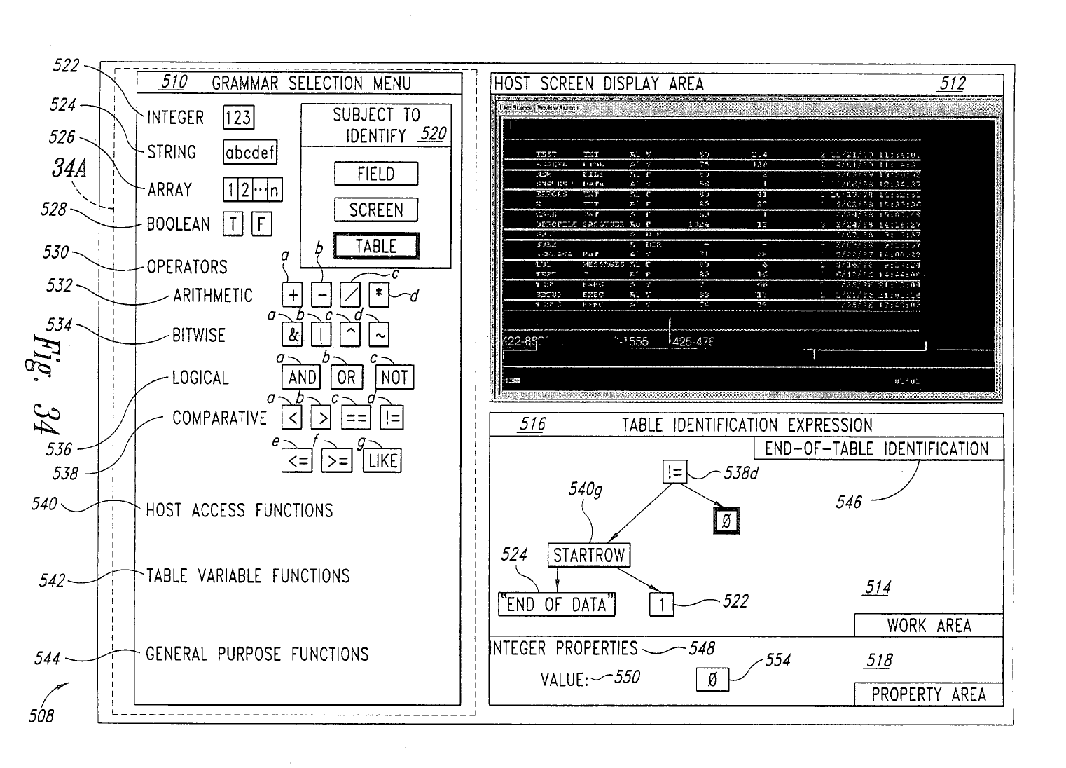

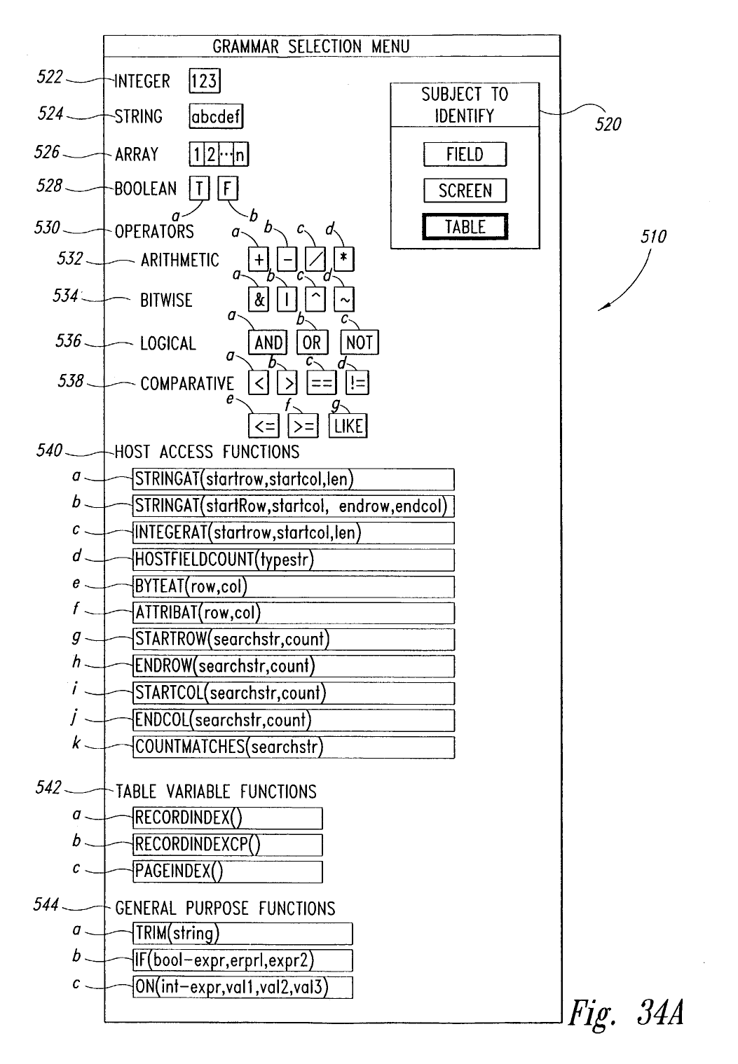

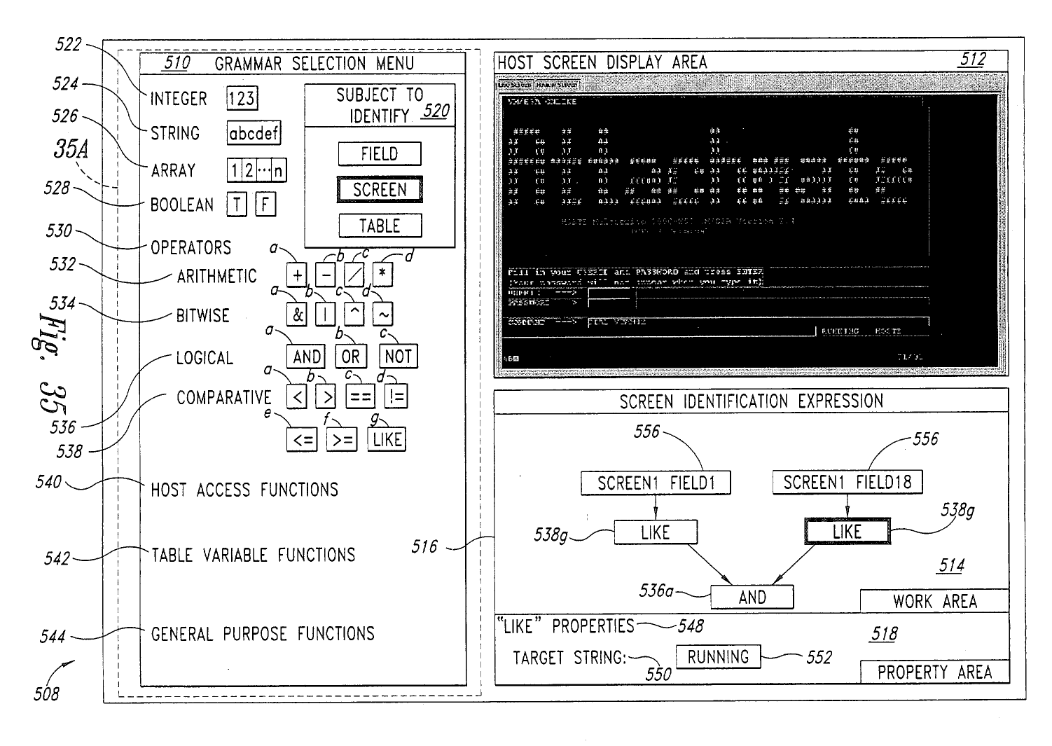

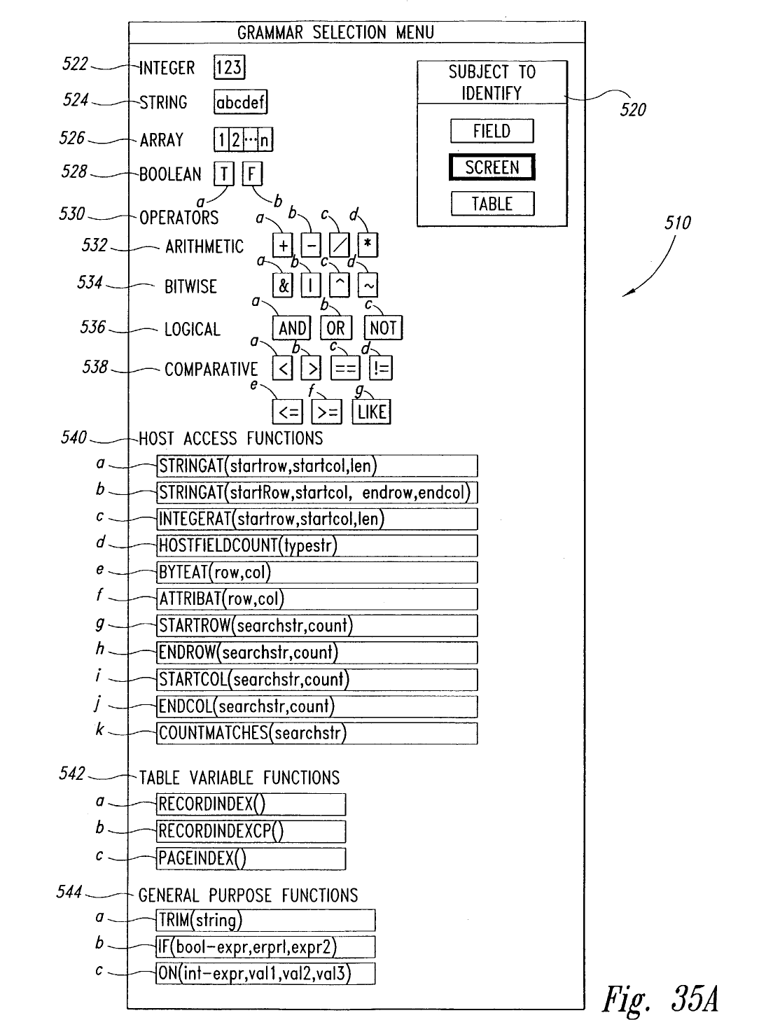

An alternative approach of the present invention relies upon an identification grammar expression builder 508 using a visual based interface as shown in FIGS. 33, 34, and 35 and as shown in more detail in FIGS. 33A, 34A, and 35A.

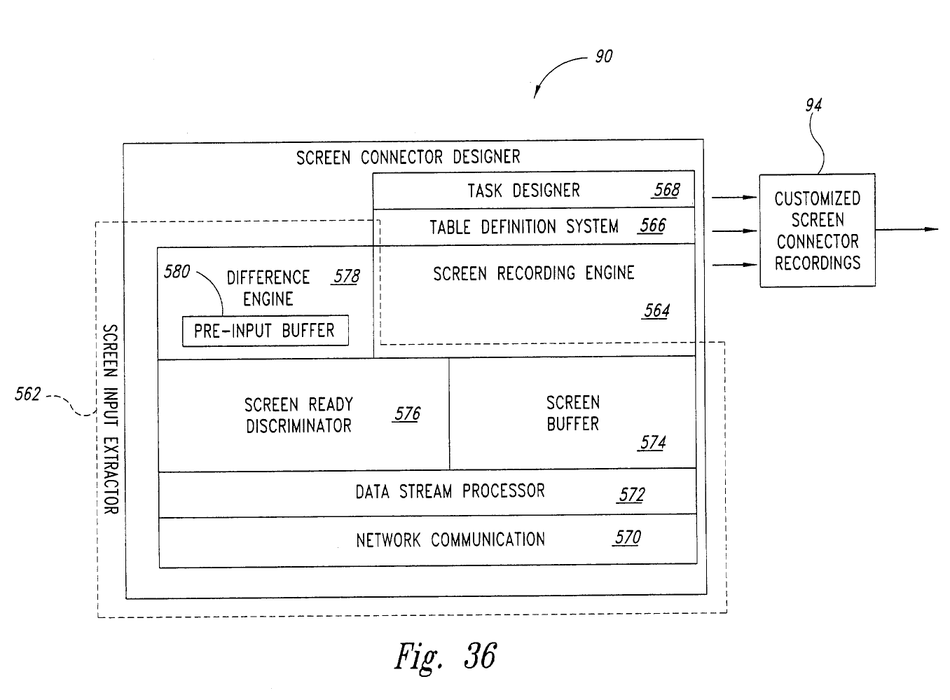

The screen connector designer 90 used to generate customized screen connector recordings 94 may consist of one tool, of several tools that are unified under one common framework, or of several tools that are separately launched by the client machine 10. An embodiment of the screen connector designer 90 is depicted in FIG. 36 as having a screen input extractor 562, a screen recording engine 564, a table definition system 566, and a task designer 568. Though these components are grouped together for illustration purposes, the components are, however, fairly separated in their tasks and need not be integrated one with another. For instance, the screen recording engine 564 could complete its task of recording screens before the table definition system 566 starts its task, which would depend on information collected during the screen recording process. Also, the recordings from each of these components need not be saved in the same recording file. For example, data from the task designer 568 could be saved in a separate recording structure or file than data saved by the screen recording engine 564. In other embodiments of the screen connector designer 90, these recordings could be saved locally on the same machine, saved remotely over a network, or saved to a remote storage device.

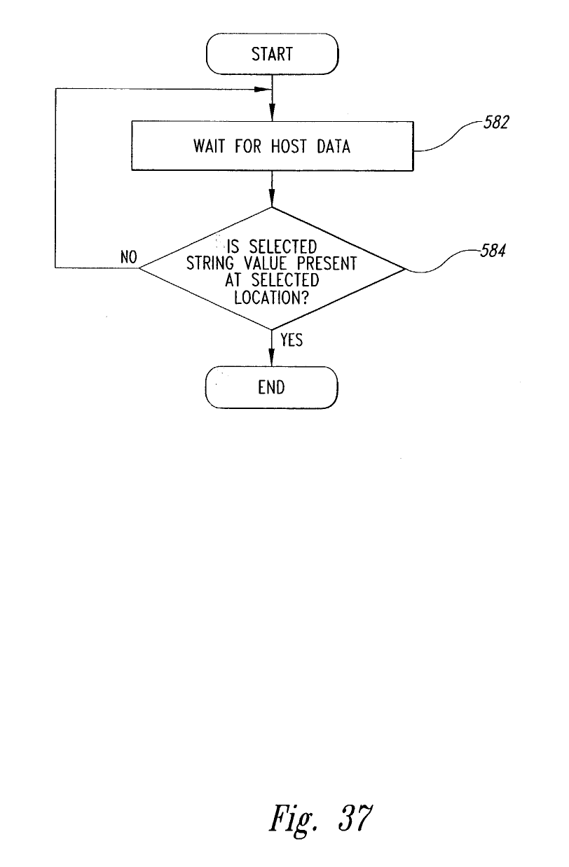

The screen input extractor 562 is comprised of a network communication 570 component, a data stream processor 572, a screen ready discriminator 576, a screen buffer 574, and a difference engine 578 containing a pre-input buffer 580. The screen ready discriminator 576 is used to determine if a host screen of a rudimentary host application screen recording represents a complete screen that is ready to be operated upon or if the host screen represents a screen that is still in the process of being drawn. FIG. 37 illustrates an exemplary method followed an embodiment of the screen ready discriminator 576 working with a host application that has a limited range of screen contents. First, the screen ready discriminator 576 waits for host data (step 582) and, from the host data, determines if a predefined string value is present at a selected location in the recorded host screen. For example, many host screens end with the word “Ready” in the lower right-hand corner to indicate that they are complete and not in the process of being drawn. In this case, an embodiment of the screen ready discriminator 576 could look for the string “Ready” to determine if the host screen is set to be operated upon. If the predefined string value is not present in the host screen (“No” branch of step 584), the screen ready discriminator 576 continues to wait for more host data. Otherwise (“Yes” branch of step 584), the screen ready discriminator 576 ends its method.

In an application where an embodiment of the screen ready discriminator 576 is using a plurality of fields to recognize the host screen, the screen ready discriminator would look for multiple string values in multiple specified locations in the host screen. In this embodiment, the screen ready discriminator 576 would need to access a list of all the screen additions and screen contents for each host screen in the rudimentary host application screen recording.

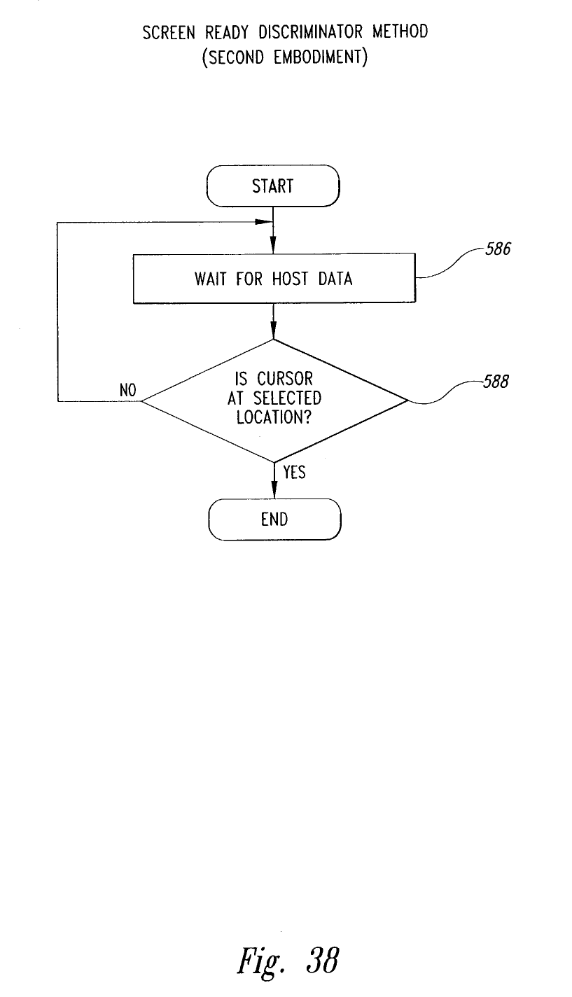

In an alternative embodiment of the invention, the screen ready discriminator 576 uses data regarding the position of a screen cursor to determine if a host screen is complete or not. As shown in FIG. 38, this embodiment of the screen ready discriminator 576 begins its method by waiting for host data that indicates the position of the screen cursor on the host screen (step 586). If the screen cursor is not present at a predetermined location (“No” branch of step 588) as supplied by the screen connector designer 90, the screen ready discriminator 576 continues to wait for host data. Once the cursor is present at the specified location (“Yes” branch of step 588), the screen ready discriminator 576 ends the method.

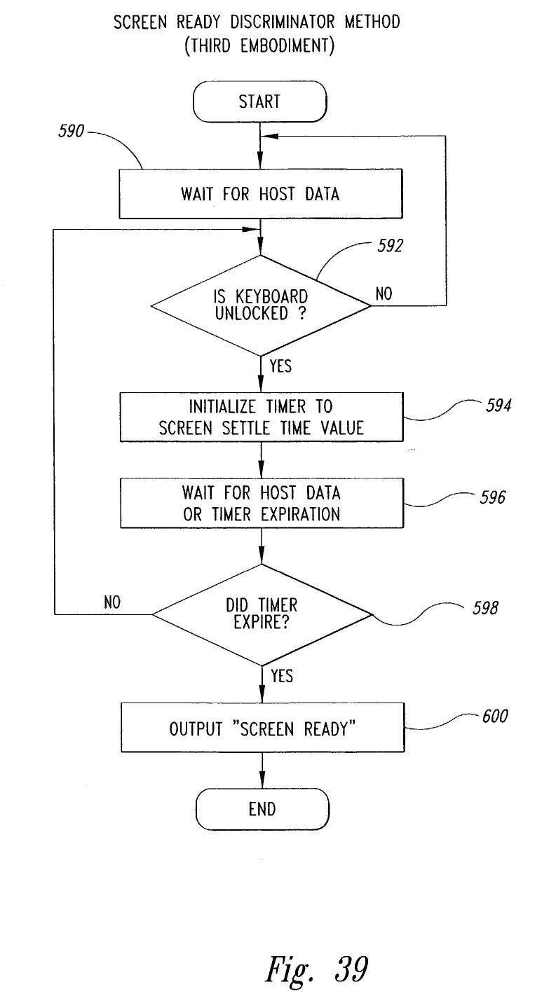

Oftentimes it is difficult to predefine all the host data from a particular host application 82 that may indicate if a host screen is complete. A method for an alternative embodiment of the screen ready discriminator 576, which differs from the methods described in FIGS. 37-38, is illustrated in FIG. 39. This method differs from the previous two methods in that it does not require as much pre-hand knowledge concerning the host data it is receiving from the host application 82. The screen ready discriminator 576 begins this method by waiting for host data (step 590). If the screen ready discriminator 576 receives a keyboard locked indicator from the data stream processor 572 (“No” branch of step 592), the screen ready discriminator continues to wait for more data from the host application 82. The type of host data indicating that a keyboard is locked or unlocked depends on the type of host terminal being used. For instance, an IBM 3270 type terminal has a unique character on its screen to indicate that a keyboard is unlocked. On the other hand, some host terminals, such as Digital Equipment Corporation VT type terminals, do not have a keyboard locked indicator. In this case, the screen ready discriminator 576 would not need to look for a keyboard locked indicator and could bypass step 592.

If the keyboard is unlocked (“Yes” branch of step 592) or the host terminal does not have a keyboard locked indicator, the screen ready discriminator 576 proceeds to initialize a timer to a screen settle time value (step 594). In this embodiment of the screen ready discriminator 576, the screen settle time value is “per host screen” in the rudimentary host application screen recording and is automatically adjusted based on observed timeout values. Thus, because screen recognition is being applied at the same time the timer is being applied, a different screen settle time value is assigned for each host screen or for each host screen in the same screen collection. After initializing the timer, the screen ready discriminator 576 then waits for either specified host data from the data stream processor 572 or for the expiration of the timer (step 596).

If the timer does not expire prior to the screen ready discriminator 576 receiving the host data (“No” branch of step 598), the screen ready discriminator starts the method again by determining if the keyboard is unlocked. Otherwise (“Yes” branch of step 600), the screen ready discriminator 576 outputs a “screen ready” signal (step 600) and ends the method.

In alternative embodiments of the screen ready discriminator 576, the screen settle time value could be a global value for the entire rudimentary host application screen recording. Other embodiments of the screen ready discriminator 576 could also include the screen ready discriminator running on one thread while the timer and data stream processor 572 are running on separate threads. In the multi-thread embodiment, the screen ready discriminator 576 would create a thread for the timer when initializing the timer to the screen settle time value (step 594), and step 596 would consist of the screen ready discriminator suspending its method until it is asynchronously “re-awakened” either by a thread running the data stream processor 572 or by a thread running the timer. Multi-thread timer execution is often used in real-time operating systems and is built into the Java language.

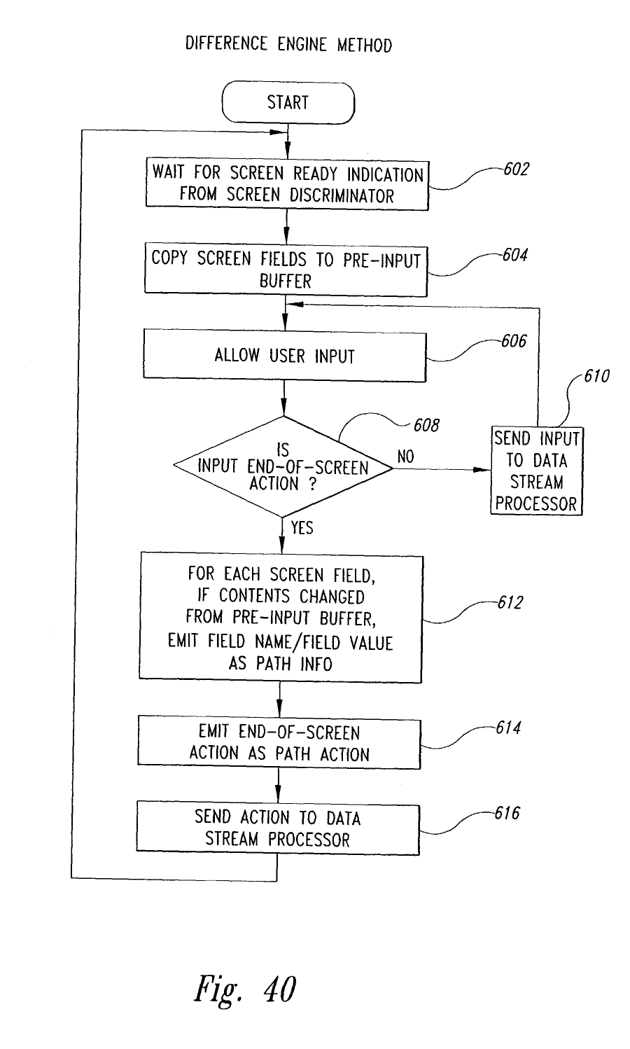

Once the screen ready discriminator 576 has determined that a host screen is complete, the difference engine 578 compares the fields of the host screen, before a user has input data, with the same fields of the host screen after the user has input data. In comparing the final state of the host screen to the initial state of the host screen, the difference engine 578 determines what data was applied to the host screen but ignores extraneous information regarding how the data was inputted. An example of a method followed by an embodiment of the difference engine 578 is shown in FIG. 40. The difference engine 578 begins this method by waiting for a “screen ready” indication from the screen discriminator 576 (step 602). The difference engine 578 may call the screen ready discriminator 576 synchronously as a subroutine, or the difference engine may asynchronously suspend or awaken separate threads. Upon receiving the “screen ready” indication, the difference engine 578 copies the host screen fields to the pre-input buffer 580 (step 604). The difference engine 578 then allows the user to input data (step 606) and evaluates whether or not the user input consists of an end-of-screen action. An end-of-screen action consists of an action that causes the host computer to process the user input and to display a new page or screen, and end-of-screen actions are particular to the host application 82 and host terminal being used. For instance, in the IBM 3270 type terminal, end-of-screen actions are defined by the 3270 specifications and are called attention identifier keys, which include the “enter” key, the function keys, and other miscellaneous keys such as the “clear” key. In the Digital Equipment Corporation VT type terminals, however, an end-of-screen action is not defined and depends on the particular host application 82. In embodiments where the end-of-screen actions are application-specific, the keys indicating an end-of-screen action would be defined prior to running the screen connector designer 90.

If the input by the user is not an end-of-screen action (“No” branch of step 608), the difference engine 578 sends the input to the data stream processor 572 (step 610) and allows more user input. Otherwise (“Yes” branch of step 608), the difference engine 578 compares each host screen field captured after the end-of-screen action with its related host screen field stored in the pre-input buffer 580. For each comparison that yields differences between the host screen fields, the difference engine 578 emits a field name and a field value as path information (step 612). The difference engine 578 also emits an end-of-screen action as a path action (step 614). The path action is sent to the data stream processor 572 (step 616), and the difference engine 578 repeats its method by returning to wait for another “screen ready” indication from the screen ready discriminator 576.

The method described in FIG. 40 is exemplary and in other embodiments some steps may be reordered or combined. For instance, the difference engine 578 may emit an end-of-screen action as a path action (step 614) prior to emitting a field name and a field value as path information (step 612). In an alternative embodiment of the difference engine 578 where the data stream processor 572 is autonomous, or running on a separate thread from the difference engine, steps 610 and 616 may also be omitted. In this embodiment, the data input or action would have already been sent through the data stream processor 572 and would not need to be sent through the data stream processor a second time.

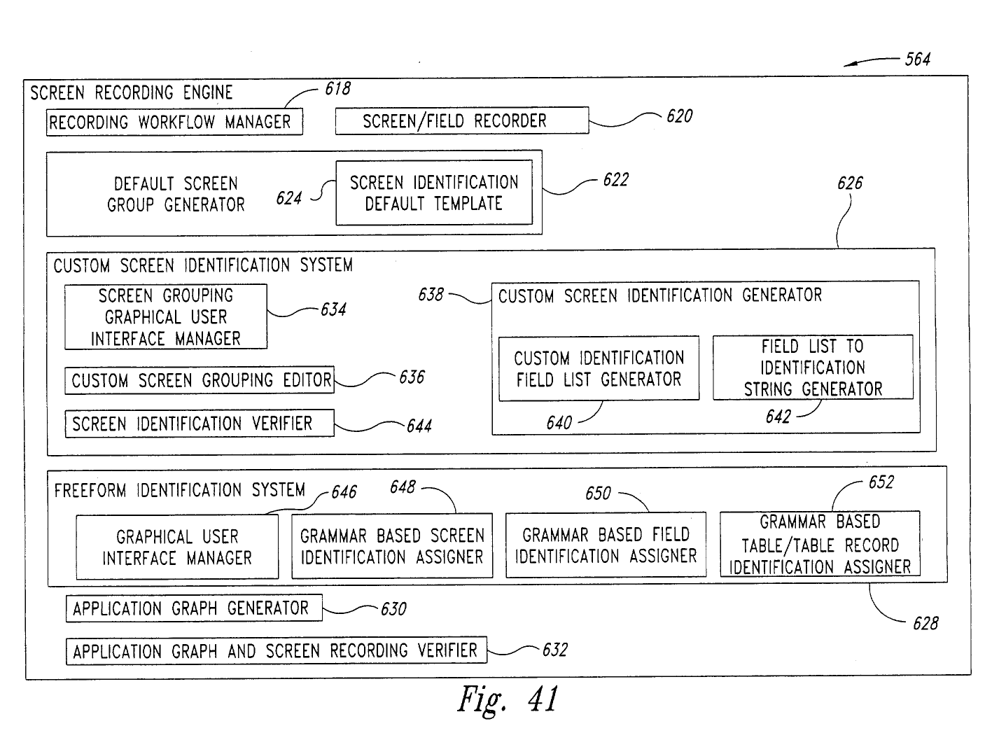

The screen recording engine 564 is used by the screen connector designer 90 to convert rudimentary host application screen recordings into customized screen connector recordings 94. As shown by the schematic diagram in FIG. 41, an embodiment of the screen recording engine 564 consists of a recording workflow manager 618, a screen/field recorder 620, and a default screen group generator 622 having a screen identification default template 624. The screen recording engine 564 is further comprised of a custom screen identification system 626, a freeform identification system 628, an application graph generator 630, and an application graph and screen recording verifier 632.

The custom screen identification system 626 includes a custom screen identification generator 638 having both a custom identification field list generator 640 and a field list to identification string generator 642, a screen grouping graphical user interface manager 634, a custom screen grouping editor 636, and a screen verification verifier 644. The freeform identification system 628 is comprised of a graphical user interface manager 646, a grammar based screen identification assigner 648, a grammar based field identification assigner 650, and a grammar based table/table record identification assigner 652.

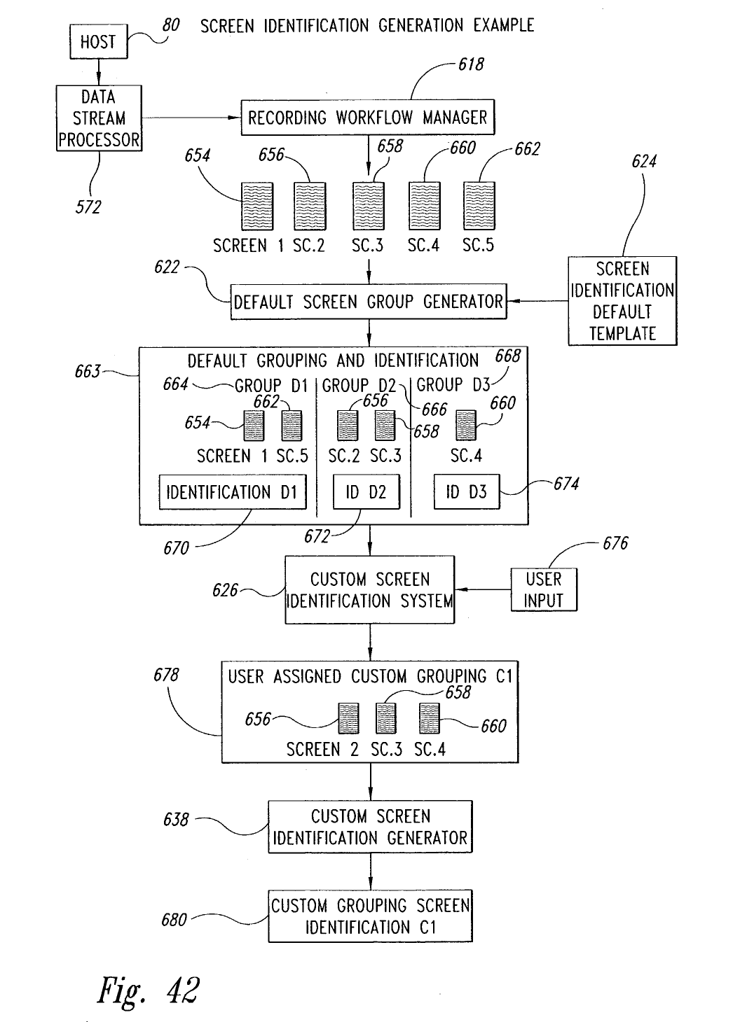

An exemplary overall process of how the customized screen connector recordings are generated is illustrated by the transition diagram in FIG. 42. Data sent from the host computer 80 through the data stream processor 572 is used by the recording workflow manager 618 to generate a linear list of host screens 654-662, which list could contain screen field identifications and the contents of each host screen. The default screen group generator 622 is then invoked to create preliminary collections of host screens based on the application of the screen identification default template 624 to each host screen. This preliminary grouping of host screens is based on the contents of each host screen. In FIG. 42, group D1 664 consists of screen 1 654 and screen 5 662 and is identified by an identification D1 670. Group D2 666 contains screen 2 656 and screen 3 658 and is identified by an identification D2 672. Group D3 668 contains only screen 4 660 and is identified by identification D3 674. These preliminary collections of host screens may then be modified by the user through the custom screen identification system 626. As shown in the transition diagram, the user assigned custom group C1 678 combines group D2 666 and group D3 678 of the default groups and is thus comprised of screen 2 656, screen 3 658, and screen 4 660. The user assigned custom group C1 678 is then given a custom grouping screen identification C1 680 by the custom screen identification generator 638, which is used later in the system.

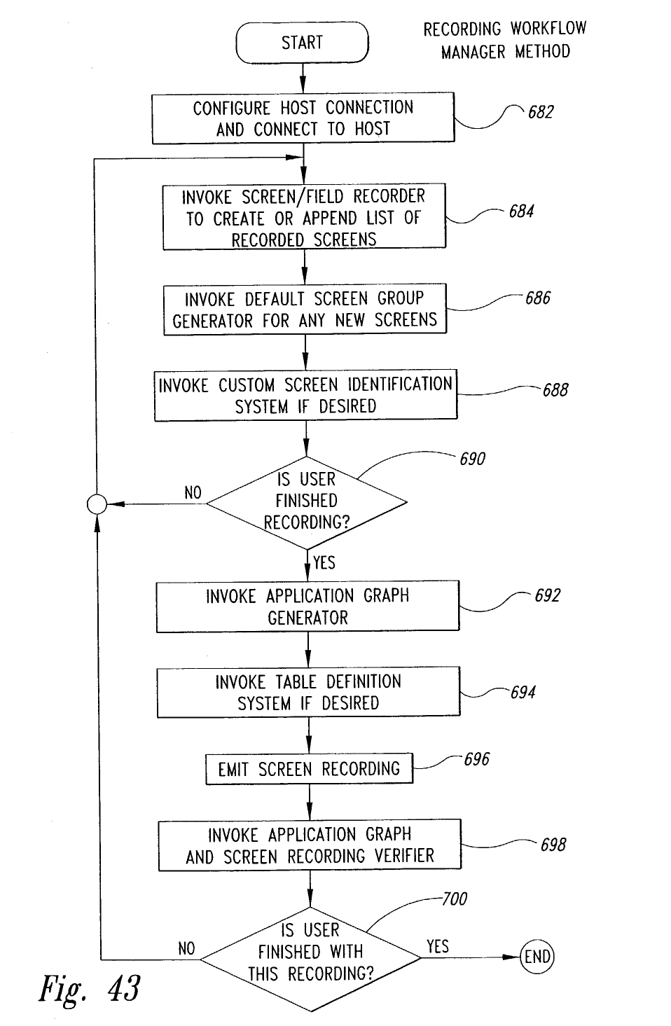

The generation of same screen collections is managed by the recording workflow manager 618, and an exemplary method followed by an embodiment of the recording workflow manager is shown in FIG. 43. This method includes displaying the host screens to the user, recording the contents of the host screens, organizing the host screens into same screen collections, and creating group recognition rules that can be used later by the screen connector runtime engine 100. To accomplish its task, the recording workflow manager 618 interacts with the difference engine 578, the screen buffer 574, and components of the screen recording engine 564.

The recording workflow manager 618 starts its method by configuring a host connection and connecting to the host computer 80 (step 682). After the connection is established, the recording workflow manager 618 invokes the screen/field recorder 620 to create or append a list of recorded host screens (step 684) and invokes the default screen group generator 622 for any new host screens (step 686). During these steps, the recording workflow manager 618 continues to individually record host screens and displays the collections of host screens until the user decides to end the recording process. For instance, users may indicate that they are ready to move on from the recording process by clicking a specified button or by engaging in any other predefined action.

The user then has the option to invoke the custom screen identification system 626 (step 688) to further modify the collections of host screens. Once the user is finished using the custom screen identification system 626, or if the user chooses to bypass step 888, the recording workflow manager 618 must determine if the user is finished with the process of grouping the host screens (step 690). If the user is not finished (“No” branch of step 690), the recording workflow manager 618 continues to invoke the screen/field recorder 620 (step 684). Otherwise (“Yes” branch of step 690), the recording workflow manager 618 moves on to the second stage in the recording process by invoking the application graph generator 630 (step 692), which converts a time-ordered sequence of recorded host screens to a state map recording of host screens. Next, the user has the option to invoke the table definition system 566 (step 694). The recording workflow manager 618 then emits the host screen recording (step 696) and invokes the application graph and screen recording identifier 632 (step 698). Finally, the recording workflow manager 618 determines if the user is finished with this second stage in the recording process. If the user has finished (“Yes” branch of step 700), the recording workflow manager 618 ends its method. Otherwise (“No” branch of step 700), the recording workflow manager 618 returns to invoke the screen/field recorder 620 to create or append a list of recorded host screens (step 684).

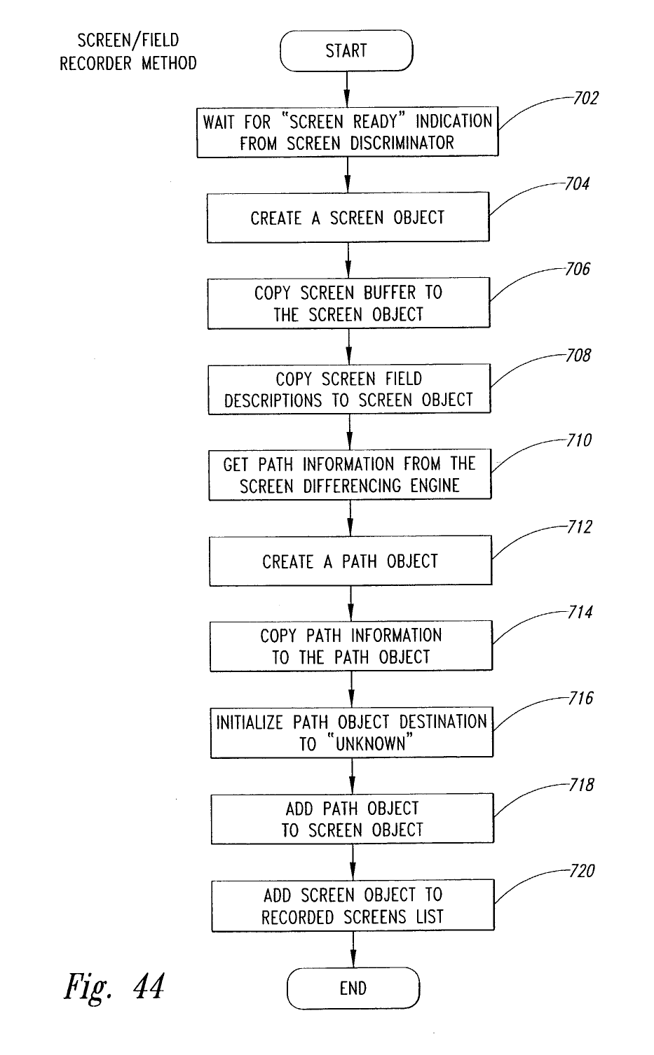

The screen/field recorder 620 is called by the recording workflow manager 618 to record important information from a host screen after receiving confirmation from the screen discriminator 576 that the host screen is complete. Recording this information, as illustrated by an exemplary method in FIG. 44, includes copying data concerning screen buffers, screen fields, and paths to other screens. The screen/field recorder 620 begins its method by waiting for a “screen ready” indication from the screen ready discriminator 576 (step 702). The screen/field recorder may call the screen ready discriminator 576 asynchronously as a subroutine or can asynchronously awaken or suspend separate threads. Upon receiving the screen ready signal, the screen/field recorder 620 creates a screen object (step 704) and copies both the screen buffer 574 (step 706) and the screen field descriptions (step 708) to the screen object.

The screen/field recorder 620 also retrieves path information from the screen difference engine 578 (step 710) and creates a path object (step 712). Next, the screen/field recorder 620 copies the path information to the path object (step 714), initializes the path object destination to “unknown” (step 716), and adds the path object to the screen object (step 718). Finally, the screen/field recorder 620 adds the screen object to the recorded screen list (step 720) and ends the method.

If the user does not want to review the screens for custom group editing, the screen/field recorder 620 may bypass the step of copying the screen buffer 574 to the screen object (step 706). Thus, in an alternative embodiment of the invention, the screen/field recorder 620 may ask the user if he or she wants to edit the application screen recording. If the user does not want to do so, the screen/field recorder 620 would copy to the screen object only the field descriptions and the path information and not the screen buffer 574.

The term “object” is used in FIG. 44 only as a convenience for notation, and the screen/field recorder 620 should not be viewed as being limited to working only with objects. Alternative embodiments of the screen/field recorder 620 may use any data structure that is capable of capturing relationships between data. Examples of these data structures include hierarchically related tables, linked lists, and relational databases with tables representing objects.

The steps shown in FIG. 44 represent an example of one method followed by an embodiment of the screen/field recorder 620. In other embodiments of the screen/field recorder 620, these steps may be combined or reordered. For instance, the order is which the screen buffer 574 (step 706), the screen fields (step 708), and the screen path (steps 710-718) are recorded could be rearranged. Thus, the screen/field recorder 620 may copy the path information before copying information concerning the screen field or the screen buffer 574.

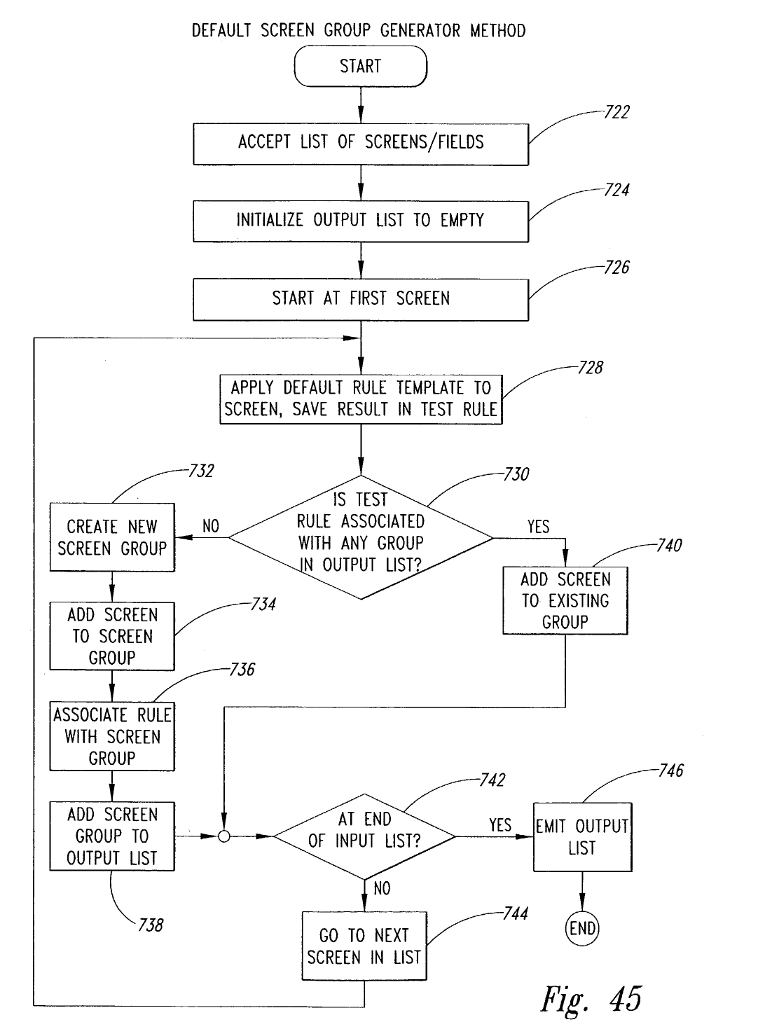

After a time sequence of recorded host screens has been generated, the default screen group generator 622 extracts particular features that are important to the host screens, creates test rules based on the extracted features, and groups the host screens that have identical test rules. These preliminary collections of host screens are then sent to the user for further modification and regrouping. A method followed by an embodiment of the default screen group generator 622 is illustrated in FIG. 45.

The default screen group generator 622 begins its method by accepting a list of host screens (step 722) and by initializing an output list to empty (step 724). The default screen group generator 622 then loads the first host screen (step 726) and applies the screen identification default template 624 to the host screen and saves the result as a test rule (step 728). In alternative embodiments, the screen identification default template 624 could be compiled in, supplied by the user, or be a combination of both. For instance, the screen identification default template 624 could use the first “x” characters of the first “y” field and the last “z” field in the host screen to construct the test rule. In another embodiment, the screen identification default template 624 could ask for a string of field names or field values from the host screen.

The default screen group generator 622 then searches the output list of collections of host screens to determine if the test rule is associated with any collection of host screens (step 730). If the test rule is associated with one of the existing collections of host screens (“Yes” branch of step 730), the default screen group generator 622 adds the loaded host screen to that collection of host screens (step 740) and determines if there are remaining host screens in the input list (step 742). Otherwise (“No” branch of step 730), the default screen group generator 622 creates a new collection of host screens (step 732), adds the screen to the new collection of host screens (step 734), and associates the test rule with the new collection of host screens (step 736). The default screen group generator 622 also adds the new collection of host screens to the output list (step 738). Finally, the default screen group generator 622 determines whether or not it has reached the end of input list. If the default screen group generator 622 has not reached the last host screen in the input list (“No” branch of step 742), then the default screen group generator moves to the next host screen (step 744) and applies the screen identification default template 624 to that host screen. Otherwise, the default screen group generator 622 emits the output list of the collections of host screens (step 746) and concludes the method.

After the default screen group generator 622 has organized the host screens into preliminary collections of host screens, the user has the opportunity to edit the collections of host screens into customized same screen collections and verify that each host screen is grouped in the appropriate same screen collection. This process is overseen by the screen grouping graphical user interface manager 634, and an exemplary method followed by the screen grouping graphical user interface manager is depicted in FIG. 46.

Initially, the screen grouping graphical user interface manager 634 saves the state of each same screen collection in case there are errors discovered later during the editing process (step 748). Next, the screen grouping graphical user interface manager 634 invokes the custom screen grouping editor 636 (step 750) through which the user may edit a same screen collection, after which the same screen collection is given an identification string by the custom screen identification generator 638 (step 752). The screen grouping graphical user interface manager then calls the screen identification verifier 644 (step 754) to check for errors in the identification of the same screen collection. If errors are not returned by the screen identification verifier 644 (“No” branch of step 756), the screen grouping graphical user interface manager 634 determines if the user has finished editing the same screen collection (step 764). If the user has finished (“Yes” branch of step 764), the screen grouping graphical user interface manager 634 ends its method. However, if the user has not finished editing the same screen collection (“No” branch of step 764), screen grouping graphical user interface manager 634 saves the state of the same screen collection (step 748) and repeats the method.

In the case that errors are returned from the screen identification verifier 644 (“Yes” branch of step 756), the screen grouping graphical user interface manager 634 notifies the user of the errors (step 758) and asks if the user wants to undo the changes to the state of the same screen collection (step 760). If the user does not want to undo the changes (“No” branch of step 760), the screen grouping graphical user interface manager 634 again invokes the custom screen grouping editor 636 (step 750). Otherwise, the screen grouping graphical user interface manager 634 reverts to the original state of the same screen collection (step 762) and invokes the custom screen grouping editor 636 (step 750).

In an alternative embodiment of the invention in which the user is not given the opportunity to undo mistakes, steps in the exemplary method shown in FIG. 46 could be omitted. For instance, the screen grouping graphical user interface manager 634 would not need to save the initial state of the same screen collections (step 748) nor provide the user with the option to undo changes to the same screen collections (steps 760-762).

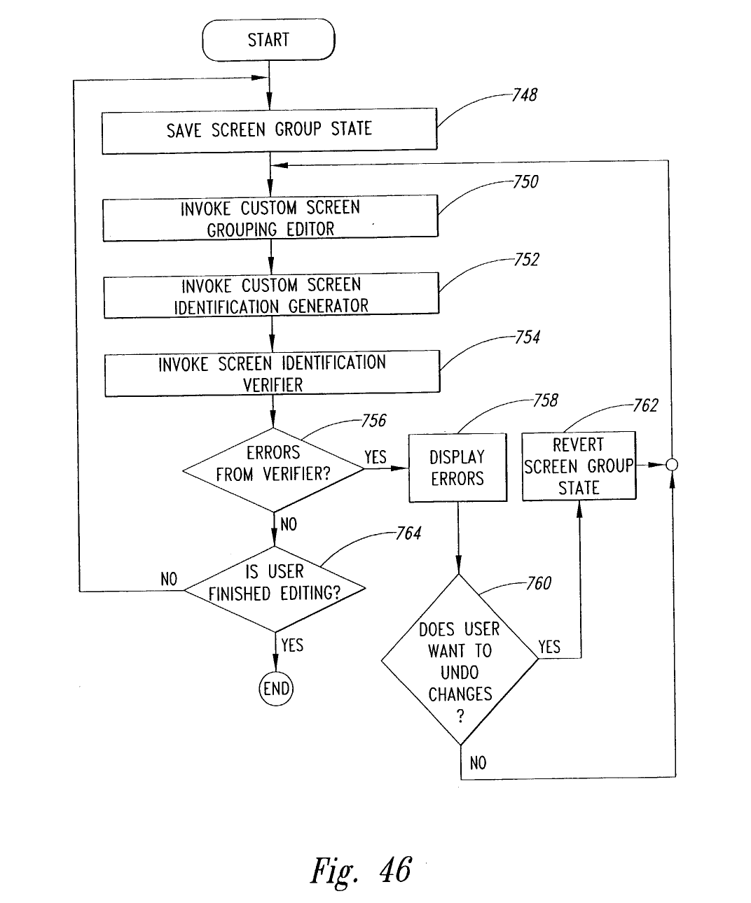

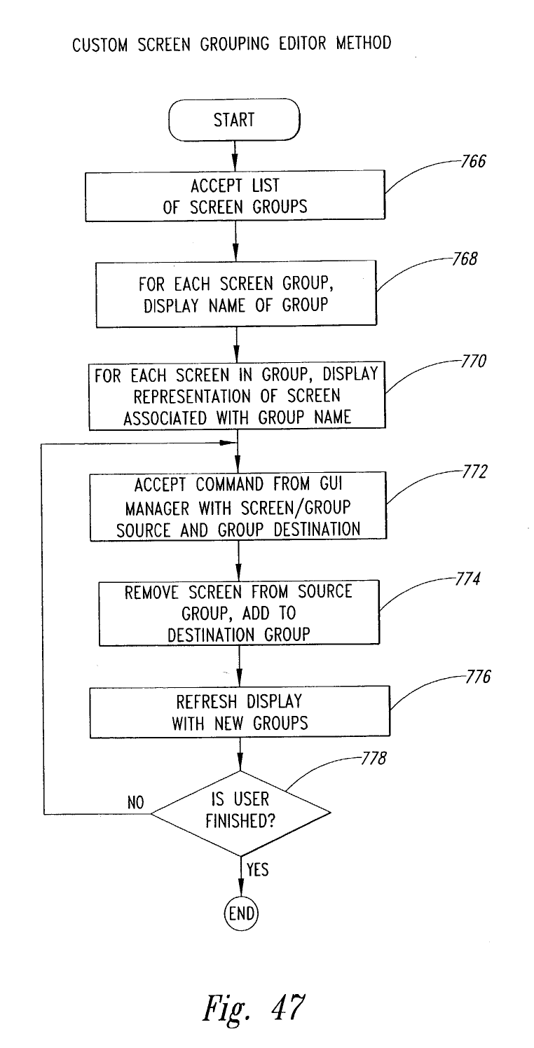

A method by which a user customizes collections of host screens is shown in more detail in FIG. 47. The custom screen grouping editor 636 provides the user with a graphical user interface in which the user can select individual host screens and add them to particular same screen collections. In one embodiment, the custom screen grouping editor 636 begins the method by accepting a list of same screen collections (step 766) and displaying the name of each same screen collection (step 768). This displaying of same screen collection names is for the convenience of the user in working with the designer user interface 92. In an alternative embodiment of the custom screen grouping editor 636 in which the display of same screen collection names is not necessary, step 768 would be omitted, and the user would work with unnamed same screen collections.

For each host screen in a same screen collection, the custom screen grouping editor 636 displays a representation of the host screen and its associated same screen collection name (step 770). For example, this representation could take the form of a tree diagram in which each host screen name appears under the name of its same screen collection, or the display could consist of thumbnails of host screen displays clustered according to their same screen collections.

After the custom screen grouping editor 636 displays the host screens in their respective same screen collections, the user is then able to customize the same screen collections by moving recorded host screens from a source same screen collection to a destination same screen collection. The user could accomplish this task in a number of ways. For instance, in one embodiment the user could drag and drop, such as with the use of the mouse 44, a recorded host screen from a source same group collection to a destination same group collection. Alternative embodiments could include other ways for a user to input a command to modify the same screen collections. This command indicating the user selection of source and destination same screen collections comes to the custom screen grouping editor 636 through the screen grouping graphical user interface manager 634 (step 772).

After the custom screen grouping editor 636 accepts the command from the screen grouping graphical user interface manager 634, it removes the selected host screen from the source same screen collection and adds the host screen to the destination same screen collection (step 774). The custom screen grouping editor 636 also refreshes the interface display with the modified same screen collections (step 776). Finally, if the user is finished with the customization process (“Yes” branch of step 778), the custom screen grouping editor 636 ends the method. Otherwise (“No” branch of step 778), the custom screen grouping editor 636 accepts the next user command from the screen grouping graphical user interface manager 634.

The steps represented in the method shown in FIG. 47 are exemplary, and some steps may be combined or rearranged. For instance, in an alternative embodiment, the custom screen grouping editor 636 could refresh the user interface with the modified same screen collections (step 776) before moving the selected host screen from its source same screen collection to its destination same screen collection (step 774).

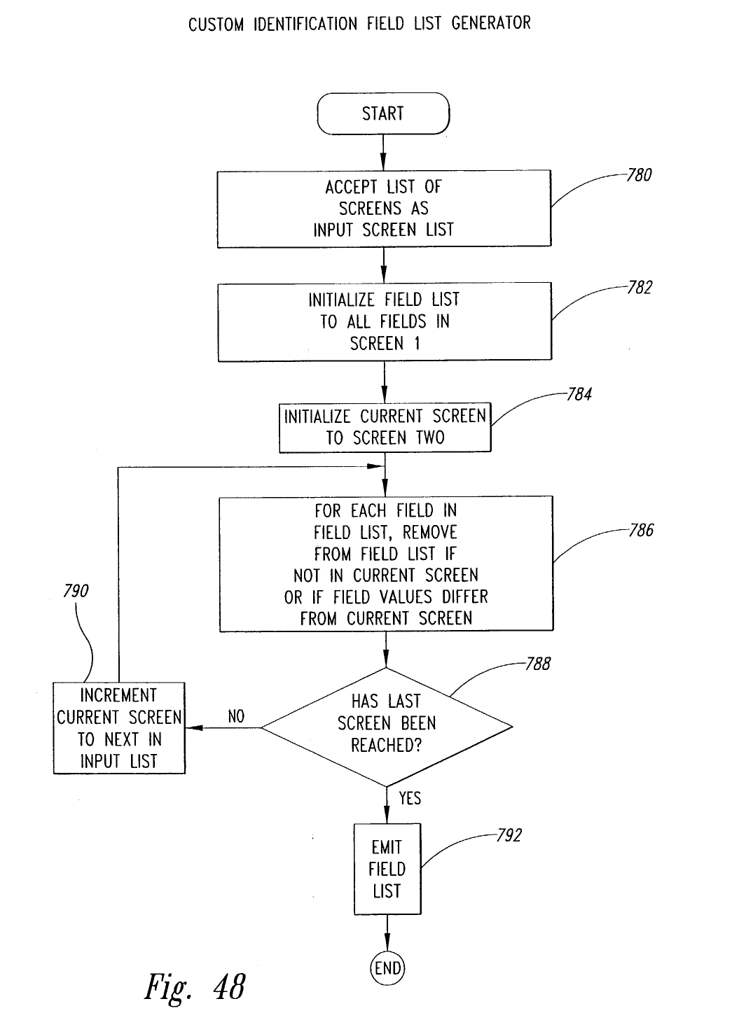

Once the user has customized the same screen collections, the custom identification field list generator 640 examines all the host screens in a specific same screen collection and determines which fields are similar between the host screens. One method followed by an embodiment of the custom identification field list generator 640 is shown in FIG. 48. The custom identification field list generator 640 first accepts a list of host screens of a particular same screen collection as an input screen list (step 780). Then, a field list is initialized to contain all the fields that are present in the first host screen in the input screen list (step 782), and a “current screen” is initialized to the second host screen in the input screen list (step 784). For each field in the field list, the custom identification field list generator 640 removes the field from the field list if the field is not in present in the current screen or if the field value in the field list differs from the corresponding field value in the current screen (step 786). Thus, fields that are not common between host screens of the same screen collection are eliminated from the field list and are not used in subsequent comparisons. After the comparisons of the fields in the host screens, the custom identification field list generator 640 determines if it has looked at each screen in the input list. If it has (“Yes” branch of step 788), the custom identification field list generator 640 emits the list of the common fields between the host screens in the input list (step 792) and finishes the method. Otherwise (“No” branch of step 788), the custom identification field list generator 640 increments the current screen to the next host screen in the input list (step 790) and repeats the field comparisons (step 786).

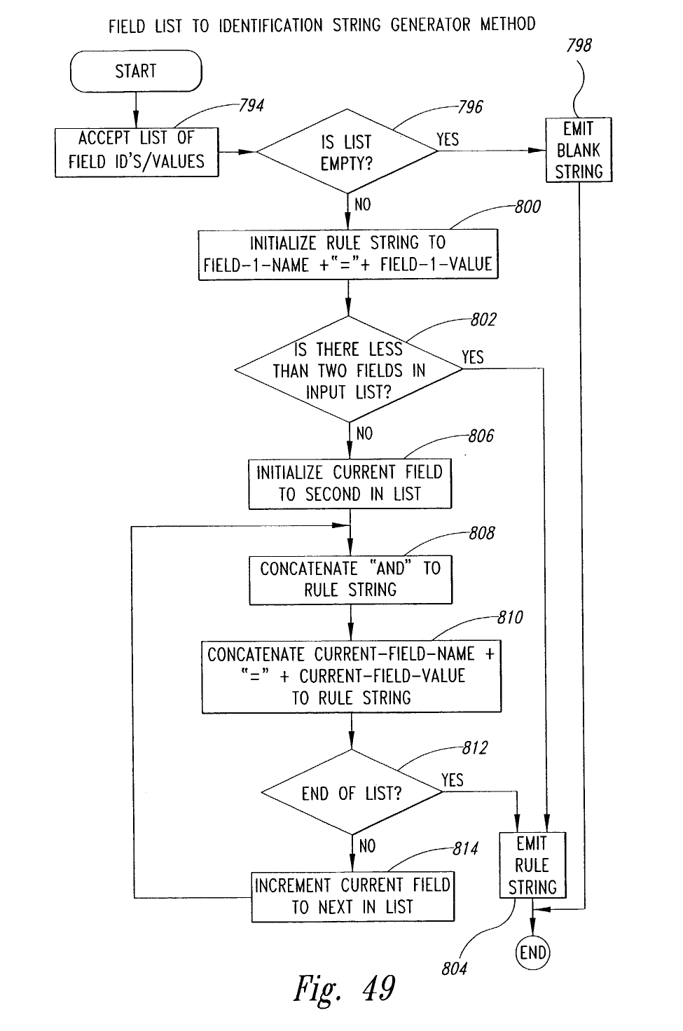

The field list generated by the custom identification field list generator 640 is subsequently used by the field list to identification string generator 642 to construct an identification string for the particular same screen collection. This identification string is constructed using an identification grammar, and an example of a method that accomplishes this identification string formulation is shown in FIG. 49. An embodiment of the field list to identification string generator 642 begins the method by accepting a list of fields, and their corresponding values, from the custom identification field list generator (step 794). If the list of fields is empty (“Yes” branch of step 796), meaning that there were no common fields among the host screens in a same screen collection, the field list to identification string generator 642 emits a blank string (step 798) and ends its method. If the list of fields is not empty, the field list to identification string generator 642 initializes a rule string to contain the following string of characters (step 800): the name of the first field (represented in FIG. 49 as “Field-1-name”), an “=,” and the value of the first field (represented in FIG. 49 as “Field-1-value”). If there are no other fields in the input list (“Yes” branch of step 802), the field list to identification string generator 642 emits the rule string as an identification string (step 804) and ends the method.

If there are more fields in the input list (“No” branch of step 802), the field list to identification string generator 642 next initializes the current field to the second field on the input list (step 806) and concatenates the term “and” to the rule string (step 808). The field list to identification string generator 642 then proceeds to concatenate to the rule string the name of the current field, an “=,” and the value of the current field (step 810). If the current field is the last field in the list (“Yes” branch of step 812), the field list to identification string generator 642 emits the rule string as an identification string and ends its method (step 804). Otherwise (“No” branch of step 812), the field list to identification string generator 642 increments the current field to the next field on the input list (step 814) and returns to step 808.

The steps of the method illustrated in FIG. 49 are exemplary and may be modified, combined, or rearranged. For example, in alternative embodiments of this invention, another identification grammar could be used to identify same screen collections as long as the identification grammar could be properly interpreted in subsequent processes.

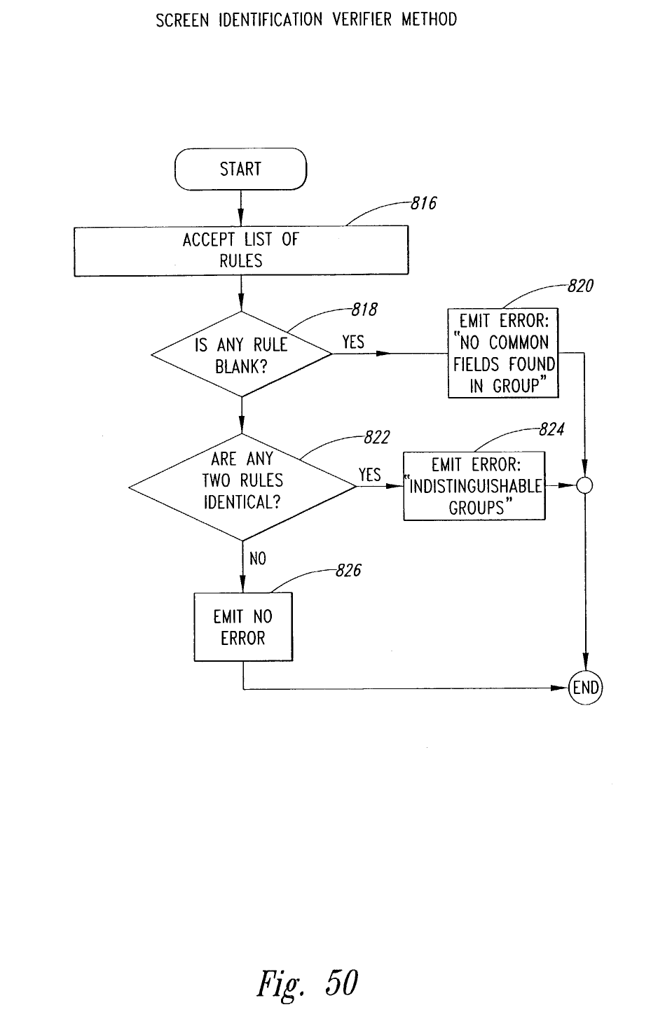

After the field list to identification string generator 642 emits the lists of identification strings, the screen identification verifier 644 is used to identify same screen collections that have identical identification strings and to notify the user of a same screen collection in which the host screens have no common fields. FIG. 50 illustrates an exemplary method followed by an embodiment of the screen identification verifier 644. The screen identification verifier 644 begins its method by accepting a list of identification strings that are used as rules to identify same screen collections (step 816). If any of the identification strings are blank (“Yes” branch of step 818), the screen identification verifier 644 emits an error alerting the user that no common fields were found for the host screens of a particular same screen collection (step 820). After notifying the user as to the error, the screen identification verifier 644 would then end the method.

If none of the identification strings are blank (“No” branch of step 818), then the screen identification verifier 644 determines if any two identification strings in the list are identical (step 822). If there are identical identification strings (“Yes” branch of step 822), the screen identification verifier 644 emits an error notifying the user that there are indistinguishable same screen collections. In other words, the fields that are common between the host screens of one same screen collection are identical to the fields that are common between the host screens of a second same screen collection. After emitting this error, the screen identification verifier 644 would end the method. Otherwise, if none of the identification strings are identical (“No” branch of step 822), the screen identification verifier 644 confirms to the user that there were no errors with the identification strings (step 826) and ends the method.

The steps represented in FIG. 50 are exemplary and, in other embodiments of the invention, may be rearranged or combined. For instance, in an alternative embodiment, the screen identification verifier may look for identical identification strings (step 822) before determining if any of the identification strings are blank (step 818).

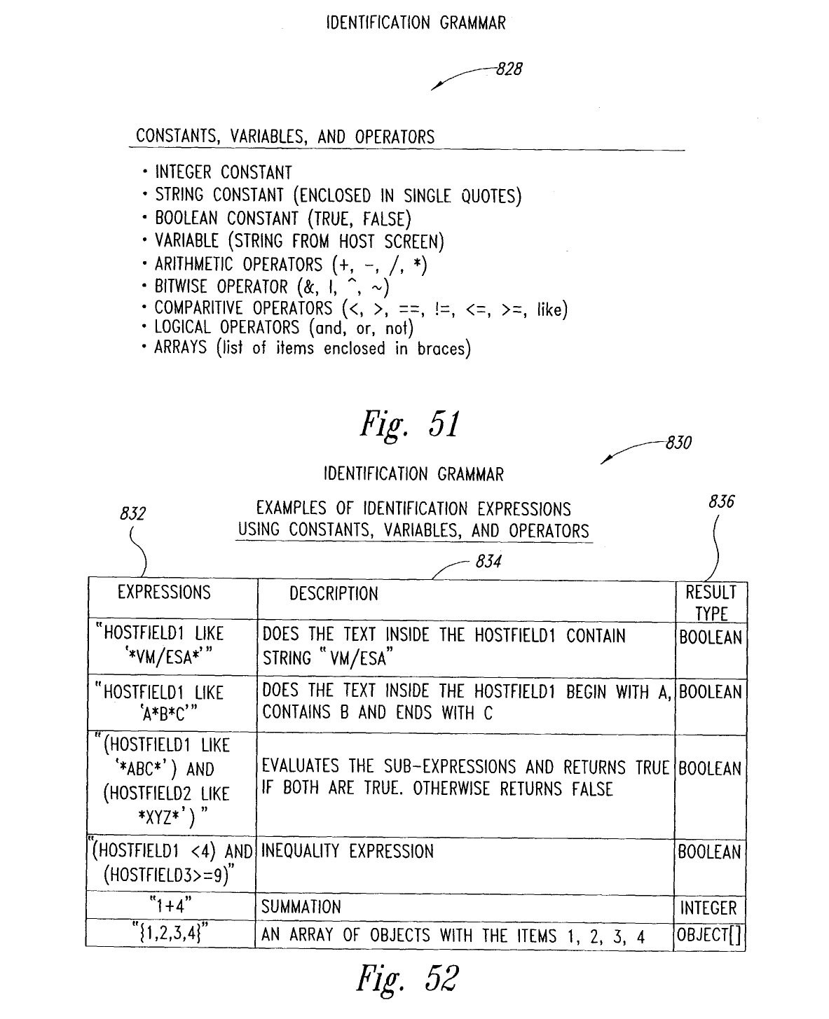

The identification grammar used to construct identification strings for same screen collections and to classify host screens during the runtime process may be comprised of various constants, variables, and operators. An exemplary list of constants, variables, and operators 828 that could be used in an identification grammar is shown in FIG. 51. These constants, variables, and operators can be arranged to build identification grammar expressions that are used to categorize host screens. The table in FIG. 52 shows some examples of identification grammar expressions 832, examples of the descriptions 834 of the identification grammar expressions, and examples of the result type 836 after applying the identification grammar expression to a host screen.

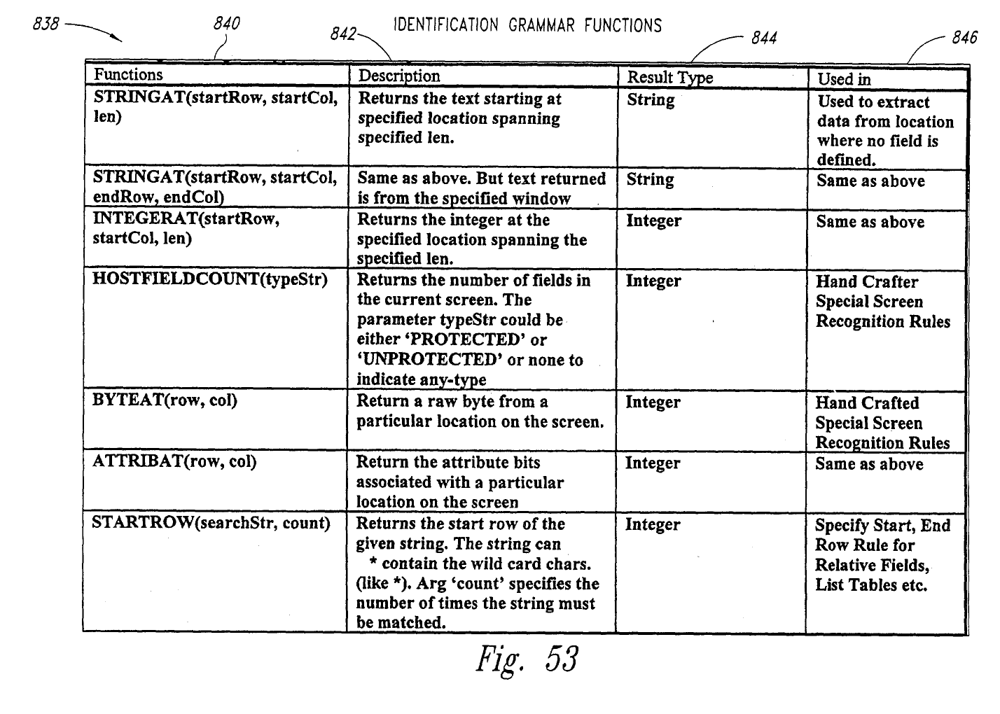

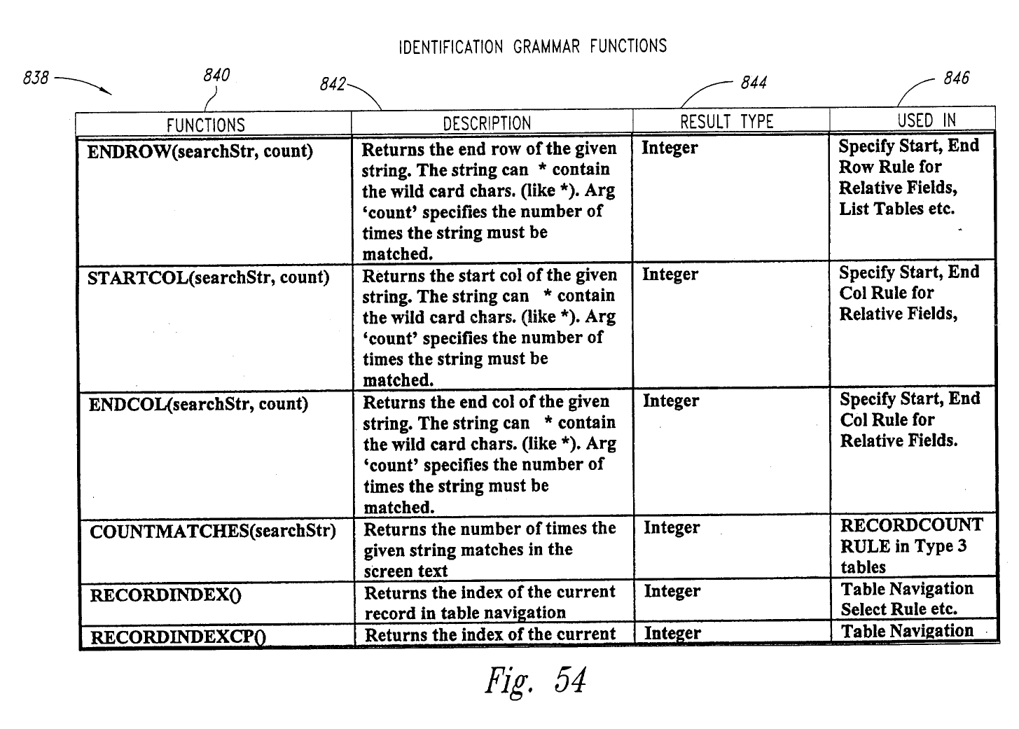

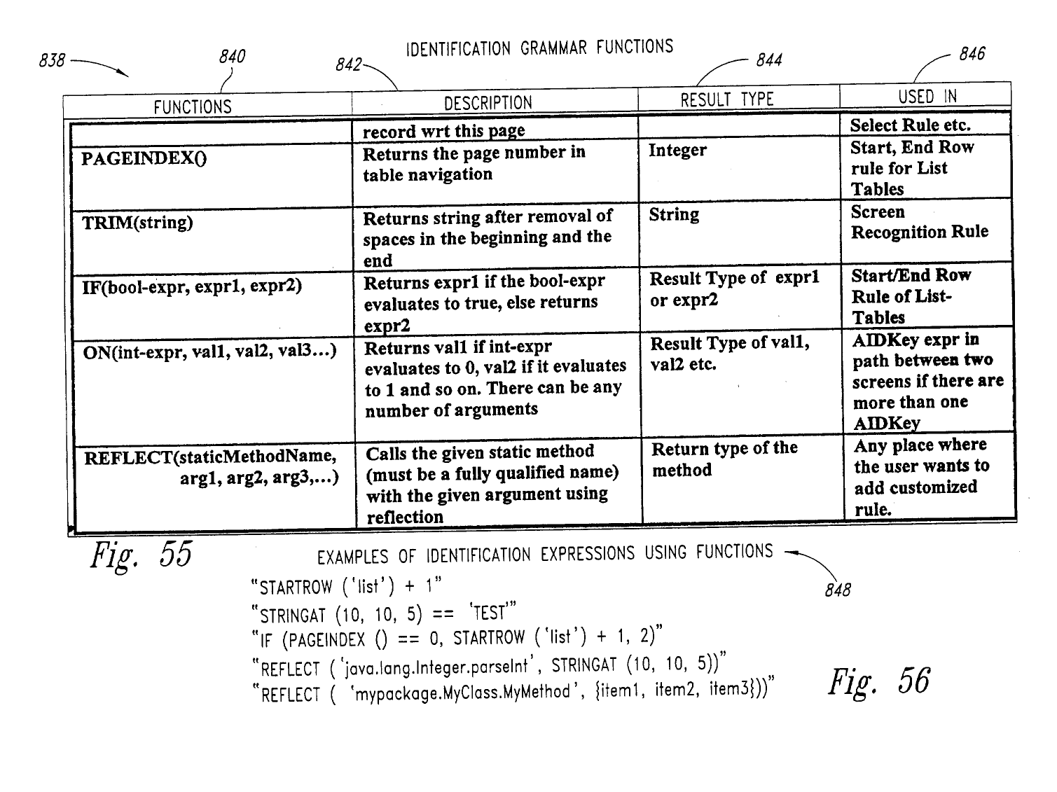

An identification grammar may also contain identification grammar functions that can be used to evaluate host screens. The results of these identification grammar functions depend on what data is displayed on the host screen and, therefore, depend on the type of host terminal. FIGS. 53-55 contain tables showing examples of identification grammar functions 840, descriptions 842 of the identification grammar functions, the result type 844 of the identification grammar functions, and descriptions of how the identification grammar functions are used 846. The identification grammar functions 840 listed do not represent an exhaustive list but are examples of generic identification grammar functions that could be used with almost any host terminal type that displays a rectangular array of characters. Thus, other generic identification grammar functions or identification grammar functions that are specific to a certain host terminal type could be used in the identification grammar. Examples of identification grammar expressions using identification grammar functions 848 are shown in a list in FIG. 56.

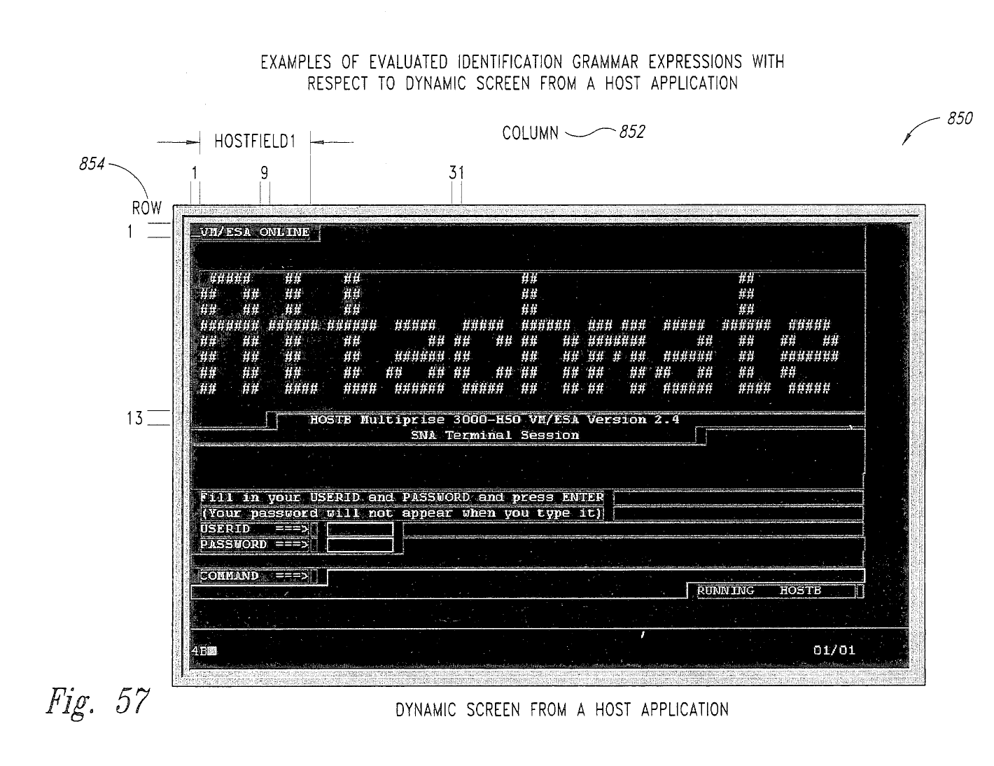

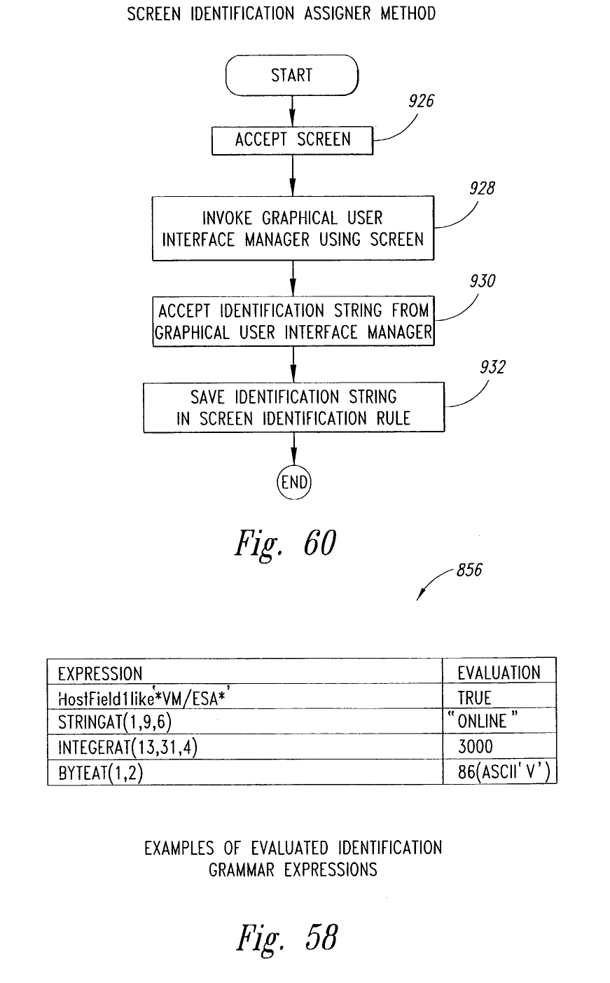

An example of evaluated identification grammar expressions with respect to a dynamic screen 850 from a host application 82 is shown in FIGS. 57-58. A table 856 on FIG. 58 shows four identification grammar expressions that have been applied to the dynamic screen 850 in FIG. 57. The table 856 also shows the results of applying the four identification grammar expressions to data received from the dynamic screen 850, which data was segmented by the use of columns 852 and rows 854.

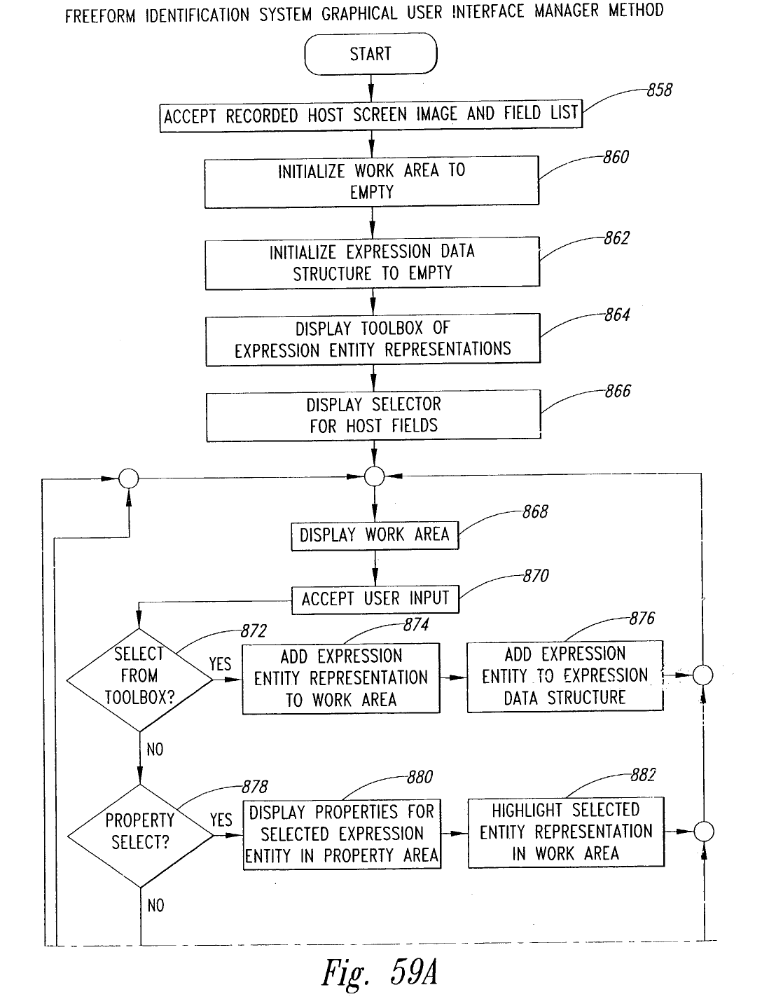

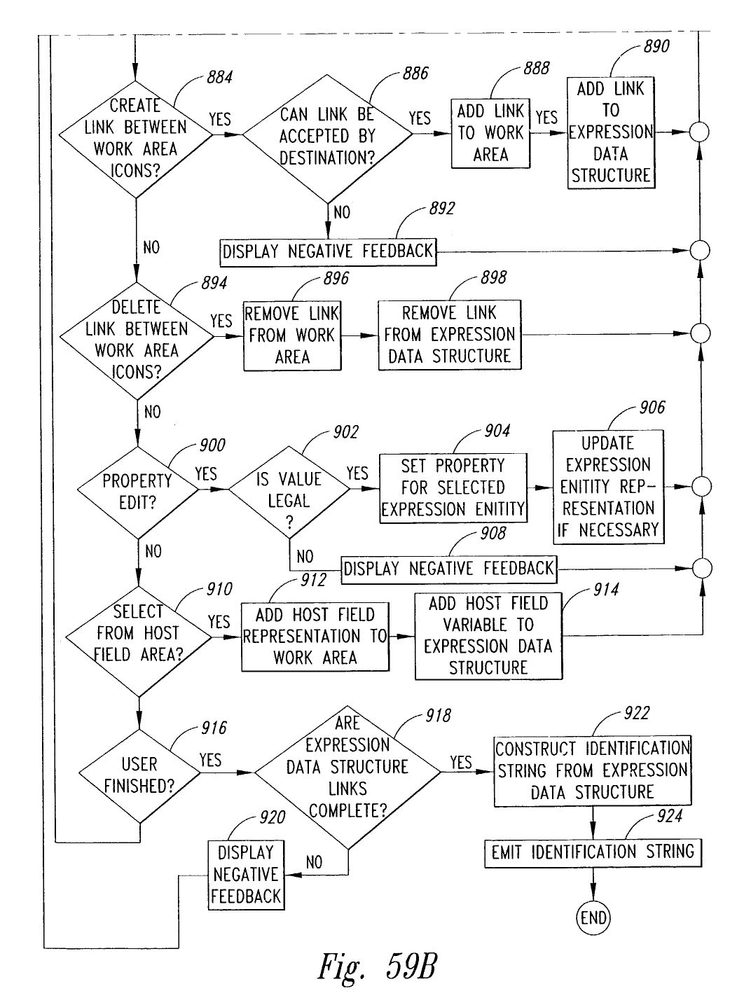

After the grouping of the same screen collections, the user is able to view host screens and construct identification strings to be used later in the runtime system. The user builds these identification strings using the identification grammar through the graphical user interface manager 646 of the freeform identification system 628. An exemplary method followed by an embodiment of the graphical user interface manager 646 is depicted in FIGS. 59A and 59B. Through the graphical user interface manager 646, the user is able to select specific entities, to add in properties for constants, and to create links between entities for different operators and functions, which results in the compilation of an identification string for the host screen.

The graphical user interface manager 646 starts its method by accepting a recorded host screen image and a field list (step 858). The graphical user interface manager 646 then initializes both a work area 514 (step 860) and an expression data structure (step 862) to empty. The graphical user interface manager 646 proceeds to display to the user both a toolbox of expression entity representations (step 864) and a selector for the fields of the host screen (step 866). The selector display, for example, could be shown as a tree diagram in which the fields of the host screen could be listed under the appropriate host screen name.

The graphical user interface manager 646 then displays the work area 514 to the user (step 868) and allows the user to edit the expression data structure by offering the user several options (step 870). These options, which will be discussed in more detail, provide the user with a graphical interface in which to construct a complex expression, or expression data structure, that will be converted into a “well-formed” identification string used to identify the host screen. First, the user has the option to select from a toolbox that contains a list of representations of certain expression entities (step 872). An example of such a toolbox is depicted in the grammar selection menu 510 in FIGS. 33-35. For instance, an addition operator entity 532a could be represented by a “+” in the toolbox. If the user selects an expression entity from the toolbox (“Yes” branch of step 872), the graphical user interface manager 646 adds the expression entity representation to the work area 514 (step 874) and adds the expression entity to the expression data structure (step 876). Hence, through the use of the graphical user interface manager 646 the user will have a user interface-intensive forum in which to more fully develop the expression data structure using the selected expression entity. After the addition of the expression entity to the expression data structure, the graphical user interface manager updates the work area 514 display and awaits further user input.

If the user does not want to select an expression entity from the toolbox (“No” branch of step 872), the graphical user interface manager 646 determines if the user wants to view a property of a particular expression entity (step 878). If an expression entity property is selected (“Yes” branch of step 878), the graphical user interface manager 646 displays the properties for the selected expression entity in the property area 518 of the user interface (step 880), highlights the selected expression entity representation in the work area 514 (step 882), and displays the updated work area (step 868). Otherwise (“No” branch of step 878), the graphical user interface manager 646 gives the user the option to create a link between icons in the work area 514 (step 884).

If the user wants to create this link (“Yes” branch of step 884), the graphical user interface manager 646 evaluates whether the link between the icons is a valid link and can be accepted by the destination icon. If the link cannot be accepted (“No” branch of step 886), the graphical user interface manager 646 alerts the user regarding the problem with the link (step 892) and returns to step 868. Otherwise (“Yes” branch of step 886), the link is added to the work area 514 (step 888) and to the expression data structure (step 890). The graphical user interface manager 646 then displays the updated work area 514 and waits for more user input.

If the user does not want to create a link between icons in the work area 514 (“No” branch of step 884), the user has the option to delete a link between icons. If the user decides to delete a link (“Yes” branch of step 894), the graphical user interface manager 646 removes the link from both the work area 514 (step 896) and the expression data structure (step 898) and updates the work area display. Otherwise (“No” branch of step 894), the graphical user interface manager 646 allows the user to edit properties of specific expression entities, which editing could take place through the property area 518 in the user interface. After the user has edited a property (“Yes” branch of step 900), the graphical user interface manager 646 determines if the value entered by the user is valid for the particular property of the expression entity (step 902). For example, the graphical user interface manager 646 would verify that a string value was not entered for a property that required an integer value. An invalid value entry (“No” branch of step 908) is brought to the attention of the user (step 908), and the user has an opportunity to correct the entry. If a valid value is entered for the expression entity property (“Yes” branch of step 902), the graphical user interface manager 646 sets the property for the selected expression entity (step 904) and updates the expression entity representation if necessary (step 906).

If the user does not desire to edit an expression entity property (“No” branch of step 910), the graphical user interface manager 646 allows the user to select from a host field area. Upon user selection from this area (“Yes” branch of step 910), the graphical user interface manager 646 adds a host field representation to the work area 514 (step 912) and adds a host field variable to the expression data structure (step 914). Otherwise (“No” branch of step 910), the graphical user interface manager 646 determines if the user is finished constructing the expression data structure. If the user is not finished (“No” branch of step 916), the graphical user interface manager 646 continues to display the work area 514 and wait for further user input.

Once the user indicates that he or she has completed the editing process (“Yes” branch of step 916), the graphical user interface manager 646 evaluates whether the expression data structure links created by the user are complete (step 918). Each expression entity has a list of zero or more links that are initially empty and must be filled by links with other expression entities. The number of links between the entities depends on the type of expression grammar used. For example, the graphical user interface manager 646 would check if the user had created two links for an addition (“+”) operator or would verify that all the required variables were filled for a function evaluator. The only expression entities that would not require links are constants. If the links are not complete for the compiled expression data structure (“No” branch of step 918), the graphical user interface manager 646 alerts the user, through negative feedback, of the incomplete link (step 920) and allows the user to remedy the problem. If the links are all complete (“Yes” branch of step 918), the graphical user interface manager 646 concludes its method by constructing an identification string from the expression data structure (step 922) and emitting the identification string (step 924) for subsequent use in the system.

The method shown in FIGS. 59A and 59B is exemplary for one embodiment of the graphical user interface manager 646, and in other embodiments the steps described may be combined or rearranged. For instance, the steps of initializing the work area 514 (step 860) and the expression data structure (step 862) could be reordered, and the order in which the toolbox (step 864) and the selector for host fields (step 866) are displayed could also be reversed. In other embodiments, the process of allowing the user to make various choices in constructing the expression data structure may take an alternative form other than the depicted decision tree. For example, the method could be an object oriented command pattern to handle the process of allowing the user to make selections and to input data.

An overall method for assigning an identification string to a recorded host screen is shown in FIG. 60. An embodiment of the grammar based screen identification assigner 648 operates on a host screen that has previously been recorded and whose fields have also been identified and stored in a recording. The grammar based screen identification assigner 648 begins the method by accepting a recorded host screen (step 926). The grammar based screen identification assigner 648 then invokes the graphical user interface manager 646 and allows the user to select a field in the loaded host screen (step 928). After the graphical user interface manager 646 returns the identification string to the grammar based screen identification assigner 648 (step 930), the identification string is saved in a string identification rule (step 932). The grammar based screen identification assigner 648 then ends its method.

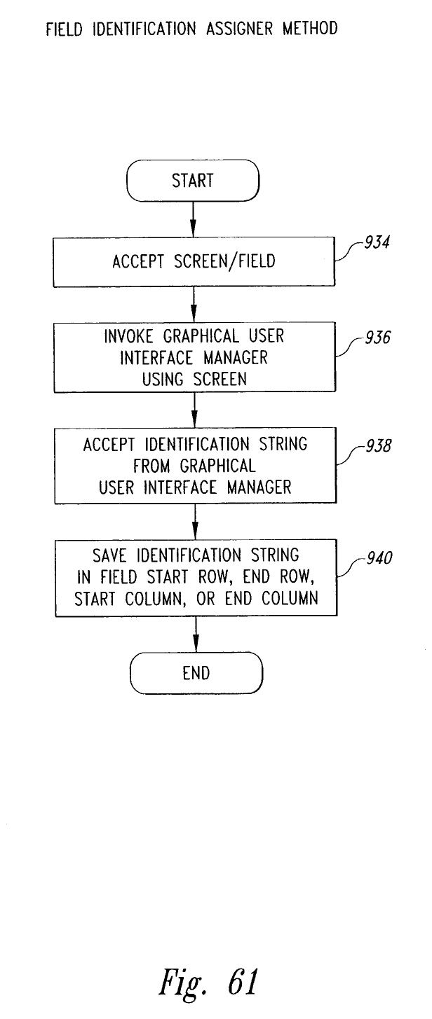

A method for assigning an identification string to a field, as shown in FIG. 61, is similar to the grammar based screen identification assigner method of FIG. 60. First, the grammar based field identification assigner 650 begins the method by accepting both a host screen and a field within the host screen (step 934). The grammar based field identification assigner 650 then invokes the graphical user interface manager 646 (step 936) to generate an identification string based on user input. After receiving the identification string (step 940), the grammar based field identification assigner 650 saves the identification string in a field start row, an end row, a start column, or an end column (step 940) and ends the method.

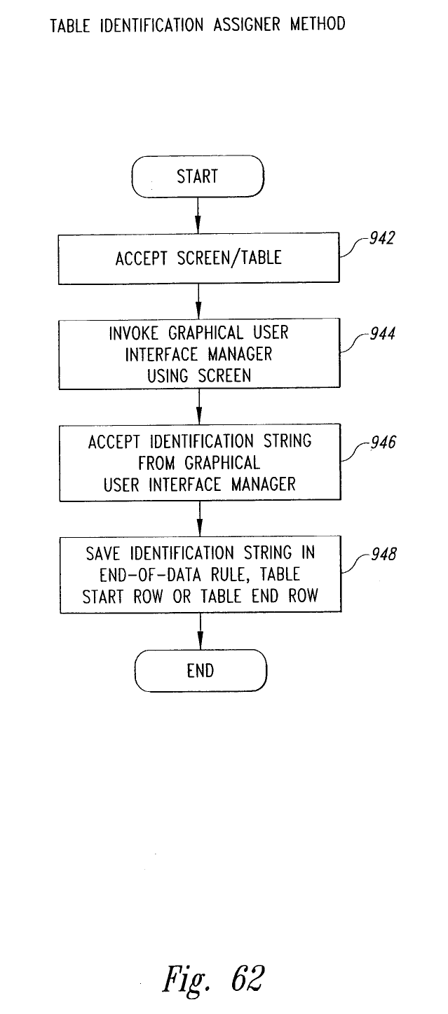

Likewise, a method for assigning an identification string to a table, as shown in FIG. 62, is similar to the previous two methods. To begin the method, the grammar based table identification assigner 652 first accepts a host screen and a table within the host screen (step 942) and proceeds to invoke the graphical user interface manager 646 (step 944). The user constructs an identification string through the graphical user interface manager 646, and the grammar based table identification assigner 652 accepts this identification string (step 946) and saves it in an end-of-data rule, a table start row, or a table end row (step 948). The data stored in the table start row and the table end row is subsequently used to build list tables, which list table types will be discussed later in further detail.

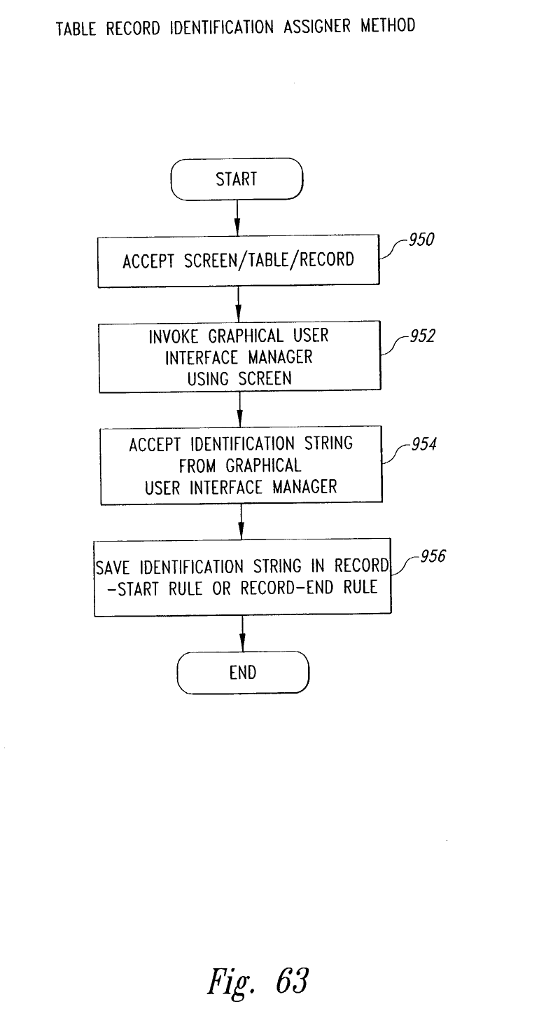

The grammar based table/table record identification assigner 652 is used to assign an identification string to a record, and an exemplary method is depicted in FIG. 63. First, the grammar based table/table record identification assigner 652 accepts a record within a table within a particular host screen (step 950). The grammar based table/table record identification assigner 652 then invokes the graphical user interface manager 646 (step 952) and accepts an identification string complied by the graphical user interface manager (step 954). The grammar based table/table record identification assigner 652 concludes its method by saving the identification string as a record-start rule or as a record-end rule (step 956), both of which are subsequently used to construct variable length records.

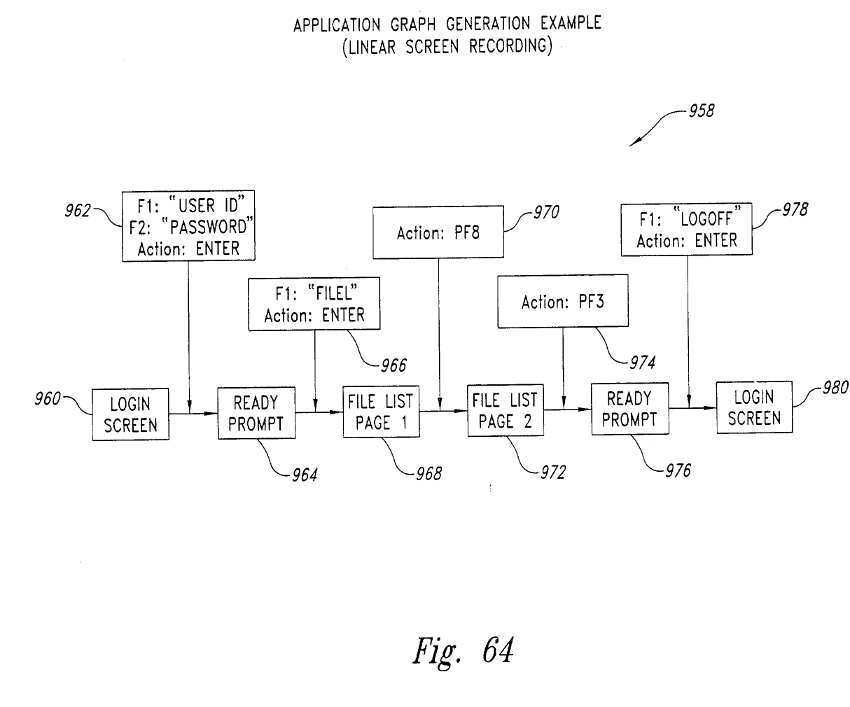

After the host screens have been identified with their identification strings, the application graph generator 630 is able to convert a rudimentary host application screen recording in a time-ordered sequence, or linear style recording, to an application graph sequence, or state map recording, of the host screens. An example of a linear screen recording 958 is depicted in FIG. 64. In this example, the first recorded host screen is a first login screen 960. After the host computer 80 receives user input 962 of a “USER ID,” a “PASSWORD,” and an enter action, the next host screen displaying a ready prompt 964 is recorded. Next, the user inputs “FILEL” and an enter action 966, and a host screen displaying page 1 of a file list 968 is recorded. A third user action 970 is a PF8 action, and a host screen displaying page 2 of a file list 972 is subsequently recorded. Next, the user enters a PF3 action 974, and a second host screen to display a ready prompt 976 is recorded. The final user input consists of “LOGOFF” and an enter action 978, after which a second host screen to display a login screen 980 is recorded.

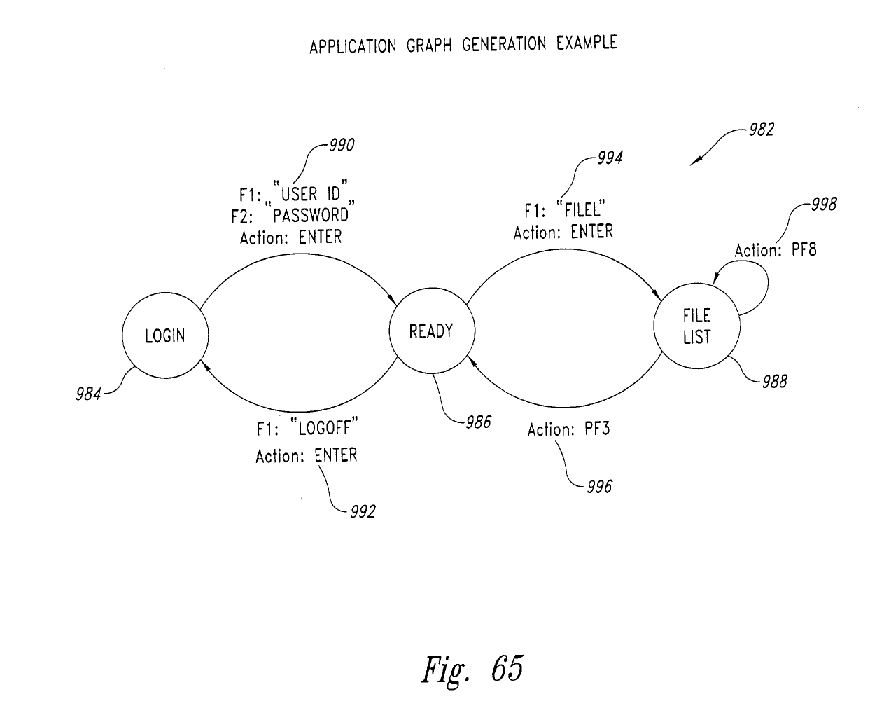

Because a linear style recording can have the same host screen occur multiple times, this type of linear screen notation is not conducive to use in a runtime system. For example, if a task is to use a certain field from a particular recorded host screen, in the linear style recording that host screen could exist repeatedly in various locations throughout the recording. Therefore, it is helpful to convert the linear style recording to a state map recording. This conversion primarily consists of logically combining identical host screens in a manner that preserves the information regarding their relationships with other host screens. An example of this type of state map recording 982 generated from the linear style recording 958 is shown in FIG. 65.

In this example, the first state 984 in the state map recording is a login screen. One may move to a second state 986, which displays a ready prompt, from the first state 984 by entering a “USER ID,” a “PASSWORD,” and an enter action 990. From the second state 986, one may either move to a third state 988 or return to the first state 984. To move to the third state 988, which is a host screen displaying a file list, one must input “FILEL” and an enter action 994. To return to the first state 984 from the second state 986, one must enter “LOGOFF” and an enter action 992. From the third state 988, one may remain in the third state by inputting a PF8 action 998, or one may return to the second state 986 by inputting a PF3 action 996.

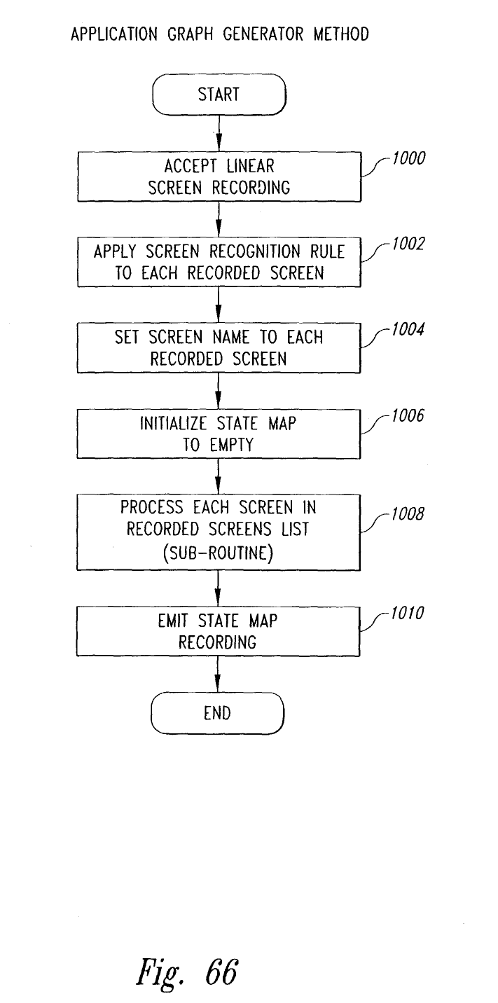

To convert a linear style recording to a more practical state map recording as shown in FIG. 65, the application graph generator 630 may follow an exemplary method as illustrated in FIG. 66. Through this method, redundant recorded host screens are removed from the recording and the remaining host screens are appropriately linked together. An embodiment of the application graph generator 630 begins the method by accepting a linear style recording of host screens (step 1000), and each recorded host screen is associated with its screen recognition rule, or identification string (step 1002). These identification strings would have been developed previously when the default same screen collections or customized same screen collections were being generated.

The application graph generator 630 then sets the name of each recorded host screen to its respective identification string (step 1004) and initializes the state map recording to empty (step 1006). Next, the application graph generator 630 repeats a subroutine that processes each host screen in the linear style recording (step 1008) and builds the state map recording screen by screen. Because all the host screens are initially linked in a time-ordered sequence, this subroutine ensures that the final state map recording will not be partitioned. In other words, at the end of the subroutine there will not be islands of host screens that cannot be reached from other host screens. After this subroutine has concluded, the application graph generator 630 emits the final state map recording (step 1010) and ends its method.

The steps in this method are exemplary and may be combined or rearranged in alternative embodiments of the application graph generator 630. For instance, the step of initializing the state map recording to empty (step 1006) could occur at any time prior to the state map construction, which occurs during the processing of the host screens in the subroutine (step 1008).

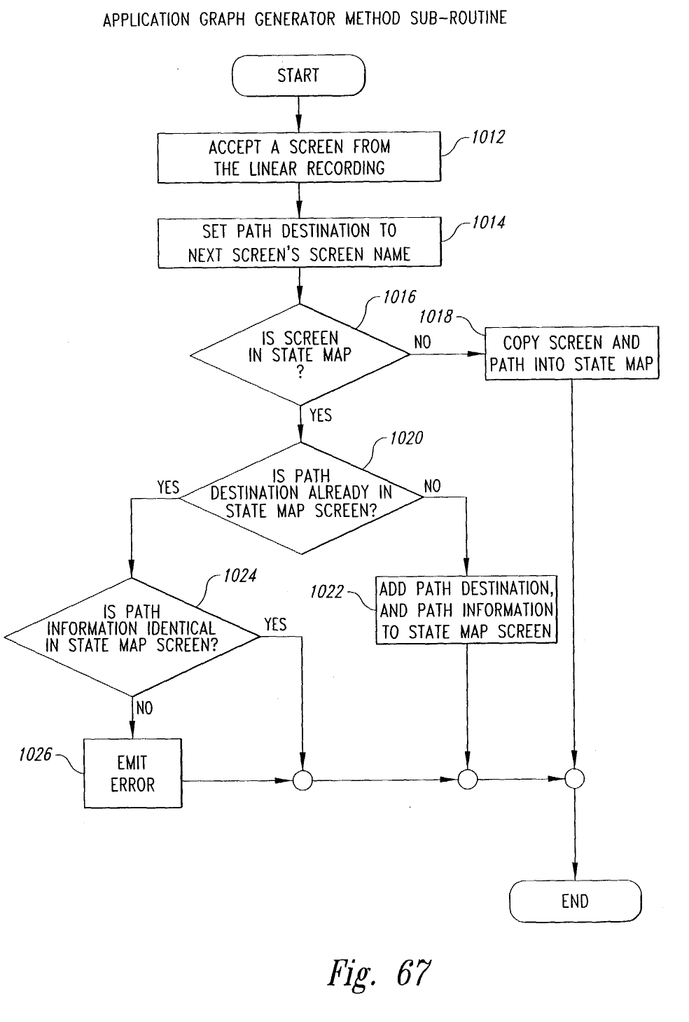

An example of the subroutine (step 1008) followed by the application graph generator 630 is shown in FIG. 67. In the subroutine, the application graph generator 630 begins by accepting a host screen from the linear style recording (step 1012) and by setting the path destination to the screen name of the next host screen (step 1014). In the event that there is not another host screen in the linear style recording, the path destination would be blank.

If the accepted host screen is not in the state map recording (“No” branch of step 1016), the application graph generator 630 copies the host screen and the path information into the state map (step 1018) and ends the subroutine. Otherwise (“Yes” branch of step 1016), the application graph generator 630 determines if the path destination of the host screen is already located in the state map (step 1020). If the path destination is not in the state map (“No” branch of step 1020), both the path destination and path information are added to the state map recording (step 1022) and the subroutine is completed. Otherwise (“Yes” branch of step 1020), the application graph generator 630 evaluates whether the path information contained in the host screen is identical to the path information contained in the state map recording (step 1024). If the path information differs (“No” branch of step 1024), the application graph generator 630 emits an error (step 1026) and ends the subroutine.

Each host screen and path combination must have one unique destination. If this is in fact not the case, the application graph generator 630 alerts the user, by emitting an error as shown in step 1026, that there are two identical paths that have different destinations. This problem could arise if there was an error in the screen recognition process, and the error notifies the user to return and fix the screen recording. On the other hand, if the path information is the same in both the host screen and the state map recording (“Yes” branch of step 1024), the application graph generator 630 concludes the subroutine. The subroutine is then repeated for each host screen in the linear style recording until the final state map recording is generated.

After the final state map recording has been generated by the application graph generator 630, the application graph and screen recording verifier 632 is used to ensure that the state map recording produced is a good recording and that it does not have any dead-ends. FIGS. 68A and 68B show an example of a method that could be followed by the application graph and screen recording verifier 632 to make its verification. In this method the application graph and screen recording verifier 632 applies a series of three tests to the state map recording. The application graph and screen recording verifier 632 begins by accepting a state map recording of host screens and their paths (step 1028) and by accepting a home screen identification (step 1030). This home screen serves as a root or primary screen for the tests run during the method. Next, the application graph and screen recording verifier 632 initializes the current screen to the first host screen in the state map recording (step 1032) and begins the testing.

The first test ensures that each host screen in the state map recording can be reached from the selected home screen. To do this, the application graph and screen recording verifier 632 computes a traversal path from the home screen to the current screen (step 1032) and checks to see if the path exists (step 1036). If the path does not exist (“No” branch of step 1038) the application graph and screen recording verifier 632 emits an error (step 1038) and looks to see if there are more host screens in the state map recording (step 1056). Otherwise (“Yes” branch of step 1038), the application graph and screen recording verifier 632 conducts a second test. The second test ensures that the home screen can be reached by each screen in the state map recording by computing a traversal path from the current screen back to the home screen (step 1040). If this traversal path does not exist (“No” branch of step 1042), the application graph and screen recording verifier 632 emits an error (step 1044) and checks if there are more host screens in the state map recording (step 1058).

If the current screen passes the second test (“Yes” branch of step 1042), the application graph and screen recording verifier 632 moves on to a third test in which the application graph and screen recording verifier checks the state map recording, using the screen connector runtime engine 100, against a live host session. In this test, the screen connector runtime engine 100 is used to move an actual session from the home screen to the current screen and back to the home screen. To run the test, the application graph and screen recording verifier 632 invokes route processing 2142 from the home screen to the current screen (step 1046) and back from the current screen to the home screen (step 1048). If any route processing errors are discovered (“Yes” branch of step 1050), the application graph and screen recording verifier 632 emits an error signal (step 1052) and checks if there are more host screens in the state map recording (step 1056). Otherwise (“No” branch of step 1050), an “OK” signal is emitted (step 1058) and the application graph and screen recording verifier 632 determines if there are more host screens in the state map recording. If there are more host screens (“Yes” branch of step 1056), the current screen is set to the next host screen in the state map recording, and the testing procedure is repeated with the next host screen. Otherwise (“No” branch of step 1056), the application graph and screen recording verifier 632 has reached the end of the state map recording (“No” branch of step 1056), and it ends the verification method.

The steps depicted in FIGS. 68A and 68B are exemplary, and some may be combined or reordered. For instance, the first two tests, which are both made against the recording, could be rearranged. In this situation, the application graph and screen recording verifier 632 would check the traversal path from the current screen (step 1040) before looking at the traversal path from the home screen (step 1034). Also, the third test, which invokes components of the screen connector runtime engine 100 to check the screens in the recording, is optional and may be omitted in alternative embodiments of the invention.

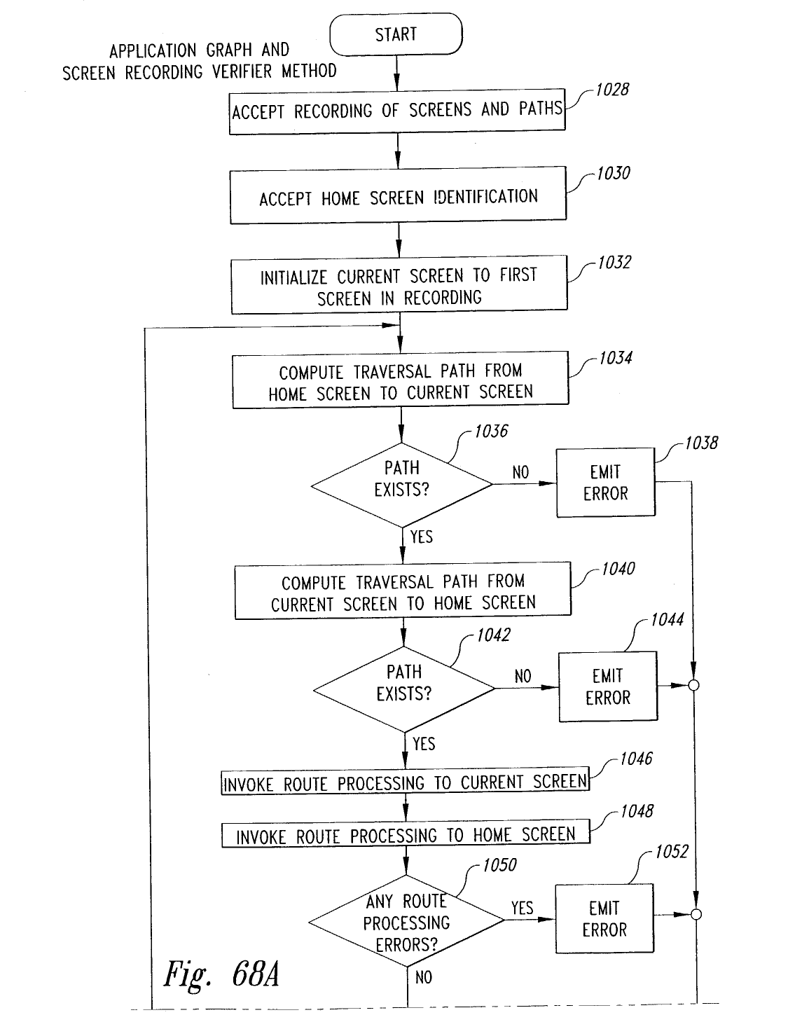

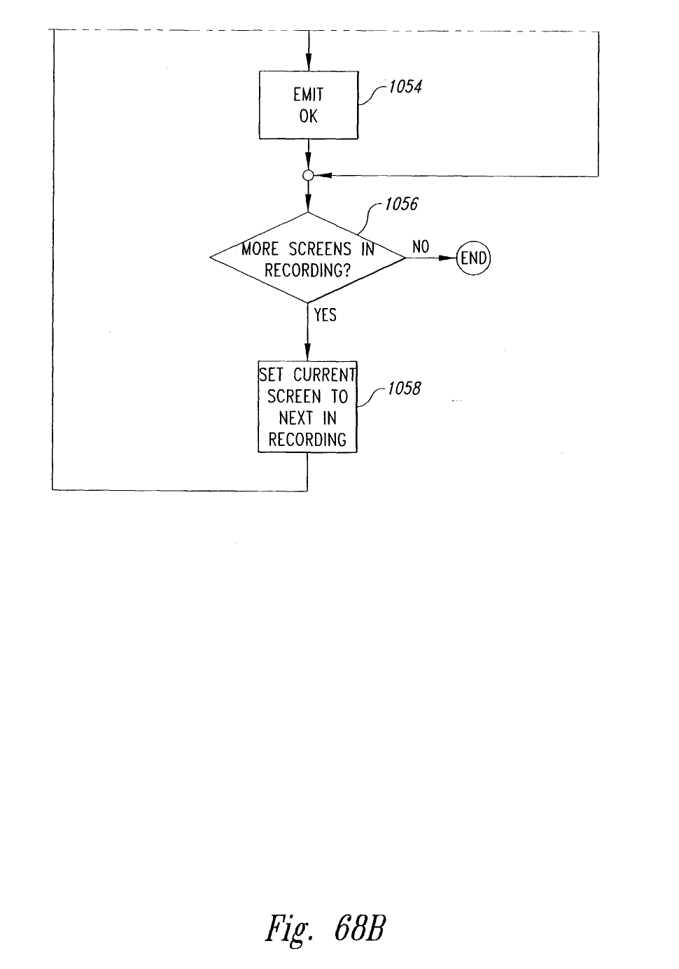

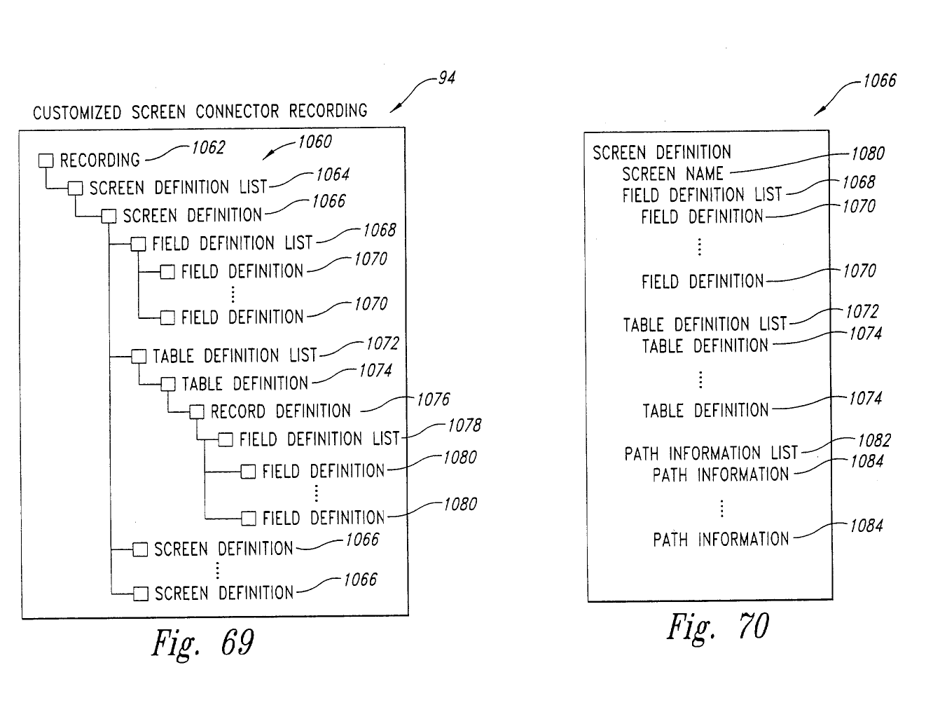

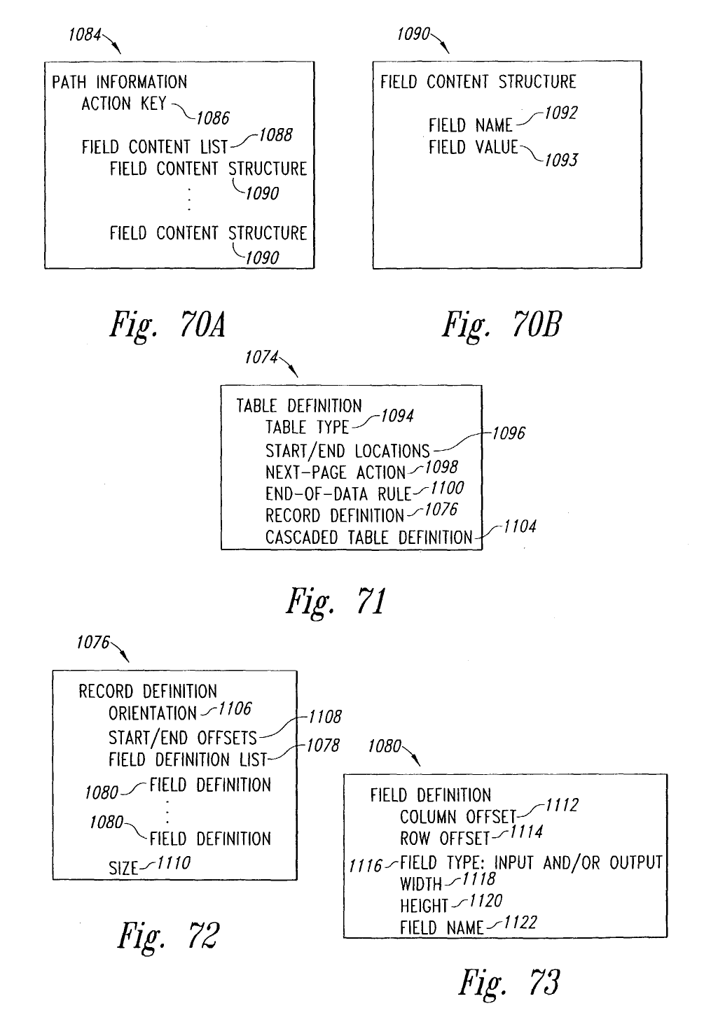

An example showing the hierarchal relationships between data stored in the customized screen connector recording 94 is shown in FIG. 69. This example is meant to serve as a general overview of what is contained in a customized screen connector recording 94 and does not contain all the information that could be recorded. FIG. 69 shows a customized screen connector recording 94 having a recording of a host screen 1062, which is comprised of a screen definition list 1064 containing multiple screen definitions 1066. The screen definition 1066, which is shown in more detail in FIG. 70, is comprised of a screen name 1080, a field definition list 1068 having multiple field definitions 1070 of the fields within the recorded host screen. The screen definition 1066 is further comprised of a table definition list 1072 having multiple table definitions 1074 of tables within the recorded host screen, and a path information list 1082 having multiple recordings of path information 1084 that indicate how to move from the host screen to another host screen.

The recorded path information 1084, as shown in FIG. 70A, contains an action key 1086 and a field content list 1088 having multiple field content structures 1090. This path information 1084 would have been recorded by the screen difference engine 578 and indicates to which host screen one may travel given some input and an action key being applied to the recorded host screen. The path information 1084 could be related to the linear style recording of the host screens, in which case there would be only one recording, or possibly zero recordings, of path information in the path information list 1082 because there would be, at most, one path from a host screen. The path information 1084 could also be related to the state map recording of the host screens, in which case there could be several recordings of path information leading to various host screens based upon user input. The field content structure 1090 is shown on FIG. 70B as having a field name 1092 and a field value 1093.

The table definition 1074, as shown in FIG. 71, is comprised of a table type 1094, start/end locations 1096, a next-page action 1098, an end-of-data rule 1100, a record definition 1076, and a cascaded table definition 1104. The record definition 1076 is further defined in FIG. 72 as having an orientation 1106 of either horizontal or vertical, start/end offsets 1108, a field definition list 1078 containing multiple field definitions 1080, and a size 1110 indicating the height or width of the record, depending on the record orientation. FIG. 73 further illustrates the field definition 1080 contents, which include a column offset 1112, a row offset 1114, a field type 1116 that indicates whether the field is an input and/or an output field, a width 1118, a height 1120, and a field name 1122.

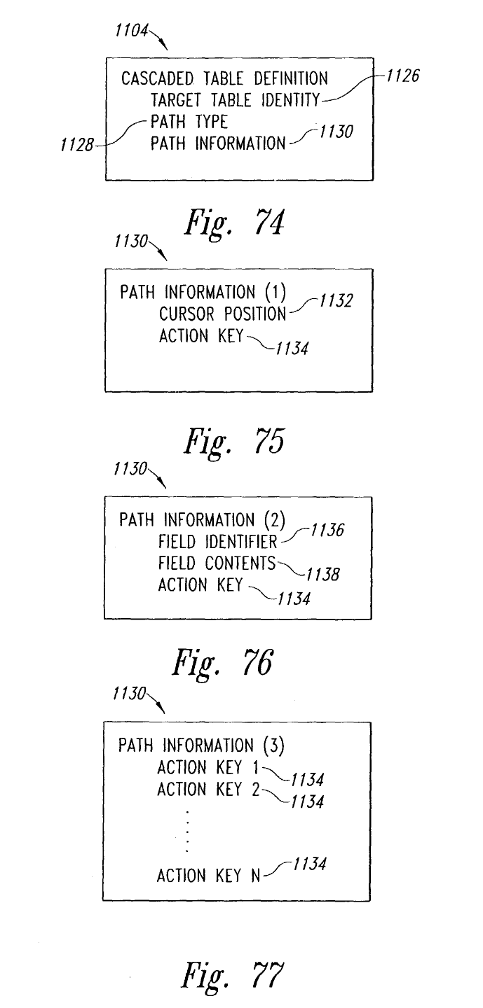

The cascaded table definition 1104, which captures the relationship between two tables, is broken down further in FIG. 74. A cascaded table contains multiple tables that occur on different screens and are linked together through table paths. One may move through a cascaded table by following the appropriate table path from a first table, or parent table, to a second table, or daughter table. In the cascaded table definition 1104, a target table identity 1126 identifies the daughter table that is linked to the parent table. For instance, the target table identity 1126 could be the name of the daughter table or, in the case that the system data structures are objects, could be an object reference. A path type 1128 and path information 1130 to the daughter table are also included with the cascaded table definition 1104 of the parent table.

FIGS. 75-77 contain examples of path information 1130 relating to different ways of moving through a cascaded table. The path information (1) 1130 data structure in FIG. 75 contains information regarding a cursor position 1132 and an action key 1134 and would be used in an embodiment where the user moves through a cascaded table by selecting a record and inputting an action. The path information (2) 1130 data structure in FIG. 76 contains a field identifier 1136, field contents 1138, and an action key 1134. This path information (2) 1130 would be used when the user moves through cascaded tables by entering a string in a certain location and inputting an action. The final path information (3) 1130 data structure, found in FIG. 77, contains multiple action keys 1134. This third type of data structure would be used in an embodiment where certain actions inputted by the user correspond with traversing to different daughter tables.

The data structures in FIGS. 69-77 are exemplary, and alternative embodiments of the invention could contain other data in their recordings. For instance, when recording information concerning cascaded table definitions 1104, as depicted in FIG. 74, the data structure could contain information about the parent table instead of information about the daughter table. The data stored in the data structures of FIGS. 69-77 does not need to be object oriented and could also be represented as tables in databases, as a flat file, as XML, or as any other data representation that is suitable for the invention.

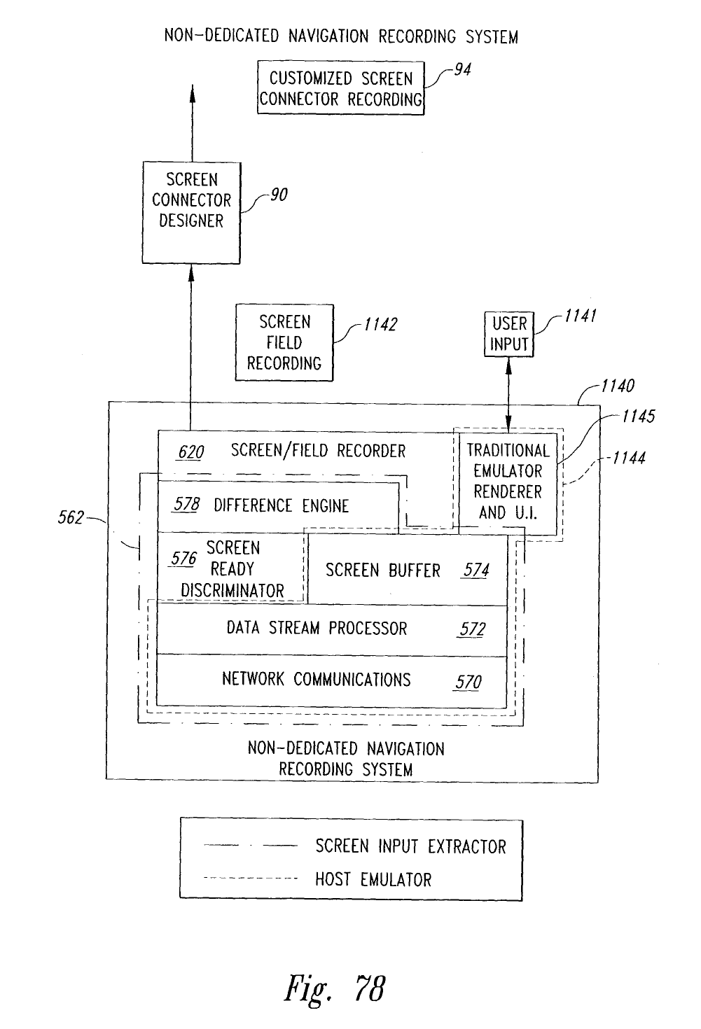

A non-dedicated navigation recording system 1140 is shown in FIG. 78 as being comprised of the screen input extractor 562, the screen/field recorder 620, and a host emulator 1144, as sending and receiving input 1141 from a user, and as outputting data to the screen connector designer 90. The non-dedicated navigation recording system 1140 provides a way to carry out some of the functions normally processed by the screen connector designer 90 and allows for a two-tier recording process of the host screens. First, one who is familiar with the host application 82 running on the legacy host data system 80 could work with the host emulator 1144 portion of the non-dedicated navigation screen recording system 1140. The host emulator 1144 consists of the screen buffer 574, the data stream processor 572, the network communications 570, and a traditional emulator renderer and user interface 1145. The traditional emulator renderer and user interface 1145 could include all the tool bars and menu features necessary for one to work with the recorded host screens.

Another user, who was primarily responsible for the screen recording process, could work with the screen/field recorder 620 and the screen input extractor 562, which share the screen buffer 574, the data stream processor 572, and the network communications 570 with the host emulator 1144. The screen input extractor 562 is further comprised of the screen ready discriminator 576 and the difference engine 578. A screen/field recording 1142 being outputted from the non-dedicated navigation recording system 1140 would be a linear style recording that would be further modified in the screen connector designer 90. In an alternative embodiment of the invention, where it is not possible to send the screen/field recording 1142 directly from the host emulator 1144 to the screen connector designer 90, the screen/field recording could be sent to a temporary directory or to a configuration server where the screen/field recording could be downloaded later by the screen connector designer for further use in creating the customized screen connector recording 94.

Examples of host screens that could be emitted by the legacy host data system 80 are shown in FIGS. 79-83. FIG. 79 depicts a host screen 1146 that contains a horizontal fixed record table 1148 that could occupy the entire host screen, span more than one host screen, or occupy only a portion of the host screen. The host screen 1146 could also contain more than one table. In the depicted example, the horizontal fixed record table is comprised of multiple horizontal fixed records 1150, each containing multiple horizontal fixed record fields 1152. These horizontal fixed records 1152 are identical in size and form template-type structure that spans down the screen.

A vertical fixed record table 1156 is shown on a host screen 1154 in FIG. 80. The vertical fixed record table 1156 differs from the horizontal fixed record table 1148 in that the records in the vertical fixed record table span from top to bottom on the host screen 1154 instead of from left to right. The vertical fixed record table 1156 contains multiple vertical fixed records 1158 that are comprised of multiple vertical fixed record fields 1160.

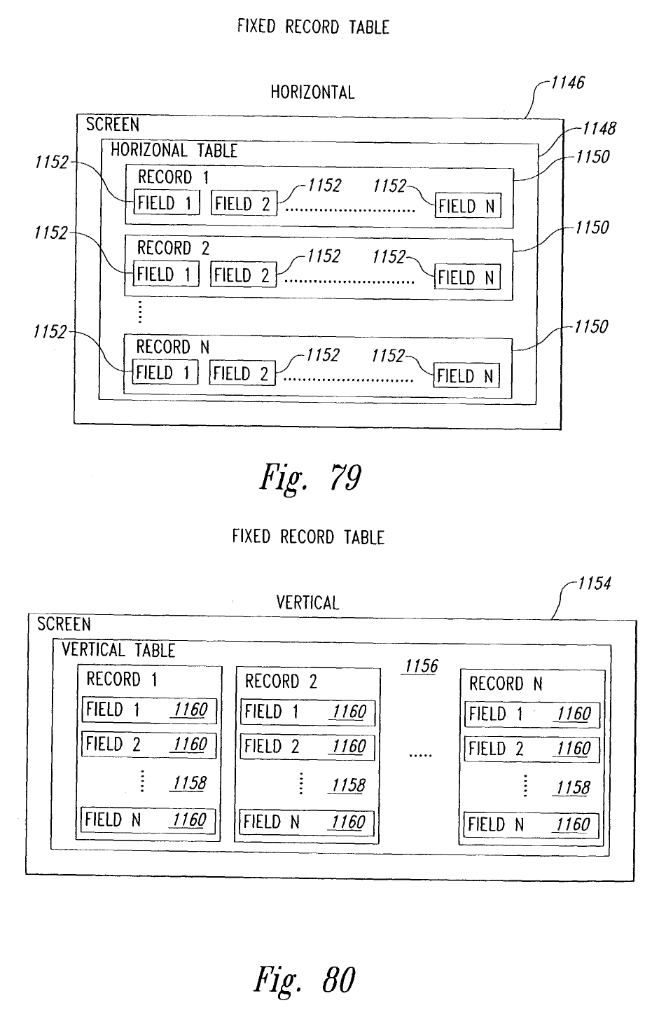

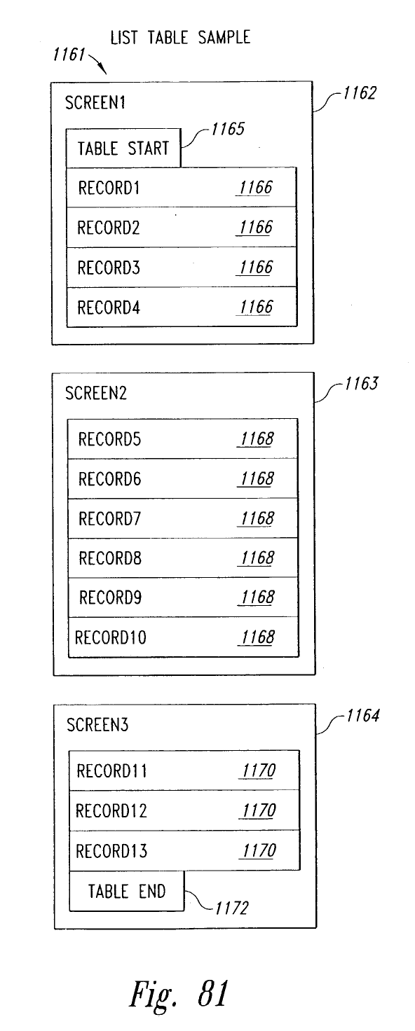

The vertical fixed record table in FIG. 79, as well as the horizontal fixed record table in FIG. 80, can also be called a window table because the data displayed in each of the tables is within the same rectangular region of the screen, regardless of which page of table data is being displayed. FIG. 81, on the other hand, depicts a list table 1161 that spans several host screens 1162-1164 and whose data is displayed on different regions of the host screens depending on which portion of the data is being displayed. In the list table 1161, records 1166-1700 are fixed but a table start position 1165 may vary from host screen to host screen. In the example, the list table 1161 contains records 1166 that run from the middle to the bottom of host screen 1 1162, records 1168 that span the entire host screen 2 1163, and records 1170 that run from the top to the middle of host screen 3 1164.

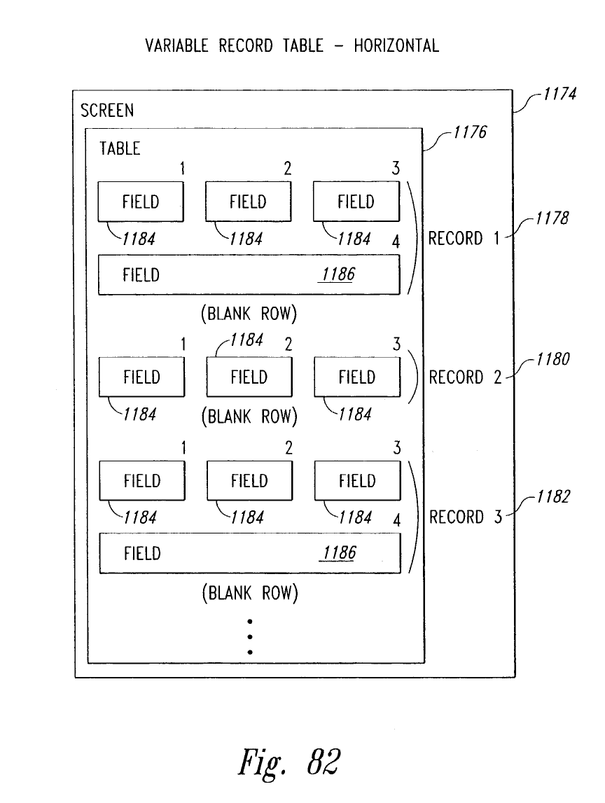

Another type of window table, or table in which the data is displayed on some specific region of the host screen, is shown in FIG. 82 as a horizontal variable record table 1176. The horizontal variable record table 1176 is displayed on a host screen 1174 and contains three variable records 1178-1182. In this embodiment of the horizontal variable record table 1176, the end of each variable record 1178-1182 is marked by a blank row. In other embodiments, other features could be used to indicate where a variable record starts and finishes. For example, a row of dashes or a special string could be used to show the beginning and ending of a variable record.

In this example of the horizontal variable record table 1176, the first variable record 1178 contains three short fields 1184 and one long field 1186. The second variable record 1180 only contains three short fields 1184. The third variable record 1182 is similar to the first variable record 1178 in that it contains three short fields 1184 and one long field 1186. In other embodiments of the horizontal variable record table 1176, the length of the variable record 1182 could vary depending on the number of fields it contained and also depending on the length of the fields.

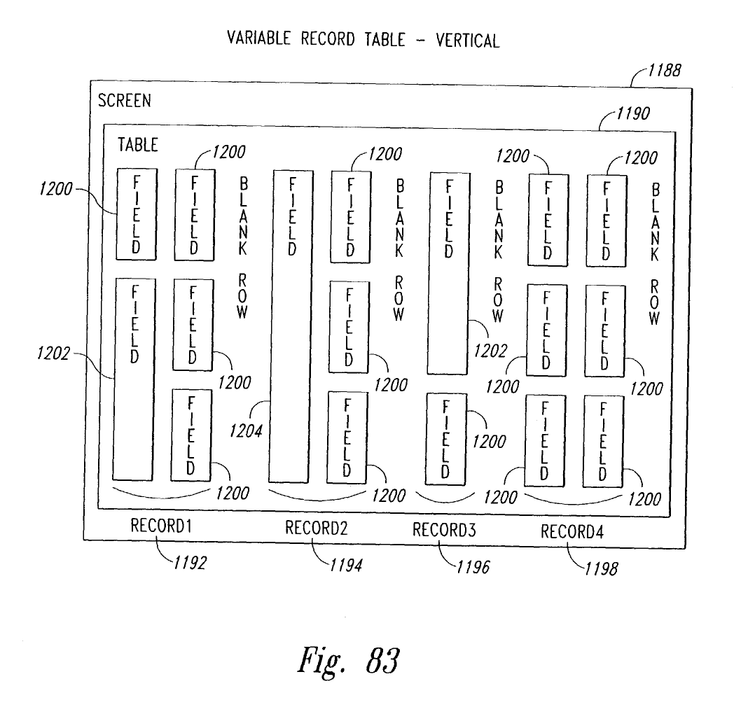

An embodiment of a vertical variable record table 1190 on a host screen 1188 is shown in FIG. 83. The vertical variable record table 1190 consists of four variable records 1192-1198 each separated by a blank row. The first variable record 1192 is comprised of four short fields 1200 and one medium-length field 1202. The second variable record 1194 is comprised of three short fields 1200 and one long field 1204. The third variable record 1196 is comprised of one medium-length field 1202 and one short field 1200. The fourth variable record 1198 is comprised of six short fields 1200.

The vertical variable record table 1190 is shown in FIG. 83 as an example, and other embodiments of the vertical variable record table could differ in structure. For instance, another embodiment of the vertical variable record table 1190 could be comprised of more than four variable records, or the variable records could be separated by some feature other than a blank row, such as a row of stars or a special string of characters.

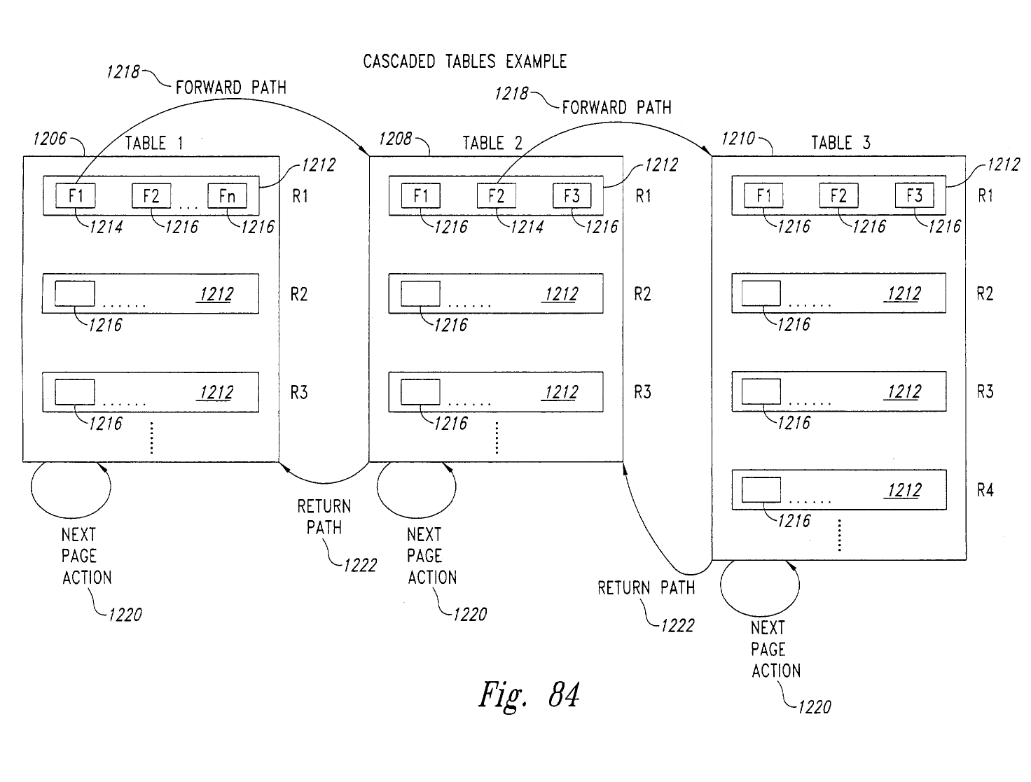

Any of the table types shown in FIGS. 79-83 may be combined to form cascaded tables. An example of three tables 1206-1210 that are cascaded together is shown in FIG. 84. A first table 1206 is comprised of multiple table records 1212, one of which contains one forward path invoking function 1214 and multiple functions 1216 that do not invoke forward paths 1218. When selected by the user, the forward path invoking function 1214 of the first table 1206 causes the data in a second table 1208 to be displayed on the screen. In this embodiment, the first table 1206 would be considered the parent table to the second table 1208, and the second table would be considered the daughter table to the first table. Thus, the daughter table may be accessed via a table path applied to the appropriate record of the parent table. The second table 1208 is also comprised of multiple records 1212, one of which contains a forward path invoking function 1214 and multiple functions 1216 that do not invoke forward paths. The forward path invoking function 1214 of the second table allows the user to view the data from a third table 1210.

Three examples of forward paths were described in FIGS. 74-76: a cursor path, a command path, and a function key path. The cursor path is invoked when the user positions the cursor at some offset in the record and then inputs an action key. The command path is invoked when the user enters a string in some field of the record and then inputs an action key. The function key path is invoked when the user enters some specified function key that carries the user to a certain table within the cascaded table group.

When within a cascaded table, one may view other pages of the same table by inputting a next page action 1220. One may also move from a daughter table to a parent table by following a return path 1222. Though the embodiment depicted in FIG. 84 is only two levels deep, other embodiments of cascaded tables may contain any number of tables, which tables may be of the same table type or be of different table types.

Cascaded tables can occur in situations where a parent table contains information that is explained in more detail in a daughter table. For instance, cascaded tables could relate to a mail system on the host computer 80. When the mail system application is called, it displays a list, or table, of mail messages to the user. The user may then select a message, press an appropriate function key, and view the text of the selected message in a second table, which table would be considered a daughter table.

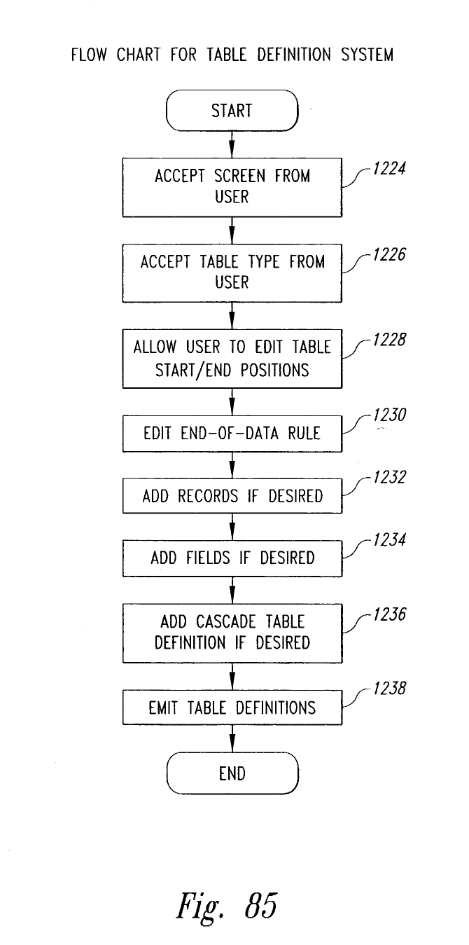

The table definition system 566 enables the user to define tables, such as those described in FIGS. 79-84. An example of a method followed by an embodiment of the table definition system 566 is illustrated in FIG. 85. The table definition system 566 first accepts both a host screen (step 1224) and a table type (step 1226) from the user. The user is then allowed to edit the table start and end positions (step 1228). For example, the user could edit the positions through a simple process of typing text into a box, or the editing process could be more integrated with the user interface. In the second scenario, the user could select a box, draw a box region overlaid on the image of the host data that was received, and start a table from this box region. Along with editing the table positions, the user may also edit the end-of-data rule (step 1230).

The table definition system 566 then gives the user the option to add records (step 1232) to the table, and after adding records, the user may add fields (step 1234) by selecting fields from the host screen and by adding the fields to the selected record definition. Next, the user has the option to add a cascaded table definition by following a subroutine that links two tables together (step 1236). After the additions to the table are completed, the table definition system 566 emits the final table definitions (step 1238) and ends the method.

The steps in FIG. 85 are exemplary and some steps may be combined or rearranged. For instance, the table definition system 566 may accept the table type from the user (step 1226) before accepting the host screen (step 1224), or the table definition system could allow the user to add the cascaded table definition (step 1236) before adding the fields (step 1234). The table definition system 566 could also accept all the data concerning a particular table at the beginning of the method instead of accepting portions of the table data throughout the entire method.

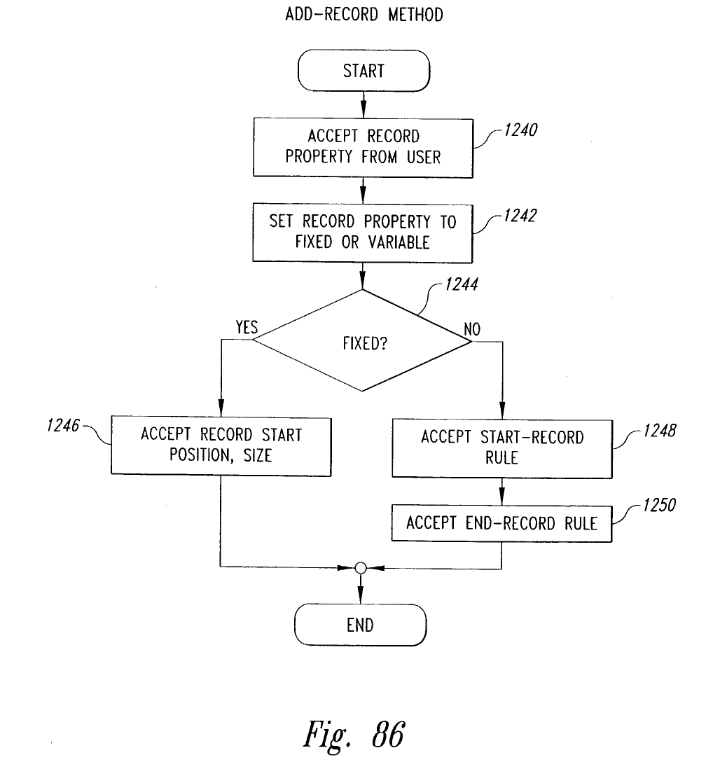

The add-record method shown in FIG. 86 represents an example of a subroutine called by the table definition system 566 when the user wants to add a record to a table (step 1232 in FIG. 85). The table definition system 566 first accepts record properties from the user (step 1240). In an alternative embodiment where the table definition system 566 has previously received all the data concerning the table, this step would be omitted. Depending on the table properties accepted by the table definition system 566, the record property is set as fixed or variable (step 1242).

If the record property is fixed (“Yes” branch of step 1244), the table definition system 566 accepts user input for the properties relating to the start position and the size of the record (step 1246). This input would consist of a constant for each required field. If the record property is variable (“No” branch of step 1244), the table definition system 566 accepts both a start-record rule (step 1248) and an end-record rule (step 1250) from the user. In one embodiment, these rules, which identify the record position, could be defined by the user through the freeform identification system 628. After receiving the necessary user input to define the records, the table definition system 566 finishes its subroutine.

The order of the steps shown in FIG. 86 is exemplary, and some steps may be rearranged or combined in alternative embodiments of the invention. For example, the table definition system 566 may accept the end-record rule from the user (step 1250) before accepting the start-record rule (step 1248).

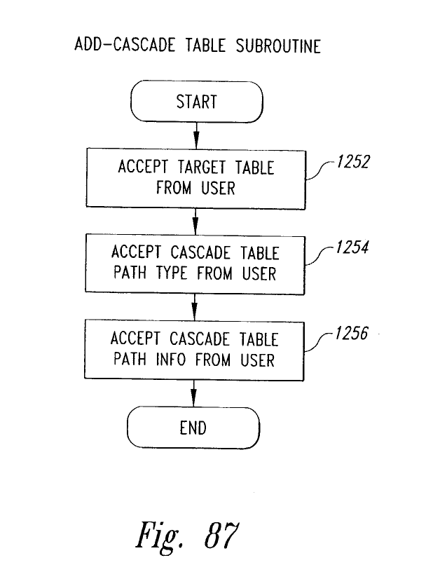

The table definition system 566 can also follow a subroutine when the user wants to add a cascaded table to the table being defined (step 1236 of FIG. 85). An example of such a subroutine is depicted in FIG. 87. The table definition system 566 begins the subroutine by accepting a target table, or daughter table, from the user (step 1252). The table definition system 566 then retrieves from the user a cascade table path type (step 1254) and information concerning the cascade table path (step 1256). In one embodiment of the invention, these two steps could correspond to the three different cascade table path types shown in FIGS. 75-77 that are used to link a parent table to a daughter table. After accepting the user input, the table definition system 566 ends the subroutine.

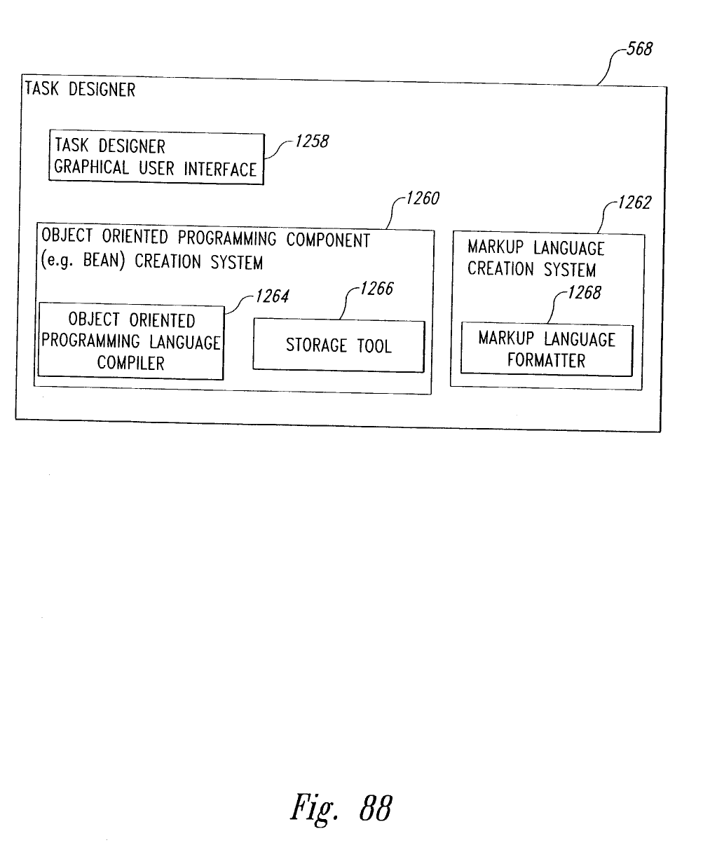

Along with creating tables through the table definition system 566, the embodiment of the screen connector designer 90 shown in FIG. 36 also manages the creation of tasks through the task designer 568. A schematic diagram of an embodiment of the task designer 568 is shown in FIG. 88 and is comprised of a task designer graphical user interface 1258, an object oriented programming component creation system 1260, and a markup language creation system 1262 having a markup language formatter 1268. The object oriented programming component creation system 1260 is comprised of an object oriented programming language compiler 1264 and a storage tool 1266.

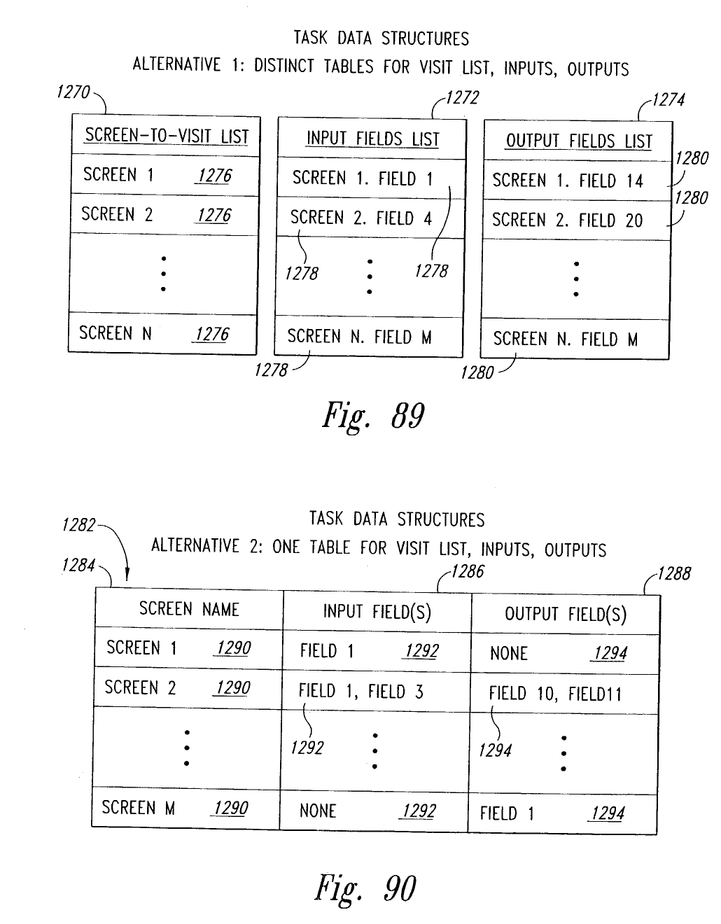

Various examples of task data structures that could be created by the task designer 568 are shown in FIGS. 89-91. Each of these task data structures is related to the same task: accepting input from the user, associating the input data with the correct host screen, and returning output data to the user. In a first embodiment of the task data structure, as shown in FIG. 89, the task data structure is comprised of three distinct tables. A screen-to-visit list table 1270 is comprised of a list of host screens 1276. An input fields list table 1272 is comprised of a list of input fields with their respective host screens 1278. An output fields list table 1274 is comprised of a list of output fields with their respective host screens 1280.

In a second embodiment of the task data structure 1282, as shown in FIG. 90, the task data structure is contained in one table with three columns. The first column 1284 is comprised of screen names 1290 of various host screens. The second column 1286 is comprised of the input fields 1292 that correspond to the screen name 1290 of the same row. The third column 1288 is comprised of output fields 1294 that correspond to the screen name 1290 of the same row.

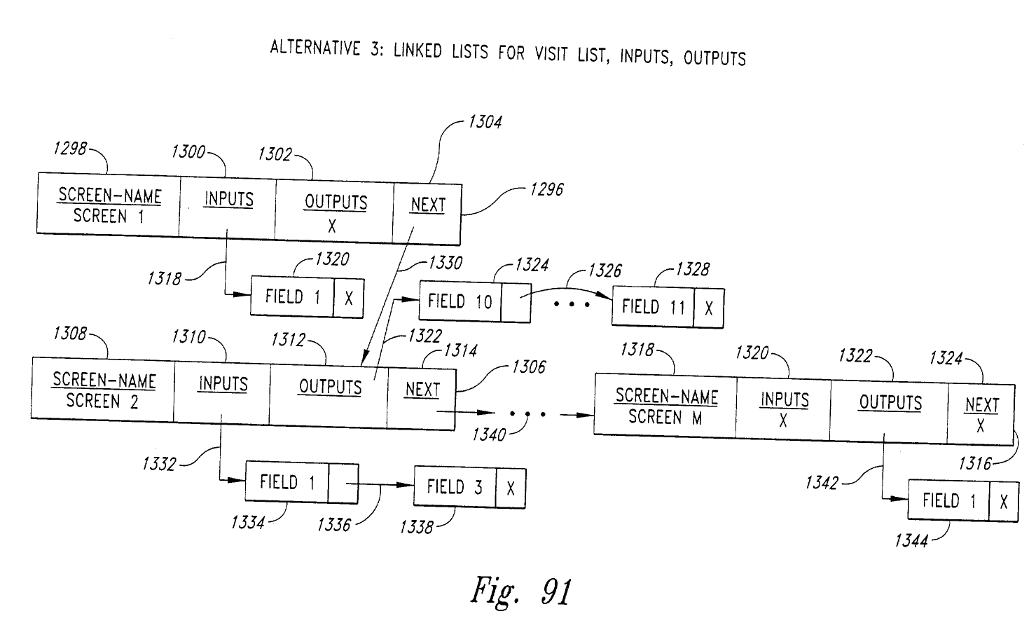

A third way to structure a task, as shown in FIG. 91, is by using blank lists that are linked together instead of using tables. This third alternative structure contains identical task information to that of the second embodiment of the task data structure 1282 shown in FIG. 90. A first linked list 1296 contains the task information relating to a first screen and is comprised of a screen name portion 1298, of an inputs portion 1300 containing a first link 1318 to a first screen first field 1320, of an outputs portion 1302, and of a “next” portion 1304 containing a second link 1330 to a second linked list 1306.

The second linked list 1306 contains the task information relating to a second screen and is comprised of a screen name portion 1308 and an inputs portion 1310 containing a third link 1332 to a second screen first field 1334 having a fourth link 1336 to a second screen third field 1338. The second linked list 1306 is further comprised of an outputs portion 1312 containing a fifth link 1322 to a second screen tenth field 1324 and a sixth link 1326 to a second screen eleventh field 1328 and comprised of a “next” portion 1314 containing a seventh link 1340 to a subsequent linked list.

The final linked list 1316 contains task information relating to an Mth screen and is comprised of a screen name portion 1318, of an inputs portion 1320, of an outputs portion 1322 having an eighth link 1342 to an Mth screen first field 1344, and of a “next” portion.

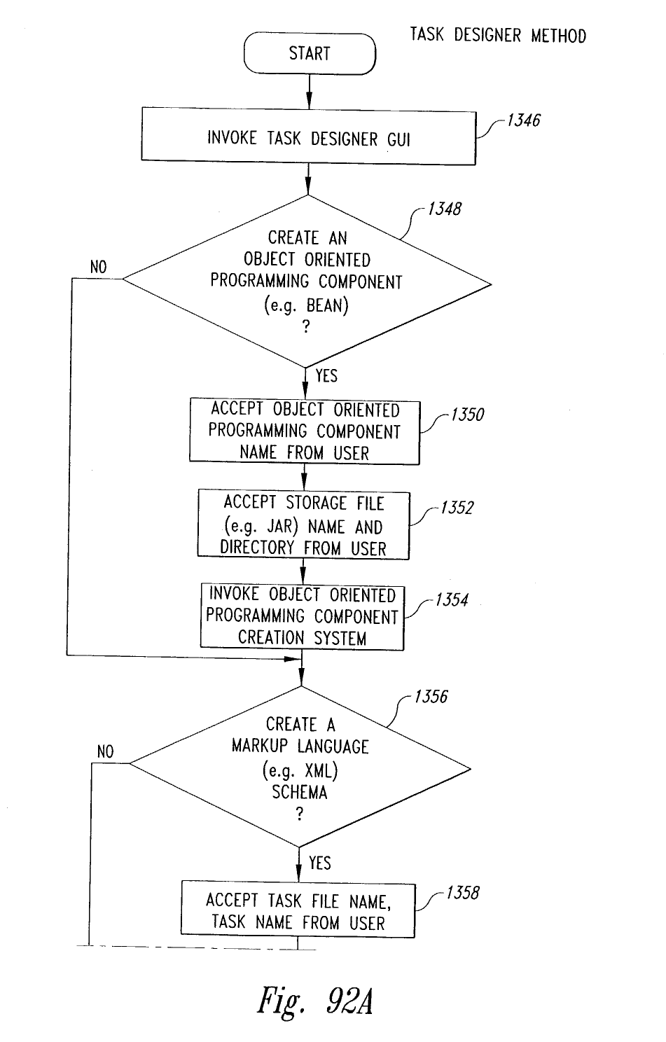

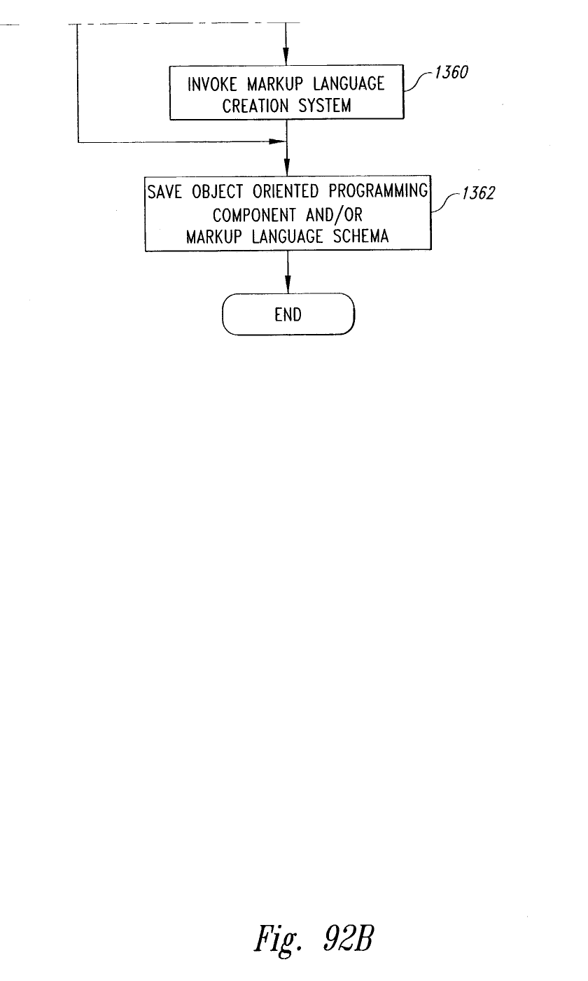

A high level view of a method followed by an embodiment of the task designer 568 is illustrated in FIGS. 92A and 92B. In this method, the purpose of the task designer 568 is to determine whether the user wants to create an object oriented programming component (e.g. JavaBean) or a markup language (e.g. XML) schema and to accept from the user the parameters needed to create either one. The task designer 568 begins the method by invoking the task designer graphical user interface 1258 (step 1346). The task designer 568 then gives the user the option to create an object oriented programming component (step 1348). If the user wants to create an object oriented programming component (“Yes” branch of step 1348), the task designer 568 accepts both an object oriented programming component name (step 1350) and a storage file (e.g. Java Archive) name and directory (step 1352) from the user. Next, the object oriented programming component creation system 1260 is invoked by the task designer 568 (step 1354) and uses the user input to create an object oriented programming component.

When the user has completed the process of creating an object oriented programming component, or if the user does not want to create an object oriented programming component (“No” branch of step 1348), the task designer 568 determines if the user wants to create a markup language schema (step 1356). If the user wants to create a markup language schema (“Yes” branch of step 1356), the task designer 568 accepts from the user a task file name and a task name (step 1358). The task designer 568 also invokes the markup language creation system 1262 (step 1360) to create the markup language schema.

After the user has finished inputting the required data, the task designer 568 saves the object oriented programming component and/or the markup language schema (step 1362) and ends its method.

The steps depicted in FIGS. 92A and 92B are exemplary and some may be rearranged or combined. For instance, the task designer 568 could first go through the process of creating a markup language schema (steps 1356-1360) before giving the user the option to create an object oriented programming component (steps 1348-1354).

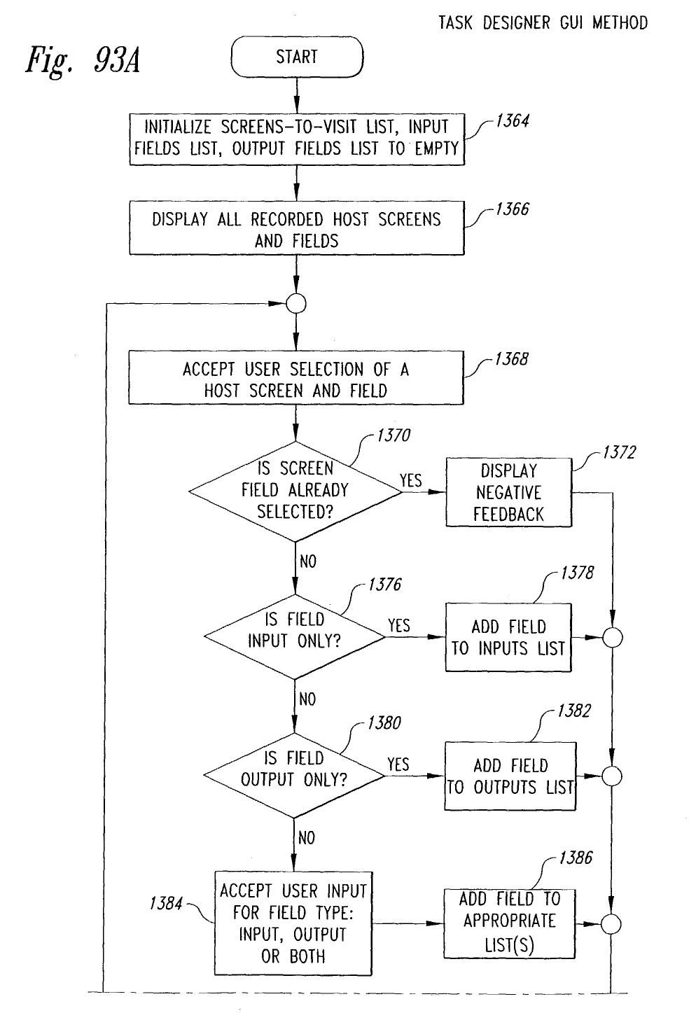

The function of the task designer graphical user interface 1258 is to allow a user to view a screen recording that has its application graph generated and to let the user choose any field in the recording and label it as an input or output. An example of a method followed by the task designer graphical user interface 1258 is shown in FIGS. 93A and 93B. The task designer graphical user interface 1258 begins the method by initializing a screens-to-visit list, an input fields list, and an output fields list to empty (step 1364). A customized screen connector recording, with all its host screens and screen fields, is then displayed to the user (step 1366). The task designer graphical user interface 1258 next accepts a user selection of a host screen and screen field (step 1368) and determines if the screen field has already been selected (step 1370). If the screen field has already been selected (“Yes” branch of step 1370), the task designer graphical user interface 1258 alerts the user by displaying negative feedback (step 1372) and checks if the host screen is in the screens-to-visit list (step 1374).

If the screen field has not been previously selected (“No” branch of step 1370), the task designer graphical user interface 1258 decides if the screen field is an input only field. If the screen field is an input only field (“Yes” branch of step 1376), the screen field is added to the input fields list (step 1378), and the task designer graphical user interface 1258 moves on to check if the host screen is in the screens-to-visit list (step 1374). Otherwise (“No” branch of step 1376), the task designer graphical user interface 1258 determines if the screen field is an output only field. If the screen field is an output only field (“Yes” branch of step 1380), the screen field is added to the output fields list (step 1382), and the task designer graphical user interface 1258 moves on to check if the host screen is in the screens-to-visit list (step 1374). For instance, a screen field that is read-only and cannot accept input would be considered an output only field and would be added to the appropriate list.

If the task designer graphical user interface 1258 determines that the screen field cannot be classified as an output only field (“No” branch of step 1380), the user must decide under which field type the screen field should be grouped (step 1384). Based upon knowledge of the application, the user indicates whether the screen field accepts input, output, or both. In accordance with the user response, the task designer graphical user interface 1258 then adds the screen field to the appropriate list or lists (step 1386).

After adding the screen field to the appropriate fields list, the task designer graphical user interface 1258 determines if the host screen is already in the screens-to-visit list (step 1374). If it is not in the list (“No” branch of step 1374), the host screen is added to the screens-to-visit list (step 1388). Next, the task designer graphical user interface 1258 checks if the user is finished designing the task (step 1390). If the user is not finished (“No” branch of step 1390), the task designer graphical user interface 1258 accepts another user selection of a host screen and a screen field (step 1368). Otherwise (“Yes” branch of step 1390), the task designer graphical user interface 1258 ends its method.

In an embodiment where the screen connector designer 90 receives user input as to whether a screen field accepts input, output, or both (as shown in the data structure in FIG. 73), the task designer graphical user interface 1258 would not need to request information from the user concerning the field type. Thus, in this alternative embodiment, step 1384 would be modified. Instead of accepting information from the user, the task designer graphical user interface 1258 would retrieve the field type information directly from the screen connector designer 90 and add the screen field to the appropriate fields list.

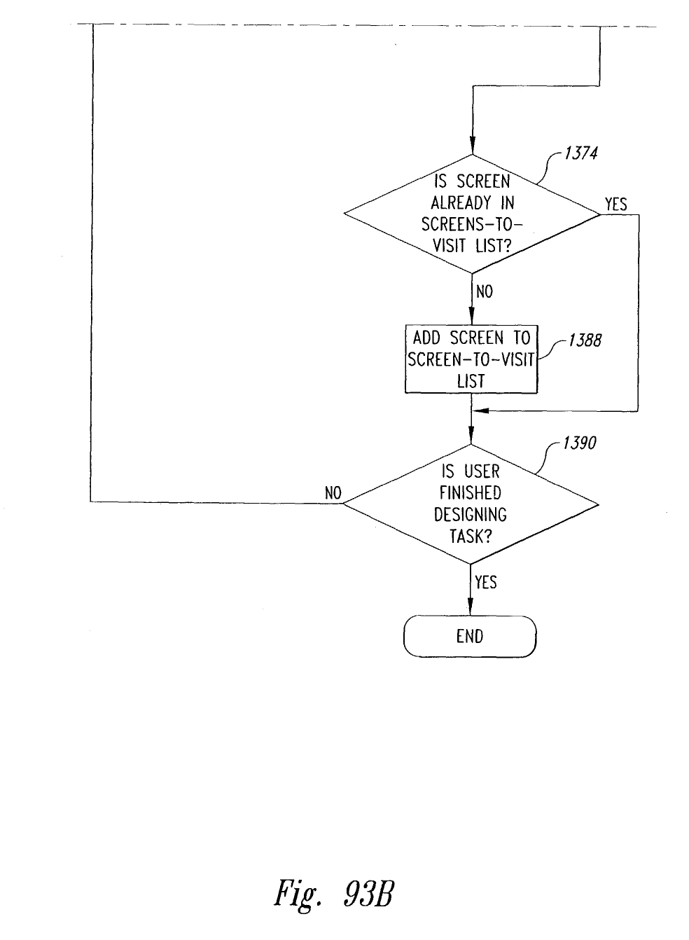

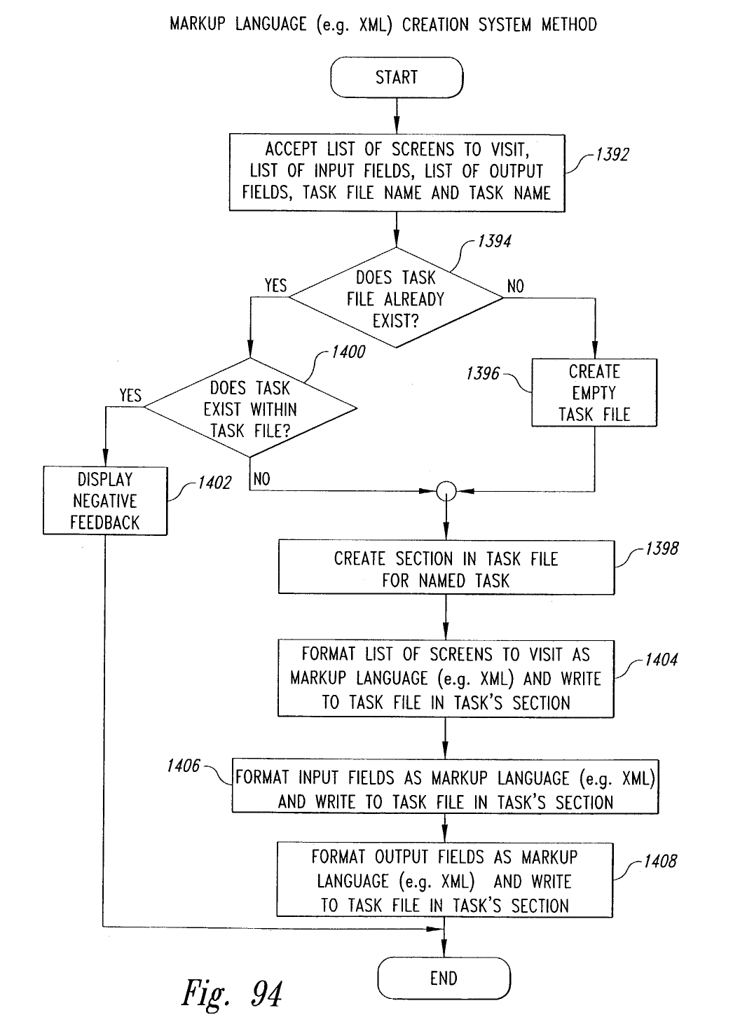

The task designer 568 calls the markup language creation system 1262 to create a markup language schema from inputted lists of screen fields and host screens. A method followed by an embodiment of the markup language creation system 1262 is depicted in FIG. 94. During the method, the markup language creation system 1262 sets up a task file, creates a section for the schema being constructed, writes information concerning screen fields and host screens into the schema, and closes the task file. To begin the method, the markup language creation system 1262 accepts a screens-to-visit list, an input fields list, and an output fields list from the task designer graphical user interface 1258 and accepts a task file name and a task name from the task designer (step 1392). If the task file already exists (“Yes” branch of step 1394), the markup language creation system 1262 determines if a task exists within the task file. If there is a task within the task file (“Yes” branch of step 1400), the user is notified of the problem through negative feedback (step 1402) and the markup language creation system 1262 ends the method. Otherwise (“No” branch of step 1400), the markup language creation system 1262 creates a section in the task file for the named task (step 1398).

If the named task file does not exist (“No” branch of step 1394), the markup language creation system 1262 creates an empty task file (step 1396) and proceeds to create a section in the task file for the named task (step 1398). Once this section is created, the markup language creation system 1262 formats the list of screens-to-visit in markup language and writes the list to the task file in the newly created task section (step 1404). The input fields (step 1406) and output fields (step 1408) are also formatted in markup language and written to the task file. The markup language creation system 1262 then ends the method.

XML is an example of a markup language that could be used in the markup language creation system 1262. In this example, the final product from the markup language creation system 1262 would be an XML schema for a particular task. The creating of and writing to this XML schema file could be accomplished in a couple of ways. First, the markup language creation system 1262 could use an intermediate object called a Document Object Module (DOM) to create sections in and write to the XML schema file. A second approach would consist of writing the data out directly, without an intermediate object, using language features of the implementation.

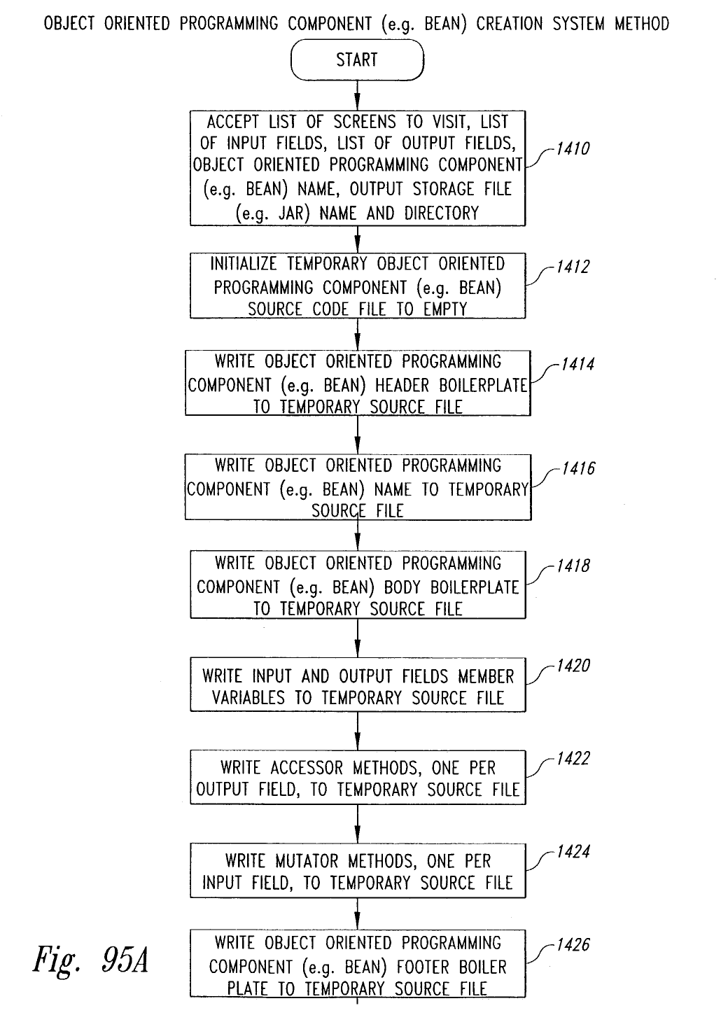

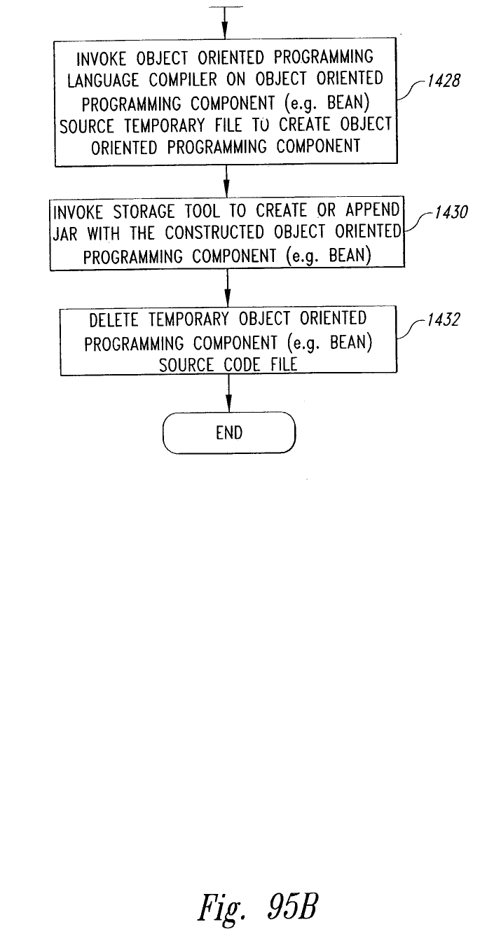

The object oriented programming component creation system 1260 differs from the markup language creation system 1262 in that the object oriented programming component creation system 1260 constructs an active compiled piece of code instead of a document or some type of repository of characters. Thus, the object oriented programming component creation system 1260 creates a source code for the object oriented programming component, compiles the code, and then saves the code for later use as seen in the method depicted on FIGS. 95A and 95B.

The object oriented programming component creation system 1260 begins its method by accepting a list of screens-to-visit, a list of input fields, and a list of output fields from the task designer graphical user interface 1258 and by accepting an object oriented programming component name and an output storage file name and directory from the task designer 568 (step 1410). The object oriented programming component creation system 1260 then initializes, to empty, a temporary source code file for the object oriented programming component (step 1412). After this initialization, a header boilerplate (step 1414), a name (step 1416), and a body boilerplate (step 1418) for the object oriented programming component are written to the temporary source file. Included in the object oriented programming component body boilerplate could be an execute method or another method that allows the object oriented programming component to invoke a task after required input has been gathered.

The object oriented programming component creation system 1260 then writes the input and output fields member variables to a temporary source file (step 1420). These variables give information as to how the object oriented programming component is structured and whether the object oriented programming component will store the results of a task in itself or if it will just be a front end that accesses those results elsewhere in the runtime system. For each output field, an accessor method is written to the temporary source file (step 1422), and for each input field, a mutator method is written to the temporary source file (step 1424). After the accessor and mutator methods are written, an object oriented programming component footer boilerplate is also written to temporary source file (step 1426).

The object oriented programming component creation system 1260 then moves on to invoke the object oriented programming language compiler 1264 on the temporary source file in order to create the object oriented programming component (step 1428). After the object oriented programming component is constructed, the object oriented programming component creation system 1260 invokes the storage tool 1266 to create or append the storage file for the newly created object oriented programming component (step 1430). To conclude its method, the object oriented programming component creation system 1260 deletes the temporary source code file (step 1432).

An example of an embodiment of the object oriented programming component creation system 1260 could include Java as the object oriented programming language and a JavaBean as the object oriented programming object. In this embodiment, the JavaBean could be created using a Java compiler in step 1428 and could be saved with a Java archive (JAR) tool. These two external tools could be invoked in two ways. One approach would be to allow the user to invoke the external tools through a command line using some of the features of Java to invoke another utility through the command line. This first approach would be taken if the Java compiler or the JAR tool were not written in Java. Another approach would be to invoke a class that directly implements the particular functionality. Thus, it would be possible to have a Java compiler with a Java interface where the Java compiler could be invoked from Java to Java.

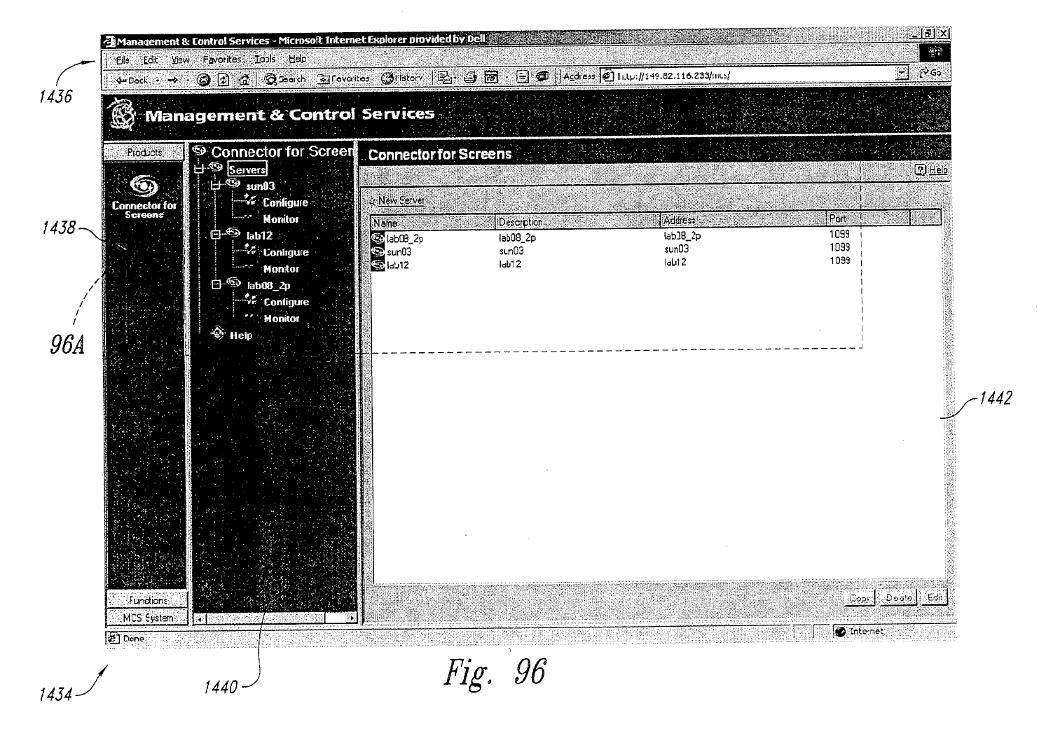

Another major component of the screen connector runtime system is the connector configuration management server 96, which can manage multiple screen connector runtime engines 100. The user interacts with and configures these screen connector runtime engines 100 through the connector configuration management server 96 using the connector configuration management user interface 98. An example of a management and control server user interface 1434 is shown in FIG. 96 and depicts three server computers 60 being connected to the connector configuration management server 96. The management and control server user interface 1434 runs in a browser that has a standard toolbar 1436. At the top of the management and control server user interface 1434 is a banner, and on the left side of the display is a products bar 1438 that displays the different types of connectors that are available for the particular suite of systems. In the example, only one connector, a connector for screens, is available. However, other products, such as a CICS connector or a database, could be listed in the products bar 1438.

To the right of the products bar 1438, and shown in more detail in FIG. 96A, is a server tree display bar 1440. The server tree display bar 1440 shows which server computers 60 are connected to the connector configuration management server 96 and provides the user with a help link 1456. Once one of these servers is selected, the user has the option to configure or monitor the server. Three connected server computers 60 are shown in the exemplary server tree display bar 1440 as being SUN03 1446, LAB12 1448, and LAB08_{—}2P 1450, each having a configure server branch 1452 and a monitor server branch 1454. These same server computers 1446-1450 are also listed in a screen connector display area 1442 having a name column 1458, a description column 1460, an address column 1462, a port column 1464, and a new server link 1465.

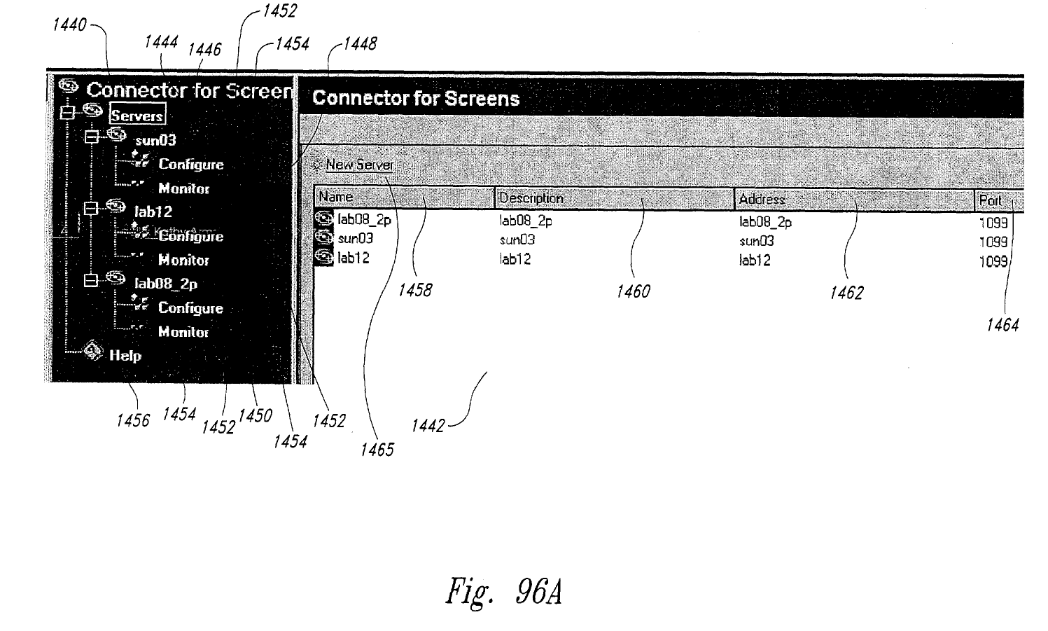

The new server link 1465 allows users to connect new server computers 60 to the connector configuration management server 96. When the new server link 1465 is selected, a new session wizard user interface 466 is called, as shown in FIG. 97 and in more detail in FIG. 97A. Through the new session wizard user interface 1466, the user is able add a server computer 60 to the connector configuration management server 96 by inputting a server name 1468, a server description 1470, a server address 1472, and a server port 1474. In an embodiment of the invention where the server computer 60 configuration is done over hypertext transfer protocol (HTTP), the server address 1472 would be a TCP/IP address.

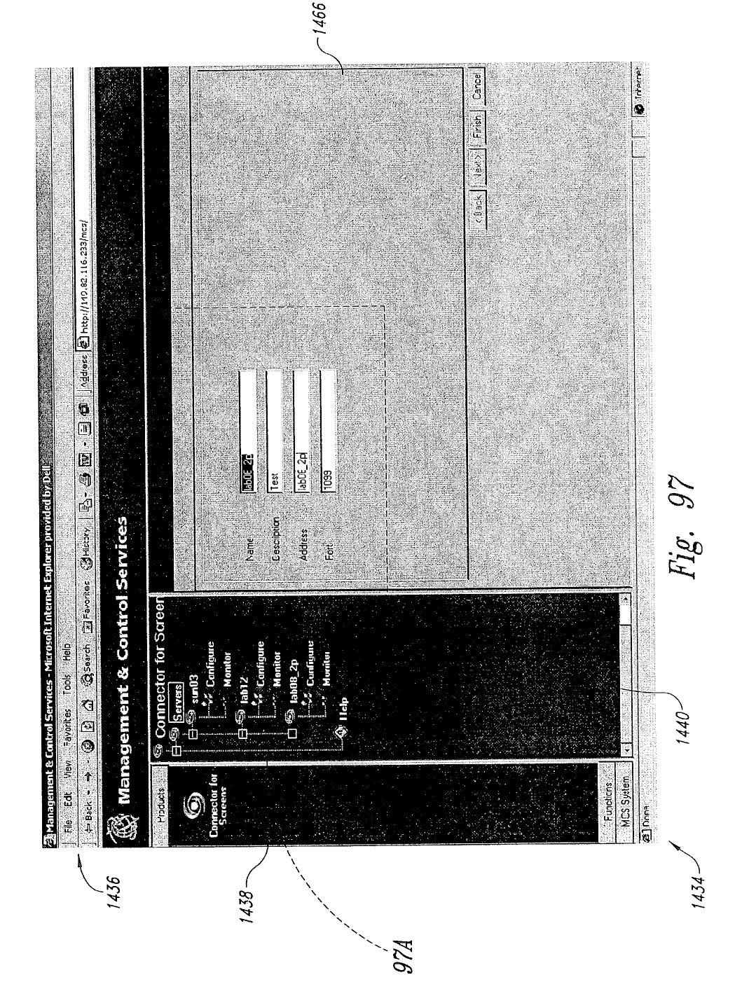

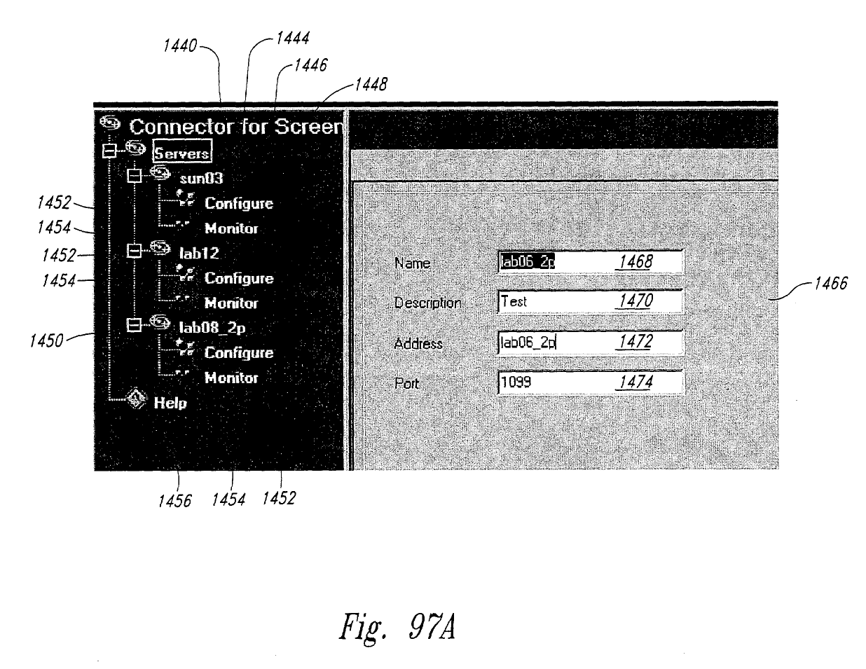

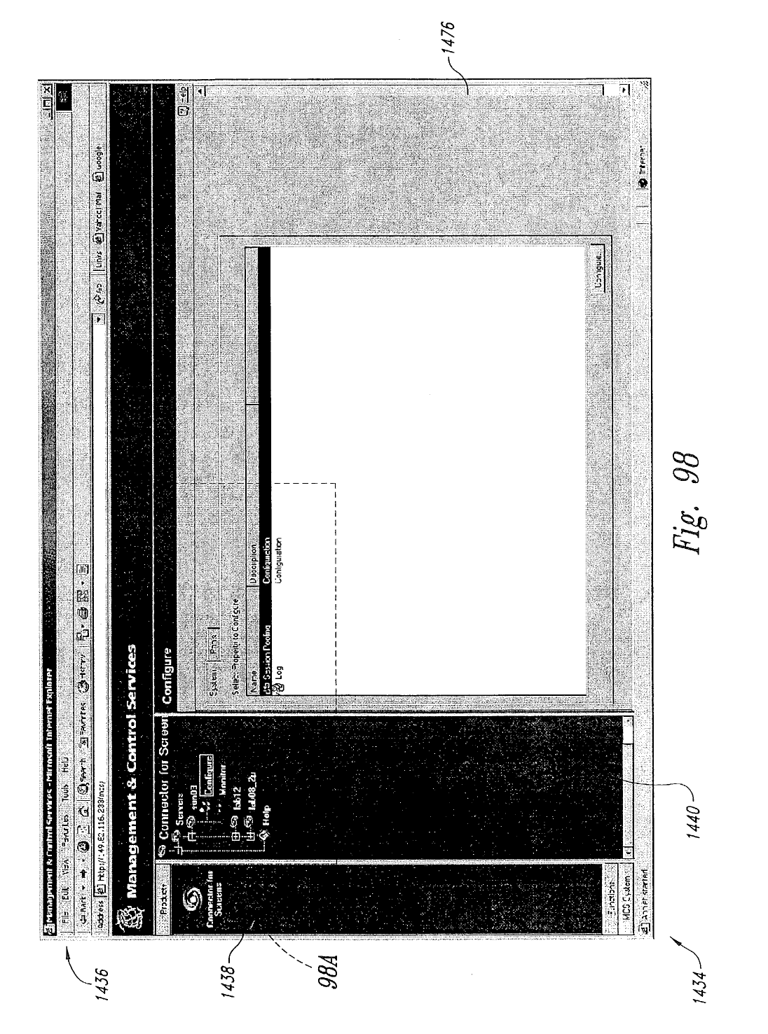

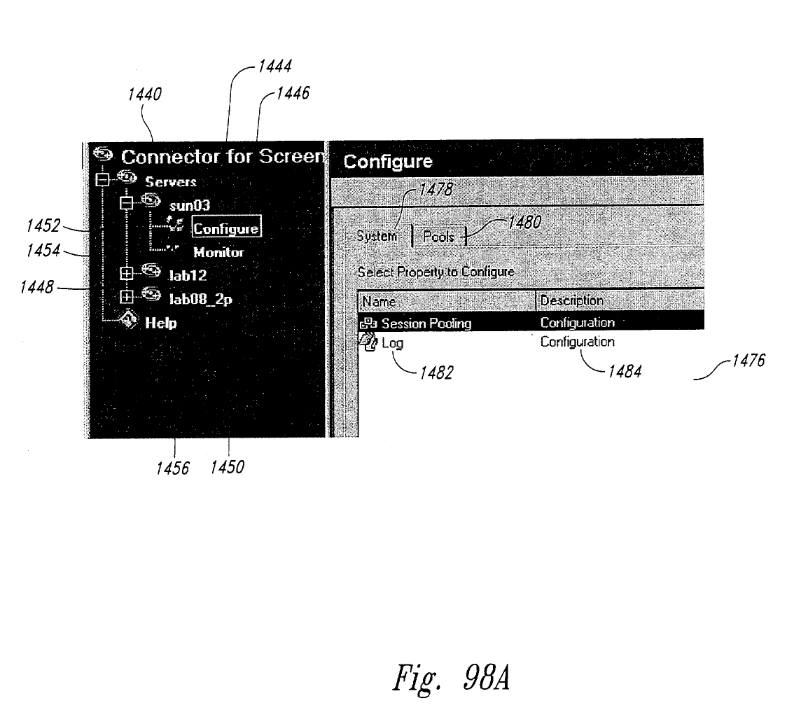

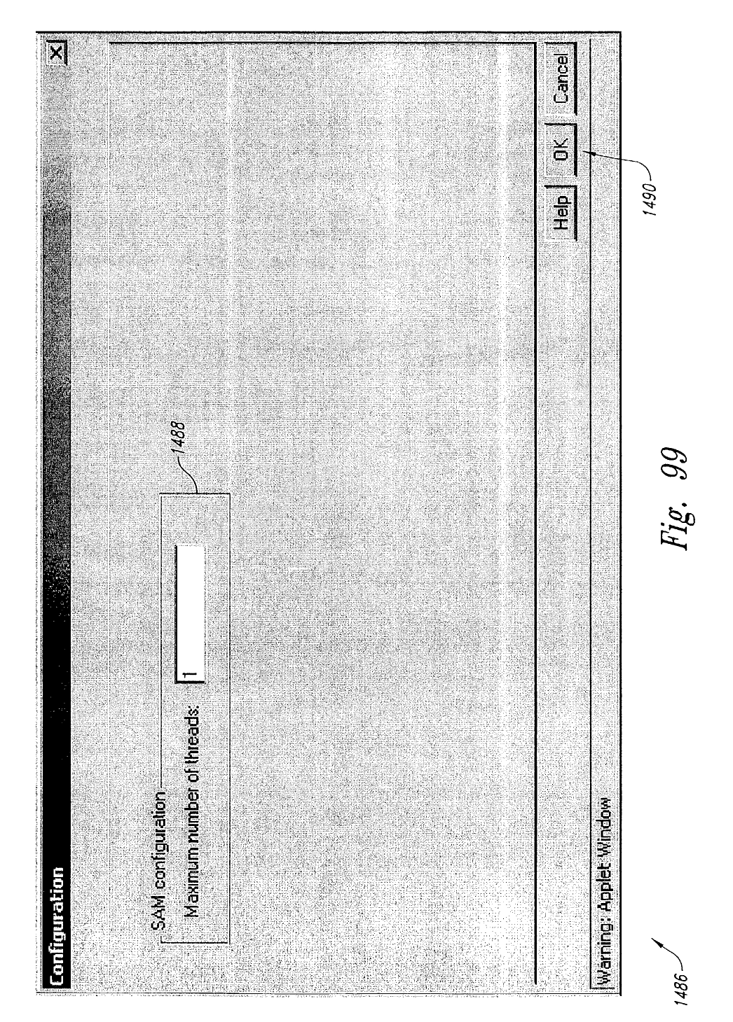

When the configure server branch 1452 is selected from the server tree display bar 1440, a first configuration screen display 1476 is called, as shown in FIG. 98 and in more detail in FIG. 98A. The first configuration screen display 1476 has both a systems tab 1478 and a pools tab 1480. When selected, the systems tab 1478 shows a name column 1482 and a description column 1484 and allows the user to select a property in order to configure the listed system settings. In this depicted example, the user is able to configure either the session pooling or the session log. If the user chooses to configure the session pooling, a session pooling configuration applet window 1486 appears, as shown in FIG. 99, that allows the user to control the number of threads 1488 dedicated to the system allocation manager. The user may confirm or cancel the configuration, or ask for help, by selecting from menu controls 1490 at the bottom of the session pooling configuration applet window 1486.

When choosing to configure the session log, the user would be required to input information such as the name of the file in which the log is to be saved, the number of days worth of recordings to be saved, and the types of events that are to be captured in the log. The user could also configure various filter settings for the session log.

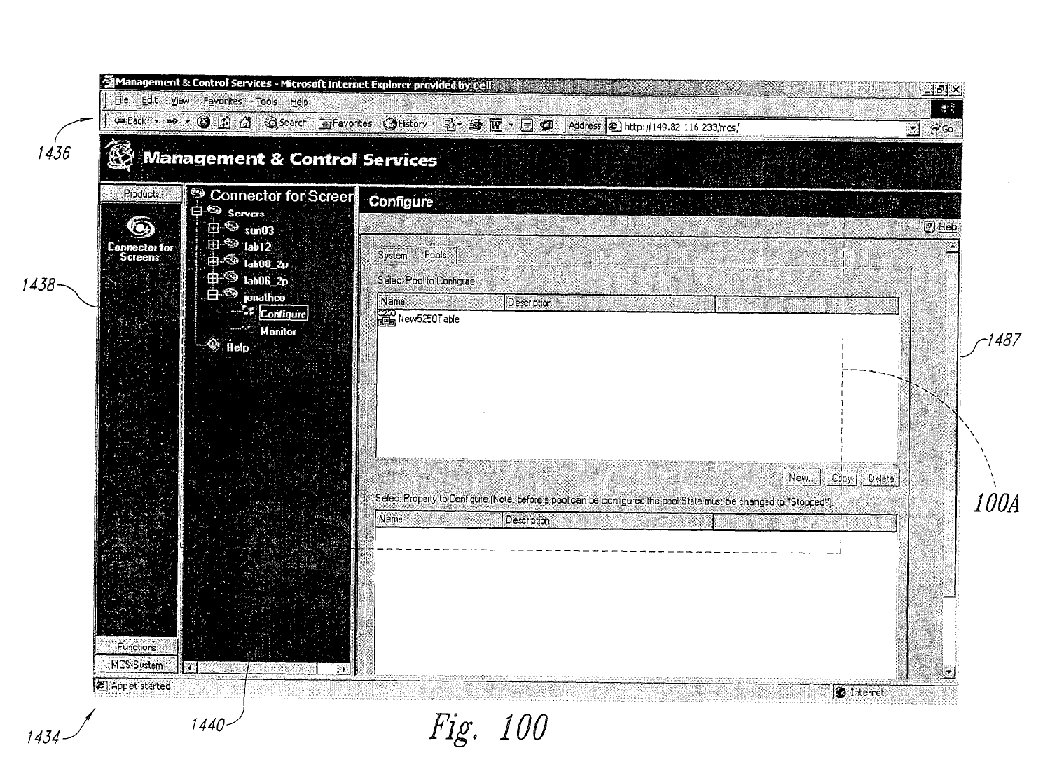

If the pools tab 1480 from the first configuration screen display 1476 is selected, a pool configuration display 1487 is brought to the front of the browser, as shown FIGS. 100 and 100A. The pool configuration display 1486 is broken into two frames. The top frame shows a list of pool names 1492 and pool descriptions 1494 that may be selected and configured. The user also has the option of configuring a new pool by selecting from the “NEW” button 1500 of the menu controls. The bottom frame displays a list of pool property names 1496 and pool property descriptions 1498 that may be selected and configured.

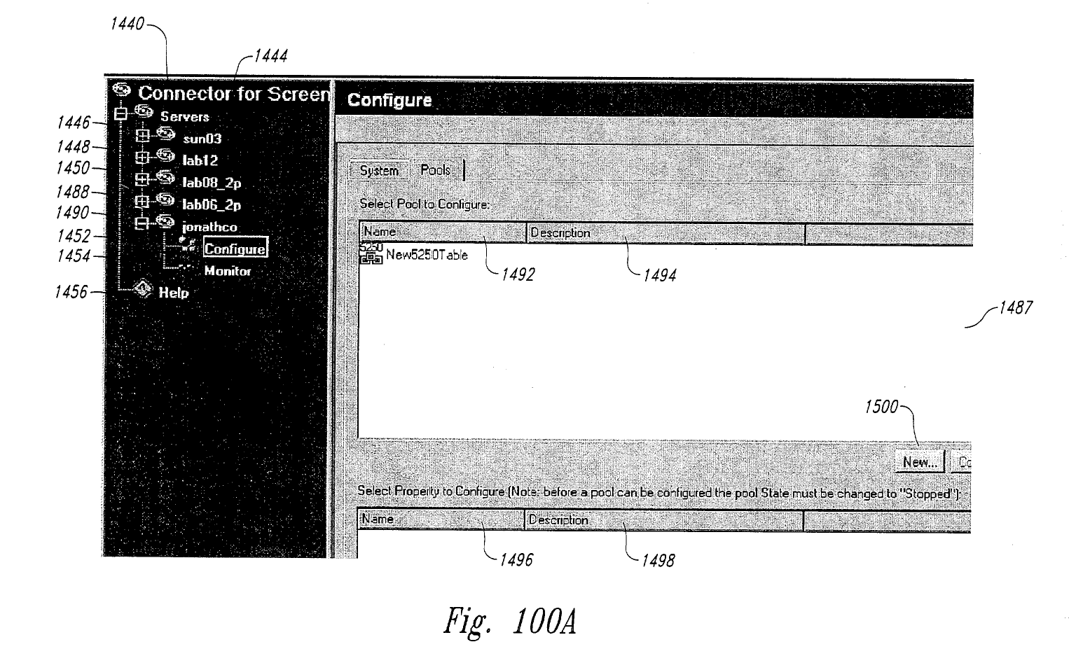

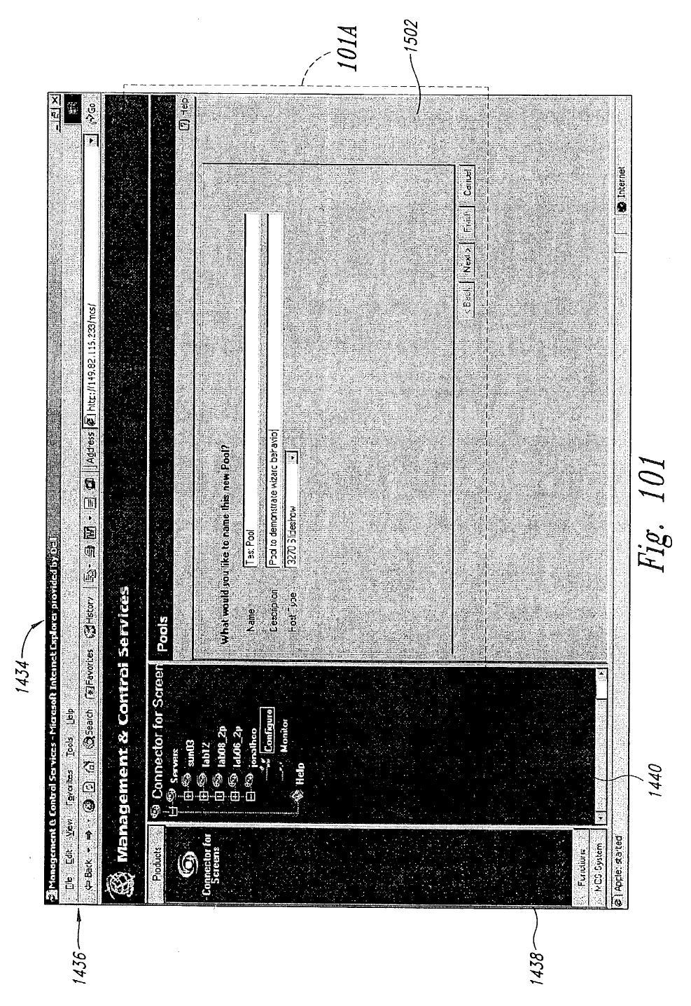

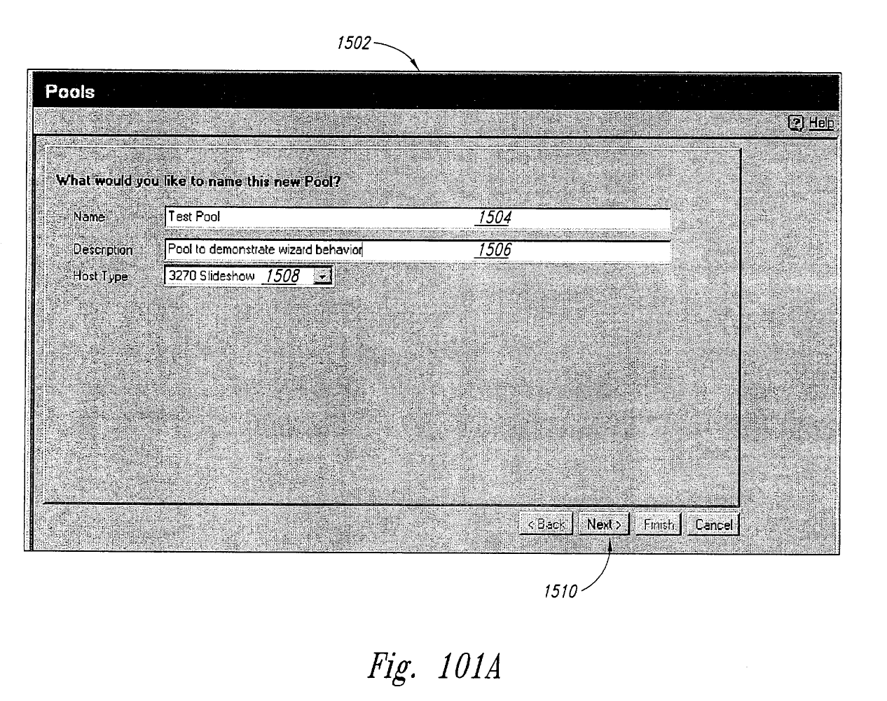

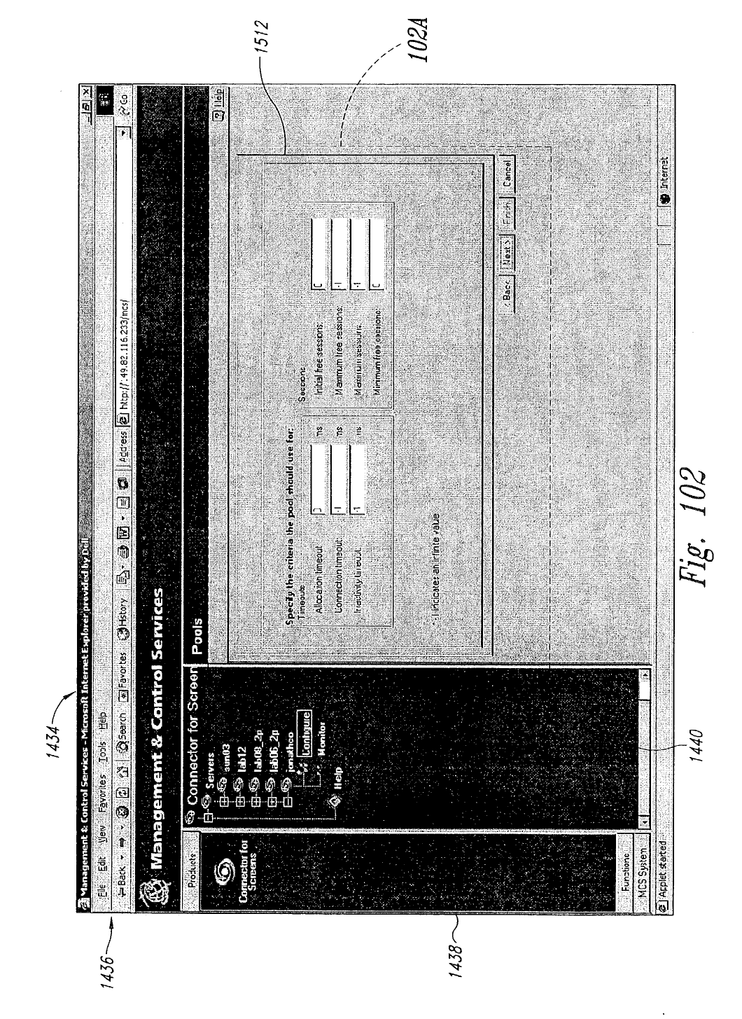

The user may select the “NEW” button 1500 to invoke the new pool wizard. A new pool wizard first page 1502 is depicted in FIGS. 101 and 101A and allows the user to input a pool name 1504, a pool description 1506, and a host type 1508. By selecting the “NEXT” button from the menu controls 1510, the user moves on to a new pool wizard second page 1512, as shown in FIGS. 102 and 102A. The new pool wizard second page 1512 allows the user to set general session pool configurations relating to timeouts and number of sessions.

The timeouts box has sections to set an allocation timeout 1514, a connection timeout 1516, and an inactivity timeout 1518. The allocation timeout 1514 is the delay for how long it will take for a session to be allocated out of the memory of the system. The connection timeout 1516 is the maximum time duration that a session may be connected to the host computer 80. The inactivity timeout 1518 is the time duration a session is allowed to be idle without being used in any interactions with the host computer 80. If the time period entered in the activity timeout 1518 section expires, the session is returned to free up system resources for another session.

The session parameters box deals mainly with how large and how small a pool is permitted to be and includes entries for initial free sessions 1520, maximum free session 1522, maximum sessions 1524, and minimum free sessions 1526. The user may indicate completion of this new pool wizard second page 1512 by selecting the appropriate button from the menu controls 1528.

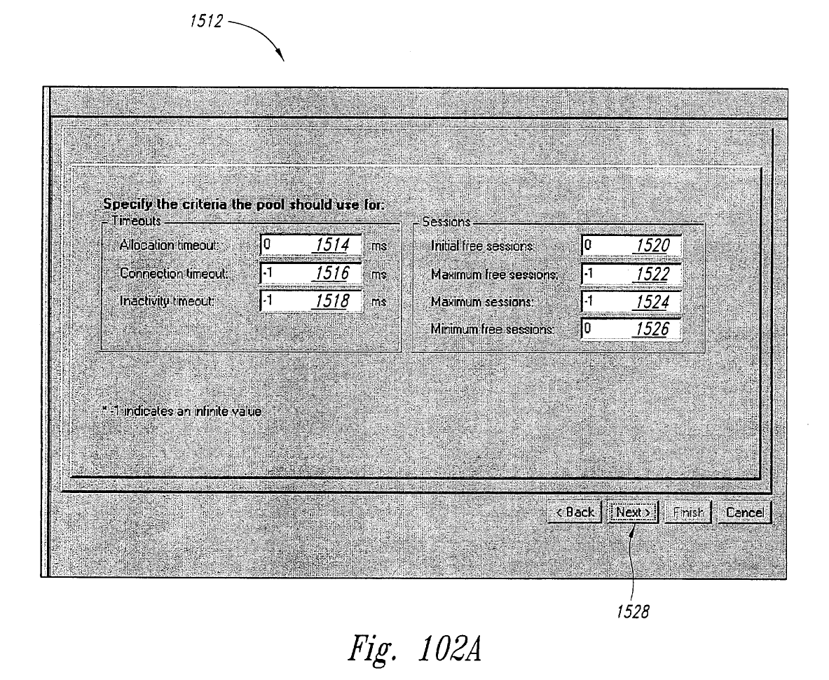

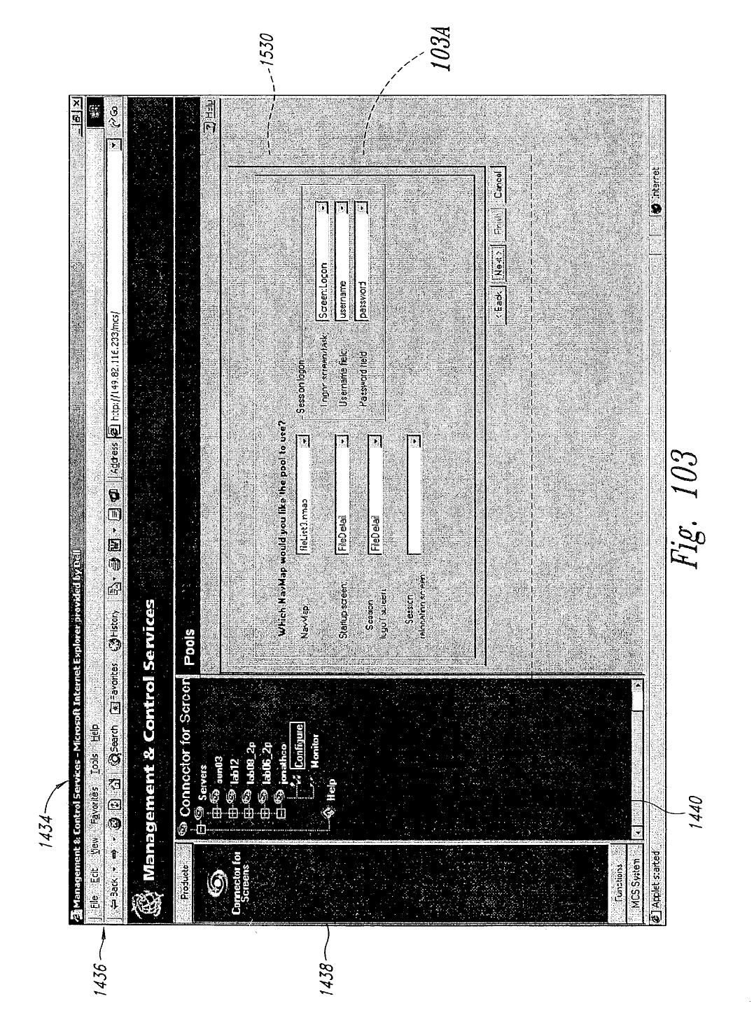

A new pool wizard third page 1530 is shown in FIGS. 103 and 103A. The new pool wizard third page 1530 allows the user to enter information concerning which navigation map 1532 is to be used with the selected pool. Configuration parameters relating to a startup screen 1534, a session logoff screen 1536, and a session relocation screen 1538 may also be set by the user. These configuration parameters contain information that helps the session manager decide where to put sessions on the host computer 80 once a session has been logged into or, if a session has not been logged into, tells the host computer how to log into the session. The user also has the option to set session logon parameters. A logon screen/task parameter 1540 indicates which screen contains the login information. A username field parameter 1542 and a password field parameter 1544 indicate which username and password fields are used for logging in. The user may indicate completion of the new pool wizard third page 1530 by selecting the appropriate button from the menu controls 1546.

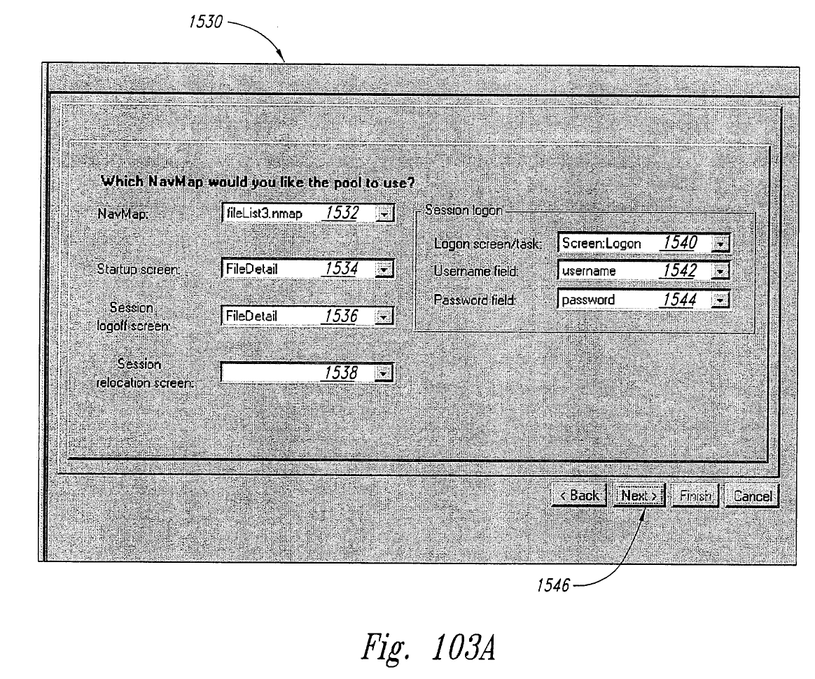

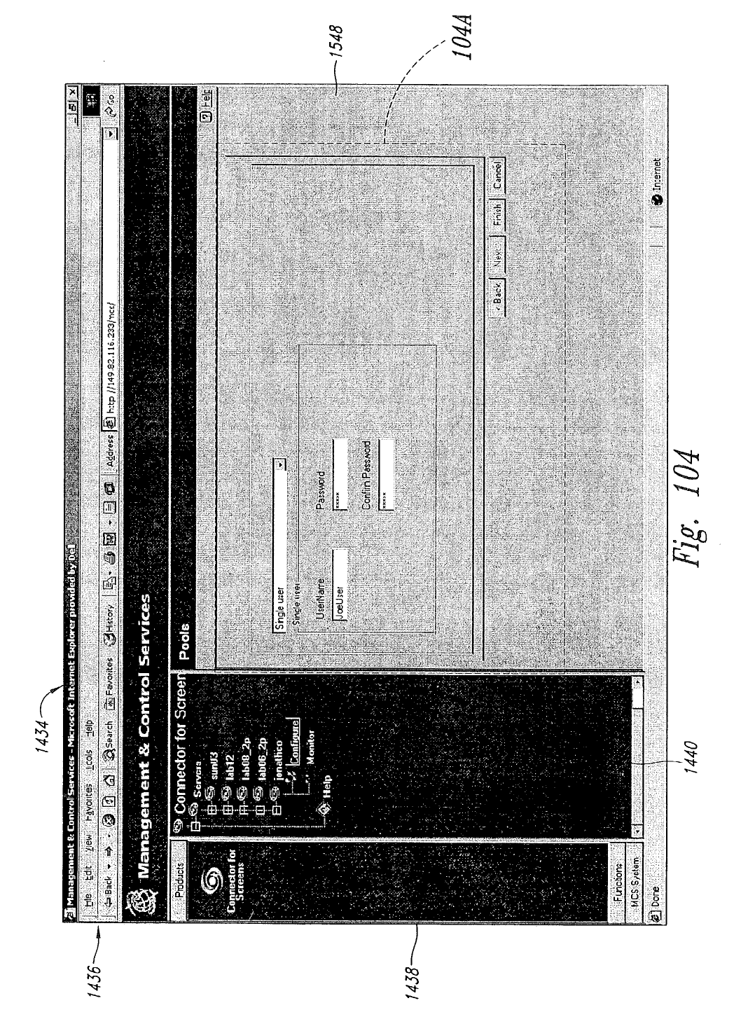

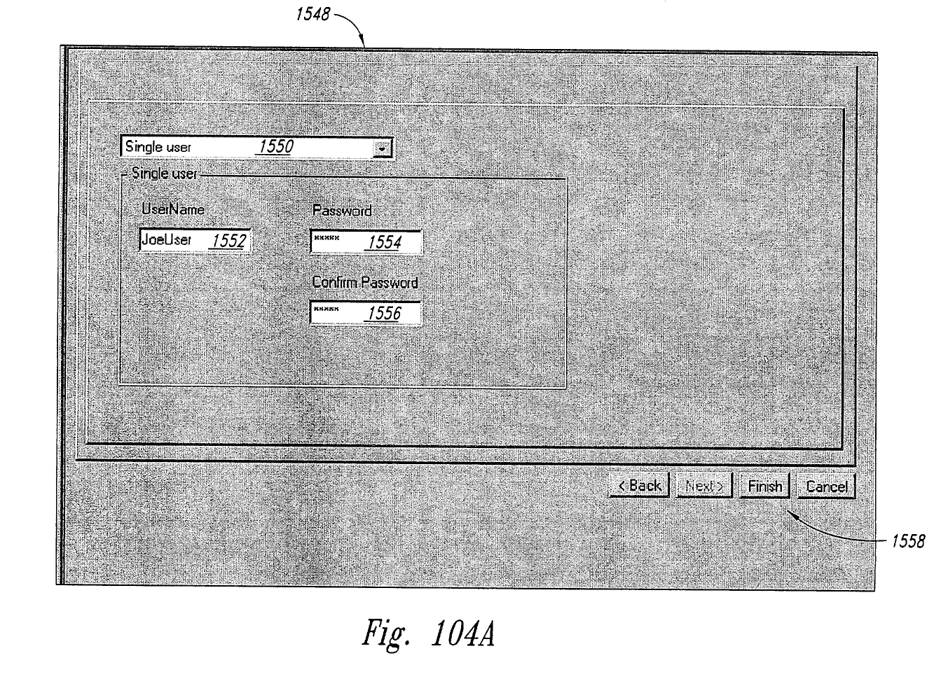

A new pool wizard fourth page 1548 contains more details of the logon configuration for a particular pool and is shown in FIGS. 104 and 104A. The new pool wizard fourth page 1548 provides a drop down menu 1550 indicating what range of usernames and passwords will be accepted to logon a session. The new pool wizard fourth page 1548 also has sections for the user to input a username 1552, enter a password 1554, and confirm the password 1556 that will be used to logon a session. The user may then finish the new pool wizard, return to previous pages, or ask for help by selecting the appropriate button from the menu controls 1558.

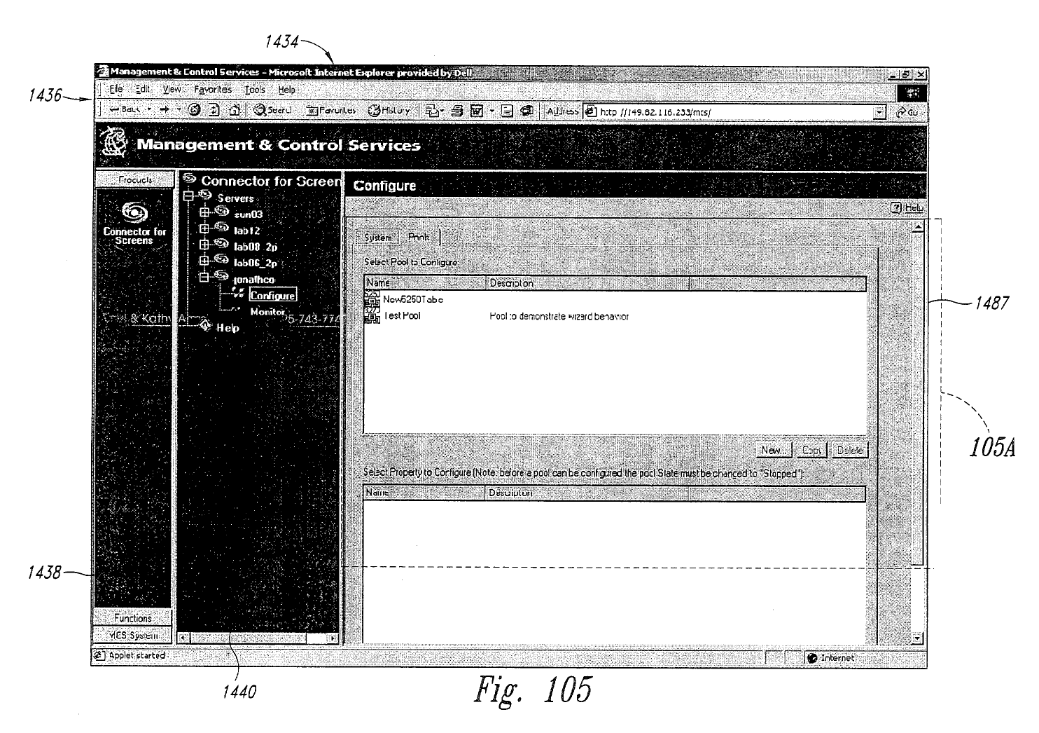

After the new pool wizard is completed, the pool configuration display 1487 is again displayed in the browser, as shown in FIGS. 105 and 105A. The newly created “Test Pool,” whose creation process is shown in FIGS. 101-104, is added to the list of pool names 1492 and pool descriptions 1494.

Users also have the option of configuring parameters of existing pools. When a pool is selected from the pool configuration display 1486, the bottom frame refreshes to display properties that are associated with the selected pool, as shown in FIGS. 106 and 106A. The exemplary screen display in FIG. 106A shows four properties associated with the selected “5250Table” pool: a general property, a connection property, a navigation map property, and a logon property. The connection property changes depending on what type of screen type is created. In this example, the connection property depicted refers to a 5250 connection. However, other connections, such as for Digital Equipment Corporation VT type terminals or Unix screen types, may be used in alternative embodiments of the invention.

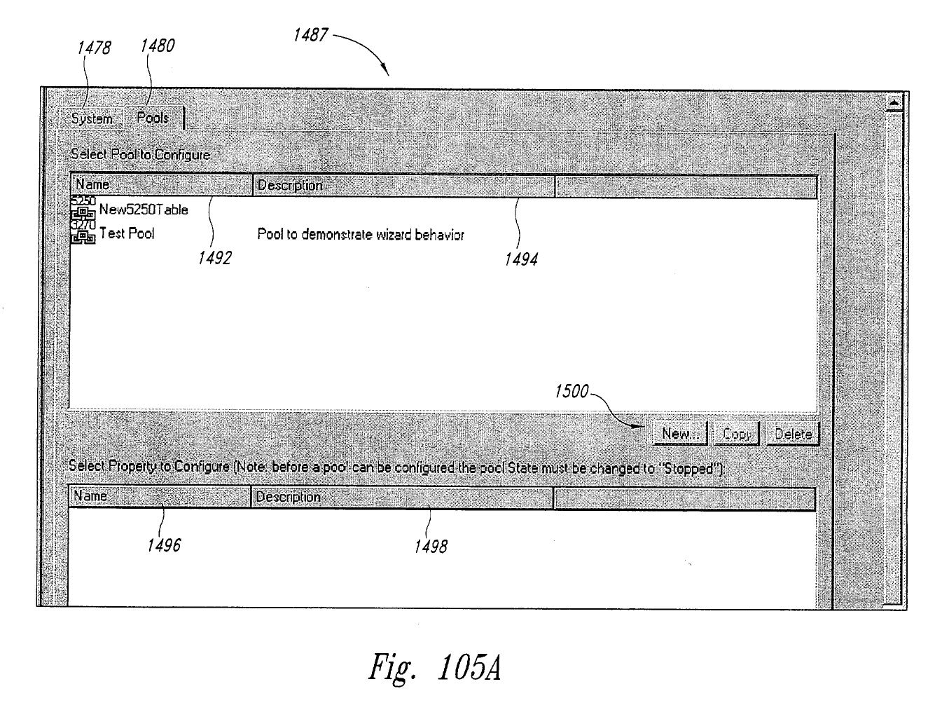

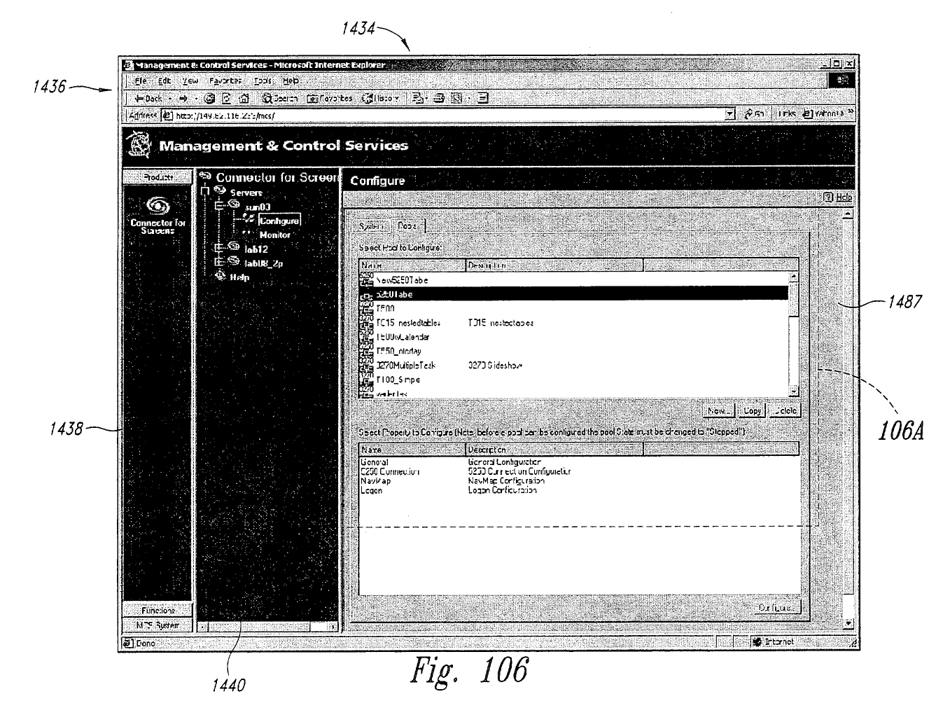

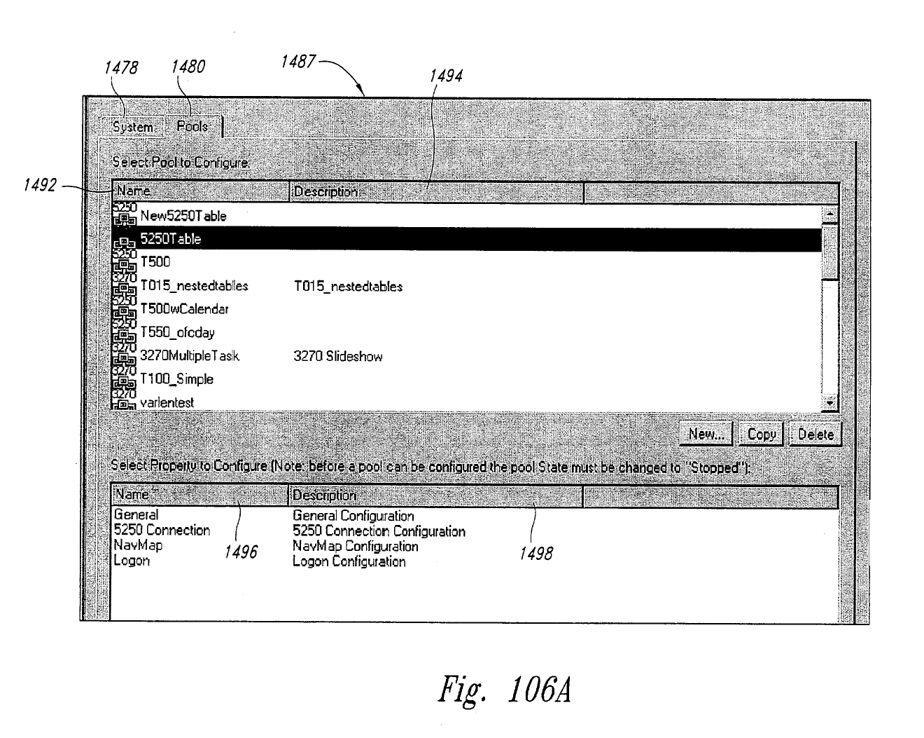

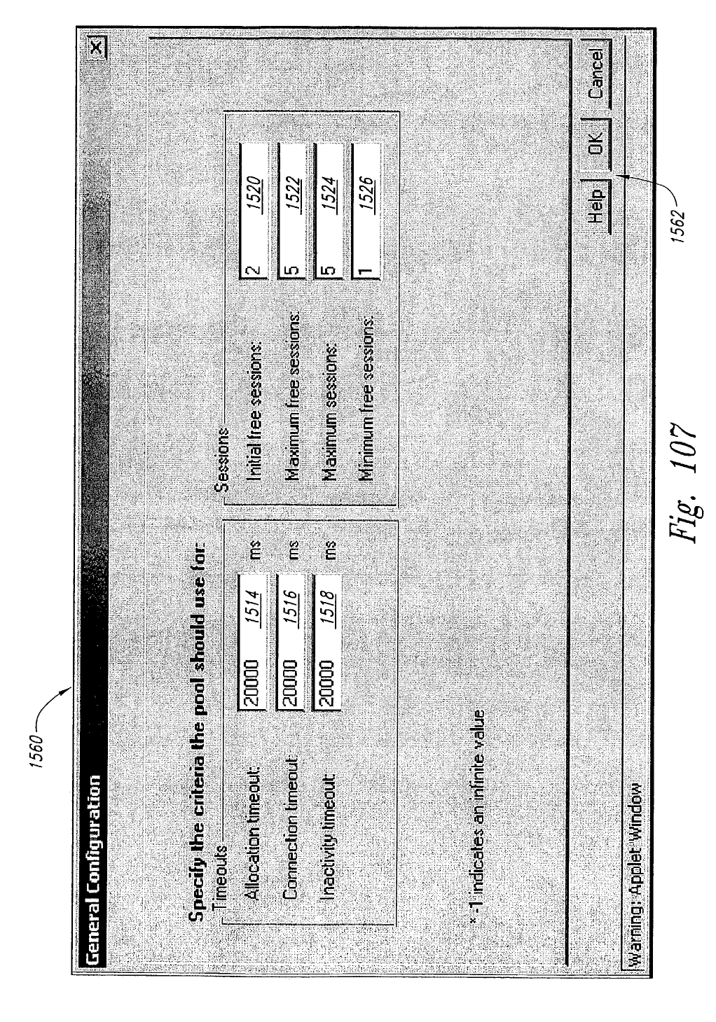

Selecting the general property calls a general configuration applet window 1560 that allows the user to configure pool parameters dealing with timeouts and the number of sessions. This general configuration applet window 1560, shown in FIG. 107, is identical to the new pool wizard second page 1512 depicted in FIG. 102A. Selecting the 5250 connection property brings up a connection configuration applet window 1564 that allows the user to configure the host connection parameters of the selected session pool.

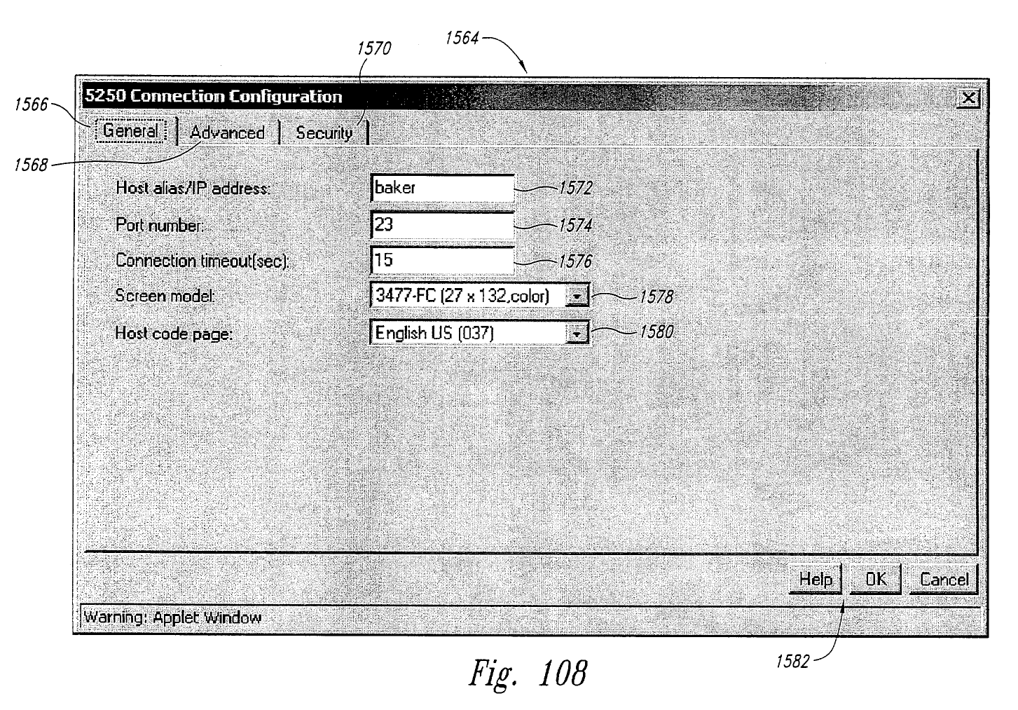

The connection configuration applet window 1564 has three tabs: a general tab 1566, an advanced tab 1568, and a security tab 1570. The general tab allows the user to configure a host alias/IP address 1572 and a port number 1574. Other parameters could include a connection timeout 1576, a screen model 1578, and a host code page 1580. The connection configuration applet window 1564 shown in FIG. 108 is an example for one connection type and is similar to a configuration setup for a standard terminal emulator. Other connection types could require a different number of parameters.

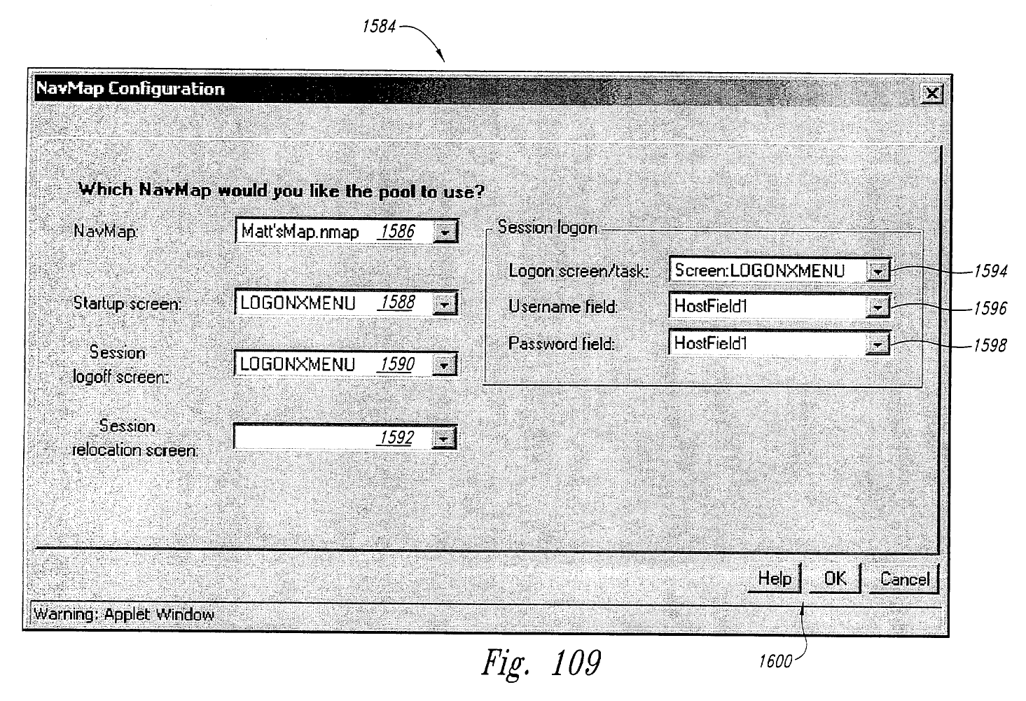

Selecting the navigation map property brings up a navigation map configuration applet window 1584, shown in FIG. 109, that is identical to the new pool wizard third page 1530 shown in FIGS. 103 and 103A. This navigation map configuration applet window 1584 gives the user the option to change parameters regarding session logon and other configuration parameters.

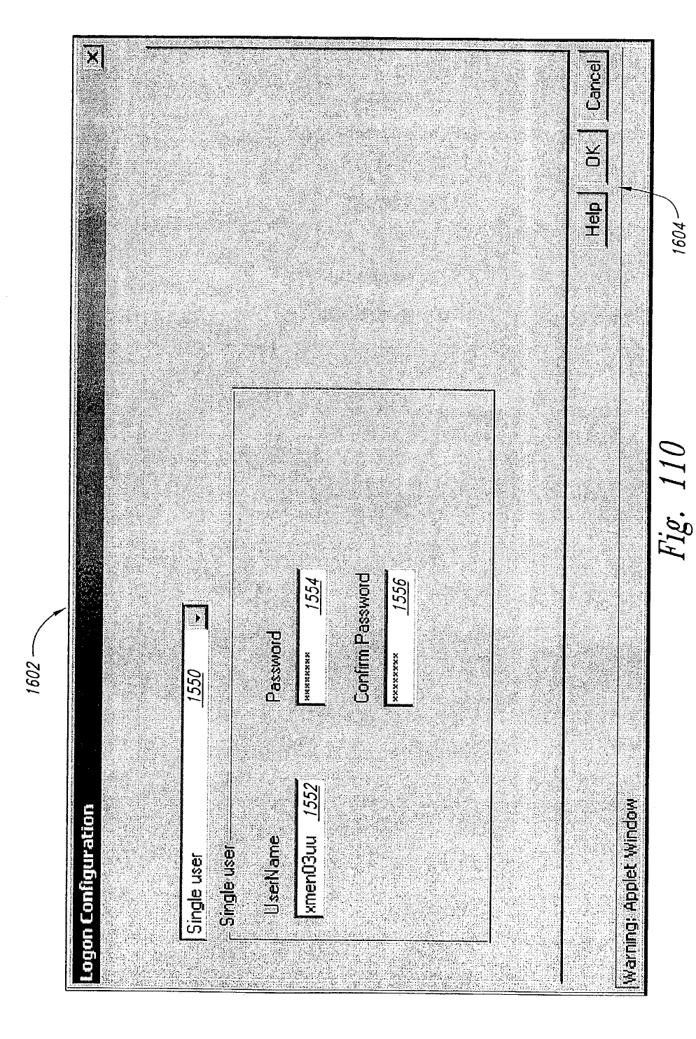

Selecting the logon property calls a logon configuration applet window 1602 that is identical to the new pool wizard fourth page 1548 depicted in FIG. 104A. The login configuration applet window 1602 for a single user is shown on FIG. 110. This single user configuration would be used in a single-user environment but could also be used across multiple logons by the same user.

Oftentimes a pool of users requires access to a particular session, creating the need for multiple unique usernames. FIG. 111 depicts a login configuration applet window for a range of users with a single password 1606. The range of users or the range of passwords may be changed by selecting from a drop down menu 1608. Because different host computers 80 have different logon requirements for the usernames, FIG. 111 shows exemplary parameters involved with the automatic generation of multiple usernames. Included in these parameters are an entry for the number of iterations 1616 involved in the username generation, an option to indicate numeric generation 1628 of the username, a defined user prefix 1618, a generated field category 1620 having a field length 1622 and a starting value 1624, and a defined user suffix 1626. Thus, one does not need to manually set individual usernames for each user, which is especially beneficial in circumstances wherein a pool has several sessions. Each username is automatically generated by concatenating a uniquely generated portion of the username to the supplied user prefix and the supplied user suffix. For example, when configuring a pool, one could define “user” as the user prefix 1618, select the numeric generation 1628 option, define the user field length 1622 to be two characters and the starting value 1624 to be 1, and leave the user suffix 1626 blank. The connector configuration management server 96 would then generate a number of usernames equal to the number of iterations 1616 entered, such as “user1,” “user2,” “user3,” and so on.

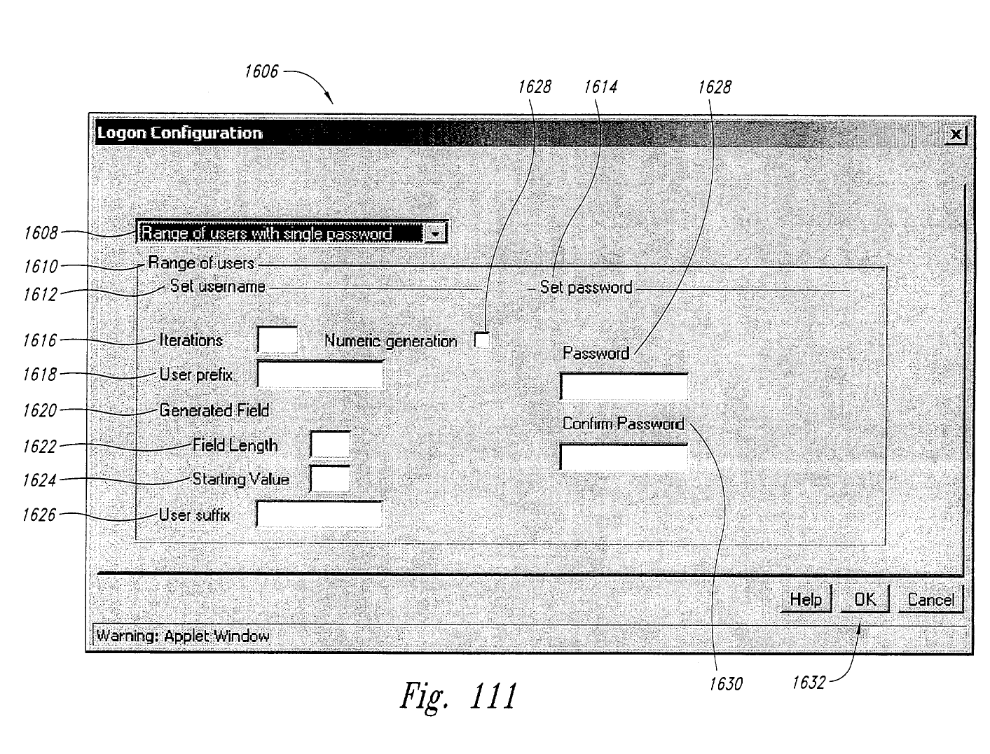

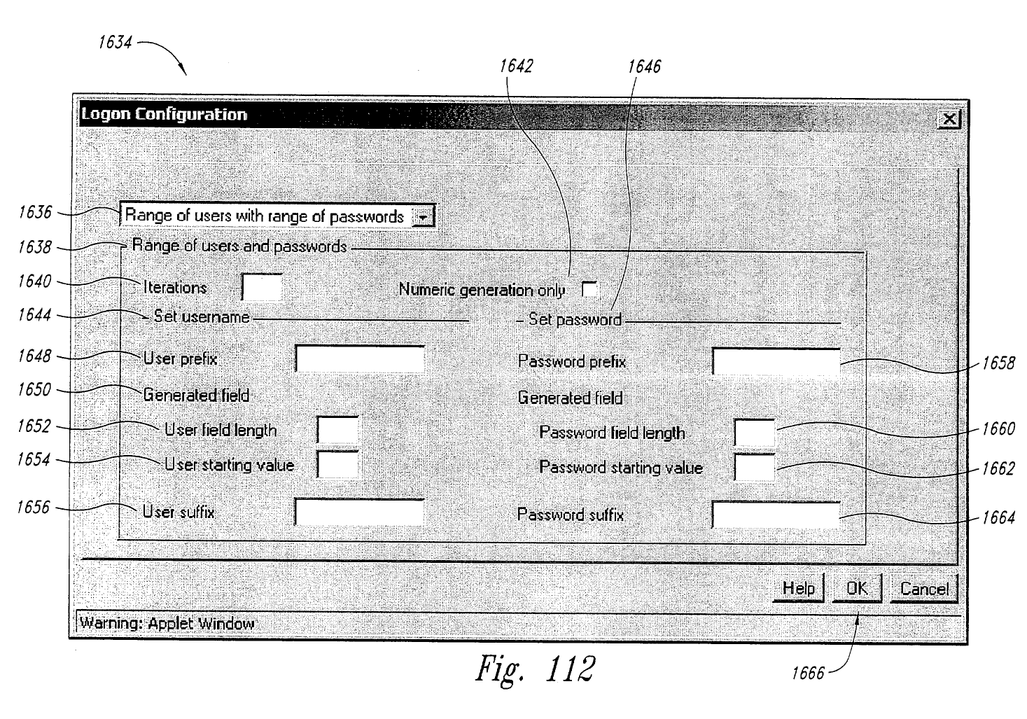

A login configuration applet window for a range of users with a range of passwords 1634, as shown in FIG. 112, adds the option of automatic password generation along with username generation. The parameters for password generation mirror the parameters for username generation. The login configuration applet window for a range of users with a range of passwords 1634 contains a set password section 1646 having a defined password prefix 1658, a password field length 1660, a password starting value 1662, and a defined password suffix 1664. Thus, in an embodiment with multiple users with multiple passwords, the connector configuration management server 96 would automatically generate the required number of usernames and passwords according to the defined parameters.

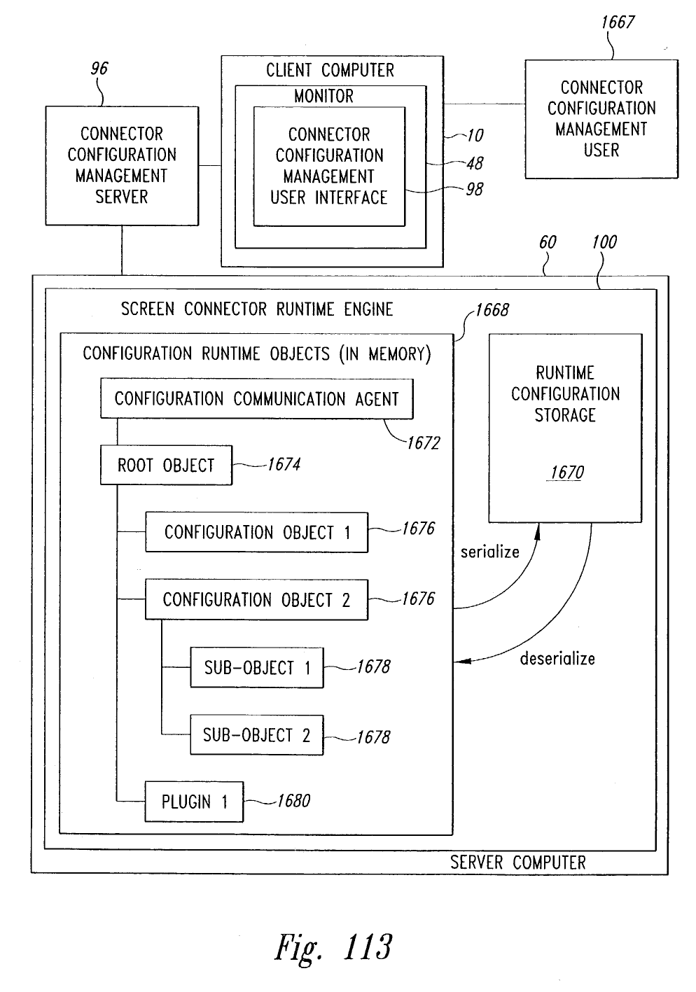

The various components that are active in the configuration system are shown in FIG. 113. A connector configuration management user 1667 interacts with a client computer 10 that is networked to the connector configuration management server 96, which is in turn networked to a server computer 60. The connector configuration management server 1667, which could consist of a number of servlets running within a web server, extracts various configuration user interfaces from the server computer 60 and sends them to the client computer 10, which displays the configuration user interfaces to the connector configuration management user 1667. After the connector configuration management user 1667 manipulates the settings to the various configuration user interfaces, the connector configuration management server 96 forwards the changes to the server computer 60.

The client computer 10 includes a monitor 48 through which the connector configuration management user interface 98 can be displayed. For example, the connector configuration management user interface 98 could contain Java applets and could run on a web browser that receives user interface descriptions and user interface contents from the connector configuration management server 96 over HTTP. Running on the server computer 60 is the screen connector runtime engine 100 having configuration runtime objects 1668 and a runtime configuration storage 1670. The configuration runtime objects 1668 consist of a configuration communication agent 1672 that communicates with the connector configuration management server 96, a root object 1674, multiple configuration objects 1676, multiple sub-objects 1678, and plugins 1680.

The runtime configuration storage 1670 is used so that the screen connector runtime engine 100 can operate when a network connection to the connector configuration management server 96 is lost, when the connector configuration management server is not running, or when the connector configuration management server cannot be contacted. All the configuration information that is required for runtime is stored by serializing the root object 1674 into the runtime configuration storage 1670. When the root object 1674 is serialized, the root object and its subsidiary objects have their states stored off to a disk or to another type of permanent storage that is capable of recording the settings of the configured objects. At some later time, when a connection between the server computer 60 and the connector configuration management server 96 is reestablished, the recorded settings can be deserialized and restored to the root object and its subsidiary objects. The deserialization and retrieval of the system configuration information, from the runtime configuration storage 1670 back to a memory representation of the configuration runtime objects 1668, occurs each time the screen connector runtime engine 100 starts up.

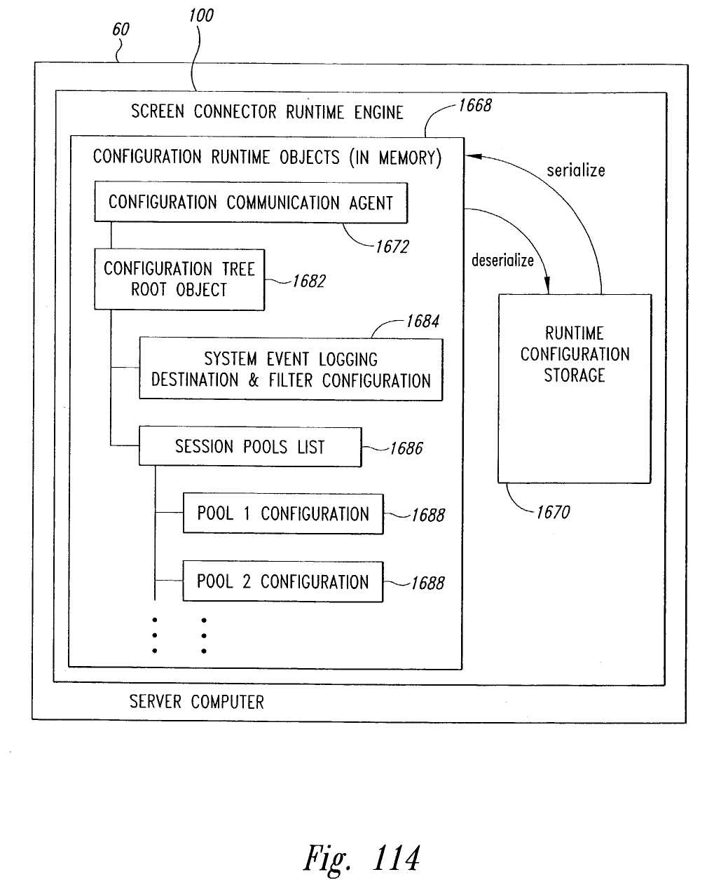

A schematic diagram showing specific examples of objects stored in the server computer 60 is depicted in FIG. 114. Running on the server computer 60 is the screen connector runtime engine 100 having the runtime configuration storage 1670 and the configuration runtime objects 1668. The configuration runtime objects 1668, which are stored in memory, could include the configuration communication agent 1672, a configuration tree root object 1682, a system event logging destination and filter configuration 1684, and a session pools list 1686 with configurations for multiple session pools 1688. Alternative embodiments of the screen connector runtime engine 100 could contain different configuration runtime objects 1668 depending on what type of screen connector was associated with the screen connector runtime engine.

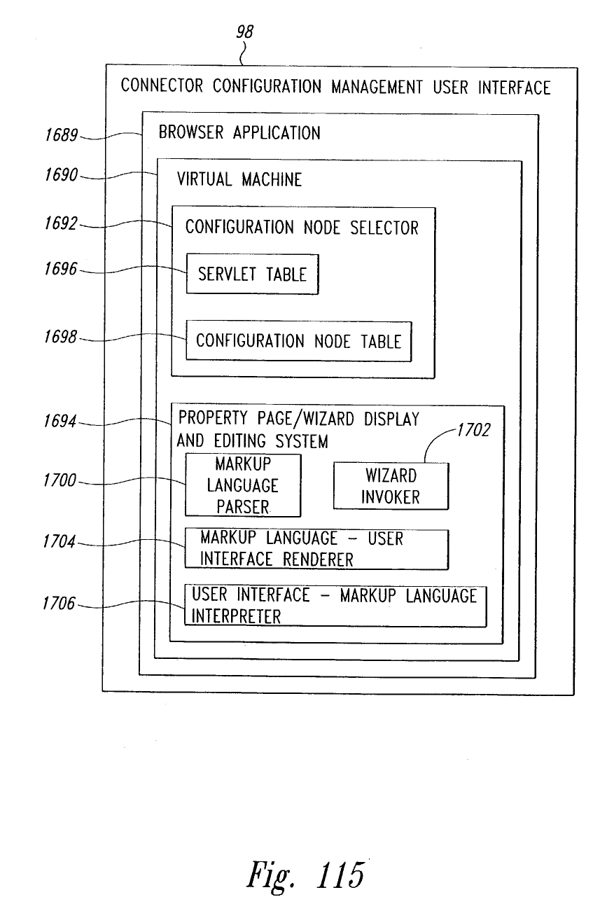

The client-side user interface is depicted in FIG. 115 as a schematic diagram of the connector configuration management user interface 98. The connector configuration management user interface 98 contains a browser application 1689 that controls a virtual machine 1690 capable of running multiple object oriented programming language applets. Two examples of Java applets that could run on the virtual machine 1690 are shown within the connector configuration management user interface 98: a configuration node selector 1692, having both a servlet table 1696 and a configuration node table 1698, and a property page applet, which is depicted as a property page/wizard display and editing system 1694. The configuration node selector 1692 displays all the server computers 60 and the objects within the server computers that can be reached from the connector configuration management user interface 98. The property page/wizard display and editing system 1694 contains a markup language parser 1700, a wizard invoker 1702, a markup language—user interface renderer 1704, and a user interface—markup language interpreter 1706. This property page applet shows the details of a configurable object that has been selected by the user. The two exemplary Java applets could also communicate with each other through applet-to-applet communications, which is a standard Java feature.

In one embodiment of the runtime system, the markup language used in the runtime system could be XML, which serves as a practical format for handling data. In this embodiment, the user interface descriptions and user interface data contents would be transmitted between the connector configuration management server 96 and the connector configuration management user interface 98 using XML formatting. Of course, in other embodiments of the runtime engine, other data forming protocol could be used as well.

The connector configuration management user interface 98 is used to determine with which server computer 60 the client computer 10 is communicating and establish which servlet and which configuration node on the server computer are involved in the communication link. After making this determination the connector configuration management user interface 98 formats a request for the user interface from the server computer 60 and, if necessary, formats a request for the data that goes in the user interface. This data is then displayed to the user and may be modified via the connecter configuration management user interface 98. After the user has finished the modifications, the data is transmitted to the connector configuration management server 96.

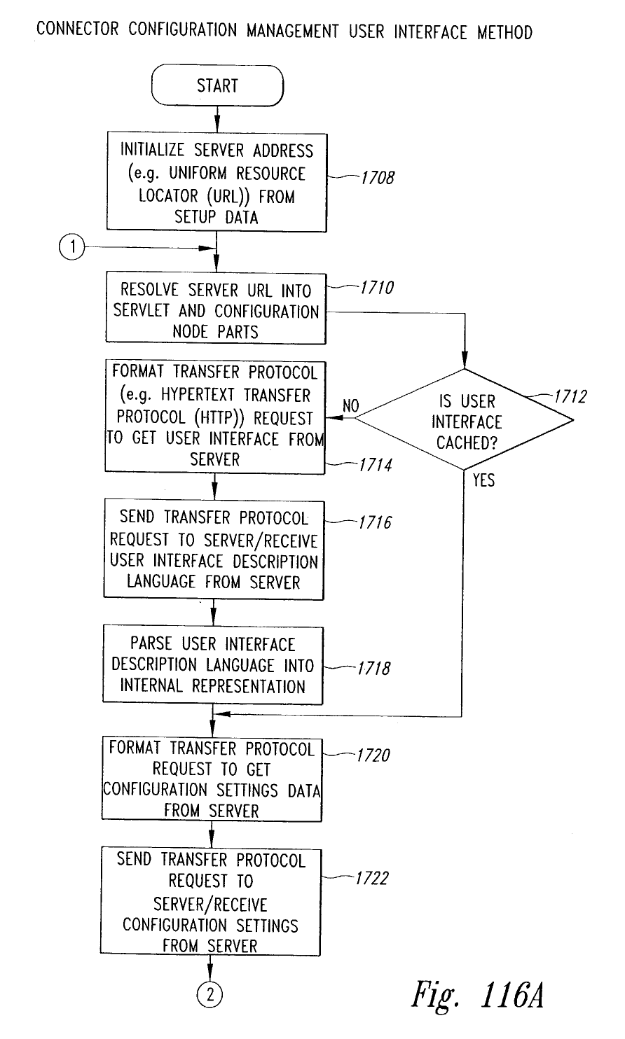

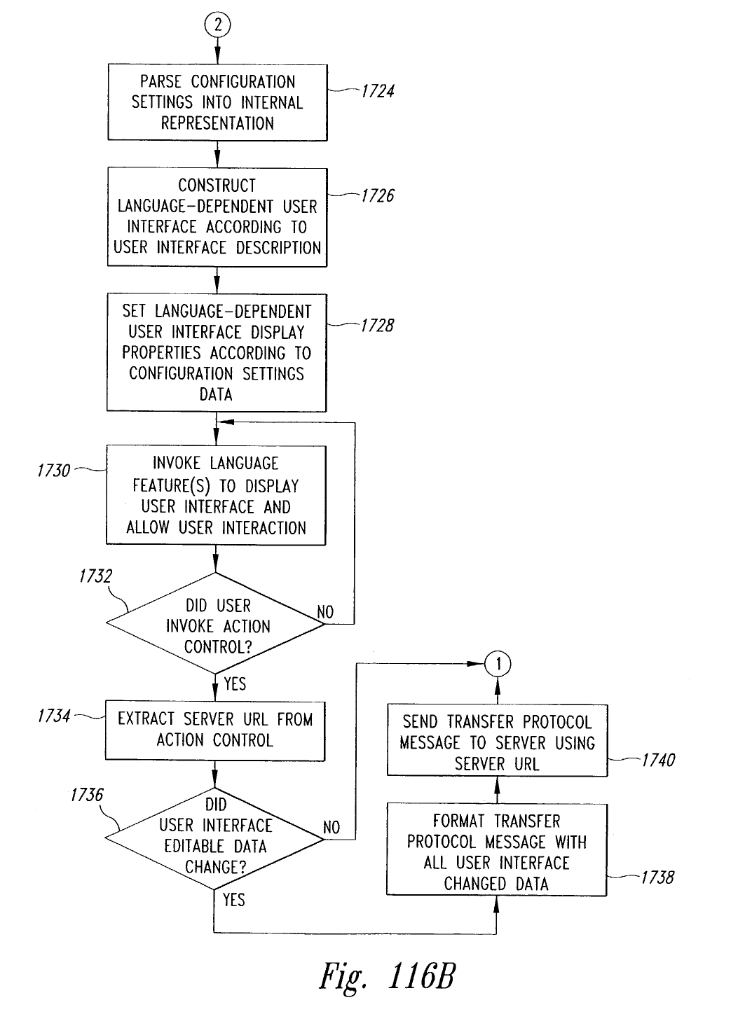

An example of a method followed by an embodiment of the connector configuration management user interface 98 is shown in FIGS. 116A and 116B. The user interface described in this method represents a generic or abstract representation of any user interface that can accommodate a number of systems and languages. This method distinguishes the data that is displayed in the user interface from the actual elements of the user interface. This is necessary so that the information that is transmitted from the connector configuration management server 96 to the user interface client consists of three things: an applet that can interpret the user interface description, a user interface description that details which elements are present on a page and where those elements are located on the page, and a description of what values are to be displayed on the user interface.

The configuration management user interface 98 begins the method by initializing a server address, such as a Uniform Resource Locator (URL), from the setup data (step 1708). After this initialization, the connector configuration management user interface 98 retrieves the user interface display by obtaining a description of the user interface fields and the different properties that make up the user interface. To obtain this description, the server address is first resolved into servlet and configuration node parts (step 1710). If the user interface is not cached (“No” branch of step 1712), the connector configuration management user interface 98 formats a transfer protocol request for the user interface (step 1714) and sends this request to the server computer 60. Upon receiving the user interface description language from the server computer 60 (step 1716), the connector configuration management user interface 98 parses the language into internal representation (step 1718), or a representation language that is directly readable by the implementation language. Examples of this internal representation could include Java objects, linked lists, arrays, and data types such as integers and strings. Once the user interface applet is downloaded and the user interface description is cached, they do not need to be re-transmitted to the client computer 10 but can be stored indefinitely, subject to memory constraints, on the client computer.

Once the connector configuration management user interface 98 parses the description language, or if the user interface is cached (“Yes” branch of step 1712), the connector configuration management user interface begins the process of retrieving the information that is displayed in the user interface. First, a transfer protocol request is formatted to obtain data from the server computer 60 concerning the configuration settings (step 1720). This request is sent to the server computer 60, and the connector configuration management user interface 98 receives the information concerning the configuration settings (step 1722). The connector configuration management user interface 98 then parses the information into internal representation (step 1724). In so doing, the connector configuration management user interface 98 converts information in an architecture-neutral format, which may be transmitted across a network, to a machine-specific format that is stored in memory. In other words, the information is converted into user interface entities that can be created on a machine. These user interface entities include calls and components that are specific to the machine on which the user interface is displayed. From the information in the user interface description, the connector configuration management user interface 98 constructs a language-dependent user interface (step 1726). This language-dependent user interface then displays properties according to the configuration settings data (step 1728).

Next, the connector configuration management user interface 98 invokes the language feature or features to display the user interface and allow user interaction (step 1730) until the user invokes an action control. This action control consists of some user interface element that indicates that the user is complete with the current user interface and that the user interface can be dismissed. For example, an action control could include “PREVIOUS,” “NEXT,” “OK,” or “CANCEL” buttons, each button having a URL that would tell the user interface what action was supposed to happen next. This URL would not be displayed to the user but would be invoked once the user selected the appropriate button.

Once the user invokes an action control (“Yes” branch of step 1734), the connector configuration management user interface 98 extracts the server address from the action control (step 1734) and determines whether the user interface editable data changed. If the data did not change (“No” branch of step 1736), the connector configuration management user interface 98 repeats the outlined method by resolving the server address into servlet and configuration node parts (step 1710).

If the user interface editable data did change (“Yes” branch of step 1736), the connector configuration management user interface 98 formats the transfer protocol message with the changed data and sends the formatted message to the server computer 60 using the server address. The connector configuration management user interface 98 then returns to resolving the server address into servlet and configuration node parts (step 1710).

The steps depicted in FIGS. 116A and 116B are exemplary and may be rearranged or combined in alternative embodiments of the connector configuration management user interface 98. For example, the process of retrieving information displayed in the user interface (steps 1720-1724) could be conducted before the process of retrieving the user interface display (steps 1712-1718).

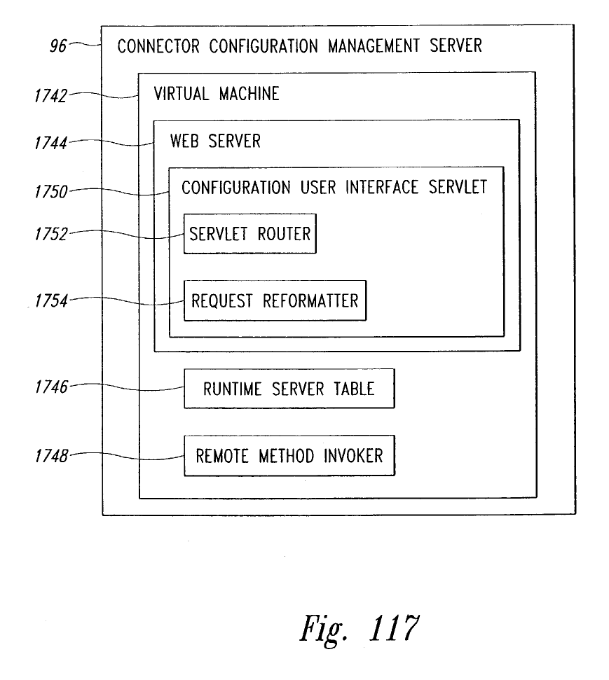

One of the purposes of the connector configuration management server 96 is to listen to a network, to receive certain requests from client computers 10, and to forward those requests to a specific screen connector runtime engine 100 that is being configured. An example of one embodiment of the connector configuration management server 96 is shown in FIG. 117 as having a virtual machine 1742. The virtual machine 1742 is running a web server 1744, a runtime server table 1746, and a remote method invoker 1748.

In the depicted embodiment of the connector configuration management server 96, the web server 1744 handles the network interfacing through HTTP and runs a Java servlet depicted in FIG. 117 as a configuration user interface servlet 1750. The configuration user interface servlet has both a servlet router 1752 and a request reformatter 1754.

When a request comes in from the web browser 1689 to configure a particular server computer 60, the configuration user interface servlet 1750 looks up the server computer in the runtime server table 1746 and converts the HTTP/XML request into a Remote Method Invocation (RMI) type request. This reformatted request is first sent to the servlet router 1752 to pick up the proper object reference and then sent through the remote method invoker 1748 to the appropriate server computer 60.

Other embodiments of the connector configuration management server 96 could use an alternative network protocol and could use different environments, other than a web server, on which to run their processing. Embodiments of the remote method invoker 1748 could use various types of object oriented message remote protocol, such as RMI, which is a Java-specific mechanism for calling remote objects, Common Object Request Broker Architecture (CORBA), Distributed Component Object Model (DCOM), or Simple Object Access Protocol (SOAP).

The requests that the connector configuration management server 96 forwards from the client computer 10 to the appropriate screen connector runtime engine 100 may consist of three types: a request that retrieves the abstract user interface description, a request that retrieves the data displayed in the user interface, and a request that forwards the changed data from the user interface to the screen connector runtime engine 100. The connector configuration management server 96 also translates between web-based HTTP requests, or other network protocols, of the client computer 10 and the object invocation request-type for the screen connector runtime engine 100. Thus, the connector configuration management server 96 routes the requests at the same time it is translating the requests from a network protocol into an object oriented protocol.

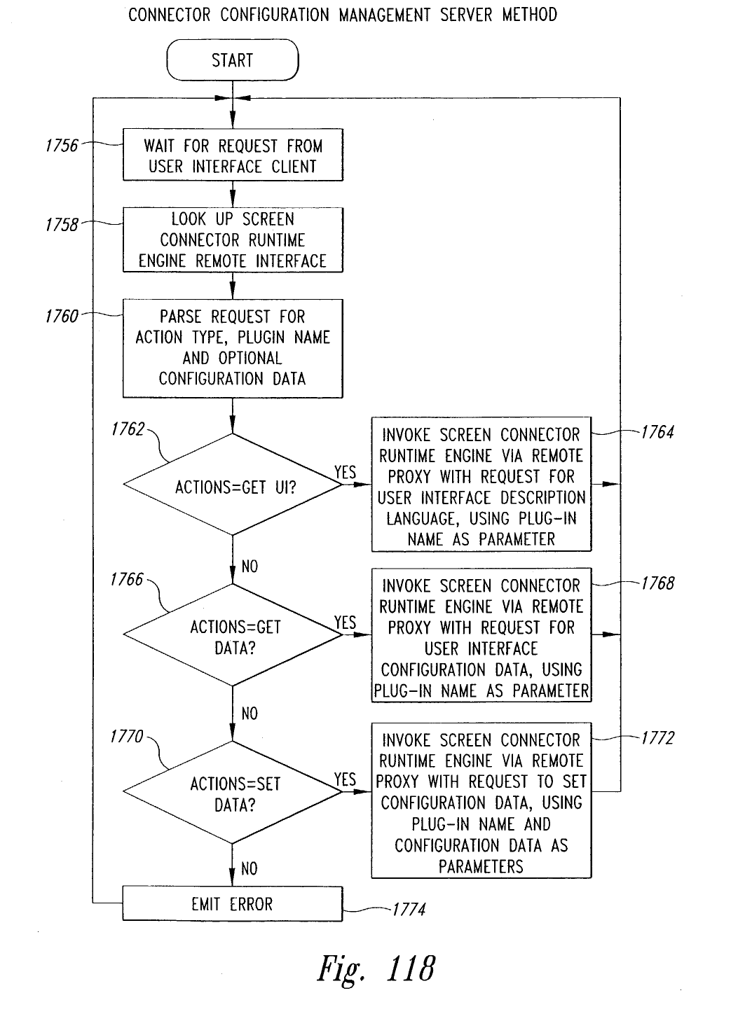

An example of an overall method that is followed by an embodiment of the connector configuration management server 96 is shown in FIG. 118. The connector configuration management server 96 begins the method by waiting for a request from a user interface client (step 1756). The connector configuration management server 96 then finds the server computer 60 that matches the request by looking up the remote interface of the screen connector runtime engine 100 (step 1758). The request is then parsed for an action type, a plugin name, and optional configuration data (step 1760).

If the action in the request is to retrieve the user interface description (“Yes” branch of step 1762), the connector configuration management server 96 invokes the screen connector runtime engine 100 via a remote proxy with a request for the user interface description language (step 1764). This get user interface request is made using the plugin name as the parameter. The connector configuration management server 96 then awaits another network request (step 1756).

If the action in the request is not to retrieve the user interface description (“No” branch of step 1762) but to retrieve data that is displayed in the user interface (“Yes” branch of step 1766), the connector configuration management server 96 invokes the screen connector runtime engine 100 via a remote proxy with a request for user interface configuration data (step 1768). This get data request is also made using the plugin name as the parameter. The connector configuration management server 96 then returns to wait for another network request (step 1756).

If the action requested is to set the data in the user interface (“Yes” branch of step 1770), the connector configuration management server 96 uses both the plugin name and the configuration data as parameters to invoke the screen connector runtime engine 100 with a request to set the configuration data in the user interface (step 1722). The connector configuration management server 96 then awaits another network request (step 1756).

If the action type does not fall into the three actions described above (“No” branch of step 1770), the connector configuration management server 96 emits an error and awaits another request from the user interface client (step 1756).

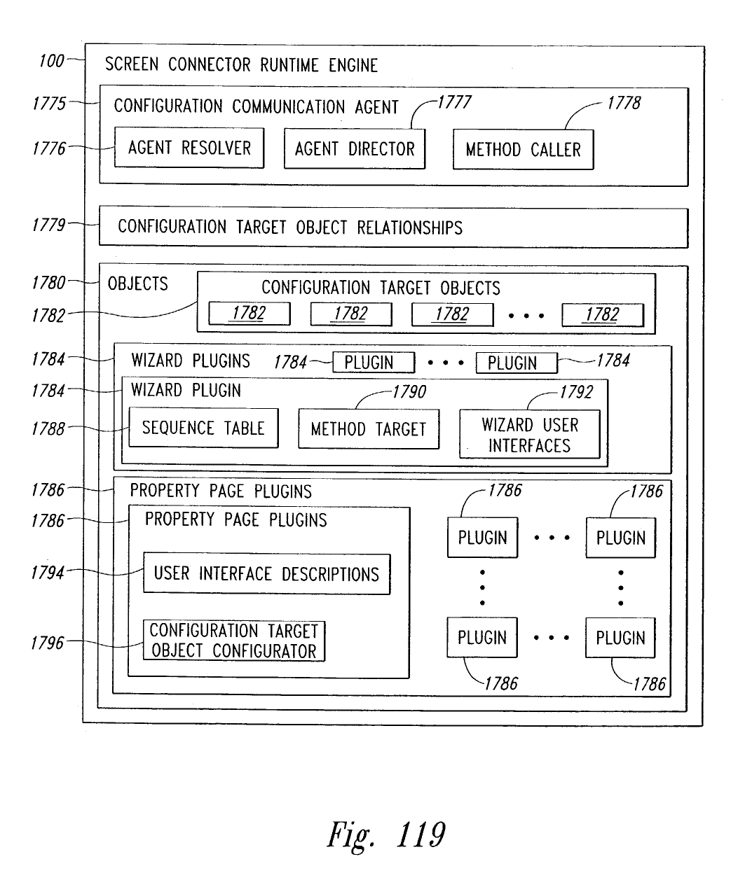

A schematic diagram of an embodiment of the screen connector runtime engine 100 is depicted in FIG. 119 as having a configuration communication agent 1775 containing an agent resolver 1776, an agent director 1777, and a method caller 1778. The configuration communication agent 1775 serves as the main entry point for configuration requests, which come from the connector configuration management user interface 98 through the connector configuration management server 96. The agent resolver 1776 receives the request and determines which object needs to be configured, and the agent director 1777 sends the method call to the correct plugin that configures the object.

The screen connector runtime engine 100 is further comprised of configuration target object relationships 1779 and objects 1780, which include configuration target objects 1782, wizard plugins 1784, and property page plugins 1786.

Each wizard plugin 1784 contains a sequence table 1788, a method target 1790, and wizard user interfaces 1792, an example of which could be the new pool wizard first page 1502 that is shown in FIG. 101A. Other pages that appear during a wizard are shared with pages that appear when configuring existing objects. An example of a shared page is the new pool wizard second page 1512, as shown in FIG. 102A, which shows the session pool settings during a wizard. The sequence table 1788 refers to other plugins that are also shown during a wizard invocation. For instance, the sequence table 1788 could describe the specific sequence of dialogues shown in FIGS. 102-105. The sequence table 1788 also refers to the property page plugins 1786, each containing user interface descriptions 1794 and a configuration target object configurator 1796.

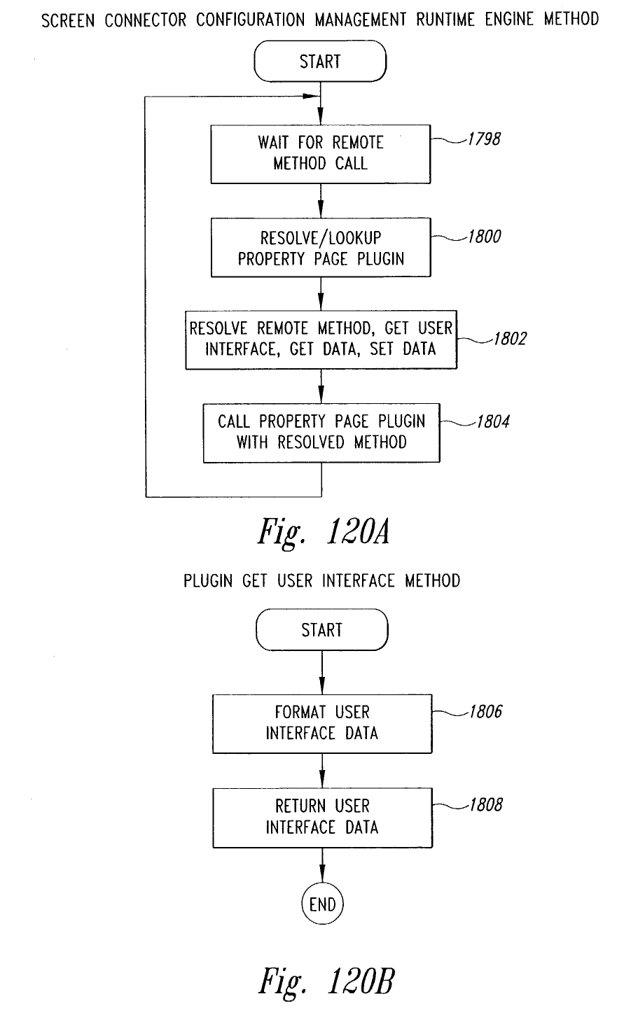

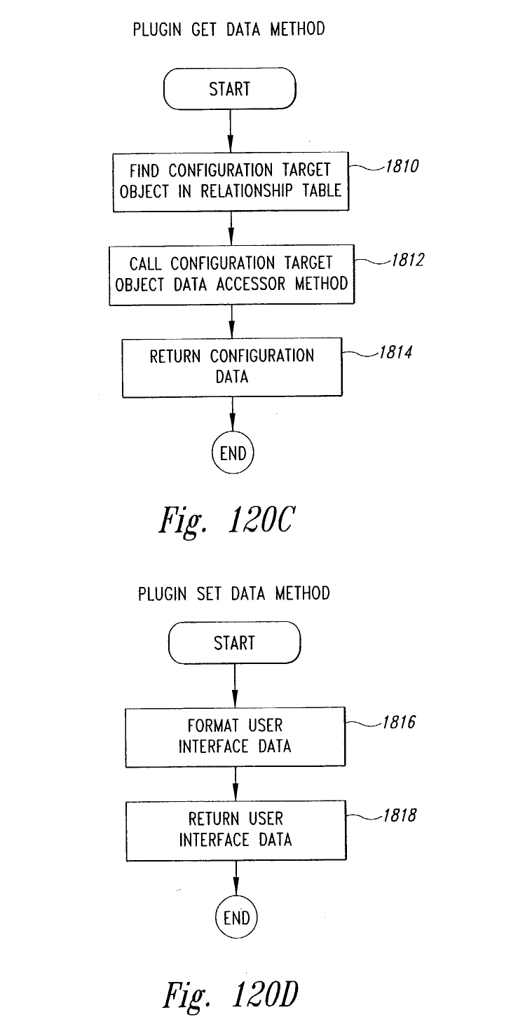

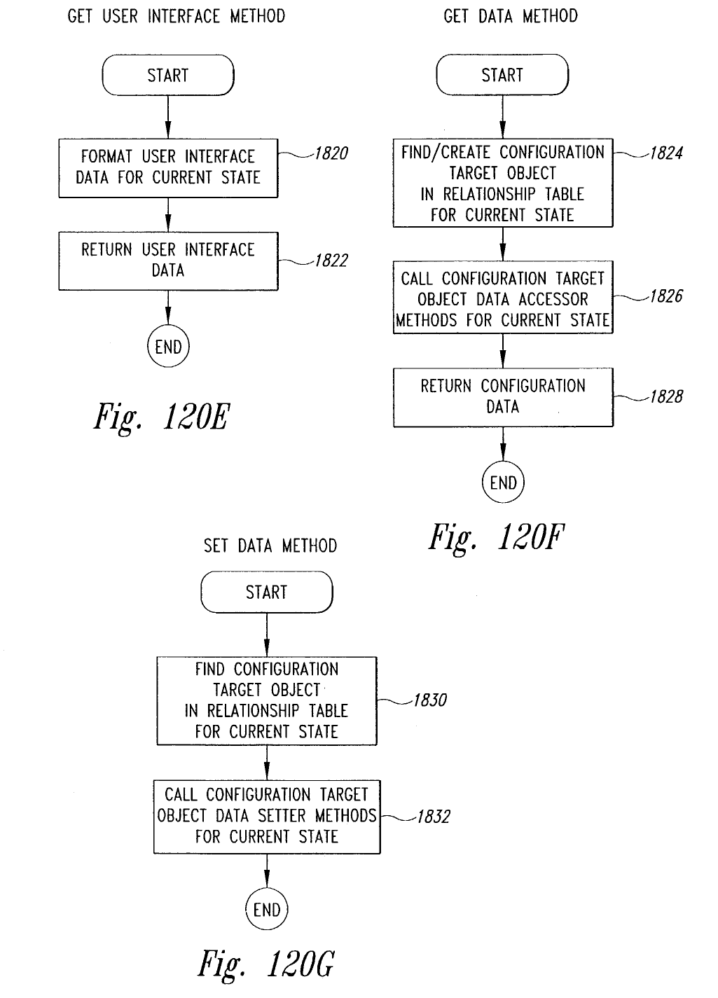

The configuration communication agent 1775 is used to handle remote method calls to the screen connector runtime engine 100. An example of a method followed by the configuration communication agent 1775 is illustrated in FIG. 120A. The screen connector runtime engine 100 on the server computer 60 waits for a remote method call from the connector configuration management server 96 (step 1798). This remote method call could be any of the three calls described in the method shown in FIG. 1118 (steps 1764, 1768, and 1772). When the screen connector runtime engine 100 receives the remote method call, the agent director 1777 of the configuration communication agent 1775 resolves who is calling and looks up the appropriate property page plugin 1786 named in the parameters of the remote method call (step 1800). The name of the property page plugin 1786 could be a name string or other identifier string with unique identifiers used for each property page plugin. For example, the property page plugin name could consist of a letter ranging from A to Z, or the property page plugin name could be included in a lookup table and referenced by integers.

Next, the agent resolver 1776 resolves the remote method, which could include a request to retrieve the user interface, get data, or set data (step 1802). As with the property page plugin names, this method name could be any sort of unique identifier, such as a string or an integer index to a lookup table. Once the method is resolved, the method caller 1778 calls a specific property page plugin 1786 to carry out the resolved method (step 1804).

The steps represented in FIG. 120A are exemplary and may be combined or rearranged in other embodiments of the invention. For instance, in an alternative embodiment of the screen connector runtime engine 100, steps 1802 and 1804 could be combined into one step that uses a switch statement to concurrently resolve and call the methods. This type of switch statement is available in most high-level languages, and in such a situation, the agent resolver 1776 and the method caller 1778 could be merged into one component.

One of the methods resolved by the configuration communication agent 1775 and carried out by the property page plugin 1786 is a get user interface method as shown in FIG. 120B. When called, the property page plugin first 1786 formats the appropriate user interface description (step 1806). This user interface description corresponds to the type of dialogue that is being displayed on the client computer screen, the locations of the controls, and the sizes and positions of various user interface components. Depending on the embodiment of the invention, the property page plugin 1786 could use any of various formatting languages in carrying out the method. Examples of different formats could include XML, binary, or display postscript. Once the user interface description is formatted, the property page plugin 1786 returns the user interface description to the user through the connector configuration management user interface 98 (step 1808) and ends the method.

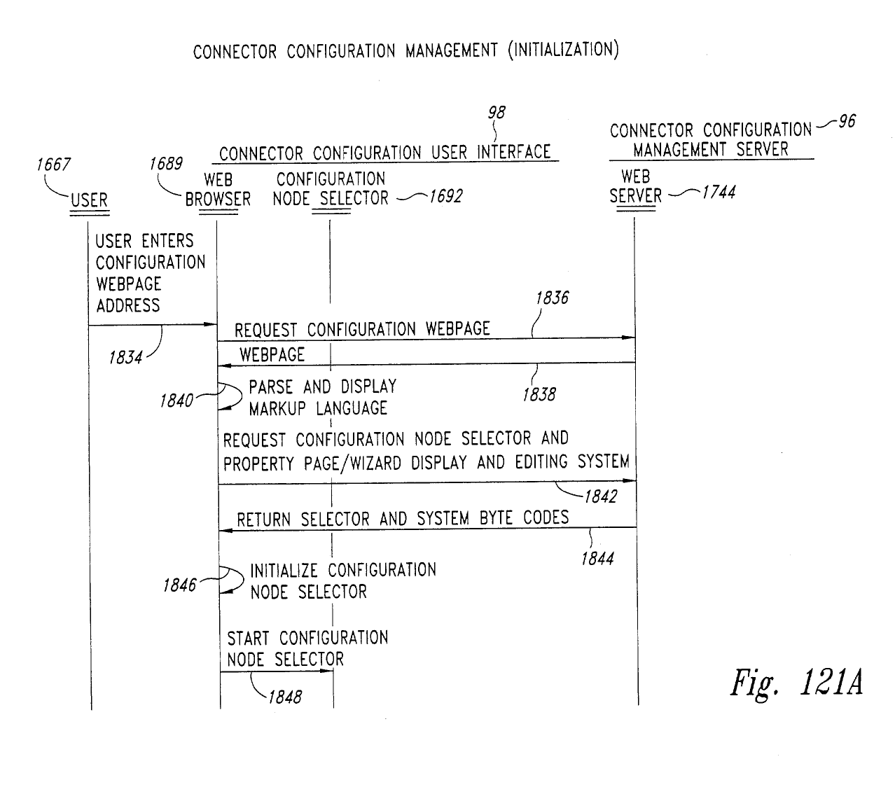

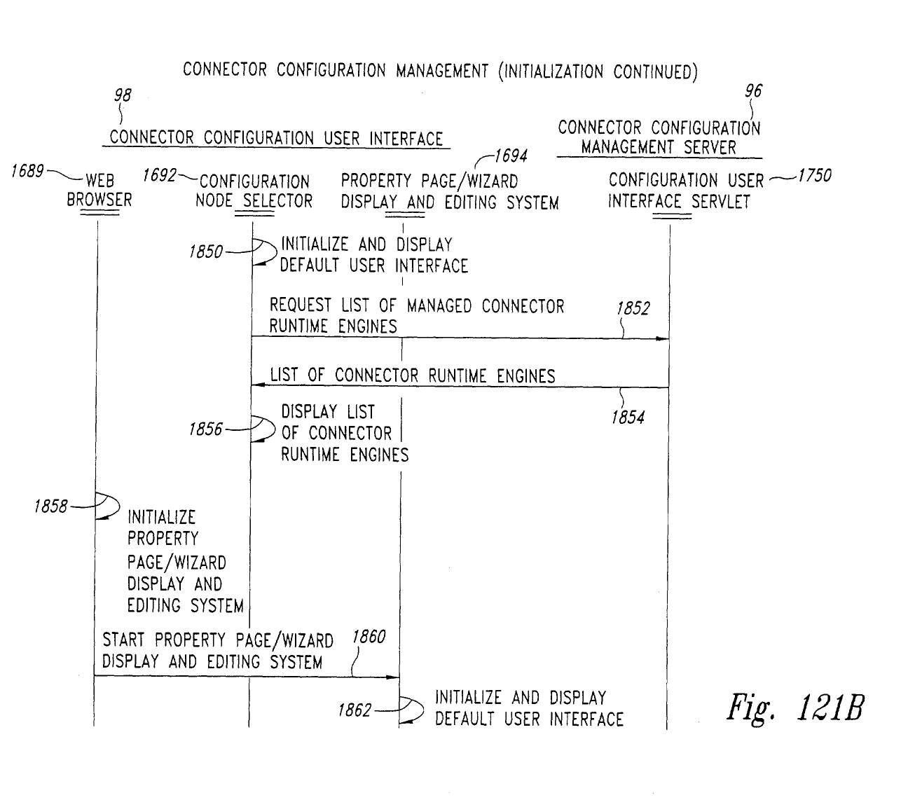

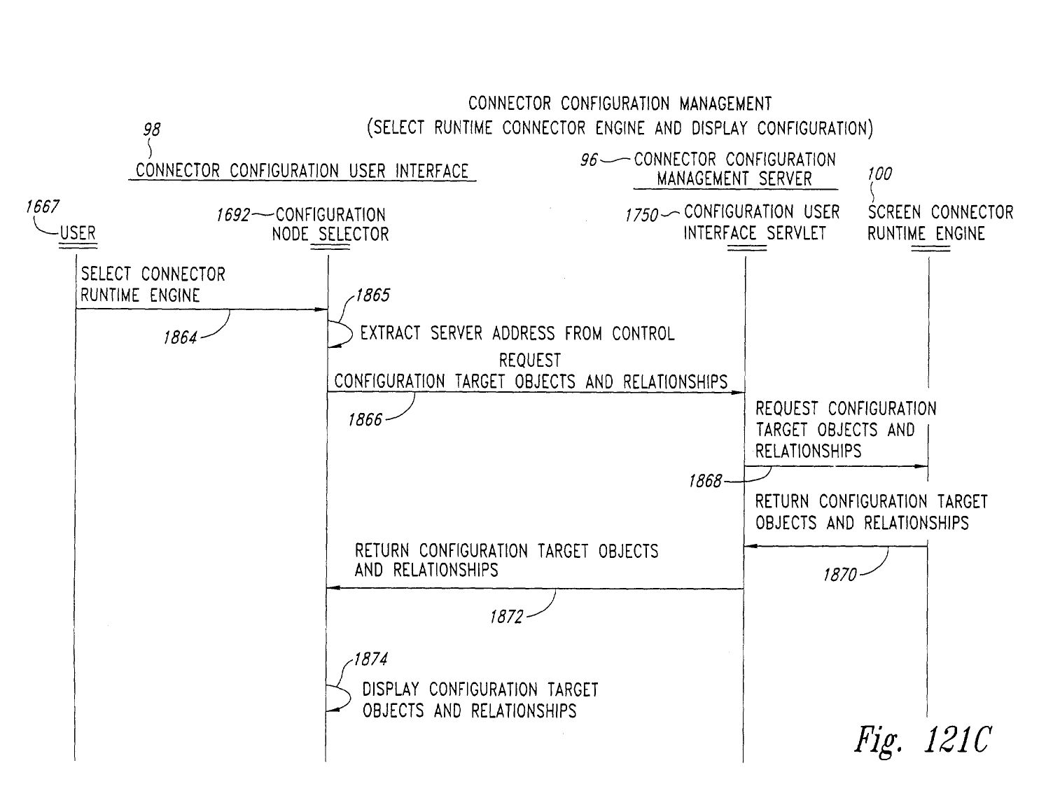

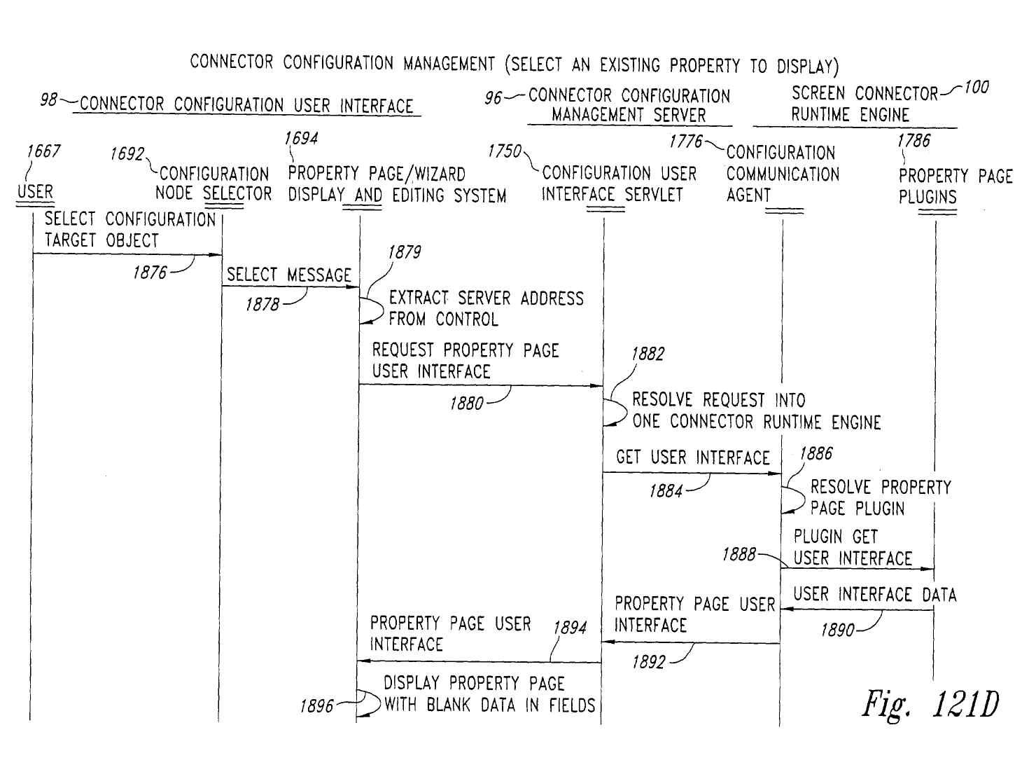

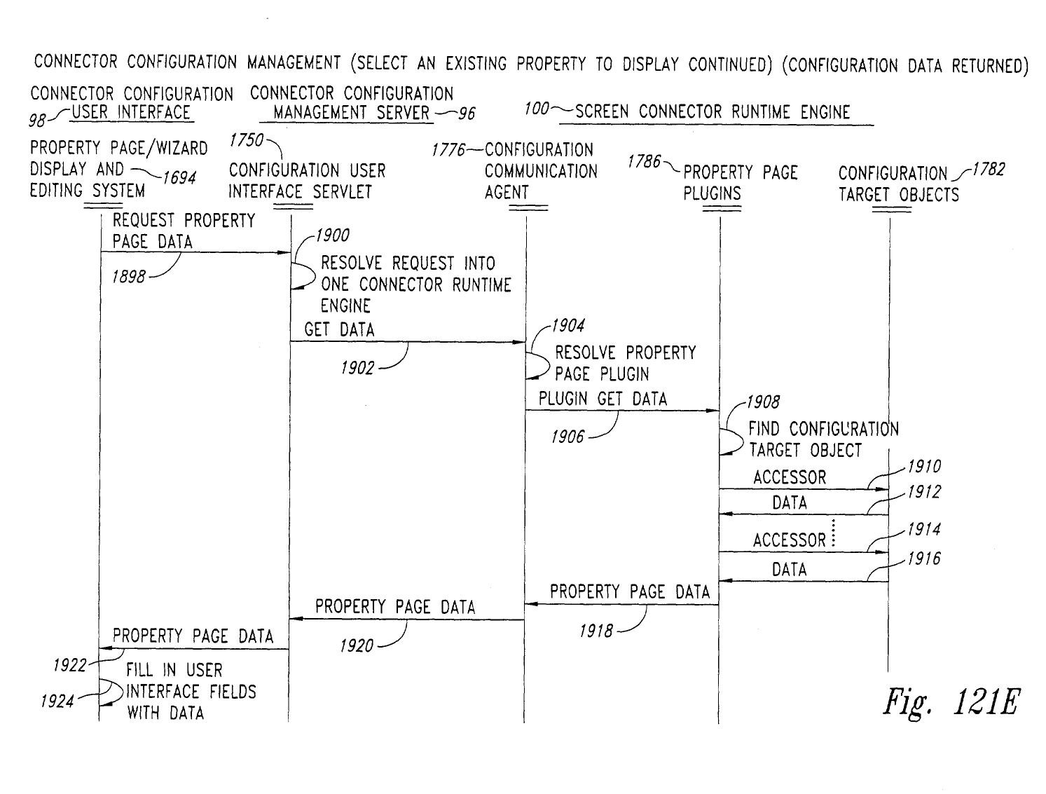

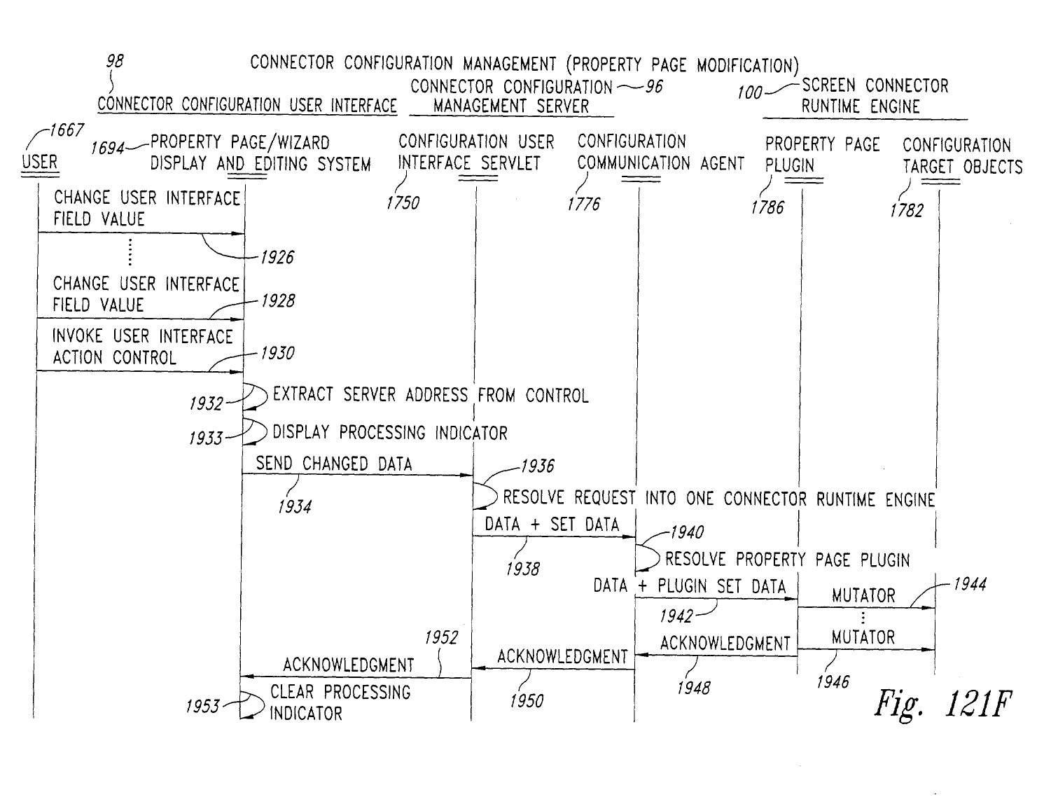

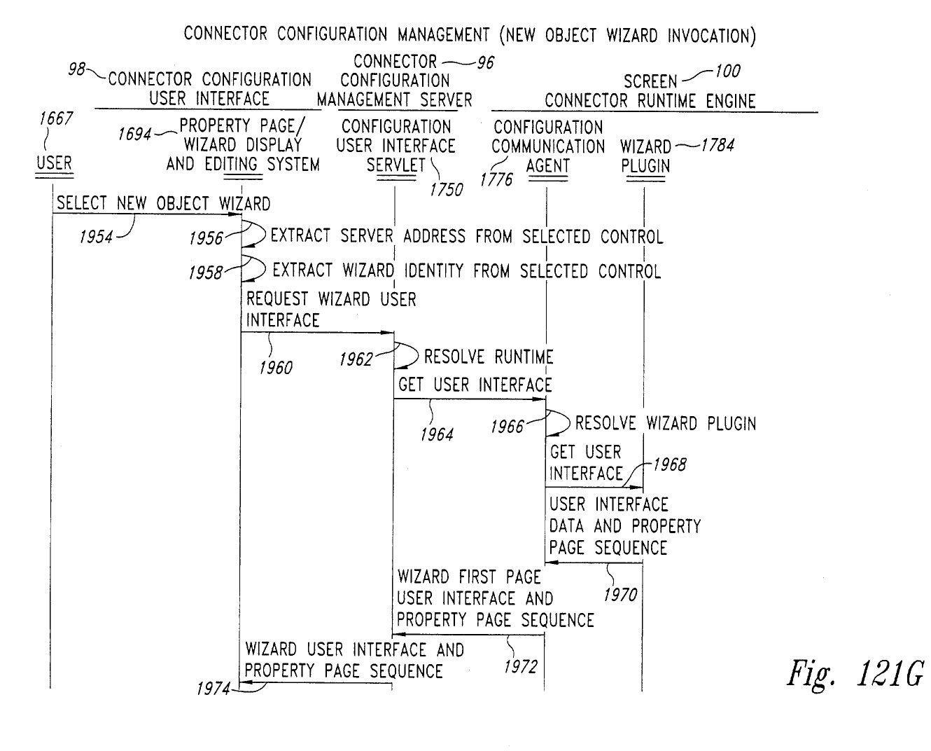

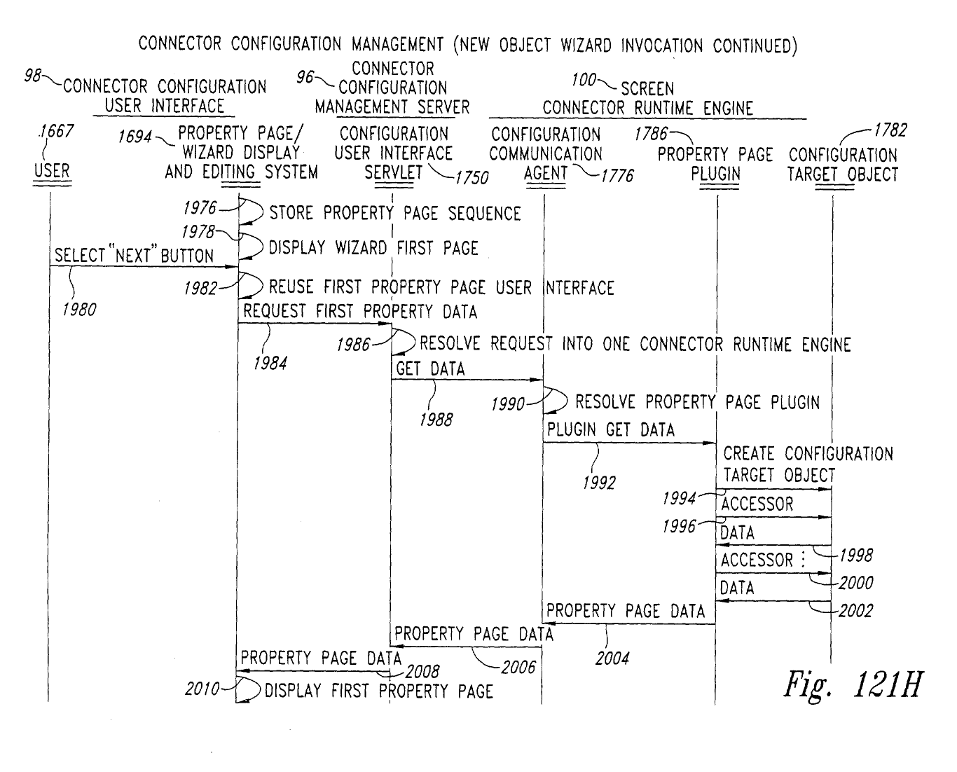

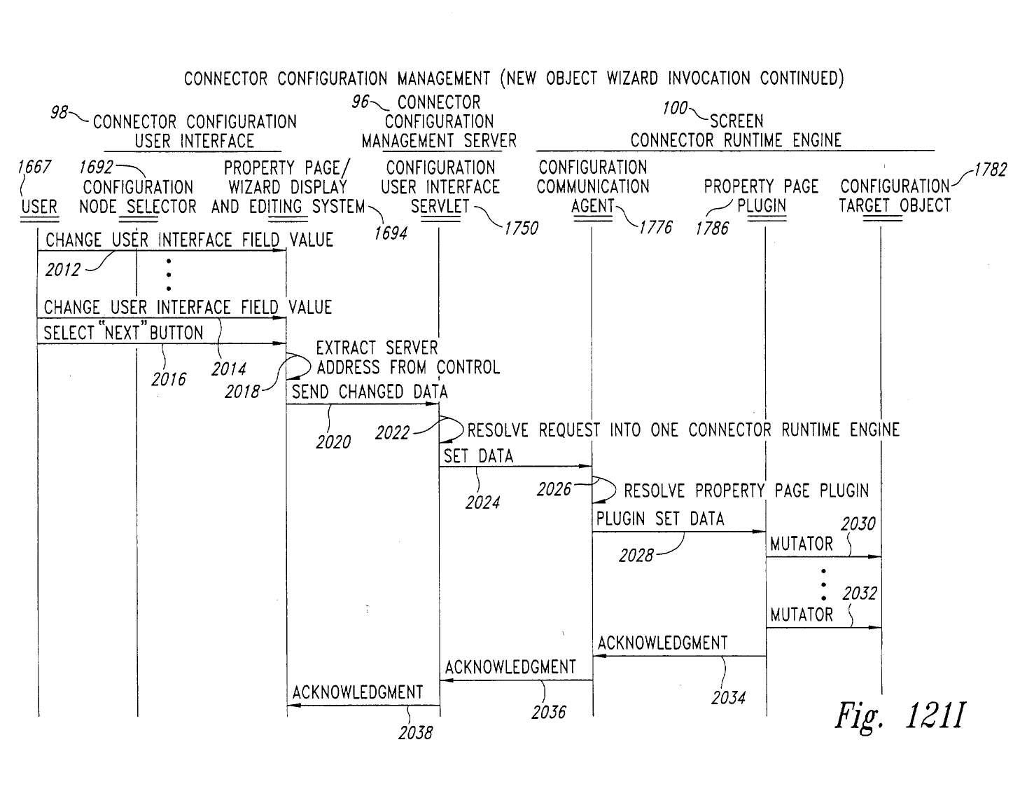

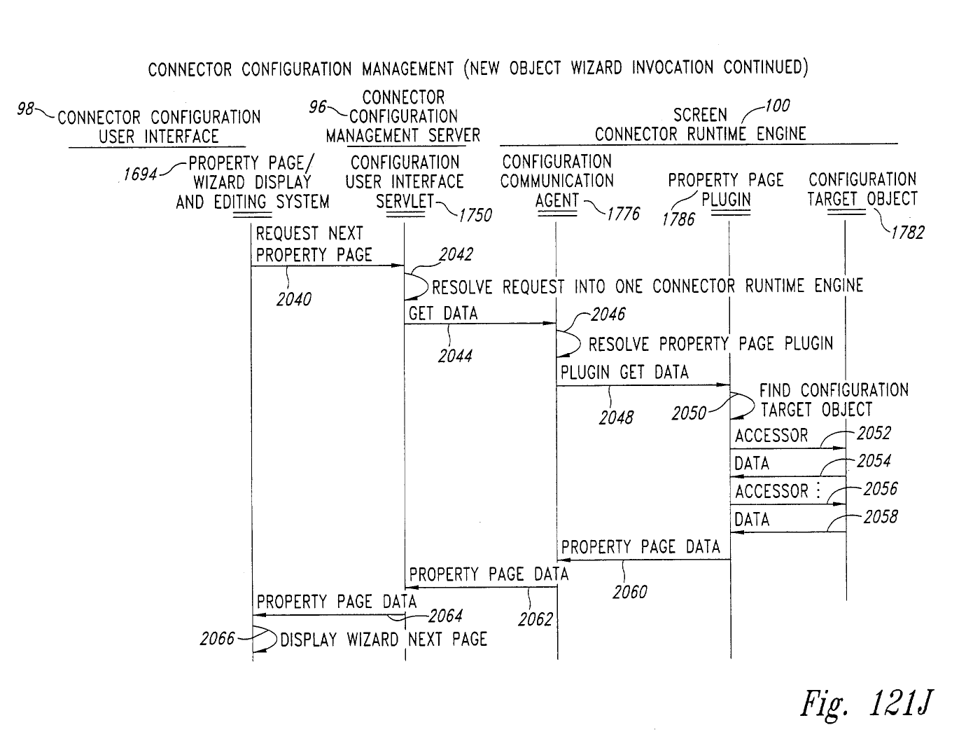

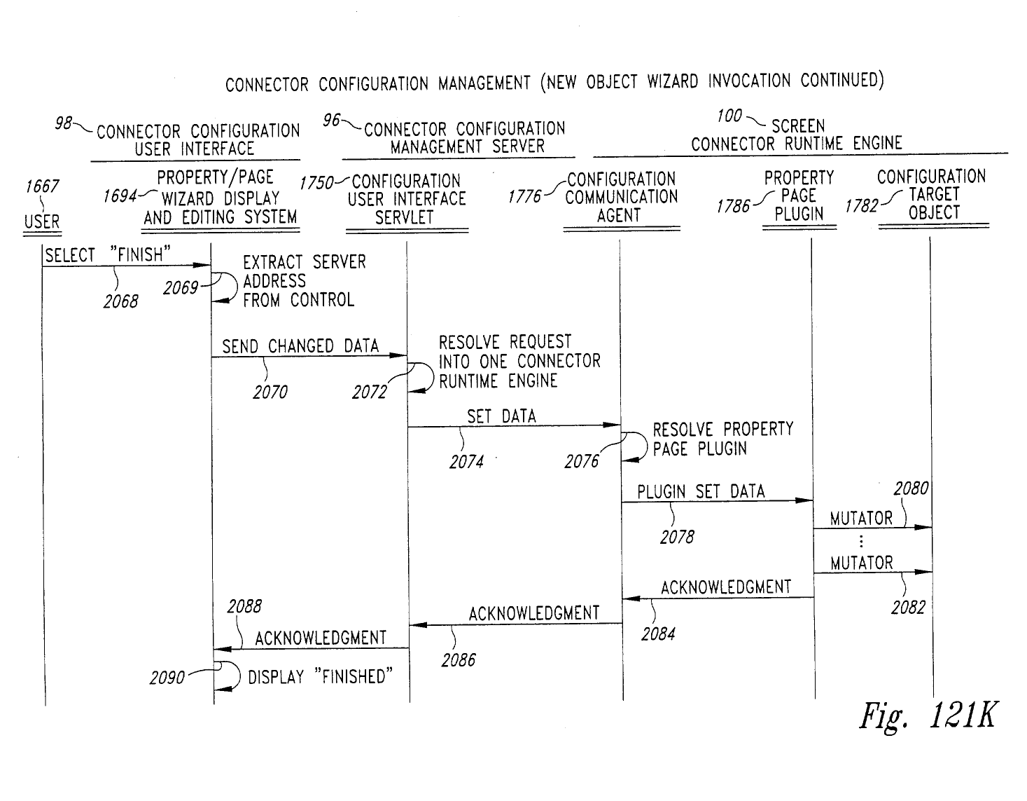

After the user interface description has been retrieved, a second method, which is displayed in FIG. 121C, is carried out by the property page plugin 1786 to get the user interface data. This user interface data relates to the actual values that are stored in the user interface. First, the property page plugin 1786 must find the appropriate configuration target object 1782 in the table of configuration target object relationships 1779 (step 1810). Although a table is used in this embodiment of the invention, other embodiments could use other forms that describe relationships between objects, such as a database or list of links. Once the property page plugin 1786 has found the appropriate configuration target object 1782, the property page plugin calls the configuration target object data accessor methods (step 1812). Because the configuration target object 1782 contains the data for the runtime system, calling the data accessor methods retrieves the runtime setting for some particular value, or retrieves a master copy of the configured information on the runtime engine. After the data accessor methods are called, the property page plugin returns the configuration data to the connector configuration management user interface 98 (step 1814), which configuration data tells the user interface where specific data is supposed to go in a particular browser.

FIGS. 120B and 120C show separate methods for retrieving the user interface description and the user interface content. If the two methods were carried out at a delayed pace, the user would first see a blank user interface on the client computer monitor 48 and then would see the user interface being filled in with data in the appropriate locations. For example, a text box and its position on a screen would be sent before a number that goes in the text box. After the user has both the user interface description and the user interface data, the user may work with or modify the user interface information. For instance, the user may want to view or update data concerning the host address contained in the user interface.

Once the user has finished working with the retrieved user interface information, the property page plugin 1786 is called to carry out a set data method, which is depicted in FIG. 120D. This set data method sends back the modified user interface information to the screen connector runtime engine 100. First, the property page plugin 1786 formats the user interface data (step 1816), and then it returns the user interface data to its appropriate location in the runtime system (step 1818).

The methods shown in FIGS. 120E-120G for wizard plugins 1784 parallel the methods shown in FIGS. 120B-120D for property page plugins 1786. A difference between the two method sets is that wizards usually have distinct states and the user interface must keep track of which wizard state, with its associated user interface information, is being displayed. This information could be stored in property page/wizard display and editing system 1694 of the browser application 1689. For example, wizards typically have a “start” state, “next” states, and a “finish” state, and the property page/wizard display and editing system 1694 would need to know when to display “NEXT,” “PREVIOUS,” or “FINISH” buttons in the connector configuration management user interface 98.

A get user interface method for the wizard plugin 1784, which parallels the method of FIG. 120B, is shown in FIG. 120E. First, the wizard plugin 1784 formats the user interface description for a current state (step 1820). After the formatting is complete, the wizard plugin 1784 returns the user interface description to the connector configuration management user interface (step 1822).

A get data method for the wizard plugin 1784 is shown in FIG. 120F, which differs slightly from the get data method for a property page plugin 1786. Typically, a wizard is initiated when the user wants to create a new “thing” or carry out a new process. In this situation, no configuration target object 1782 would exist as to the new “thing” or the new process. Thus, the wizard plugin 1784 begins the get data method by searching for a configuration target object 1782 in the table of configuration target object relationships 1779, and if the wizard plugin cannot find the appropriate configuration target object, a new configuration target object is created (step 1824). The wizard plugin 1784 then calls the configuration target object data accessor methods for the current state (step 1826) and returns the configuration data to the connector configuration management user interface 98 (step 1828).

The set data method for the wizard plugin 1784 shown in FIG. 120G mirrors the property page plugin method of FIG. 120D. First, the wizard plugin 1784 finds a configuration target object 1782 in the table of configuration target object relationships 1779 (step 1830). The wizard plugin 1784 then calls the configuration target object data setter methods for the current state (step 1832) and ends the method.

The initialization of a connector configuration management system is depicted in a data flow diagram in FIGS. 121A and 121B. This initialization process includes the user 1667 interacting with the connector configuration management user interface 98, which is networked to the connector configuration management server 96 and includes both the web browser 1689 and the configuration node selector 1692. First, the user 1667 enters a configuration webpage address into the web browser 1689 (step 1834), and the web browser automatically requests a configuration webpage from the web server 1744 (step 1836), which is part of the connector configuration management server 96. The web server 1744 then returns the webpage (step 1838), which contains generalized markup, such as the text on the page, the background, the colors, and other descriptive information. This retrieved webpage, however, does not contain the configuration node selector 1692 or the property page/wizard display and editing system 1694.

Next, the web browser 1689 parses the markup language and puts the text on the screen (step 1840). When parsing the markup language, the web browser 1689 also retrieves information regarding active code components, which include the configuration node selector 1692 and the property page/wizard display and editing system 1694. From this information, the web browser 1689 requests both the configuration node selector 1692 and the property page/wizard display and editing system 1694 from the web server 1744 (step 1842). In other embodiments of the connector configuration management system, this request could be broken in two or more requests. For instance, if each of the active code components was located in a separate file, the request from the web browser 1689 could be split in two requests, one for each file. One could also have multiple requests for individual components within each active code component, such as would occur with individual byte code files for Java applets.

After the web server 1744 returns the configuration node selector 1692 and system byte codes relating to the property page/wizard display and editing system 1694 (step 1844), the web browser 1689 initializes the configuration node selector 1692 (step 1846). After the configuration node selector 1692 is started (step 1848), it initializes and displays a default user interface (step 1850) such as a blank screen or a screen with default data. The configuration node selector 1692 then requests a list of managed screen connector runtime engines 100 from the configuration user interface servlet 1750 (step 1852), which list is subsequently displayed on the client computer 10.

Next, the web browser 1689 initializes (step 1858) and starts (step 1860) the property page/wizard display and editing system 1694. Finally, the process ends with the property page/wizard display and editing system 1694 initializing and displaying a default user interface (step 1862). This default use interface could also be a blank screen or a screen with default data. Thus, at the end of this process, there is a list of screen connector runtime engines 100 that is being displayed to the user 1667 and can be selected from by the user.

The steps depicted in FIGS. 121A and 121B are meant to serve as an example of a process and, in other embodiments of the connector configuration management system, may be combined or reordered. For example, in an alternative structure of the process, the property page/wizard display and editing system 1694 could be initialized before the configuration node selector 1692 is initialized.

The process of selecting the screen connector runtime engine 100 and displaying its configuration is illustrated in FIG. 121C. First, the user 1667 selects a screen connector runtime engine 100 from the available list (step 1864). The configuration node selector 1692 then extracts the server address from a control (step 1865) and requests the configuration target objects 1782 and the configuration target object relationships 1779 from the configuration user interface servlet (step 1866). The control is one of the user interface components that can be displayed on a screen for the user 1667, and the configuration node selector 1692, at any point in time, has some set of controls active on the screen. Each control is represented by a data structure in memory and is associated with a server address. This server address, such as a URL, is what the configuration node selector 1692 extracts in step 1865.

Next, the configuration target objects 1782 and configuration target object relationships 1779 are requested from (step 1868) and returned by (step 1870) the screen connector runtime engine 100. These configuration target objects 1782 and the configuration target object relationships 1779 are returned to the configuration node selector 1692 (step 1872) and displayed on the connector configuration management user interface 98 for the user 1667 (step 1874). These configuration target object relationships 1779 could be any type of relationship between objects, such as graph of links from object to object or a tree connection showing a hierarchy of nodes.

Once the list of configuration target objects 1782 is displayed on the connector configuration management user interface 98, the user 1667 is able to choose a configuration target object to configure. This process is outlined in FIG. 121D. First, the user 1667 selects a configuration target object 1782 (step 1876), an example of which could be a host connection properties page. In this instance, the host connection properties page could be represented as a node in a tree diagram. The configuration node selector 1692 then sends a message over to the property page/wizard display and editing system 1694 (step 1878) indicating the selection of the user.

In the described embodiment, the configuration node selector 1692 and the property page/wizard display and editing system 1694 are represented as two different active components of a webpage, and the selection message would be an applet-to-applet message. In alternative embodiments of the invention, however, these two active components could be merged into one component, in which case the nature of the selection message would be different. The selection message could also be a different type of communication, such as a direct method call.

Once the selection message is received, the property page/wizard display and editing system 1694 extracts the associated server address from the control (step 1879) and requests a property page user interface (step 1880). The configuration user interface servlet 1750 resolves this request for a particular screen connector runtime engine 100 (step 1882) and sends a message to the configuration communication agent 1776 of the screen connector runtime engine to get the user interface (step 1884). This message is examined by the configuration communication agent 1776, and a particular property page plugin 1786 is associated with the request (step 1886).

Next, the get user interface method, which is outlined in FIG. 120B is invoked (step 1888) and the property page plugin 1786 returns the user interface data (step 1890), which data is returned back to the connector configuration management server 96. Finally, the property page user interface data is returned to the property page/wizard display and editing system 1694 (step 1894) and is displayed on the screen for the user 1667 with blank data in the fields (step 1896).

A second phase of selecting an existing property to display, in which the empty user interface fields are filled in with data, is shown in FIG. 121E. In this process, actual configuration settings are returned to the property page/wizard display and editing system 1694. First, the property page/wizard display and editing system 1694 requests some property page data (step 1898). Next, the configuration user interface servlet 1750 resolves the request for one screen connector runtime engine 100 (step 1900) and sends a get data request (step 1902). The configuration communication agent 1776 then resolves which particular property page plugin 1786 is to be associated with the request (step 1904) and calls the get data method, as outlined in FIG. 120C, for the property page plugin (step 1906). The property page plugin 1786 would also have the information regarding the identification of the configuration target object 1782 that is to be selected.

Once the appropriate configuration target object 1782 is selected (step 1908), accessor data methods can be called on the configuration target object and data can be returned from the configuration target object into the property page plugin 1786 (steps 1910-1916). This process is carried out by the configuration target object configurator 1796, which determines which accessor methods are to be invoked. Once all the requested data is recovered, it is returned to the configuration communication agent 1776 (step 1918), to the configuration user interface servlet 1750 (step 1920), and then to the property page/wizard display and editing system 1694 (step 1922). Finally, the user interface fields are filled in with the data retrieved by the configuration target object 1782 (step 1924). In other words, the blank page, or some page with default values, that was being displayed to the user 1667 is updated with the appropriate field values.

In an alternative embodiment of the connector configuration management system, the property page/wizard display and editing system 1694 could wait to display any property page until all the valid data was gathered by the configuration target object 1782. As a result, step 1896 could be omitted from the display process.

Once all the data is being displayed, the user 1667 has the opportunity to modify a property on the property page through a process outlined in FIG. 121F. The user 1667 can modify one user interface field value, modify several user interface field values, or modify one user interface field value multiple times (steps 1926-1928). The user 1667 indicates completion of the modification process by selecting some action control from the user interface (step 1930), such as an “OK” button or other control. Next, the property page/wizard display and editing system 1694 extracts the associated server address from the control (step 1932). While the system is processing the data, an optional step could be included that would display some type of processing indicator alerting the user 1667 that the system is busy (step 1933). Examples of such an indicator could be changing a cursor to an hourglass shape or displaying a message on the screen that would be dismissed when the data was returned.

Once the server address is extracted, the property page/wizard display and editing system 1694 sends the user-modified data out to the connector configuration management server 96 (step 1934). The configuration user interface servlet 1750 decides to which screen connector runtime engine 100 the modified data is to be sent (step 1936) and sends the data (step 1938). The configuration communication agent 1776 then resolves which property page plugin 1786 is to be used (step 1940), and the particular property page plugin 1786 is called with the set data method (step 1942) depicted in FIG. 120D. The property page plugin 1786, having all the modified data from the user interface fields, changes the data in the configuration target object 1782 through mutator method calls (steps 1944-1946). The particular association between the set data method and which series of mutator methods is called is created by the configuration target object configurator 1796. After all the mutator methods are called and the configuration target object 1782 is configured, an acknowledgment of the changes is sent back to the property page/wizard display and editing system 1694 (steps 1948-1952). If the processing indicator was used to notify the user 1667 that the system was busy (step 1933), it is cleared when the acknowledgement is returned that the proper modifications have been made (step 1953).

In some instances, property modification can be allowed or disallowed for a particular property page, and the property page wizard can have states for each property page that will allow or disallow editing. If the editing mode is not allowed, then the process outlined in FIG. 121F would not be invoked because it would be impossible for the user interface field values to be changed; if the user interface field values were changed, it wouldn't be possible to invoke an action control. Hence, this process is a relatively simple way to implement a read-only mode for some properties on the system.

A new object wizard is used to create a new object or multiple new objects and to set certain properties on the object or objects using the property pages. An example of a process followed by the connector configuration management system when invoking the new object wizard is outlined in FIGS. 121G-121K. The user 1667 begins this process by selecting the new object wizard (step 1954), which object wizard selector itself is a control found somewhere on the property page. Next, the property page/wizard display and editing system 1694 extracts both a server address (step 1956) and a wizard identity (step 1958) from the selected control. The wizard user interface 1792 is then requested from the configuration user interface servlet 1750 (step 1960). The configuration user interface servlet 1750 resolves the proper screen connector runtime engine 100 (step 1962) and makes a request to get the user interface (step 1964). The configuration communication agent 1776 resolves the correct wizard plugin 1784 for the request (step 1966) and then calls the get user interface method, shown in FIG. 120E, for the appropriate wizard plugin 1784 (step 1968).

Once the wizard plugin 1784 has retrieved the user interface description and its associated property page sequence, the user interface description and property page sequence are returned to the configuration communication agent 1776 (step 1970). A wizard first page user interface and the associated property page sequence identification are next returned to the configuration user interface servlet 1750 (step 1972) and then sent to the property page/wizard display and editing system 1694 (step 1974). The property page sequence is subsequently stored (step 1976), and the wizard first page is displayed to the user 1667 (step 1978). The connector configuration management system then waits for another user action.

The user 1667 has the opportunity to make certain selections or modifications through the connector configuration management user interface 98. At some point, to indicate completion of the user modification, the user 1667 selects the “NEXT” button from the menu controls (step 1980). Assuming that the property page user interface descriptions were previously retrieved, as in step 1894, and cached on the property page/wizard display and editing system 1694, the first property page user interface would be reused and displayed to the user 1677 (step 1982). This data could be cached in multiple ways. For instance, the actual user interface data that was retrieved could be saved, or the user interface objects or data structures that were constructed could be saved, thus caching the entire user interface in some kind of native format. If the property page hasn't been previously downloaded, then the connector configuration management system would repeat steps 1879-1896 to retrieve the appropriate user interface.

Once the property page has been retrieved, the connector configuration management system must retrieve the data to display on the property page. To do so, the connector configuration management system follows a similar process to the one outlined in FIG. 121E. The property page/wizard display and editing system 1694 requests the first page of property data from the configuration user interface servlet 1750 (step 1984), and the configuration user interface servlet determines which screen connector runtime engine 100 needs to be the target of the request (step 1986). Next, the get data request is sent to the configuration communication agent 1776 (step 1988), and the correct property page plugin 1786 is resolved (step 1990). The get data method is then invoked on the resolved property page plugin 1786 (step 1992). If a particular configuration target object 1782 is not found, the configuration target object may be created (step 1994), which is a chief difference from the process shown in FIG. 121E.

After finding or creating the appropriate configuration target object 1782, the accessor methods are invoked and the data is returned (steps 1994-2002) to assemble the property page data. The property page data is then returned back to the property page/wizard display and editing system 1694 (steps 2004-2008) and displayed in the first property page (step 2010). This data that is returned is not necessarily blanks or zeros, but is the default data that is defined by the configuration target object 1782 that was created in step 1994. These default values could be any values that were built into the configuration target object 1782 when the configuration target object was created by a programmer.

The user 1667 is then allowed to interact with the property page by changing user interface field values (step 2012-2014) and move to the next property page by selecting the “NEXT” button (step 2016). When the user 1667 selects the “NEXT” button, the connector configuration system must do two things: send in a change data request for the current property page and make a get data request for the next property page. The change data process is shown in steps 2018-2038 and is identical to the process depicted in FIG. 121F (steps 1932-1953) except that the optional processing indicator is not displayed. The get data process for the subsequent property page (steps 2040-2066) parallels the process for displaying an existing property page (steps 1898-1924).

The process outlined in FIGS. 121I and 121J (steps 2012-2066) can be repeated for each subsequent property page in the wizard. For instance, for a wizard that was four pages long, the process would be repeated three times. Once the user 1667 reaches the final property page in the wizard, instead of selecting the “NEXT” button, the user selects a “FINISH” button (step 2068). This “FINISH” button is only displayed by the property page/wizard display and editing system 1694 on the last page of the property page sequence. Once the “FINISH” button is selected, the connector configuration management system goes through the same process of sending the changed data that is outlined in FIG. 121F (steps 1932-1953). After receiving the acknowledgement signal, the property page/wizard display and editing system 1694 would indicate that the wizard is finished (step 2090). Examples of this indication could be some statement that alerts the user 1667 that the wizard is finished, or if the wizard runs in a popup window, the popup window could simply be dismissed.

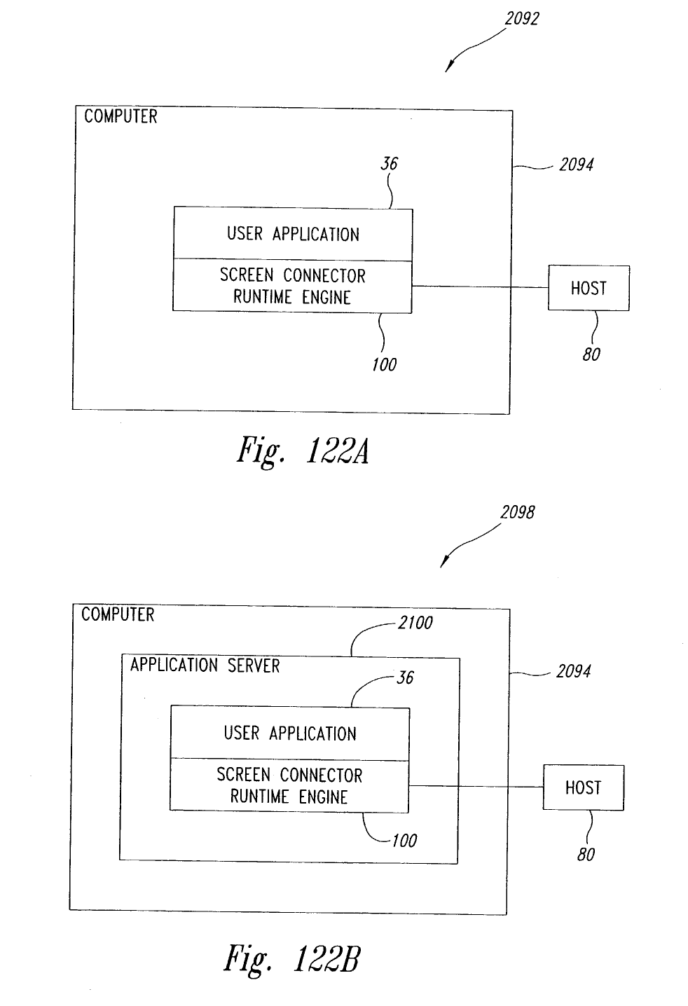

A basic architecture of the runtime system 2092 is shown in FIG. 122A as having a computer 2094 running the user application 36 along with the screen connector runtime engine 100, which is connected to the host computer 80. The connection to the host computer is over some standard host protocol, such as Data Link Communication (DLC), Synchronous Data Link Communication (SDLC), coaxial cable, TWINAX, TN3270, etc. An alternative embodiment of the basic architecture of the runtime system is shown in FIG. 122B with both the user application 36 and the screen connector runtime engine 100 running on an application server 2100, which use of the application server 2100 would depend on the user application 36.

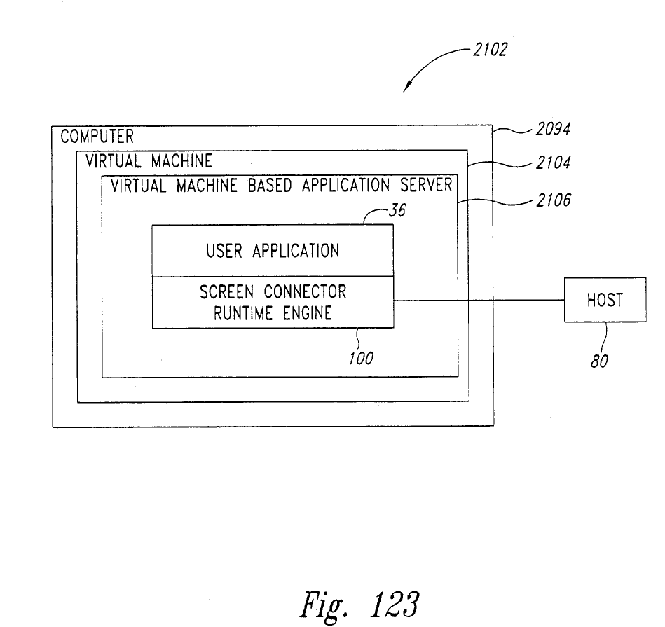

A third embodiment of the basic architecture of the runtime system is shown in FIG. 123. In this embodiment, the computer 2094 is running a virtual machine 2104 containing a virtual machine based application server 2106. Examples of the virtual machine 2104 could include a Java virtual machine or an IBM Conversational Multitasking Systems (CMS) virtual machine.

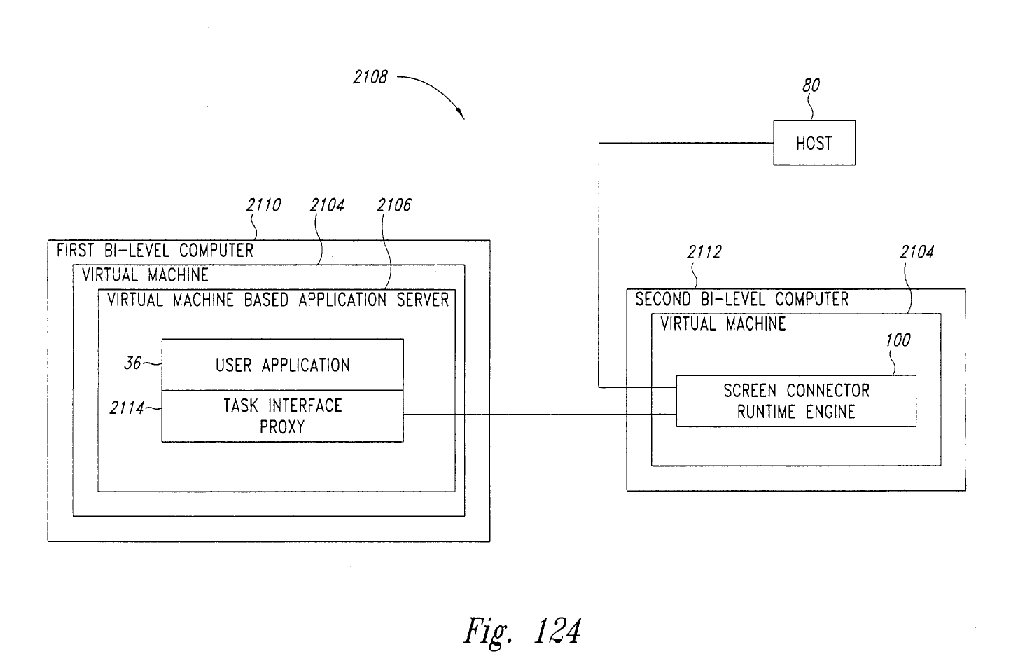

An example of a runtime system with remoting 2108 is depicted in FIG. 124 as having two servers. Because the screen connector runtime engine 100 and the virtual machine based application server 2106 may both be heavy users of the runtime system resources, they could be separated to run on separate machines for load sharing. The host computer 80 is connected to the screen connector runtime engine 100, which is running on the virtual machine 2104 of a second bi-level computer 2112. The screen connector runtime engine 100 is also communicating with a task interface proxy 2114 running alongside the user application 36 in the virtual machine based application server 2106. The virtual machine based application server 2106 is running on the virtual machine 2104, which is running on a first bi-level computer 2110. In this configuration, the virtual machine based application server is optional; however, most user applications currently run on application servers. The runtime system with remoting 2108 shown in FIG. 124 is an example of remote method invocation over TCP/IP. Other examples of remoting could include, but are not limited to, Microsoft Distributed Com or Internet Inter-Orb Protocol (IIOP) over TCP/IP.

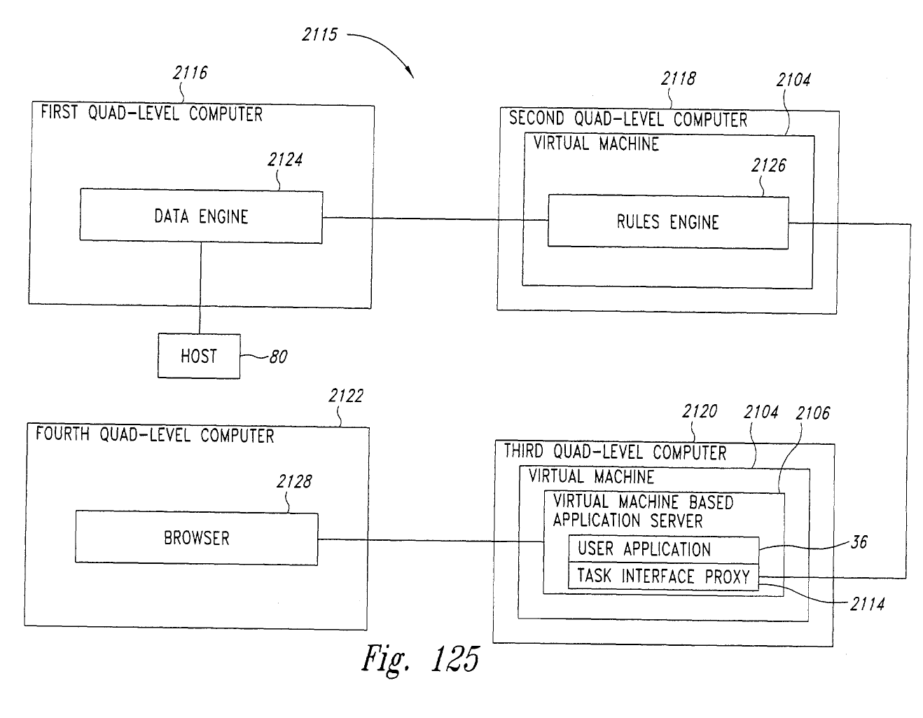

In an alternative embodiment of the runtime system with remoting 2115, the screen connector runtime engine 100 could be broken up into separate components. FIG. 125 shows a screen connector runtime engine 100 that has been broken into two parts: a data engine 2124 and a rules engine 2126. Separating the screen connector runtime engine 100 into individual components better provides for load balancing throughout the runtime system. If one part of the alternative embodiment of the runtime system with remoting 2115 is particularly CPU intensive, the load may be shared across multiple CPUs. The data engine 2124 could be a standard data engine composed of a screen buffer, a data stream processor, and network communications. Examples of standards for such a data engine 2124 may include High Level Language Application Program Interface (HLLAPI) and Open Host Interface Objects (OHIO).

Another reason to break up the screen connector runtime engine 100 would be to run part of the screen connector runtime engine with one language or with one operating system and to run another part of the screen connector runtime engine with a second language or a second operating system. These different components would then communicate with each other through remoting. For example, in FIG. 125 the data engine 2124 could be running on a first quad-level computer 2116 that uses a language, such as C, that does not require the use of the virtual machine 2104. The data engine 2124 is connected to the host computer 80 and connected to the rules engine 2126. The depicted rules engine 2126 is running on a second quad-level computer 2118 and is running in a language, such as Java, that requires the use of the virtual machine 2104. The rules engine 2126 is in turn connected to the task interface proxy 2114, which is running alongside the user application 36 on the virtual machine based application server 2106. The virtual machine based application server 2106 is running on the virtual machine 2104 in a third quad-level computer 2120 and is connected to a browser 2128 running in a fourth quad-level computer 2122, or client machine.

Depending on what type of components and what languages are used in the alternative embodiment of the runtime system with remoting 2115, the connection protocol may differ from those discussed in conjunction with FIG. 124. For example, the DCOM connection protocol is used between COM objects, and the RMI connection protocol is used between Java objects. If different parts of the alternative embodiment of the runtime system 2115 are running in different languages, other connection protocols would need to be used, such as CORBA or a specialized non-standard communication protocol over TCP/IP.

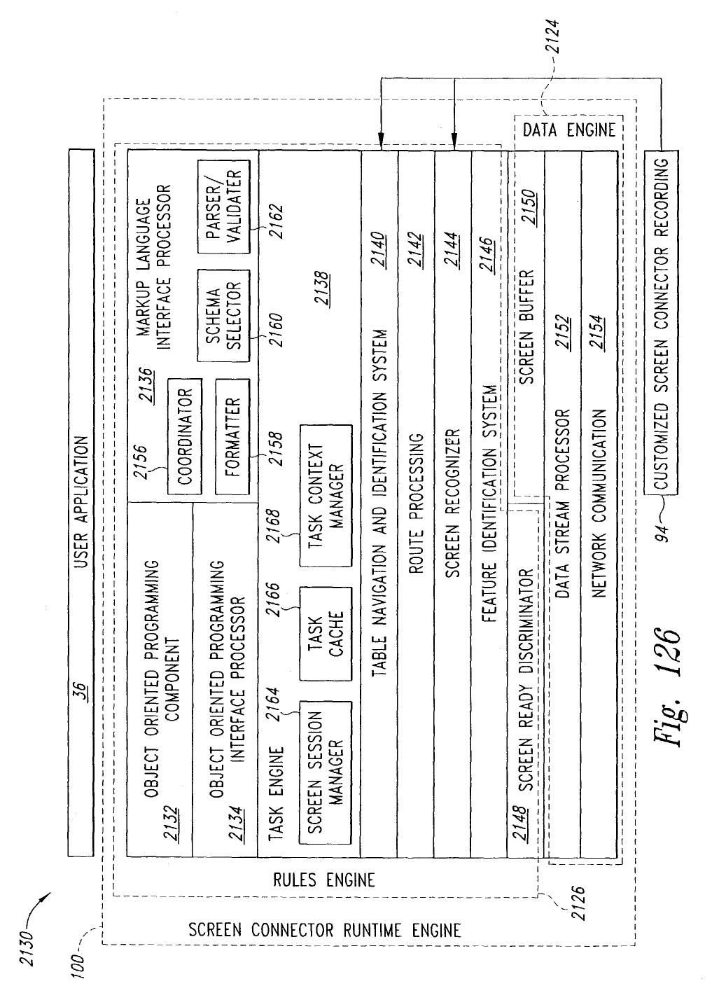

An example of a screen connector runtime engine architecture 2130 is represented in FIG. 126 as a stack of layers. The lower layers of the stack are simpler, or closer to the host computer 80, and the top layers of the stack represent higher levels of integration, or higher levels of application awareness. The screen connector runtime engine architecture has three main parts: the user application 36, the rules engine 2126, and the data engine 2124. The top layer of the screen connector runtime engine architecture 2130 is the user application 36, and the user works with the runtime system through some interface used in components programming. Examples of some standard interfaces that are used include, but are not limited to, JavaBeans, XML, COM, CORBA, SOAP, custom TCP/IP interface, email interfaces, or messaging interfaces such as MSNQ from Microsoft.

The screen connector runtime engine 100 is composed of the rules engine 2126 and the data engine 2124. The top layer of the rules engine 2126 is the interface layer, which contains an object oriented programming component 2132, an object oriented programming interface processor 2134, and a markup language interface processor 2136. It is through these interfaces that the user may interact with the runtime system. The markup language interface processor 2136 is comprised of a coordinator 2156, a formatter 2158, a schema selector 2160, and a parser/validater 2162.

Underneath the interface layer is a task engine 2138, which is a uniform way of handling the inputs and outputs that are concerned with one host task or one screen task. The task engine 2138 is comprised of a screen session manager 2164, a task cache 2166, and a task context manager 2168. The task cache 2166 is used in an optional performance enhancement technique of trading system memory for time. For instance, when results from the task engine 2138 are to be returned to the interface processors 2134-2136, the results could be cached for an indefinite or finite amount of time. Thus, the next time an identical request was made to the task engine 2138, the results could be read straight from the task cache 2166 instead of re-invoking the runtime system.

The rules engine 2126 is further comprised of a table navigation and identification system 2140, route processing 2142, and a screen recognizer 2144. Route processing 2142 is the portion of the screen connector runtime engine 100 that looks at a task that has been requested and determines to which screens it needs to go to accomplish the task. The screen recognizer 2144 takes a list of rules that was generated in the designer process and compares the rules to the current screen contents. The rules engine 2126 also contains a feature identification system 2146 and a screen ready discriminator 2148.

The data engine 2124 is comprised of a screen buffer 2150, a data stream processor 2152, and a network communications 2154 component. The screen buffer 2150 can be a two-dimensional array in to which the screen contents are written. The data stream processor 2152 and the network communications 2154 are standard components of an emulator. The data stream processor 2152 converts a linear sequence of bytes from the host computer 80 into a two-dimensional array for the screen buffer 2150. The data stream processor 2152 can also be involved in processing the state of the emulated machine, such as determining if the keyboard is locked or ready to be used. The network communications 2154 is responsible for interfacing with the communications medium, such as TCP/IP.

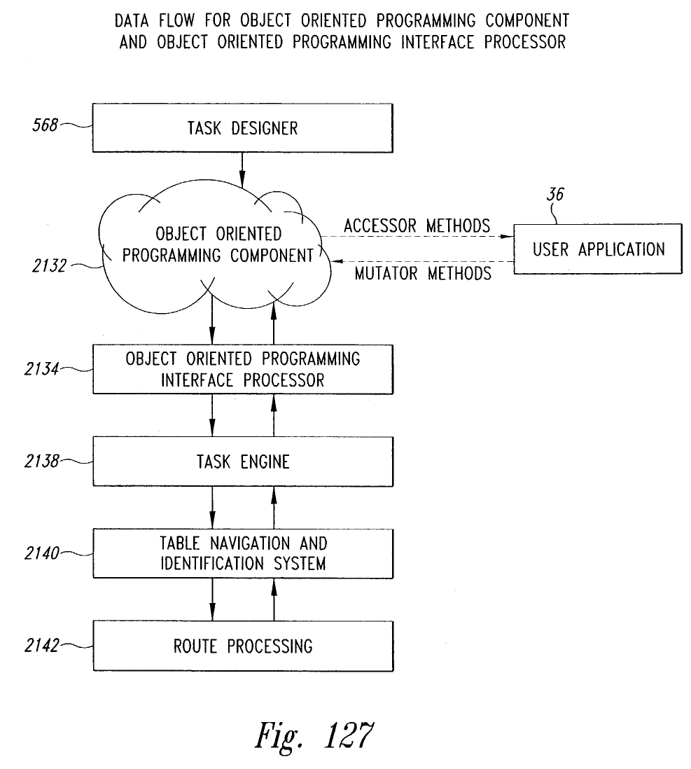

An example of a data flow schematic for the object oriented programming component 2132 and the object oriented programming interface processor 2134 is illustrated in FIG. 127. First, the task designer 568 creates the object oriented programming component 2132, such as a JavaBean, for each task that is designed. The created object oriented programming component 2132 has the appropriate accessor and mutator methods for the data that the particular task needs. The user application 36 then interfaces the object oriented programming component 2132 through these methods. When the object oriented programming component 2132 is invoked by the user application 36, the object oriented programming component interacts with the object oriented programming component interface processor 2134 during runtime, which in turn interacts with the task engine 2138. The task engine 2138 interacts with the table navigation and identification system 2140, which interacts with the route processing 2142 components.

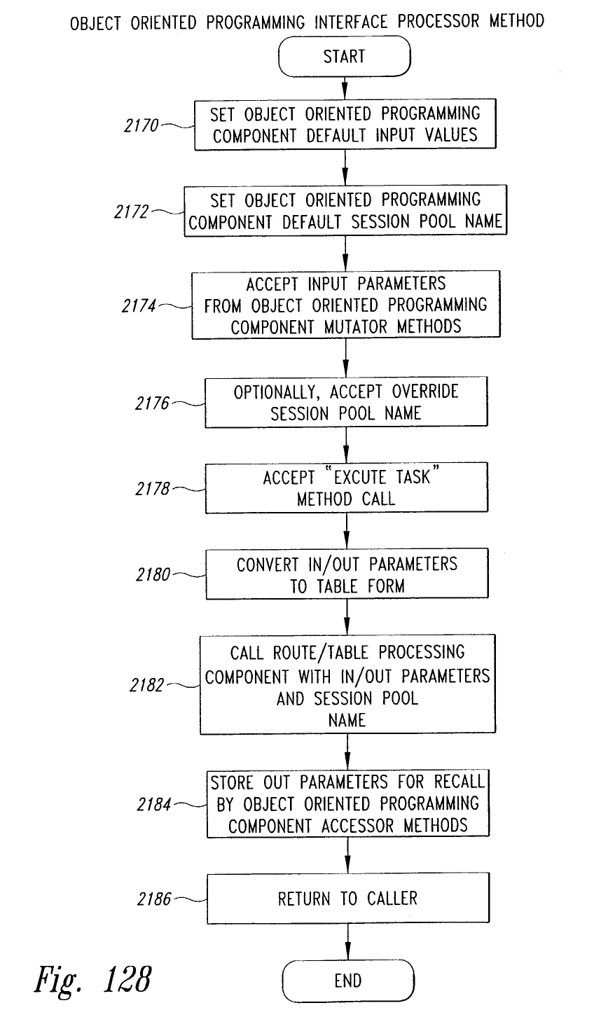

An exemplary method followed by the object oriented programming interface processor 2134 is depicted in FIG. 128. First, the object oriented programming interface processor 2134 sets the object oriented programming component default input values (step 2170) and the object oriented programming component default session pool name (step 2172). This session pool name can be compiled into the object oriented programming component 2132 so that the object oriented programming component is aware of its own session pool name, which compiling could be done in various ways. For instance, the user could interact with the path designer to select a session pool name, or the session pool name could be given some default value by the object oriented programming component interface processor 2134 without any user intervention. An example of the second process would be to assign the name of the session pool to be identical to the name of the object oriented programming component 2132. This name is assigned by the user through the designer and is used when the object oriented programming component 2132 is referenced.

Next, the object oriented programming interface processor 2134 accepts input parameters from the object oriented programming component mutator methods (step 2174) and gives the user the option to override the session pool name (step 2176). The object oriented programming interface processor 2134 then accepts an “execute task” method call (step 2178) and converts the in/out parameters to table form (step 2180). The object oriented programming interface processor 2134 then uses the in/out parameters and the session pool name to call a route/table processing component (step 2182).

Next, the object oriented programming interface processor 2134 stores out the parameters for recall by the object oriented programming component accessor methods (step 2184). This step implies that the data is to be stored in the object oriented programming component 2132 and not somewhere else in the runtime system. Because the object oriented programming component 2132 is not autonomous and exists to interface with the user application, the object oriented programming component must be connected to the screen connector runtime engine 100. This connection is necessary so that, when the user accesses the accessor methods, the methods may retrieve the stored data directly from the object oriented programming component 2132. After the parameters are stored, the object oriented programming interface processor 2134 concludes its method by returning the appropriate data to the caller (step 2186).

In an alternative method for the object oriented programming interface processor 2134, instead of having data stored directly on the object oriented programming component 2132, the data may be stored in a specified location in the runtime system. In this alternative method, when a task is invoked, the object oriented programming component 2132 would go into the runtime system and retrieve the necessary data. This data, for example, could include integers or strings that correspond to specific field types, which field types were designated in the designer. The data could also include table data where a table could be stored as an object array.

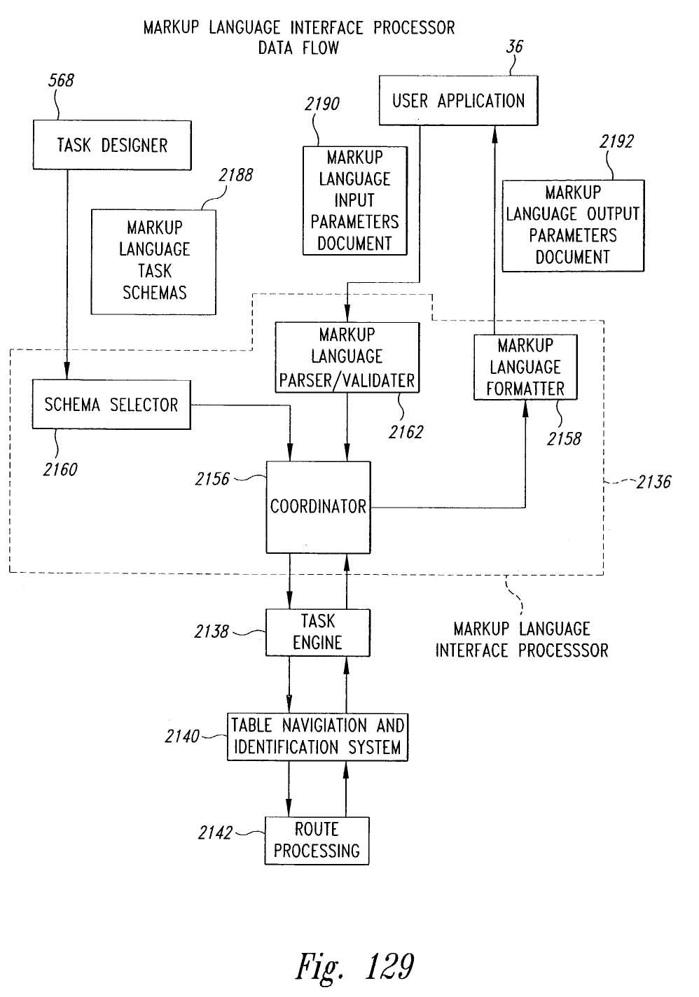

Unlike the object oriented programming interface processor 2134, the markup language processor 2136 works with documents instead of objects. An example of a data flow diagram for the markup language interface processor 2136 is shown in FIG. 129. The markup language interface processor receives an input parameters document 2190 from the user application 36. The markup language parser/validater 2162 parses the markup language input parameters document 2190 and validates the input based on a selected schema. This selected schema comes from the schema selector 2160, which selects from a group of markup language task schemas 2188 based upon user input received by the coordinator 2156. Each of the markup language task schemas 2188 serves as a description of the permissible data for a document and serves as a template during a validation process.

Once the markup language input parameters document 2190 is parsed, the markup language interface processor 2136 interacts directly with the task engine 2138 and indirectly with both the table navigation and identification system 2140 and route processing 2142 to retrieve the desired results. These results are sent through the markup language formatter 2158 and exported as a markup language output parameters document 2192 to the user application 36.

The markup language interface processor 2136 provides the main entry point for the user into the runtime system when the user is working with a markup language interface. As is generally described above, the markup language interface processor 2136 parses a document, determines which tasks the user is trying to run, invokes the task engine 2138 using the appropriate task parameters, retrieves the results from the task engine, and send the results back to the user in markup language format.

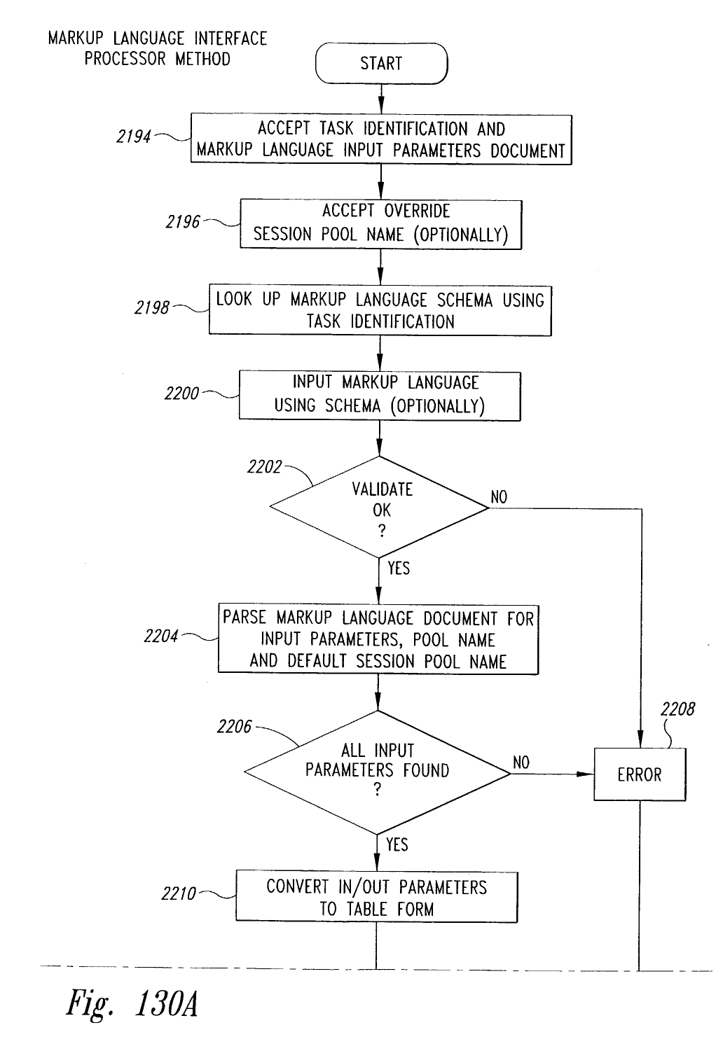

An example of a method followed by an embodiment of the markup language interface processor 2136 is depicted in FIGS. 130A and 130B. The markup language interface processor 2136 begins the method by accepting a task identification from the task designer 568 and the markup language input parameters document 2190 (step 2194). The user then has the option to override the session pool name (step 2196). Next, the markup language interface processor 2136 looks up the appropriate markup language task schema 2188 using the task identification (step 2198) and gives the user the option to input markup language using the markup language task schema 2188 (step 2200).

The markup language interface processor 2136 then goes through an optional step of validating the markup language input parameters document 2190 using the markup language task schema 2188. This validation could be carried out by a combined parser/validater component 2162, such as XERCES. Several types of these components are available to the public. If the validation fails (“No” branch of step 2202), the markup language interface processor 2136 emits an error (step 2208) and ends its method. Otherwise (“Yes” branch of step 2202), the markup language interface processor 2136 parses the markup language input parameters document 2190 for input parameters, for a pool name, and for a default session pool name (step 2204) If all the necessary input parameters are not found after the parsing (“No” branch of step 2206), the markup language interface processor 2136 emits an error (step 2208) and terminates its method. Otherwise (“Yes” branch of step 2206), the markup language interface processor 2136 converts the in/out parameters to table form (step 2210) and uses the parameters to call a route/table processing component (step 2212). Next, the output parameters are formatted using the markup language task schema 2188 (step 2214), and the markup language interface processor 2136 concludes its process by returning the markup language output parameters document 2192 to the caller (step 2216).

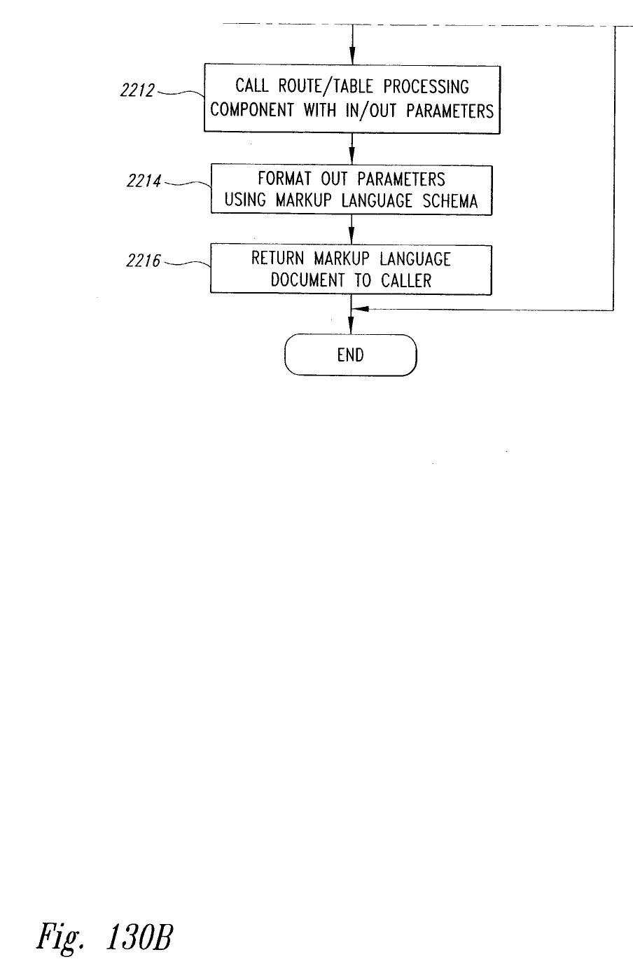

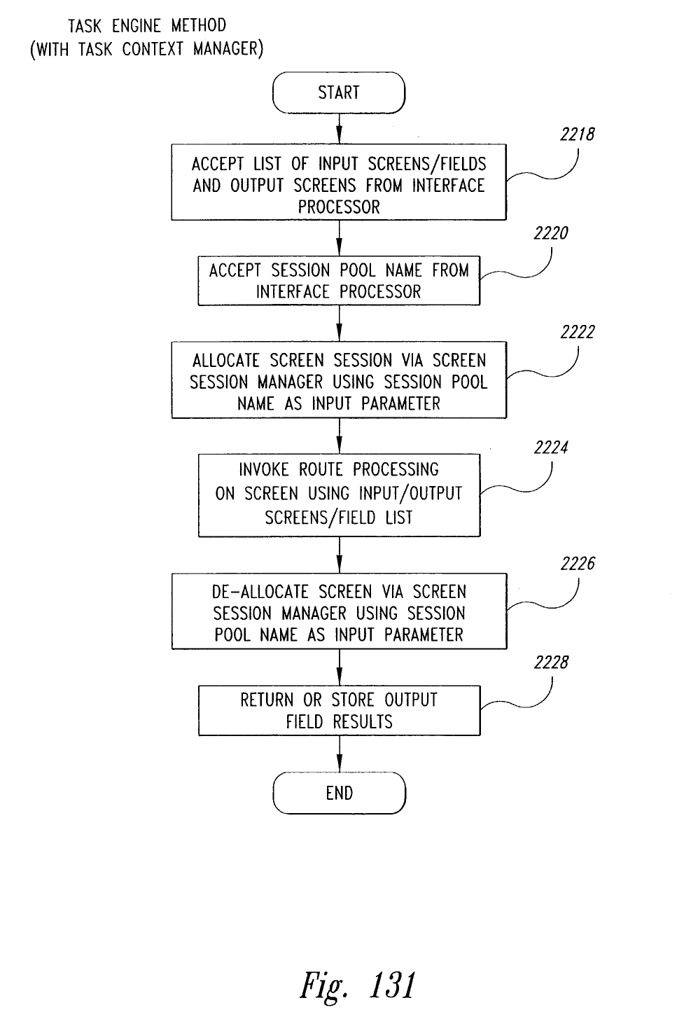

The task engine 2138 interacts with the interface processors 2134-2136 to carry out a specific task and return the results of that process. An example of a method followed by a simple embodiment of the task engine 2138, which does not include the task context manager 2168, is shown in FIG. 131. This method does not differentiate between host screens that are in their native states and host screens that have had their native states changed during a previous screen session. The method only cares if the host screen is configured against the correct host. The task engine 2138 begins the method by receiving from the interface processors 2134-2136 a list of input screens and fields (step 2218), a list of output screens (step 2218), and a session pool name (step 2220). Using the session pool name as an input parameter, the task engine 2138 allocates a screen session via the screen session manager 2164 (step 2222) Next, the task engine 2138 invokes route processing 2142 on the host screen using the input and output screens/fields lists (step 2224).

After the task is run against the host screen, the task engine 2138 de-allocates the host screen via the screen session manager 2164 using the session pool name as the input parameter (step 2226). Finally, the output field results are stored in an appropriate location, such as an object oriented programming component 2132, or are returned to the runtime system (step 2228) in order to reduce network overhead. After storing or returning the results, the task engine 2138 ends the method.

The steps representing the method shown in FIG. 131 are exemplary and may be rearranged or combined. For example, the order in which the task engine 2138 accepts information from the interface processors 2134-2136 (step 2218 and step 2220) could be reversed for an alternative embodiment of the invention.

The method followed by the task engine 2138 is further simplified when using the task context manager 2168, as shown in FIG. 131A. The task engine 2138 first accepts a list of input screens and fields (step 2230), a list of output screens (step 2230), and a session pool name from the interface processors 2134-2136 (step 2232). The task engine 2138 then invokes the task context manager 2168 and ends the method.

One problem that has traditionally existed with respect to object oriented programming component context management is the exposure of property values during the copying of property values from one object oriented programming component 2132 to another. The conventional method to copy property values has been to ask a first object oriented programming component 2132 for a certain property value and then to copy that property value to an intermediate, temporary variable. The intermediate, temporary variable is then used to copy the property value to a second object oriented programming component 2132.

By exposing the property value, this conventional method introduces several problems. First, object oriented programming component space and design are complicated. Second, data is exposed to user twiddling, which may be undesired for security or stability reasons. Third, data may be copied to more than one object. Fourth, over-the-wire traffic is created in remoted objects. Fifth, runtime type checking and memory allocation are required to create a temporary variable of the appropriate type in the user code.

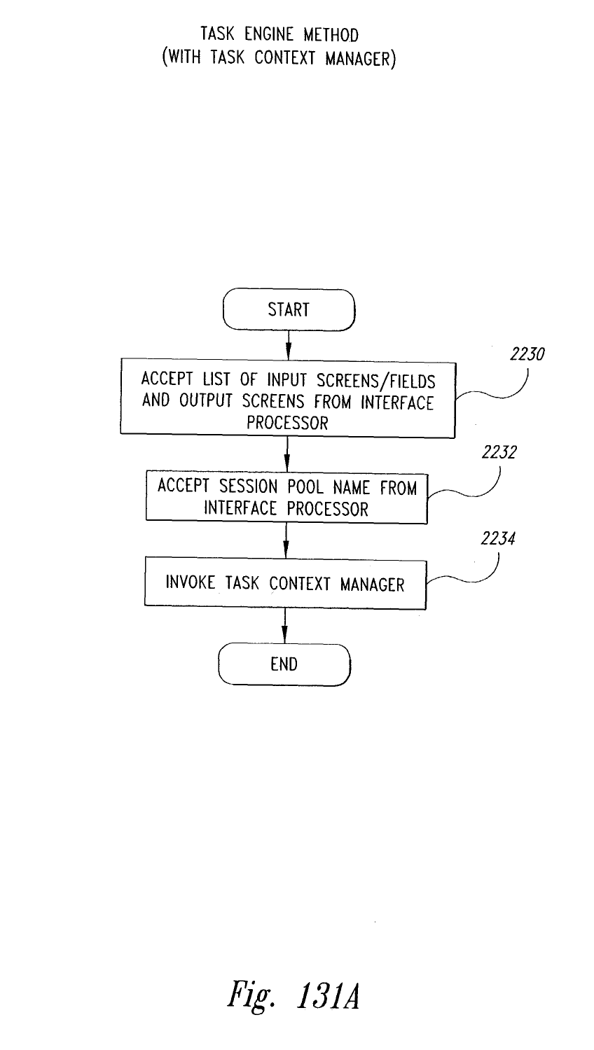

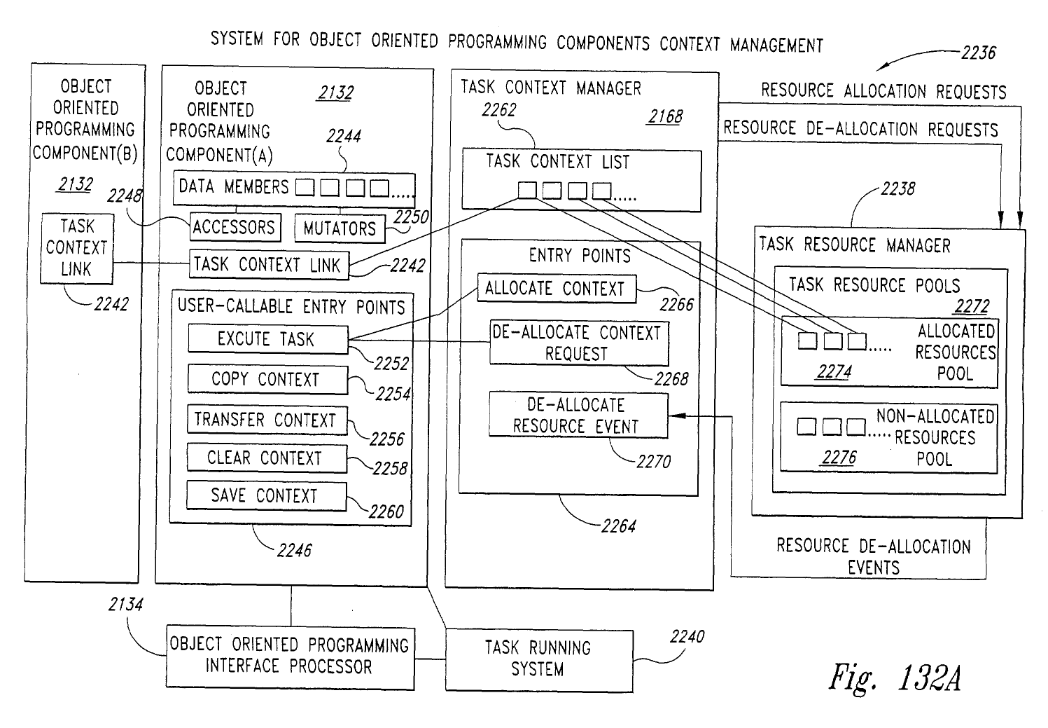

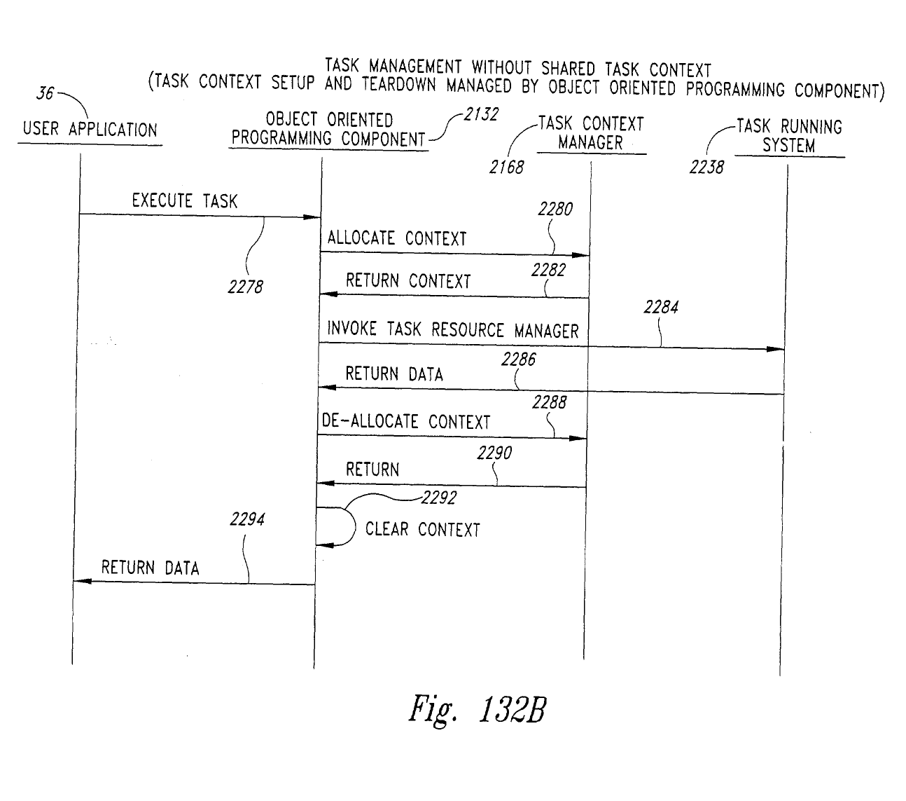

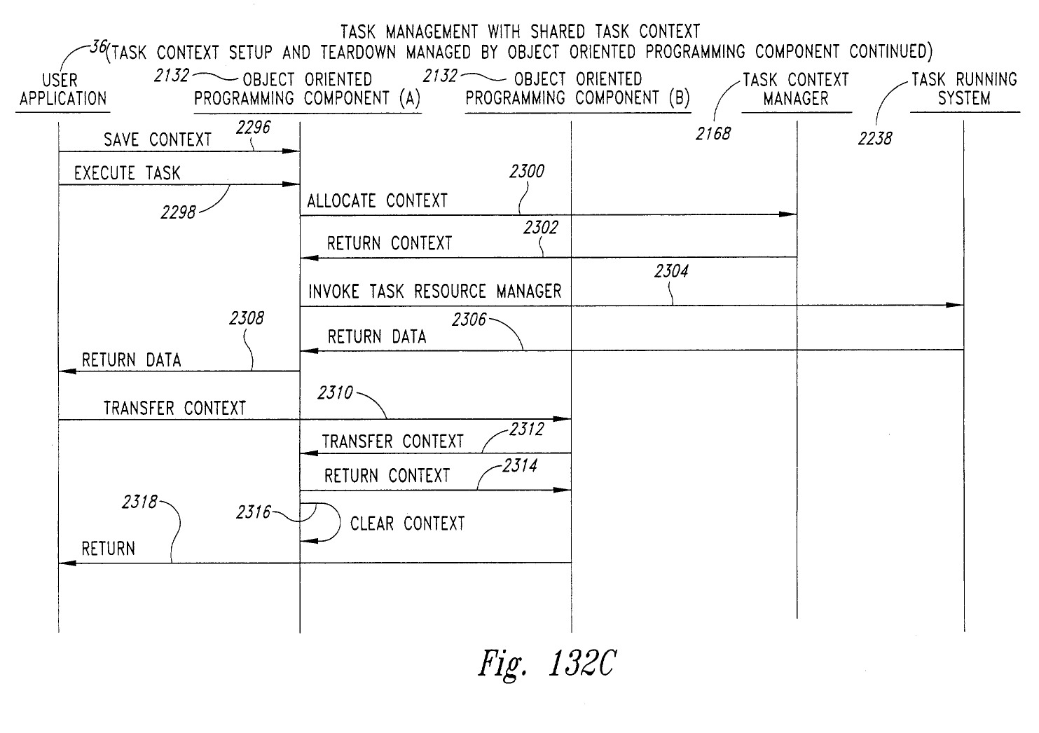

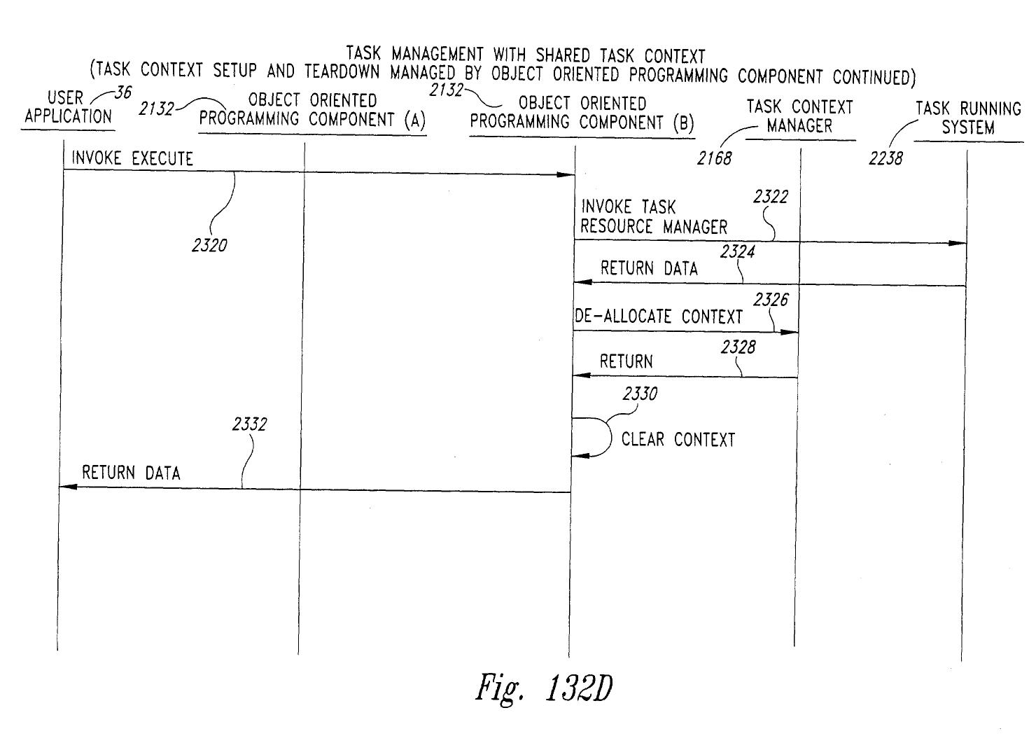

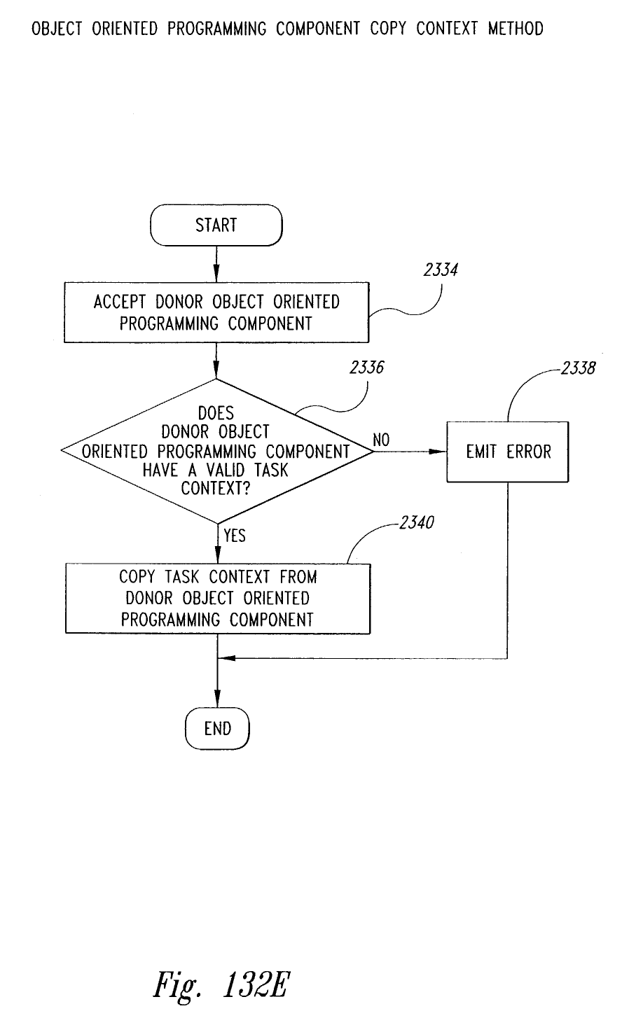

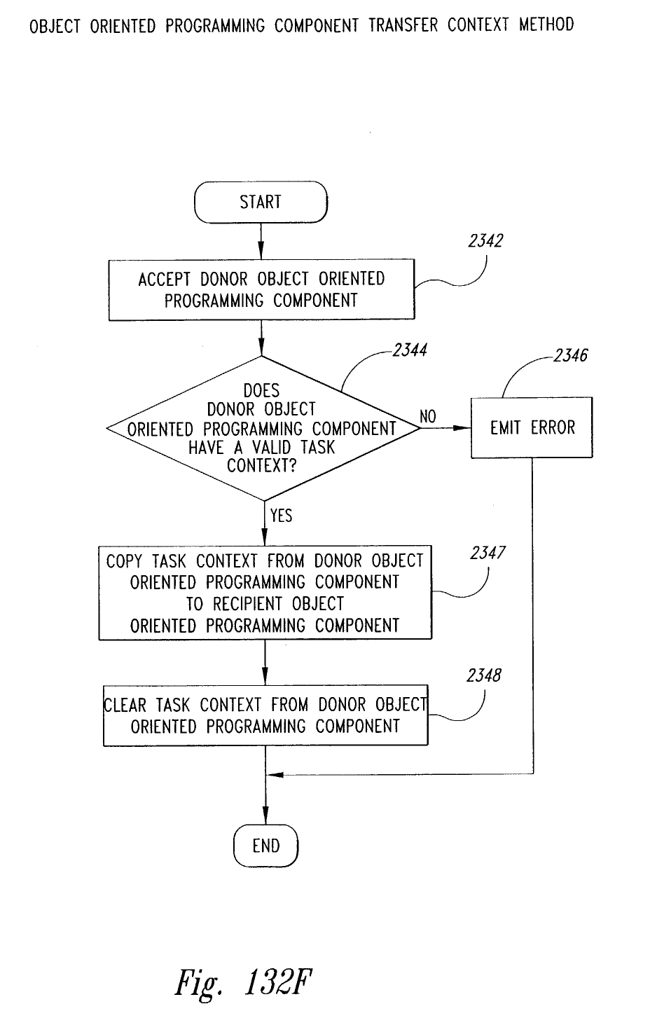

An embodiment of a system for object oriented programming components context management 2236, which provides a general programming technique for copying a property from one object oriented programming component 2132 to another without ever exposing the property value, is illustrated in FIG. 132A. This system for object oriented programming components context management 2236 simply requests an object oriented programming component (A) 2132 to directly copy or clone the object property to an object oriented programming component (B) 2132. Thus, all the copying of values and managing of permissions is carried out internally. This programming technique simplifies object space and design, does not expose data to user twiddling, minimizes over-the-wire traffic, consumes less memory, and requires fewer CPU cycles to complete.

Specific to the screen connector system, this programming technique allows multiple screen tasks to be executed on the same host session, while at the same time making automatic re-use of the host sessions for an increased scalability. If the user does not invoke the technique, the technique is transparent to the user. If the user does invoke the technique, the user is prevented from holding on to the host sessions and illegally reusing them later.

The system for object oriented programming components context management 2236 shown in FIG. 132A has been implemented in the Java language using JavaBeans as the object oriented programming components. Similar embodiments of task context management could also be implemented for other object oriented programming languages such as C++ or for other object oriented interfaces such as CORBA. The depicted system for object oriented programming components context management 2236 consists of two object oriented programming components 2132, the task context manager 2168, a task resource manager 2238, the object oriented programming interface processor 2134, and a task running system 2240. The task context manager 2168 maintains a task context list 2262, which contains a number of task contexts. Each task context represents a link to an allocated resource, which link could be embodied, for example, as an object reference in Java or Smalltalk or as a pointer in C or C++. The link may also be valid (e.g. a non-null reference) or invalid (e.g. a null reference). The task context list 2262 could be embodied as a table of links or in some other form, such as a Java Vector or Hashtable.

The task context manager 2168 also contains entry points 2264, which include an allocate context request 2266, a de-allocate context request 2268, and a deallocate resource event 2270. When the task context manager 2168 is invoked through the allocate context request 2266, the task context manager requests a resource from the task resource manager 2238. When working specifically within the screen connector runtime system, the task resource manager would fill the role of a screen session manager, which will be later described in more detail. The task resource manager 2238 contains task resource pools 2272, including an allocated resources pool 2274 and a non-allocated resources pool 2276. Once the resource is requested, the task context manager 2168 creates a task context entry in the task context list 2262 with a relationship to the requested resource. In an embodiment of the system for object oriented programming components context management 2236 without a task resource manager 2238, the task context manager 2168 would create the resource itself.

When the task context manager 2168 is invoked through the de-allocate context request 2268, the task context manager requests a resource de-allocation from the task resource manager 2238. The task context is then removed from the task context list and any associated relationships are deleted. In the case where the task resource manager 2238 does not exist, the task context manager 2168 would dispose of the resource itself.

The task running system 2240 depends on a resource to run the task. The resource may be any special value or object that is required to run the task. In our screen connector embodiment, the special object is a host emulation screen object. In other embodiments of the system for object oriented programming components context management 2236, however, the resource could be a database connection, a file system file handle, a windowing system handle, a network system socket, a keyboard handle, or other related resource. The task running system 2240 shown in FIG. 132A includes all the layers below the task engine 2138 of the screen connector runtime engine architecture 2130 shown in FIG. 126.

The object oriented programming components 2132 are manipulated by a user application in some language for data access via some task running system 2240. In the depicted embodiment, the object oriented programming component 2132 represent JavaBeans generated uniquely by the designer for user-defined host access tasks. Another embodiment of the system for object oriented programming components context management 2236 could use another object oriented programming language or even another connector runtime.

The object oriented programming component 2132 is initially created with an invalid (null) task context link 2242. A valid (non-null) task context link 2242 comes from one of two places: the task resource manager 2238 or another object oriented programming component 2132 via copy or transfer context methods. The task context itself is not exposed to the user because mutator/accessor methods are not provided for the context, which would allow the user to manipulate the context or store the context object. Instead, a base class of the task object oriented programming component 2132 has a private member variable that contains a reference to the context object. The base class also has public methods that copy or transfer the context to another instance of the base class. The combination of base class private member variables and the base class public copy methods prevent accidental manipulation of or intentional tampering with the task context.

Both object oriented programming components 2132 are shown to have the task context link 2242. Object oriented programming component (B) 2132 is shown to be further comprised of user-callable entry points 2246 and data members 2244, which are linked to accessor methods 2248 and mutator methods 2250. The user-callable entry points 2246 are comprised of an execute task method 2252, a copy context method 2254, a transfer context method 2256, a clear context method 2258, and a save context method 2260.

Each of these user-callable entry points 2246 are public methods and are accessible to the user application 36. The copy context method 2254 and the transfer context method 2256 are both “share context” methods on the receiving object oriented programming component 2132, but it would be equally valid to make them methods on the sending object oriented programming component. The save context method 2260 can set an internal true/false flag, which indicates the context may be shared, in an object oriented programming component 2132. The clear context method 2258 does not usually need to be shared by the user but is provided as a convenience for error recovery or other extraordinary circumstances.

When a task is executed, the task running system 2240 is invoked with a task resource. To obtain the task resource, the context object link must be checked. When the execute task method 2252 is invoked, the object oriented programming component 2132 sends the task context link 2242 to the task engine 2138, in which a task context will be allocated if necessary. After the task engine 2138 is invoked, the task context is deallocated (disposed) via the task context manager 2168, and the object oriented programming component internal reference is cleared unless the “save context for sharing” flag has been set.

The task resource manager 2238 is an optional component, and if it is not present, the task context manager 2168 maintains the list of task resources internally. The task resource manager 2238 may be responsible for managing task resource timeouts. If a timeout occurs, a resource is moved from the allocated resources pool 2274 to the non-allocated resources pool 2276, and the task resource manager 2238 calls the task context manager 2168 with an event message. Once moved, the particular resource is no longer available for use by the object oriented programming component 2132 that first requested the resource. The task context manager 2168 may also manage the task contexts as references to task resources, which references may be set to null when a timeout event is received. To prevent errors such as a “null reference” (Java) or a “null pointer” (C/C++), the task context should be checked before being used.

The object oriented programming interface processor 2134 supplies the input parameters of the task to the task running system 2240. When the task running system returns its data, then the object oriented programming component data members 2244 are filled with the task results, which are then accessible by the user via the accessor methods 2248 in the traditional object oriented programming style.

A data flow diagram for task management without task context sharing is illustrated in FIG. 132B. In this embodiment of the system for object oriented programming components context management 2236, the object oriented programming component 2132 manages the task context setup and teardown. From the perspective of the user, the task management process only consists of the initial execute task function (step 2278). Internally, the object oriented programming component 2132 then interacts with the task context manager 2168 by allocating a task context (step 2280) and receiving a task context (step 2282). The object oriented programming component 2132 then invokes the task resource manager 2238 (step 2284), and the task running system 2238 returns data (step 2286). After the invocation, the object oriented programming component 2132 de-allocates the task context (step 2288) and also clears the task context (step 2292). Finally, the object oriented programming component 2132 returns the data, which is comprised of the screen field contents in the screen connector embodiment, to be used by the user application 36 (step 2294).

Task management for two object oriented programming components 2132, or task context sharing, is slightly different than for one object oriented programming component 2132 in that the task context is not immediately de-allocated. As depicted in FIGS. 132C and 132D, the object oriented programming component (A) 2132 first receives a save context command (step 2296) and an execute task command (step 2298) from the user application 36. The object oriented programming component (A) 2132 then interacts with the task context manager 2168 to allocate a task context (step 2300) and to receive a task context (step 2302). The object oriented programming component (A) 2132 next invokes the task resource manager 2238 (step 2304) and receives data returned by the task running system 2238 (step 2306). This data is relayed by the object oriented programming component (A) 2132 to the user application 36.

The task context is then transferred to the object oriented programming component (B) 2132 (step 2310), which transfers the task context to the object oriented programming component (A) (step 2312) and receives the task context in return (step 2314). This task context is then cleared from the object oriented programming component (A) 2132 (step 2316). Once the user application has been notified of the transferred task context (step 2318), the user may execute the task a second time on the object oriented programming component (B) 2132 (step 2320). The object oriented programming component (B) 2132 then invokes the task resource manager 2238 (step 2322) and receives data from the task running system 2238 (step 2324). After the data is returned, the task context is finally de-allocated by the object oriented programming component (B) 2132 (step 2326) and cleared from the object oriented programming component (B) (step 2330). The data is then returned to the user application 36 (step 2332).

Though FIGS. 132C and 132D only depict two object oriented programming components 2132 involved in the task context sharing process, the same process may be used to chain together any number of object oriented programming components. In each case, the task would first be saved, then executed, and finally transferred to another object oriented programming component 2132. Thus, de-allocation of the task context would be postponed as long as desired by repeatedly calling the saved method before task execution.

A copy context method is a method implemented on one object oriented programming component 2132, which accepts another object oriented programming component as input. An example of such a method is illustrated in FIG. 132E. First, the donor object oriented programming component 2132 is accepted (step 2334) and is checked to see if it has a valid task context (step 2336). This check for validity is optional but can increase system robustness. If the donor object oriented programming component 2132 does not have a valid task context (“No” branch of step 2336), an error is emitted and the method is ended. Otherwise (“Yes” branch of step 2336), the task context is copied from the donor object oriented programming component 2132 (step 2340) to the recipient object oriented programming component and the method is ended. As a result, two object oriented programming components 2132 contain the same context for task execution, and either one can re-execute on that same task context.

Because the task context is a private member of a base class of the object oriented programming component 2132, any task object oriented programming component can copy the task context to another. However, the user is not able to access the task context directly.

The object oriented programming component transfer context method is identical to the object oriented programming component copy context method except for an additional step that clears the task context from the donor object oriented programming component 2132. The method, as illustrated in FIG. 132F, begins by accepting the donor object oriented programming component 2132 (step 2342) and checking to see if it has a valid task context. If the task context is valid (“Yes” branch of step 2344), the task context is copied from the donor object oriented programming component 2132 to the recipient object oriented programming component (step 2347), and the task context is then cleared from the donor object oriented programming component to end the method (step 2348). Otherwise (“No” branch of step 2344), an error is emitted (step 2346), and the method is ended.

An example of a method to clear a task context from the object oriented programming component 2132 is illustrated in FIG. 132G. In order to clear a task context, a donor object oriented programming component 2132 is first checked to see if it has a valid task context. If the donor object oriented programming component does not have a valid task context (“No” branch of step 2350), the method for clearing cannot be carried out, and the method ends. If the task context is valid (“Yes” branch of step 2350), the task content manager 2168 is called to release the task context (step 2352). The reference to the task context is also removed (step 2354), and the method is finished.

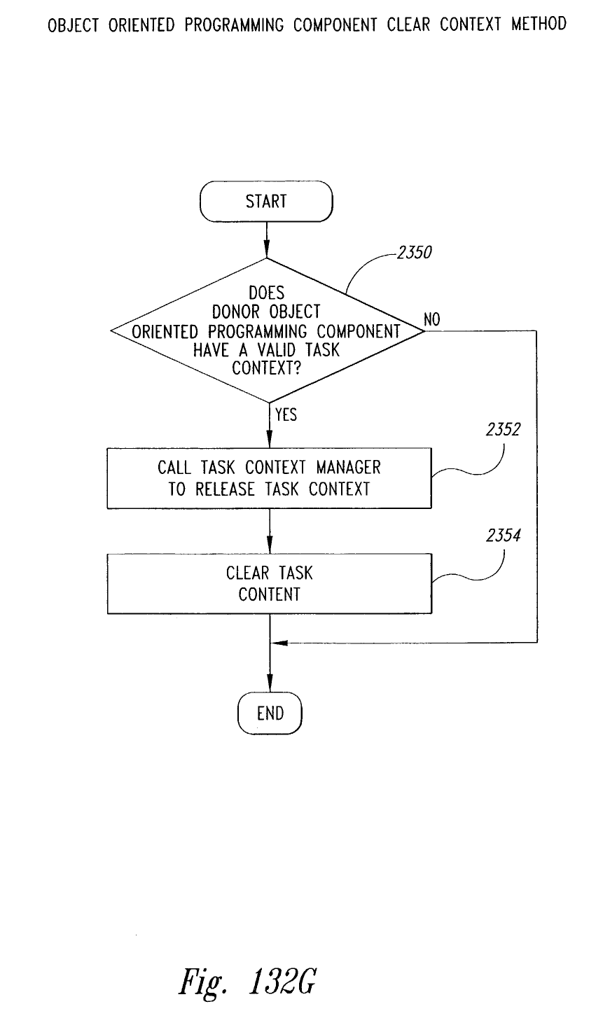

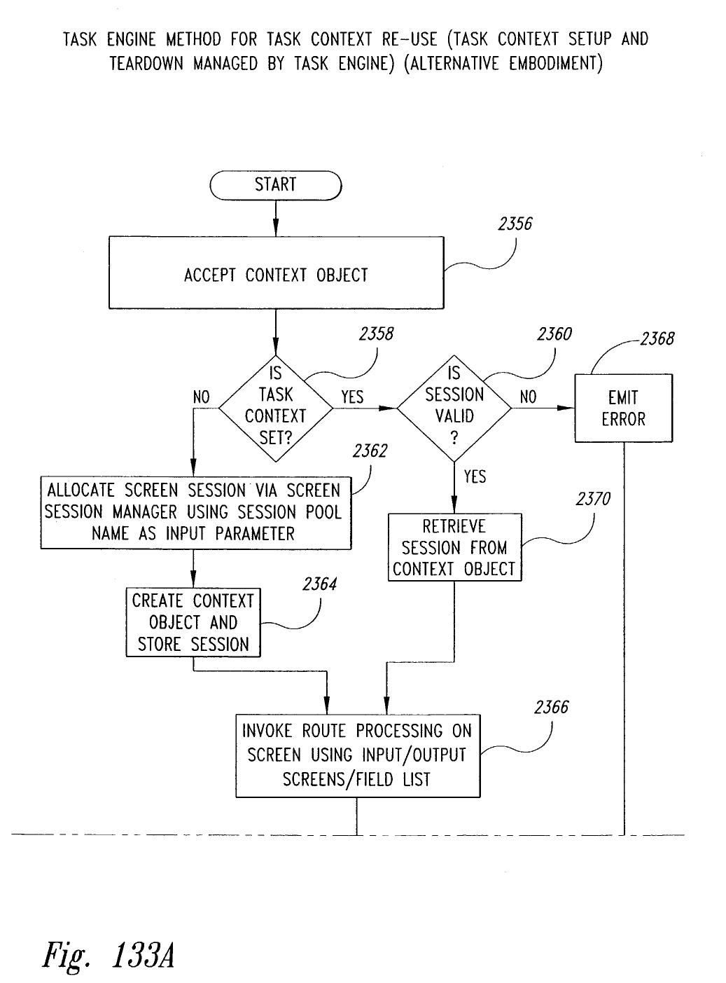

An alternative method followed by an embodiment of the task engine 2138 is depicted in FIGS. 133A and 133B. This method provides for task context re-use and relates to an embodiment of the task engine 2138 that manages task context setup and teardown. This method is used in circumstances where there exist multiple tasks that use the same host screen but run independently of each other and run at different times. Even if one task changes the host state of a screen, this embodiment of the task engine 2138 allows other tasks to subsequently operate on the same screen as it existed in its host state.

The task engine 2138 begins the method by accepting a context object (step 2356) and determines if the task context is set. If the task context is set (“Yes” branch of step 2358), the task engine 2138 verifies that the session is valid. If the session is not valid (“No” branch of step 2360), then a timeout has occurred on the session and further processing is halted. The task engine 2138 emits an error and destroys the context object (step 2376). If the session is valid (“Yes” branch of step 2360), the task engine 2138 retrieves the session from the context object (step 2370) and invokes the task running system 2240, or route processing 2142 in this embodiment, on the screen using the input and output lists of the screens/fields (step 2366).

If the task context is not set (“No” branch of step 2358), the task engine 2138 allocates a screen session via the screen session manager 2164 using the session pool name as the input parameter (step 2362). The task engine 2138 then creates a context object and stores the screen session (step 2364), after which the task engine invokes route processing 2142 on the host screen (step 2366). Once route processing 2142 has been invoked and the task has run, if the task context re-use flag is set (“Yes” branch of step 2372), the task engine 2138 saves the task context and the ends the method.

In order to afford a maximum use of the server resources and enhance the overall performance of the system, preserving the task context is normally limited to certain circumstances. Examples of conditions under which a task context would be saved could include circumstances where saving the task context keeps it locked from other users, or the user may want to save the task context when an error occurs while running the task. Thus, the context re-use flag could be conditionally set based on the errors occurring during the task or on the desires of the user.

If the task context re-use flag is not set (“No” branch of step 2372), the task engine 2138 uses the session pool name as an input parameter to de-allocate the host screen through the screen session manager 2164 (step 2374). The task engine 2138 then concludes the method by destroying the context object (step 2376) in order to free system resources.

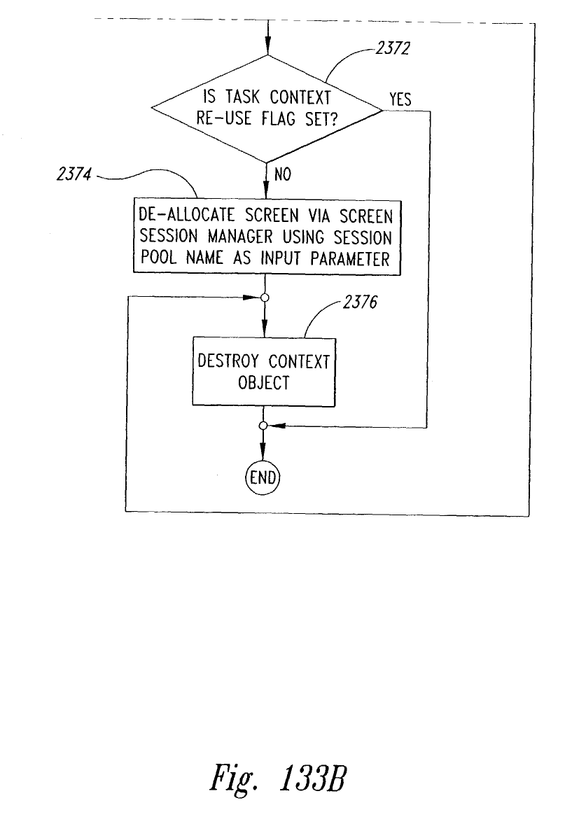

The screen session manager 2164 maintains a pool of host screen connections and thus serves as a host network connection, a data stream processor, and a screen buffer for a number of unique host connections. These unique host connections are then pooled so that multiple tasks can invoke them. An initialization method for the screen session manager 2164, as shown in FIG. 134, begins with the screen session manager accepting pool configurations (step 2378) and creating pool lists for each configured pool name (step 2380). Each pool is then initialized (step 2382) by opening the connection over a desired protocol, such as twinax or coax.

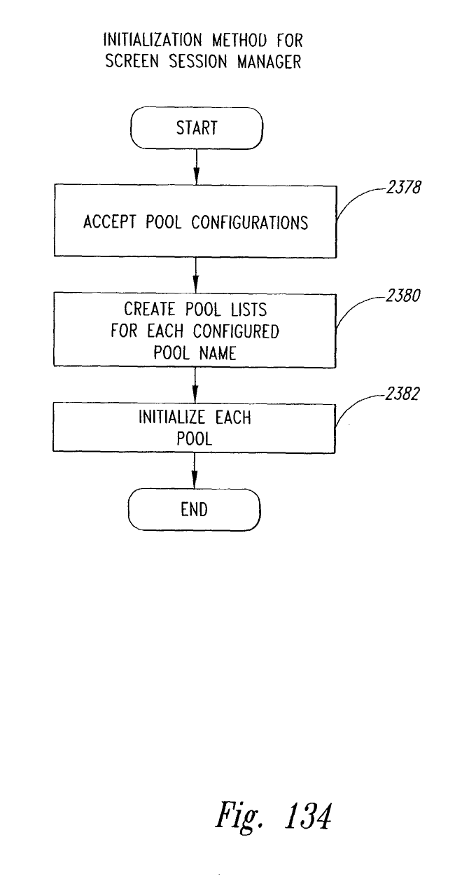

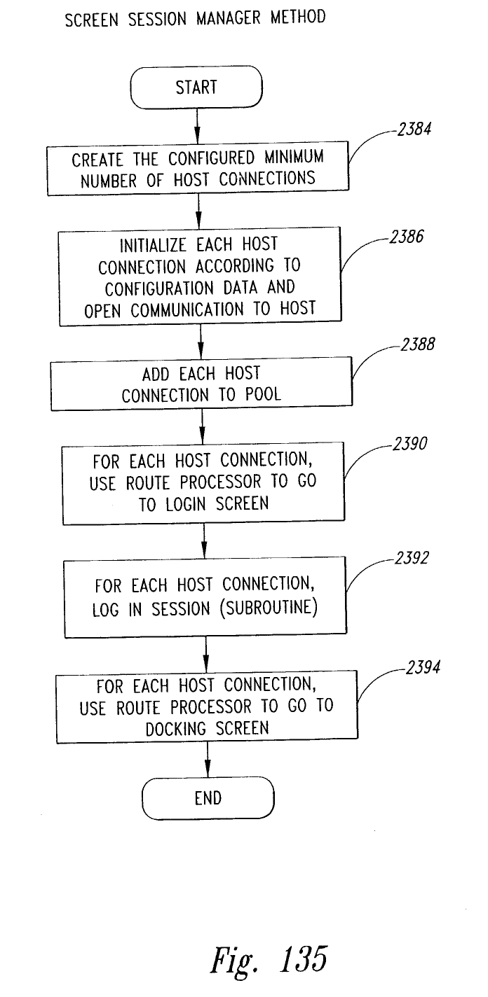

After initialization, the screen session manager 2164 proceeds with a main method, as illustrated in FIG. 135, by creating a configured minimum number of host connections (step 2384) and initializing each host connection according to the configuration data. The screen session manager 2164 then opens communication to the host computer 80 (step 2386) and adds each host connection to the connection pool (step 2388). For each host connection, the screen session manager 2164 uses route processing 2142 to go to the login screen (step 2390) and proceed through a subroutine that logs in a session (step 2392). The screen session manager 2164 then ends its main method with an optional step where, for each host connection, route processing 2142 can be used to go to a docking screen (step 2394). A “docking screen” refers to the state in a state graph in which a screen session should be stored when the screen session is not being used. This final step can improve the performance of the system because route processing 2142 moves the host screen to some specific state in which it takes less time to execute the tasks to be preformed on the host screen.

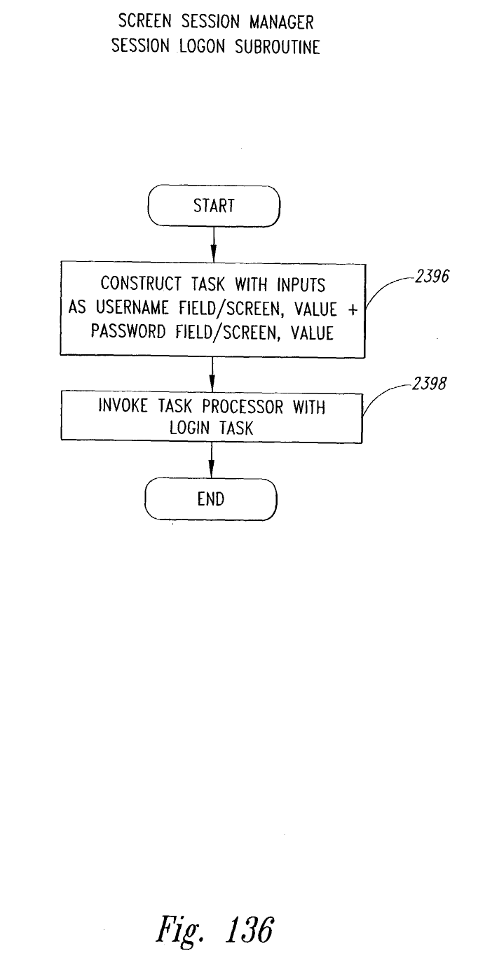

The subroutine of step 2392, through which the screen session manager 2164 logs on a session, is depicted in FIG. 136. Once a task is defined, or a task system is ready to run, an input-only task is created which allows the user to login with a user name and a password. The screen session manager 2164 first constructs the input-only task with its inputs being a value for a user name field/screen and a value for a password field/screen (step 2396). The login task makes it possible to have a user name and password on one screen or a user name and password on multiple screens, which multiple screens can be adjacent to each other in the graph or can be further apart in the graph. Once the login task has been constructed, a task processor is invoked with the login task (step 2398) and the subroutine is ended.

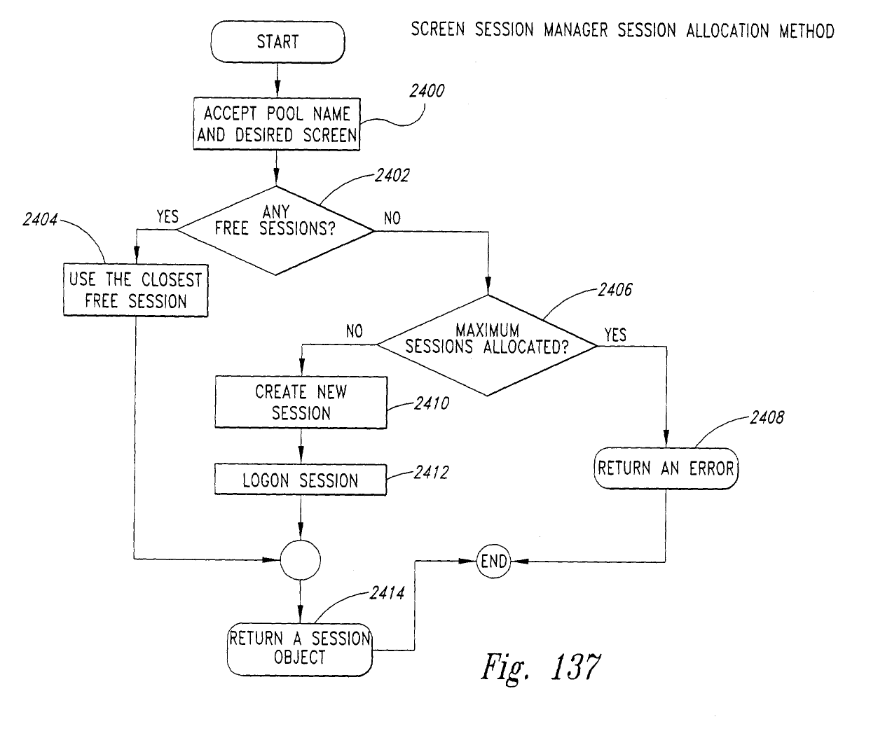

An example of a method followed by the screen session manager 2164 to allocate a screen session is depicted in FIG. 137. The screen session allocation method either takes a screen session that has already been created and returns it or creates a new screen session if possible. The screen session manager 2164 begins the method by accepting a pool name and a desired screen (step 2400) and checks if there are any free screen sessions (step 2402), or screen sessions that have been allocated and returned. If there is at least one free screen session (“Yes” branch of step 2402), the screen session manager 2164 uses the closest free screen session (step 2404). If a graph of the host application 82 exists, determining the closest free screen session can be accomplished by using a standard graph algorithm to determine the distance between any two states on the application graph. After using the closest free session, the screen session manager 2164 then returns a session object (step 2414) and ends the method.

If there are no free screen sessions (“No” branch of step 2402), the screen session manager 2164 sees if the maximum number of screen sessions has already been allocated (step 2406). To optimize system performance, it is usually necessary to have an upper limit on the number of screen sessions created for a specific pool. This maximum number is system-specific, and some applications may even allow the user to set the maximum number of screen sessions. If the maximum number of screen sessions has already been allocated (“Yes” branch of step 2406), the screen session manager 2164 returns an error to the user application (step 2408). The user application could then alert the user of the problem and tell the user to try again later or to wait while the screen session manager 2164 attempts to allocate the screen session a second time. After the error is returned, the screen session manager 2164 ends the method.

If the upper limit on the number of allocated screen sessions has not been reached (“No” branch of step 2406), the screen session manager 2164 creates a new screen session (step 2410) and logs on the screen session (step 2412). The screen session manager 2164 then returns a session object to the user application (step 2414) and ends the allocation method.

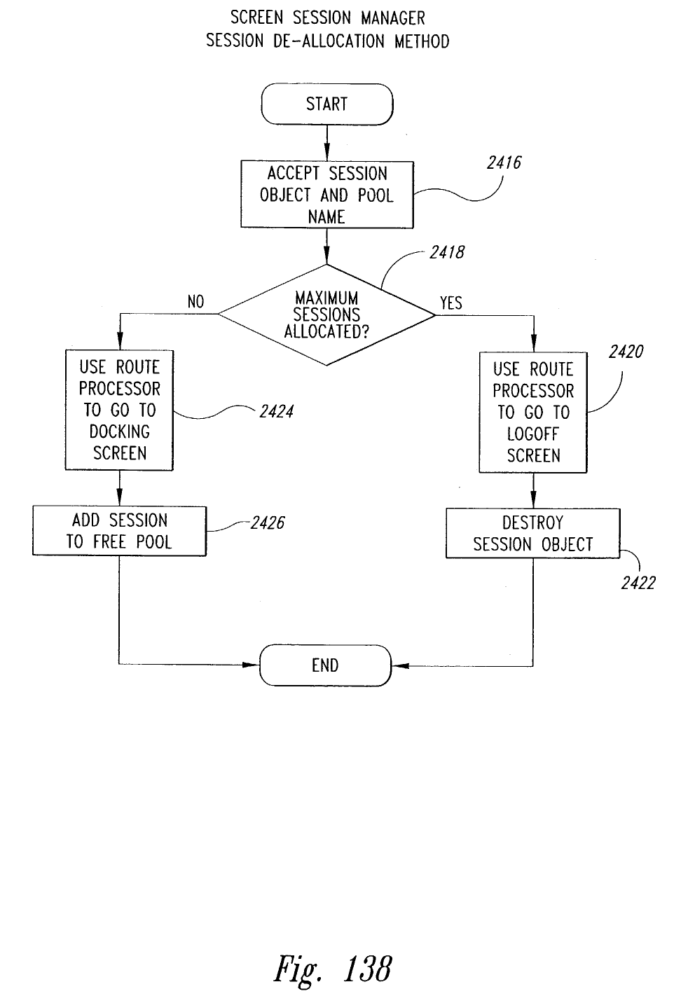

An example of a method followed by the screen session manager 2164 to de-allocate a screen session is shown in FIG. 138. There are two possible outcomes when a screen session is de-allocated; the screen session is returned to the pool for re-use, or if the pool is full, the screen session is destroyed. The screen session manager 2164 begins the de-allocation method by accepting a session object and a pool name (step 2416). The screen session manager 2164 then checks if the maximum number of screen sessions has been allocated (step 2418). If the upper limit of allocated screen sessions has been reached (“Yes” branch of step 2418), route processing 2142 is used to go to the logoff screen (step 2420). This logoff screen could be created during the pool configuration at runtime and be identified by the console user interface, or the logoff screen could be defined during the recording process, which definition would be stored until the new session pool was configured. After route processing 2142 is used to log off the screen session, the session object is destroyed (step 2422). Logging off a screen session before it is destroyed avoids problems that may arise when trying to log back in to the host application using the same login identification.

If the number of allocated sessions has not reached the maximum limit (“No” branch of step 2418), route processing 2142 is used to go to the docking screen (step 2424) and the screen session is added to the free pool (step 2426). The screen session manager 2164 then finishes the de-allocation method.

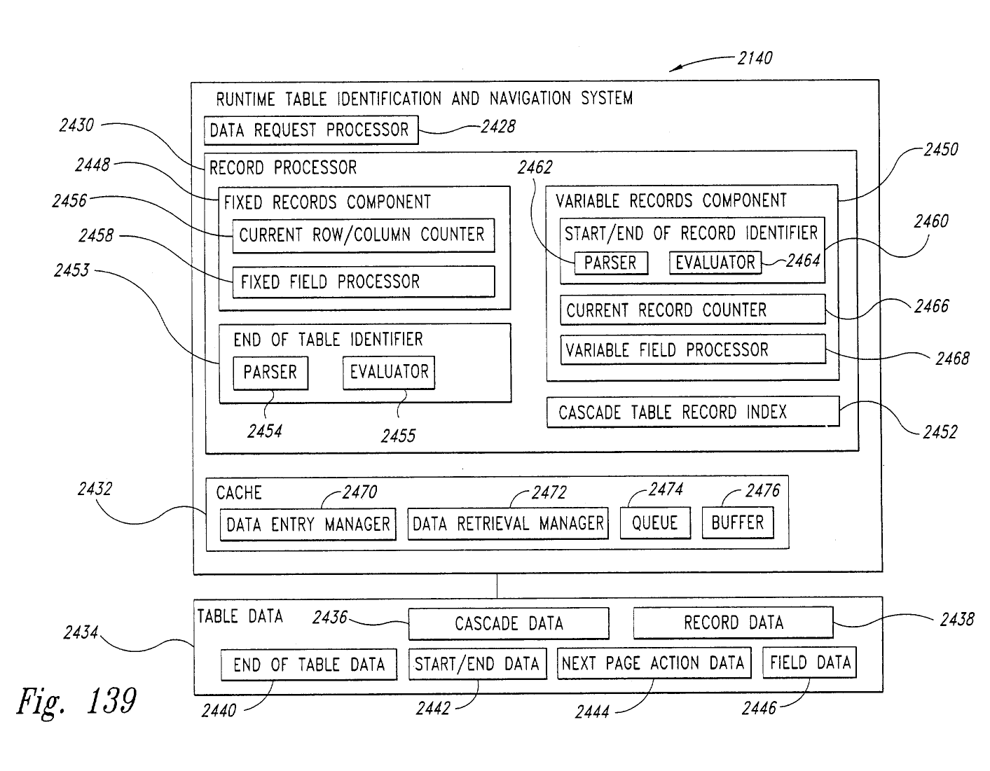

Another component of the screen connector runtime engine 100 shown in FIG. 126 that works directly with the task engine 2138, which includes the screen session manager 2164, is the runtime table identification and navigation system 2140. An embodiment of the overall architecture of a table system is illustrated in schematic diagram form in FIG. 139. This table system is used to process the tables that were identified in the host screens during the designer process. Each table contains records, and within each record are fields. The table system is comprised of the runtime table identification and navigation system 2140 and table data 2434, which is needed to run the table system. The runtime table identification and navigation system 2140 is comprised of a data request processor 2428, a record processor 2430, and a data cache 2432.

The record processor 2430 has a fixed records component 2448, a variable records component 2450, an end of table identifier 2453, and a cascade table record index 2452. The fixed records component 2448 contains a current row/column counter 2456 and a fixed field processor 2458. The variable records component 2450 has a start/end of record identifier 2460 having a parser 2462 and an evaluator 2464, a current row counter 2466, and a variable field processor 2468. The end of table identifier 2453 is used for variable length tables and contains both an end of table identifier parser 2454 and an end of table identifier evaluator 2455.

The record processor 2430 can be used to combine records together. For example, in a situation where two tables are cascaded together, fields from one record of a daughter table are retrieved from the table data 2434 along with fields from another record of the parent table. The record processor 2430 then combines the fields to appear as one large record from the daughter table, which record contains the appropriate data from the parent table.

The data cache 2432 of the runtime table identification and navigation system 2140 has a data entry manager 2470, a data retrieval manager 2472, a queue 2474, and a data retrieval buffer 2476.

The table data 2434 is comprised of cascade data 2436, record data 2438, end of table data 2440, start/end data 2442, next page action data 2444, and field data 2446.

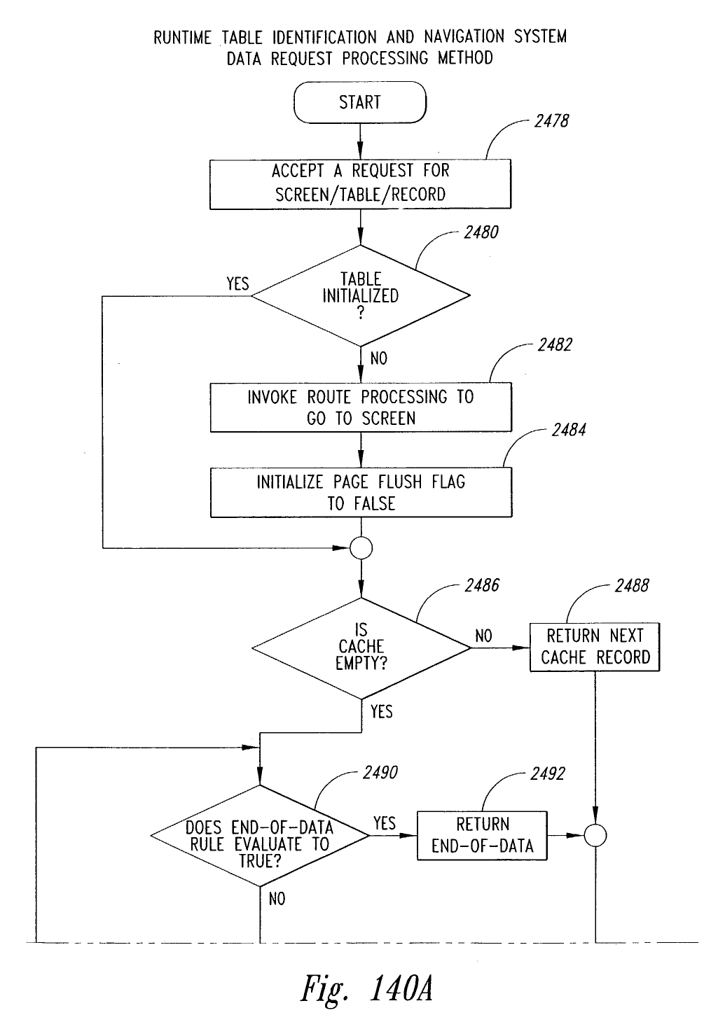

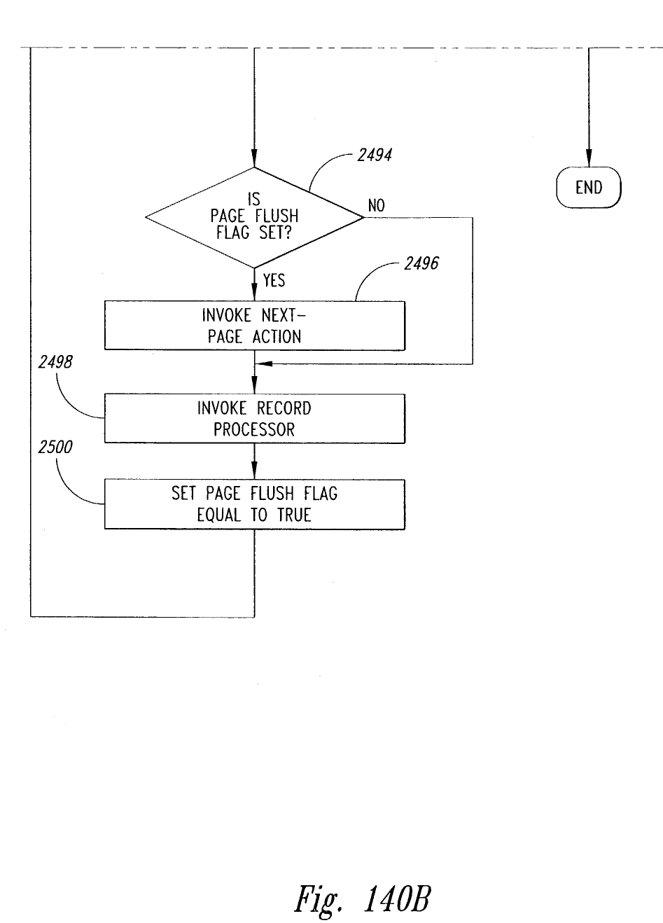

The runtime table identification and navigation system 2140 begins processing tables upon receiving a request for data. The data request processor 2428 receives the request for a record of data, finds the particular record, and returns the record. An example of a method followed by the data request processor 2428 is depicted in FIGS. 140A and 140B. The data request processor 2428 begins the method by accepting a request for a record from a particular table of a host screen (step 2478). The data request processor 2428 then checks if the table has been initialized. If the table has not been initialized (“No” branch of step 2480), the data request processor 2428 invokes route processing 2142 to go to the requested host screen (step 2482) and initializes the page flush flag to false (step 2484).

Once the page flush flag is initialized to false, or if the table is initialized (“Yes” branch of step 2480), the data request processor 2428 determines if the data cache 2432 is empty. If the data cache 2432 is not empty (“No” branch of step 2486), the next cache record is returned (step 2488) and the method is ended. The format of the returned cache record will depend on the interface through which the record is being sent. For example, an object oriented programming component, such as a JavaBean, could receive the record as some type of an object list or as a record object.

If the cache 2432 is empty (“Yes” branch of step 2486), the data request processor 2428 determines if the end-of-data rule evaluates to true (step 2490). This rule, set up by the designer operator, indicates where the end of the data is located. If the rule is not set up correctly, and the end of the data cannot be recognized, problems such as infinite looping could occur in the system. If the end-of-data rule evaluates to true (“Yes” branch of step 2490), the end-of-data is returned (step 2492), and the method is ended.

If the end-of-data rule does not evaluate to true (“No” branch of step 2490), the data request processor 2428 checks if the page flush flag is set. If the page flush flag is set (“Yes” branch of step 2494), the data request processor 2428 invokes the next-page action (step 2496) and the record processor 2430 (step 2498). Otherwise, the data request processor 2428 proceeds straight to invoking the record processor 2430 (step 2498). Next, the page flush flag is set to true (step 2500), and the data request processor 2428 returns to see if the cache 2432 is empty (step 2486).

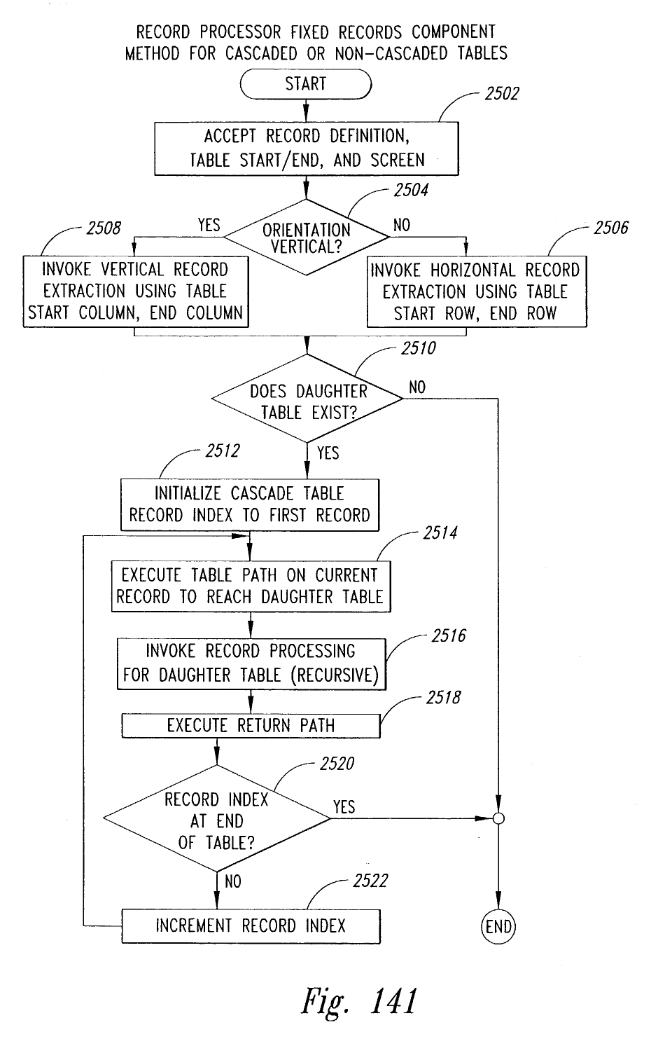

The fixed records component 2448 of the record processor 2430 is used to process data from both cascaded and non-cascaded tables. An example of a method followed by the fixed records component 2448 to process an entire page of table data is depicted in FIG. 141. First, the fixed records component 2448 accepts a record definition, table start/end data 2442, and the host screen having the table (step 2502). If the table is oriented vertically (“Yes” branch of step 2504), the fixed records component 2448 invokes a vertical record extraction method using the start column and the end column of the table as input parameters (step 2508). Otherwise (“No” branch of step 2504), the fixed records component 2448 invokes a horizontal record extraction method using the start row and the end row of the table as input parameters (step 2506).

After either the horizontal extraction method or the vertical extraction method has been invoked on the table, the fixed records component 2448 determines if the table is a cascaded table having a daughter table (step 2510). If no daughter table exists (“No” branch of step 2510), the fixed records component 2448 ends the method. Otherwise (“Yes” branch of step 2510), the fixed records component 2448 initializes the cascade table record index 2452 to the first record (step 2512). Then a table path is executed on the current record to reach the daughter table (step 2514). Next, a recursive process is followed in which the record processor 2430 is invoked for the daughter table (step 2516). Thus, each time the record processor 2430 comes to a record that links to a daughter table, the record processor is invoked again for that daughter table. Once the recursive process has completed for the daughter table, the fixed records component 2448 executes a return path to the parent table (step 2518) and sees if the cascade table record index 2452 is at the end of the table. If the cascade table record index 2452 is at the end of the table (“Yes” branch of step 2520), the method is completed. Otherwise (“No” branch of step 2520), the cascade table record index 2452 is incremented (step 2522), and the fixed records component 2448 returns to execute a table path on the next record in order to reach another daughter table (step 2514).

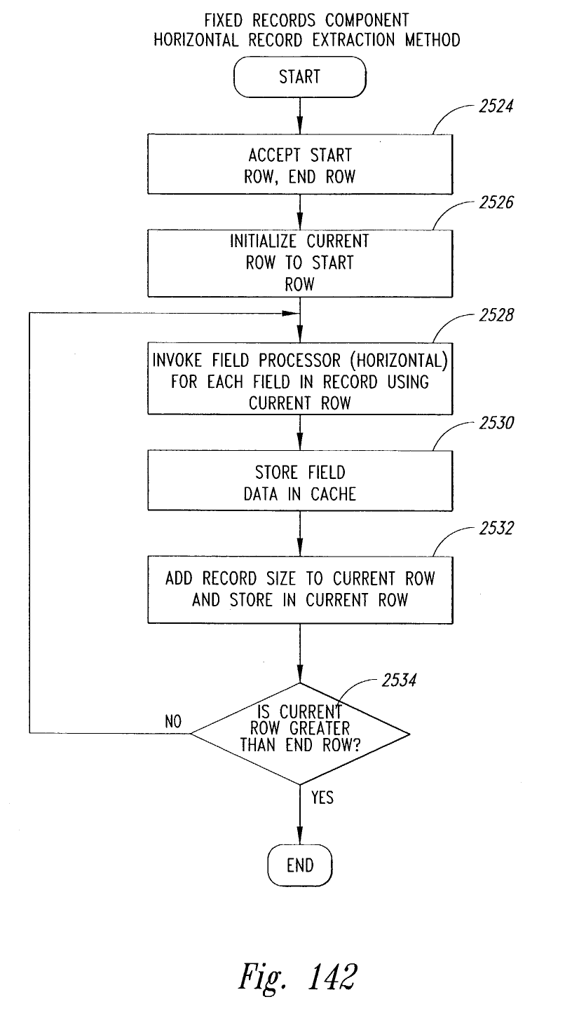

An example of the horizontal record extraction method followed by the fixed records component 2448 is shown in FIG. 142. Through this method, the fixed record component 2448 processes a table one record at a time, from top to bottom, until all the fields have been processed. The fixed records component 2448 begins the method by accepting a start row and an end row for the table (step 2524) and initializes the current row/column counter 2456 to the start row value (step 2526). Using the value of the current row/column counter 2456, the fixed records component 2448 invokes the fixed field processor 2458 for each field in the record (step 2528). The resulting field data is then stored in the cache 2432 (step 2530). Next, the value of the current row/column counter 2456 is incremented by the value of the record size (step 2532). If the value of the current row/column counter 2456 is greater than the value of the end row (“Yes” branch of step 2534), the method is ended. Otherwise (“No” branch of step 2534), the fixed records component 2448 returns to invoke the fixed field processor 2458 for the remaining fields in the record (step 2528).

In an embodiment of the invention in which the runtime table identification and navigation system 2140 does not have a data cache 2432, the field data is temporarily stored until the end of the horizontal record extraction method. Thus, instead of repeatedly looping through the horizontal record extraction method until the entire page is processed, the fixed records component 2448 moves thorough the horizontal record extraction method once and returns one record. The value of the current row/column counter 2456 would also be saved for later use when the horizontal record extraction method was invoked again.

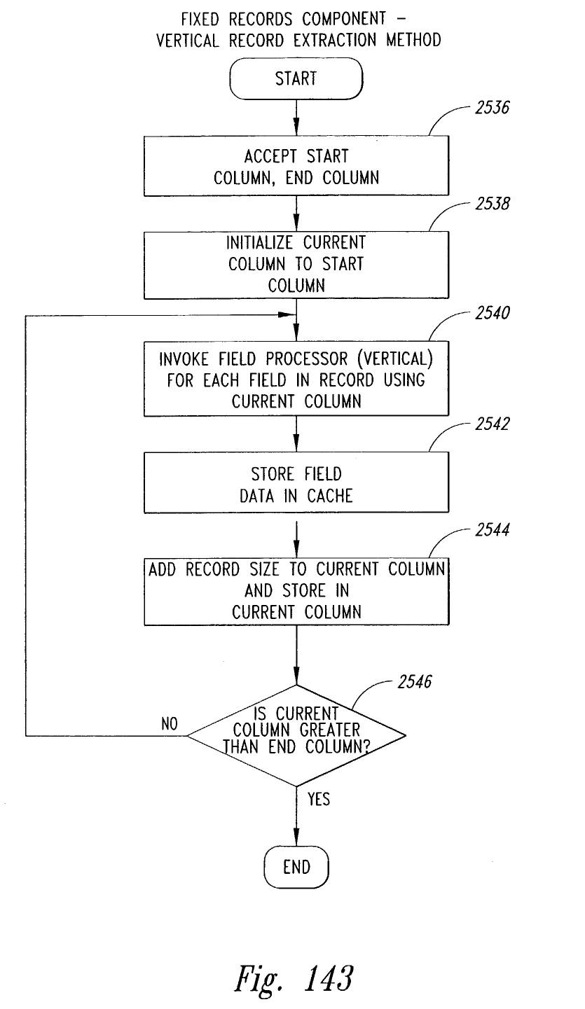

The vertical record extraction method shown in FIG. 143 differs from horizontal record extraction in that the fixed records component 2448 moves across a table from left to right instead of from top to bottom, and the fixed records component increments the current row/column counter 2456 by the width of the record instead of the height. The fixed records component 2448 begins the method by accepting a start column and an end column (step 2536) and by initializing the current row/column counter 2456 to the start column value (step 2538). The fixed records component 2448 then invokes the field processor 2458 for each field in the record using the value of the current row/column counter 2456 (step 2540). Next, the field data is stored in the data cache 2432 (step 2542) and the current row/column counter 2456 is incremented by the value of the record size (step 2544). If the value of the current row/column counter 2456 is greater than the end column value (“Yes” branch of step 2546), the method is ended. Otherwise (“No” branch of step 2546), the fixed records component 2448 returns to invoke the field processor 2458 for the remaining fields in the record (step 2540).

As previously mentioned, if the runtime table identification and navigation system 2140 operates without a cache 2432, the fixed records component 2448 would move through the record extraction method once, and the field data would be stored temporarily until being returned at the end of the method.

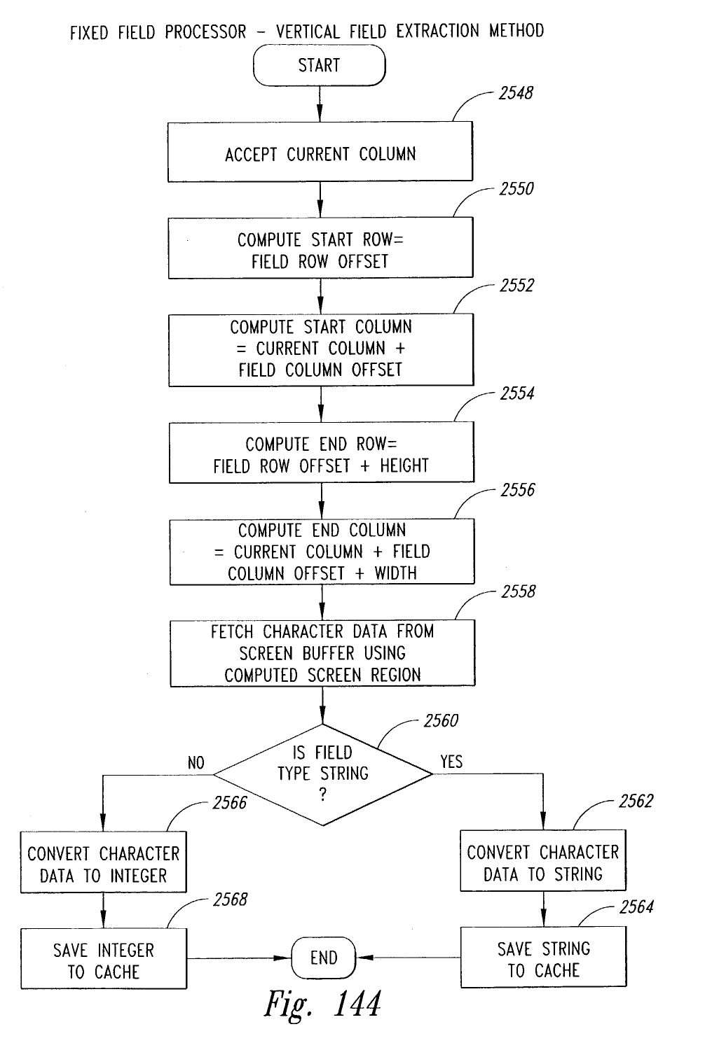

When performing vertical field extraction, the fixed field processor 2458 of the fixed records component 2448 follows a method, such as the one outlined in FIG. 144, to process field boundaries for a current column and to extract data from a screen buffer at the appropriate boundary positions. The fixed field processor 2458 begins the method by accepting the value of the current row/column counter 2456 (step 2548) and by running through a series of computations using field boundary values that were defined in the designer process. First, a start row value is set to the value of a field row offset (step 2550). Next, a start column value is computed by adding the value of the current row/column counter 2456 to the value of a field column offset (step 2552). Then, the fixed field processor 2458 computes an end row value by adding the field row offset to the height of the field (step 2554) and sets an end column value equal to the sum of the current row/column counter 2456, the field column offset, and the width of the field (step 2556). The fixed field processor 2458 uses the final computed values to define a screen region from which to fetch character data from the screen buffer (step 2558).

If the data type from the defined screen region, or field, is a string (“Yes” branch of step 2560), the fixed field processor 2458 converts the character data to a string (step 2562) and saves the string to the data cache 2432 (step 2564). Otherwise (“No” branch of step 2560), the character data is converted to an integer (step 2566) and the integer is saved to the data cache 2432 (step 2568). Once the integer or the string is saved to the data cache 2432, the fixed field processor 2458 is finished with the vertical field extraction method.

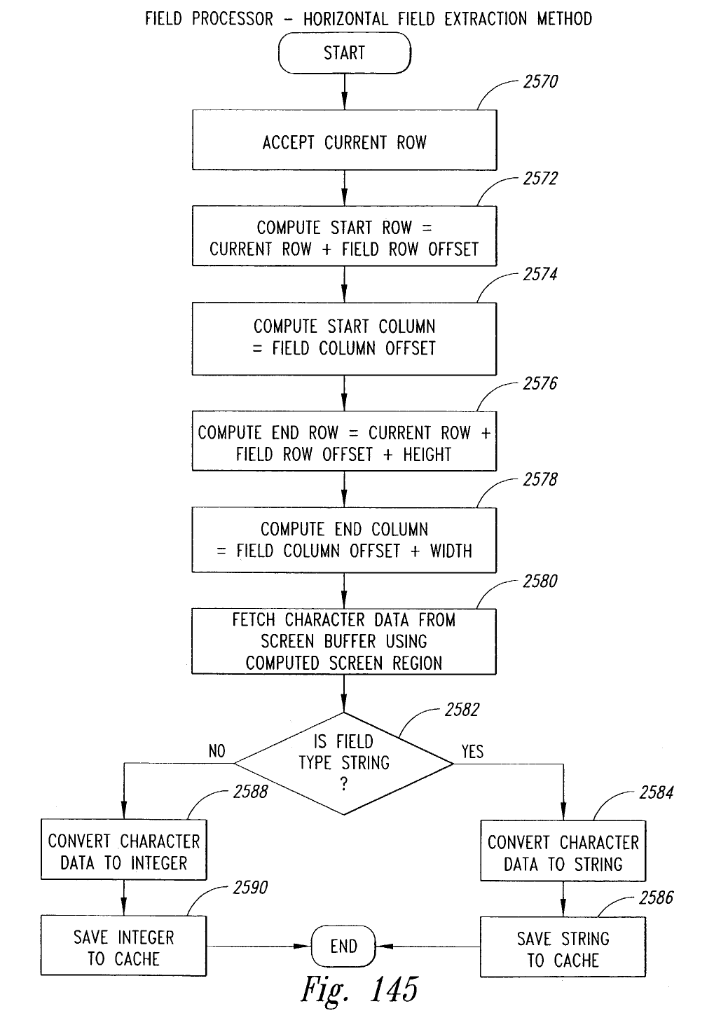

A horizontal field extraction method depicted in FIG. 145 parallels the method followed by the fixed field processor 2458 in vertical field extraction. In horizontal field extraction the fixed field processor 2458 first accepts the value of the current row/column counter 2456 (step 2570). Next, the value of a start row is computed by adding the value of the current row/column counter 2456 to the value of a field row offset (step 2572), and a start column is set to the value of a field column offset (step 2574). The fixed field processor 2458 then computes an end row by summing the value of the current row/column counter 2456, the value of the field row offset, and the height of the field (step 2576). The final computation consists of setting an end column value equal to the sum of the values of the field column offset and the width of the field (step 2578). The fixed field processor 2458 then uses the computed results to identify a screen region from which to retrieve character data from the screen buffer (step 2580).

If the data type in the screen region, or field, is not a string (“No” branch of step 2582), the fixed field processor 2458 converts the character data to an integer (step 2588) and saves the integer to the data cache 2432 (step 2590). Otherwise (“Yes” branch of step 2582), the fixed field processor 2458 converts the character data to a string (step 2484) and saves the string to the data cache (step 2586). After the string or the integer is saved to the data cache 2458, the fixed field processor 2458 ends the horizontal field extraction method.

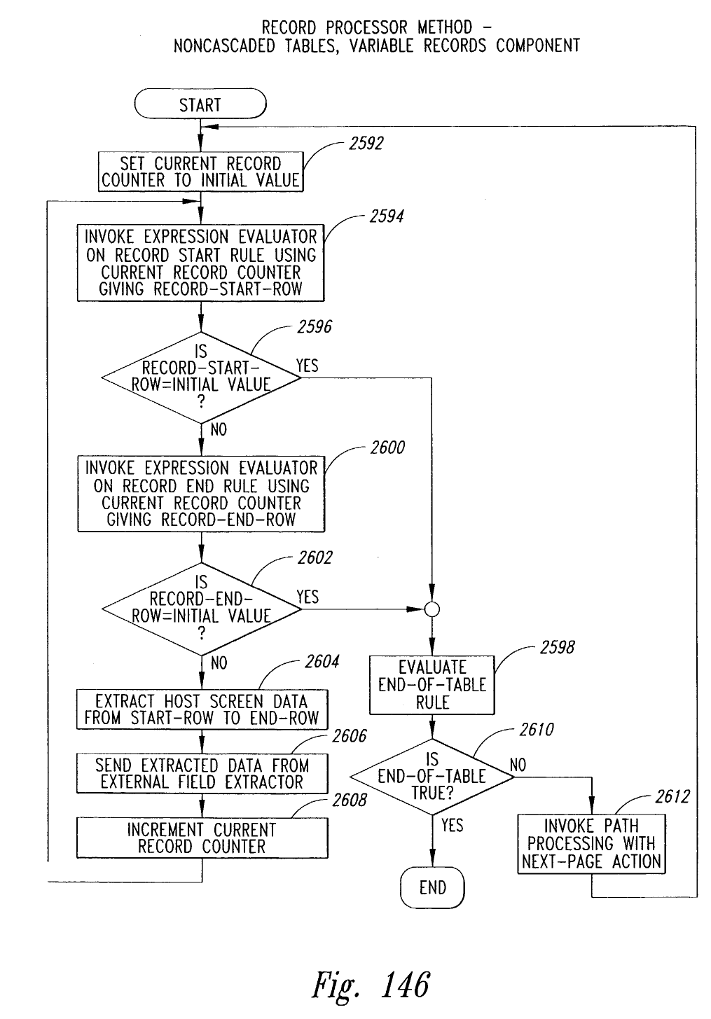

Variable records require the record processor 2430 to perform a different type of record processing than was performed with fixed records. The position of the variable record on a page is based on some expression that can be evaluated by the evaluator 2464 of the start/end of record identifier 2460. FIG. 146 depicts a method followed by the variable records component 2450 when processing variable records in non-cascaded tables. First, the variable records component 2450 sets the current record counter 2466 to an initial value (step 2592). The evaluator 2464 is then invoked on the record start rule using the current record counter 2466 to give a record-start-row (step 2594). If the record-start-row is equal to the initial value (“Yes” branch of step 2596), the variable records component 2450 evaluates the end-of-table rule (step 2598). Otherwise (“No” branch of step 2596), the expression evaluator 2464 is invoked on the record end rule using the current record counter 2466 to give a record-end-row (step 2600).

If the record-end-row is equal to the initial value (“Yes” branch of step 2602), the variable records component 2450 proceeds to evaluate an end-of-table rule (step 2598). The end-of-table rule is a user-constructed rule that the record processor 2430 uses to determine if it has reached the end of a variable-length table. For example, the end-of-table rule could state that the table ends with a certain string of data, and when the record processor 2430 reaches this string, the end-of-table rule evaluates to true. This end-of table rule should be carefully constructed in order to avoid sending the system into an infinite loop in which the record processor 2430 never reaches the “end” of the table. If the end-of-table rule evaluates to true (“Yes” branch of step 2610), the variable records component 2450 ends the method. Otherwise (“No” branch of step 2610), the variable records component 2450 invokes path processing with a next-page action (step 2612) and returns to initialize the current record counter 2466 (step 2592).

If the record-end-row does not equal the initial value (“No” branch of step 2602), the variable records component 2450 extracts the host screen data between the start-row and the end-row (step 2604) and sends the extracted data to an external field extractor (step 2606). The external field extractor is necessary because the field sizes could vary, and the field boundaries cannot be computed using simple field offsets and integer math. The external field extractor needs to be able to accept an entire record, parse the record into the appropriate fields, and store the field data in the data cache 2432. This external field extractor could be, for instance, a plugin or an addition to the table processing system. However, the external field extractor would most likely need to be developed specifically for the particular host application. The variable records component 2450 then increments the current record counter 2466 (step 2608) and returns to invoke the expression evaluator on the record start rule (step 2594).

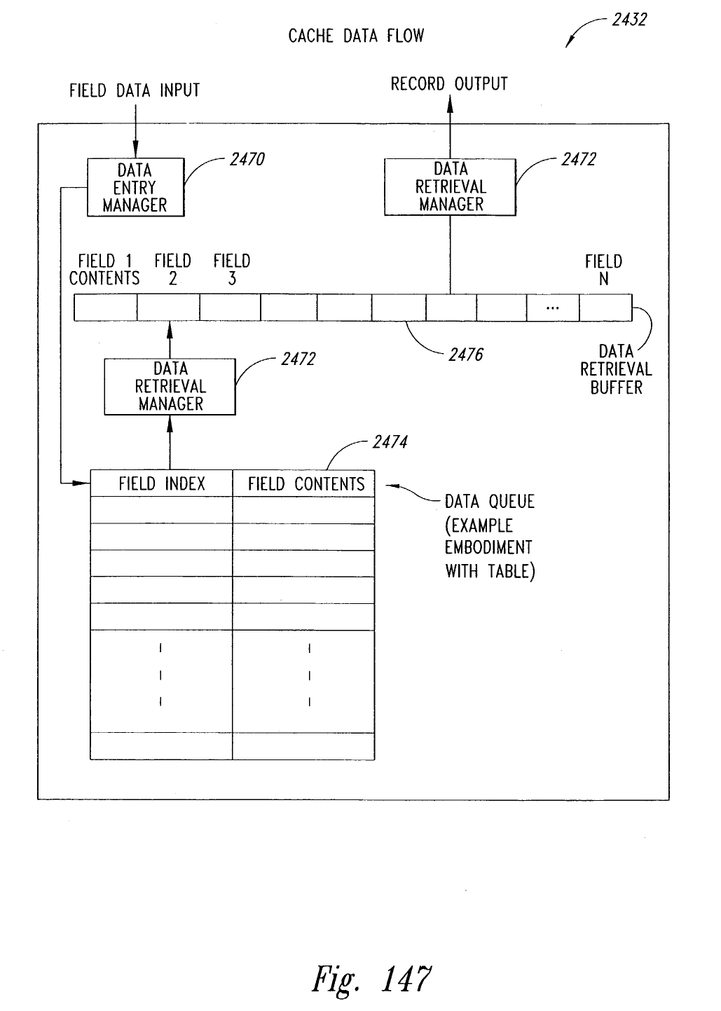

The purpose of the data cache 2432 is two-fold: to accept field data and store it for retrieval and to combine multiple fields into one record when data is being retrieved. An exemplary data flow diagram of the data cache 2432 is depicted in FIG. 147. The diagram shows field data input being accepted by the data entry field manager 2470 and being stored and indexed in the queue 2474, the queue having a field index column and a corresponding field contents column.

The queue 2474 may be implemented in several ways. One implementation of the queue 2474 could consist of an array with pointers to a current queue input index and a current queue output index. These pointers would be managed so that when they reached the end of the array they would wrap around and also so that they would not write over locations that are not supposed to be written into. Other embodiments of queues 2474 could be implemented through Java vectors, through Java list objects, through other objects in the C++ standard template library, or even through a database where one table contains the contents of the queue, one table has a pointer to the current record index, and one table has a pointer to the output record index.

The data flow diagram of FIG. 147 also shows a dual function of the data retrieval manager 2472. First, the data retrieval manager 2472 retrieves fields from the queue 2474 and stores them in their appropriate positions in the data retrieval buffer 2476, which positions correspond with the field index values in the queue. The data retrieval manager 2472 also sends the stored fields in the data retrieval buffer 2476 compiled as one record to the caller. Thus, the data retrieval manager 2472 could send cached data from multiple cascaded tables to the caller in one record as if the record was from only one table.

In alternative embodiments of the invention, the data retrieval manager 2472 could be separated into two different managers, wherein each manager would oversee one of the two functions described above.

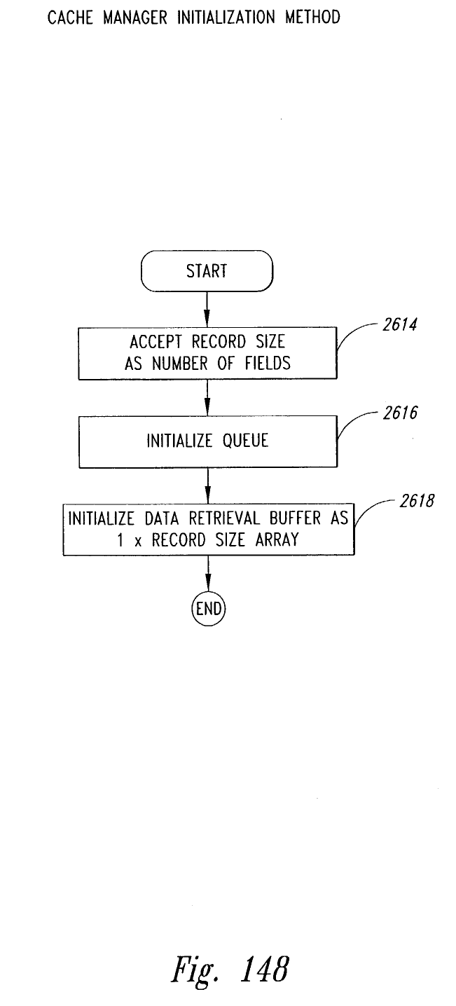

An example of a method to initialize the data cache 2432 is shown in FIG. 148. First, the data cache 2432 accepts a record size as a number of fields (step 2614). Then, both the queue 2474 (step 2616) and the data retrieval buffer 2476 (step 2618) are initialized to store the record data. The data retrieval buffer 2476 is initialized as a single-row array with its number of columns being equal to the record size.

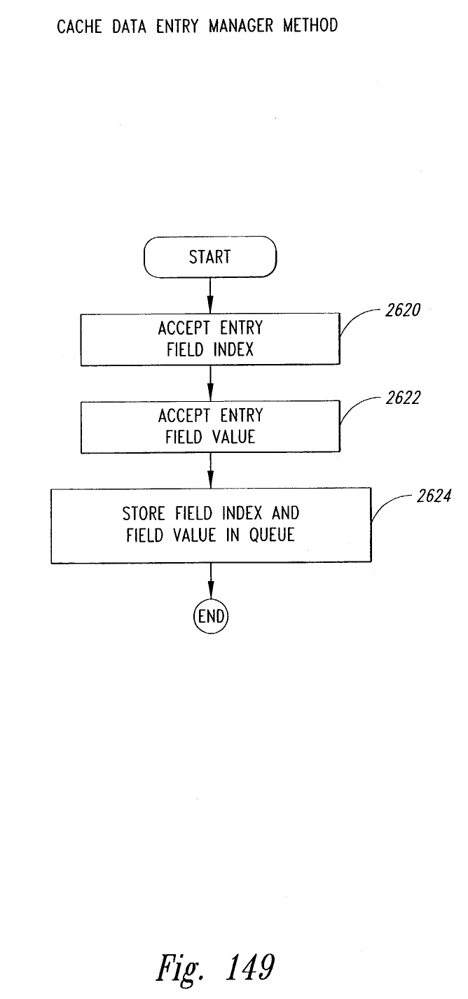

After the data cache 2432 is initialized, the data entry manager 2470 follows a short method, as shown in FIG. 149, to save data to the queue 2474. First, the data entry manager 2470 accepts an entry field index (step 2620) and an entry field value (step 2622). Then, the data entry manager 2470 stores both the field index and the field value in the queue 2474 (step 2624).

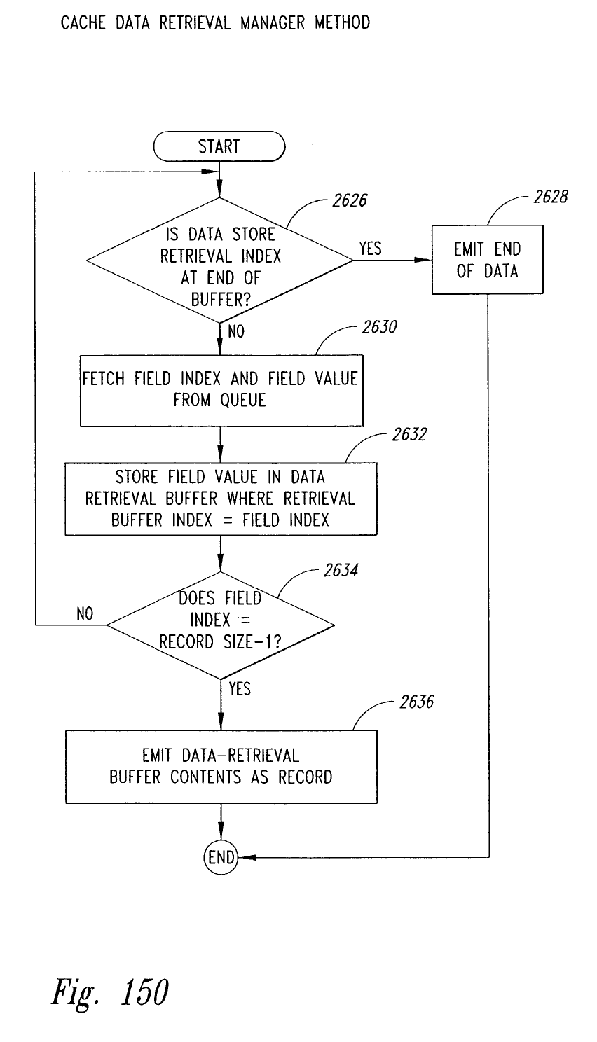

When data is requested from the data cache 2432, the data retrieval manager 2472 retrieves data from the queue 2474, combines individual fields into a large record, and returns the record to the caller. To begin its method, as shown in FIG. 150, the data retrieval manager 2472 determines if a data store retrieval index is at the end of the data retrieval buffer 2476. If it is (“Yes” branch of step 2626), the data retrieval manager 2472 emits an end of data signal (step 2628) and ends the method.

Otherwise (“No” branch of step 2626), the data retrieval manager 2472 fetches a field index and a field value from the queue 2474 (step 2630) and stores the field value in the data retrieval buffer 2476 where the retrieval buffer index is equal to the field index (step 2632). If the field index is equal to one less than the record size (“Yes” branch of step 2634), the data retrieval manager 2472 emits the contents of the data retrieval buffer 2476 as an entire record (step 2636) and ends the method. Otherwise (“No” branch of step 2634), the data retrieval manager 2472 returns to the beginning of the method.

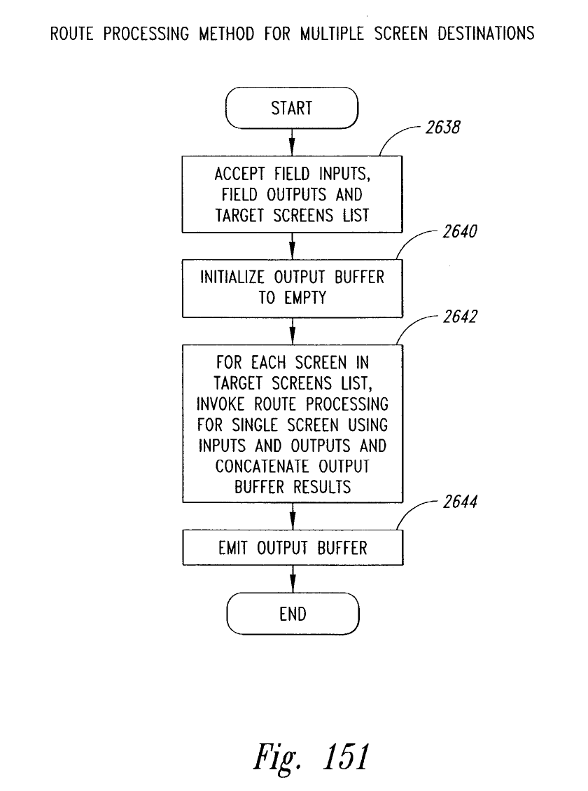

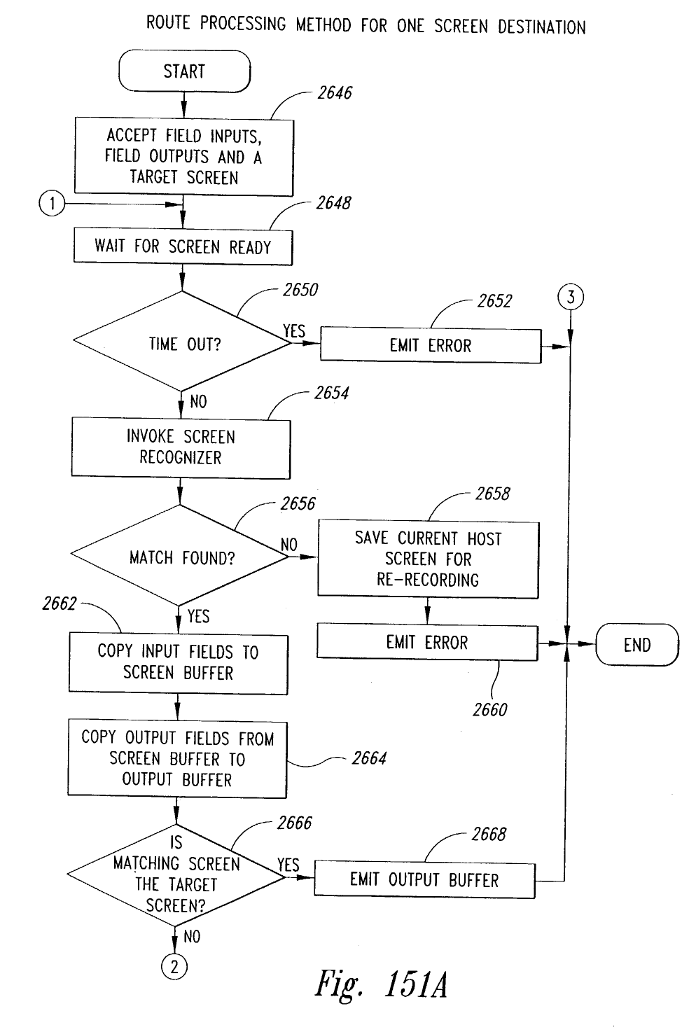

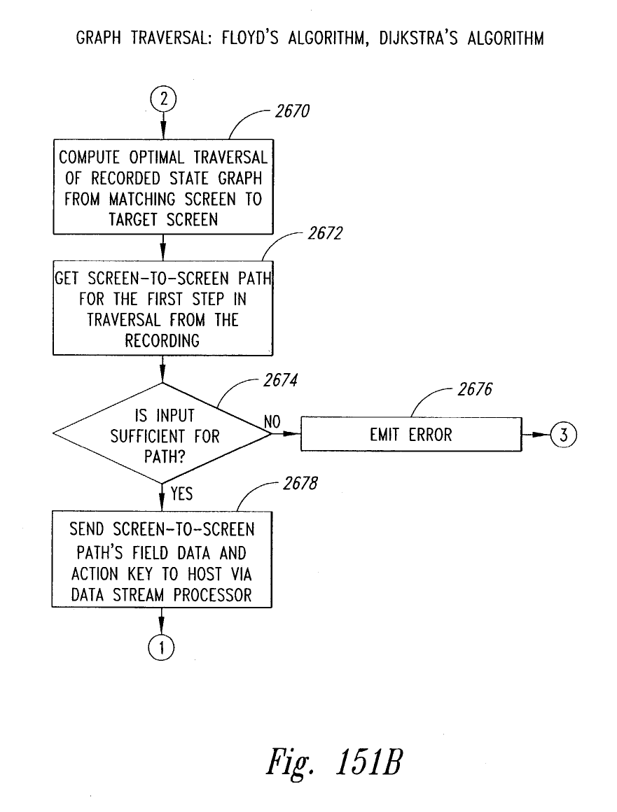

Route processing 2142 is at the heart of screen navigation. FIG. 151 depicts a method followed by route processing 2142 when working with multiple screen destinations. Through this method, route processing 2142 accepts multiple screens that need to be traversed and retrieves data from those screens throughout the traversals. First, route processing 2142 accepts a list of field inputs, a list of field outputs, and a list of target screens (step 2638). The output buffer is then initialized to empty (step 2640). For each screen in the target screens list, a single screen route processing method is invoked using the list of field inputs and the list of field outputs, and the results are concatenated to the data stored in the output buffer (step 2642). Finally, the route processing method for multiple screens is concluded by emitting the output buffer (step 2644).

The substantive portion of the screen navigation process is shown in FIG. 151A, which represents a method followed by route processing 2142 when working with one screen destination. The idea behind the method is for route processing 2142 to compute a route from one location to another and to execute paths from screen to screen until reaching the screen destination. In order to reach the screen destination, the method includes an iterative process in which route processing 2142 computes a new route if necessary to complete the required traversal.

Route processing 2142 begins the method by accepting field inputs, field outputs, and a target screen (step 2646) and by awaiting a “screen ready” signal from the screen ready discriminator 2148. When awaiting the “screen ready” signal, route processing 2142 may call the screen ready discriminator 2148 synchronously as a subroutine or can asynchronously awaken or suspend separate threads. Once route processing 2142 receives the “screen ready” signal (step 2648), it checks to see if a timeout occurred. A timeout could occur, for instance, if a screen is flashing and is being constantly updated so that the screen ready timer never finishes. In such a situation, route processing 2142 would never receive the “screen ready” signal. If there was a timeout (“Yes” branch of step 2650), route processing 2142 emits an error (step 2652) and ends the method. Otherwise (“No” branch of step 2650), route processing 2142 invokes the screen recognizer 2144 of the screen connector runtime engine 100. If a matching screen is not found (“No” branch of step 2656), route processing 2142 saves the current host screen for re-recording (step 2658), emits an error (step 2660), and ends the method. However, if a matching screen is found (“Yes” branch of step 2656), route processing 2142 copies the input fields to the screen buffer 2150 (step 2662) and copies the output fields from the screen buffer 2150 to the output buffer (step 2664). If the matching screen is the target screen (“Yes” branch of step 2666), route processing 2142 emits the data stored in the output buffer (step 2668) and ends the method. Otherwise (“No” branch of step 2666), route processing 2142 computes a graph traversal using a predetermined algorithm such as Floyd's algorithm or Dijkstra's algorithm.

An example of graph traversal is shown in FIG. 151B. First, route processing 2142 computes the optimal traversal of a recorded state graph from the matching screen to the target screen (step 2670). This traversal may be calculated by applying certain mathematical algorithms, such as Floyd's algorithm or Dijkstra's algorithm. Once the optimal traversal is computed, the screen-to-screen path is retrieved from the recording for the first step in the traversal (step 2672). If the input is not sufficient for the path (“No” branch of step 2674), route processing 2142 emits an error (step 2676) and ends the method. This test for sufficient input takes the input fields received from the user and tests them against the input fields that are required for a screen-to-screen path. If the input is not sufficient, route processing 2142 finds itself in an error state. Verifying the user input before the input is sent to the host computer 80 prevents an error condition from occurring later on the host computer if the user input is insufficient. In an alternative embodiment of this method, however, this test may be omitted.

If the input is sufficient for a path (“Yes” branch of step 2674), route processing 2142 sends transition information to the next screen and waits for another “screen ready” signal. This transition information includes sending an action key and the screen-to-screen path field data to the host computer 80 via the data stream processor 572 (step 2678).

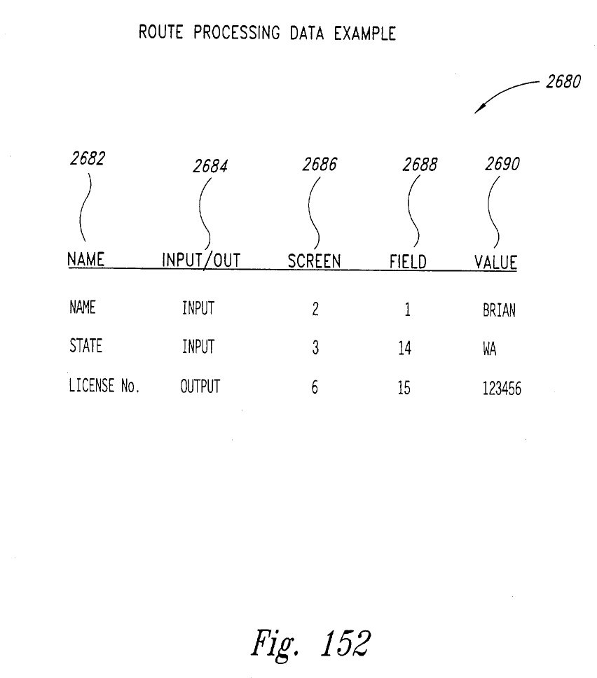

An example of some data used to traverse a route is shown in tabular form in FIG. 152. The data example table 2680 shows data that route processing 2142 could be given to execute a task that uses two inputs to retrieve one output. The data example table 2680 contains information concerning a field name 2682, a field type 2684, a screen identifier 2686, a field identifier 2688, and a field value 2690. All this information in the data example table 2680 would be known before route processing 2142 was invoked except for the value of the output field.

This example shows a task in which the user may retrieve a person's license number by inputting the person's name and state. For the first input, which requires the person's name, the user entered “BRIAN.” For the second input, which requires the person's state, the user entered “WA.” After the task is executed and route processing 2142 reaches the proper destination (screen 6, field 15), the license number value “12346” would be outputted.

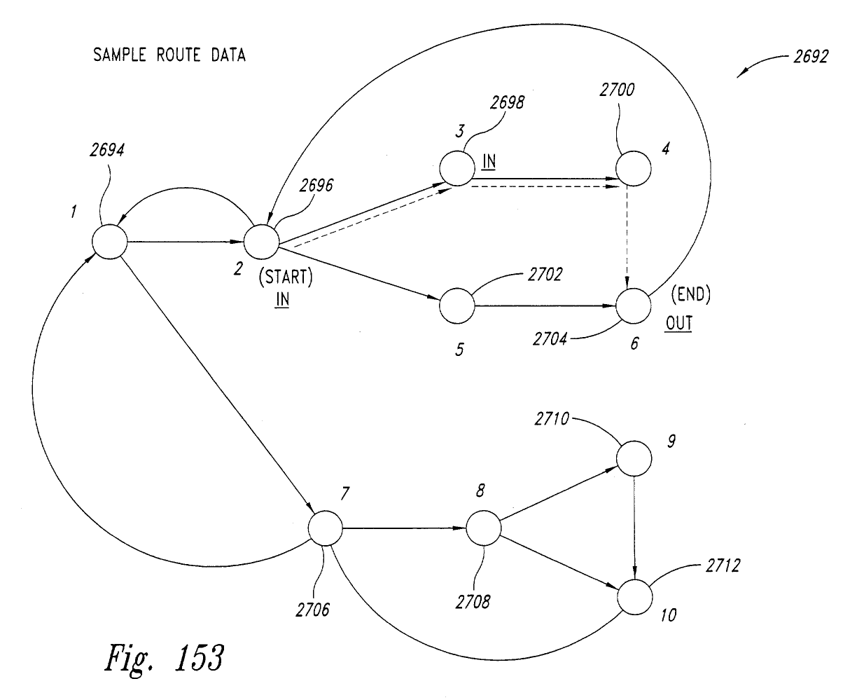

An example of how the information from the data example table 2680 may be applied to an application graph created in the designer process is shown in FIG. 153.

According to the data example table 2680, input is entered in screen 2 2696 and in screen 3 2698, and output is taken from screen 6 2704. Thus, an ordered list of screens to visit would be “236,” and route processing 2142 must determine how to follow this ordered list on the available application graph. As shown in FIG. 153, by using Dijkstra's algorithm screen 4 2700 is added to the route taken by route processing 2142 to reach the final destination of screen 6 2704. The final route becomes “2346.”

This method followed by route processing 2142 is advantageous because route processing is able to re-compute new paths during its route to the destination screen. During the screen recording process, one needs only to record transitions from one host screen to the next host screen. Because route processing 2142 is able to perform intermediate computations along the graph traversal, one does not need to record every possible route from each screen to every other screen, even though during the recording process it is not known which paths will be followed later by the user in executing the route.

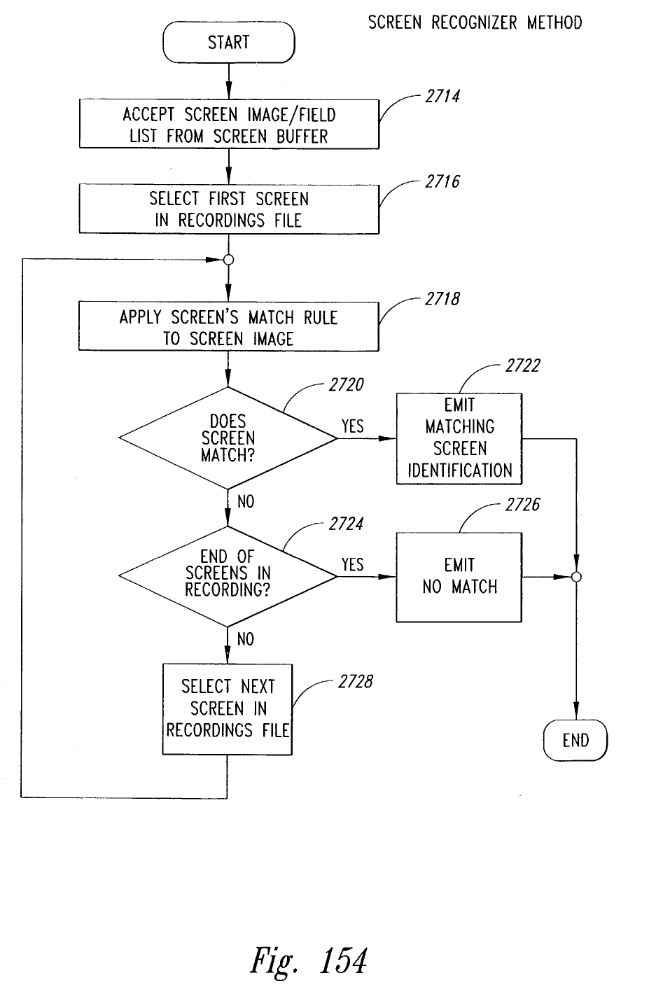

The screen recognizer 2144 is invoked by route processing 2142 to traverse an entire customized screen connector recording in search for a matching screen. An example of a method followed by the screen recognizer 2144 to test every screen in the customized screen connector recording is shown in FIG. 154. To begin the method, the screen recognizer 2144 accepts a screen image/field list from the screen buffer 2150 (step 2714) and selects the first screen in the customized screen connector recording (step 2716). Then, the screen recognizer 2144 applies a screen match rule to the current screen image (step 2718). If the screen image matches the rule (“Yes” branch of step 2720), the screen recognizer 2144 emits a signal indicating that there was a matching screen identification made (step 2722) and ends the method.

If the screen image does not match (“No” branch of step 2720), the screen recognizer 2144 determines if it has reached the last screen in the customized screen connector recording. If there are no more screens in the customized screen connector recording (“Yes” branch of step 2724), the screen recognizer 2144 emits a signal indicating that there was no matching screen (step 2726) and finishes the method. Otherwise (“No” branch of step 2724), the next screen in the customized screen connector recording is selected (step 2728) and is compared with the screen match rule (step 2718).

In an alternative method for the screen recognizer 2144, the screen recognizer could first test the nearest screens, or screens nearest to the last recognized location. Because matching screens are usually in close proximity, this alternative method could accelerate the matching process. In determining which screens are “nearest,” an application graph would be used to find out which screens were the shortest distance from the last recognized location.

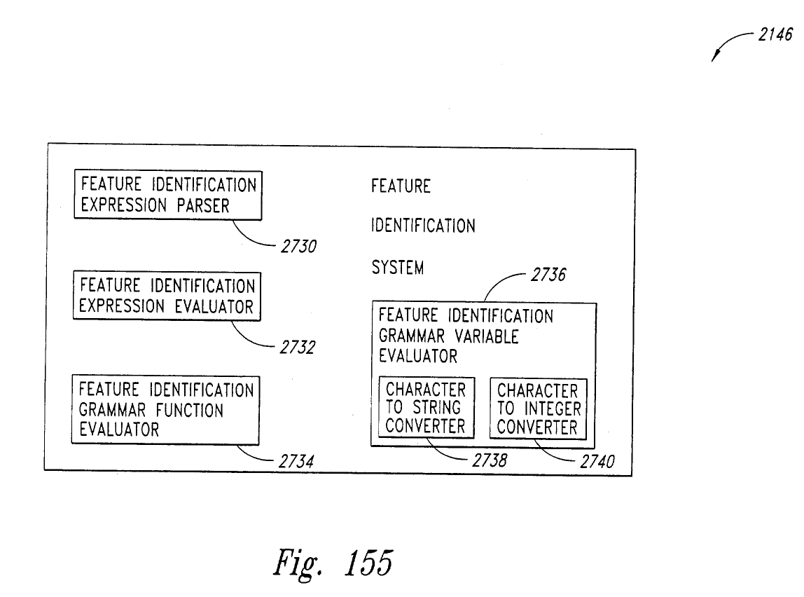

The final component to be discussed in relation to the screen connector runtime engine 100 shown in FIG. 126 is the feature identification system 2146. The feature identification system 2146 is used to apply a well-formed arithmetical string to some screen data and to compute a result based on the screen data. These computations could include string comparisons, arithmetical operations, and other applications. A schematic diagram of an embodiment of the feature identification system 2146 is shown in FIG. 155. The feature identification system 2146 is comprised of a feature identification expression parser 2730, a feature identification expression evaluator 2732, a feature identification grammar function evaluator 2734, and a feature identification grammar variable evaluator 2736. The feature identification grammar variable evaluator 2736 contains both a character to string converter 2738 and a character to integer converter 2740.

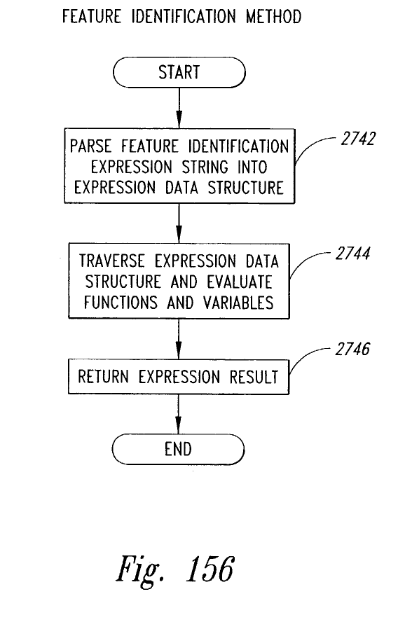

An example of an overall method followed by the feature identification system 2146 is depicted in FIG. 156. First, a feature identification expression string is parsed into an expression data structure (step 2742). The expression data structure is then traversed, and its functions and variables are evaluated (step 2744). Finally, the expression result is returned (step 2746), and the method is ended.

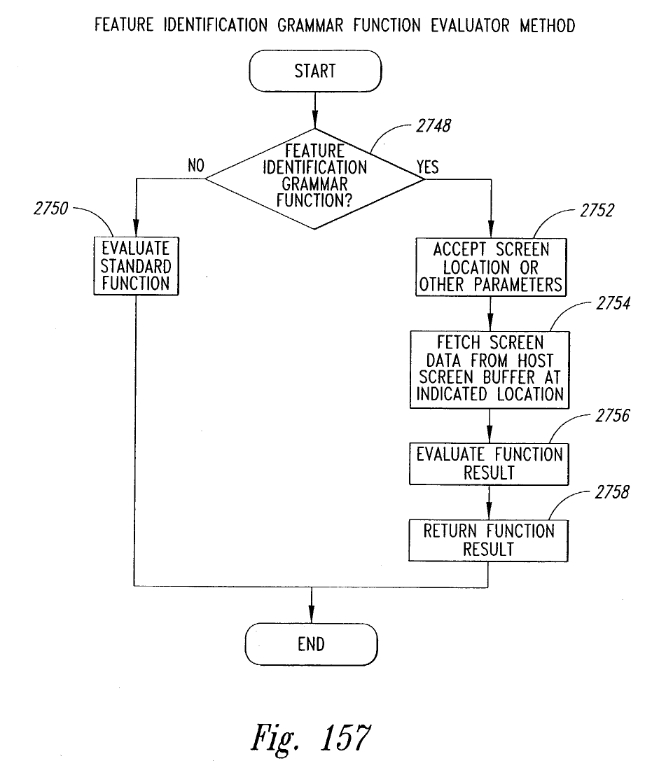

The functions in the expression data structure are evaluated by the feature identification grammar function evaluator 2734. An example of a method followed by the feature identification grammar function evaluator 2734 is depicted in FIG. 157. In this example, expression data structure grammar functions fall into one of two categories: standard functions or feature identification grammar functions. Each of the feature identification grammar functions contains a screen buffer location and some kind of evaluation of the data found within that screen buffer location. If an expression data structure function is not a feature identification grammar function (“No” branch of step 2748), the feature identification grammar function evaluator 2734 evaluates the standard function (step 2750) and ends the method.

If the data in a grammatical expression is a feature identification grammar function (“Yes” branch of step 2748), the feature identification grammar function evaluator 2734 accepts a screen location or other parameters (step 2752) and fetches screen data from the host screen buffer at the indicated location (step 2754). The feature identification grammar function evaluator 2734 then evaluates the function result (step 2756) and returns the function result to the feature identification system 2146 (step 2758). For example, a “string at” function may contain screen buffer boundaries from which to extract all the characters and then convert those characters to a string. Once the function result is returned, the method is ended.

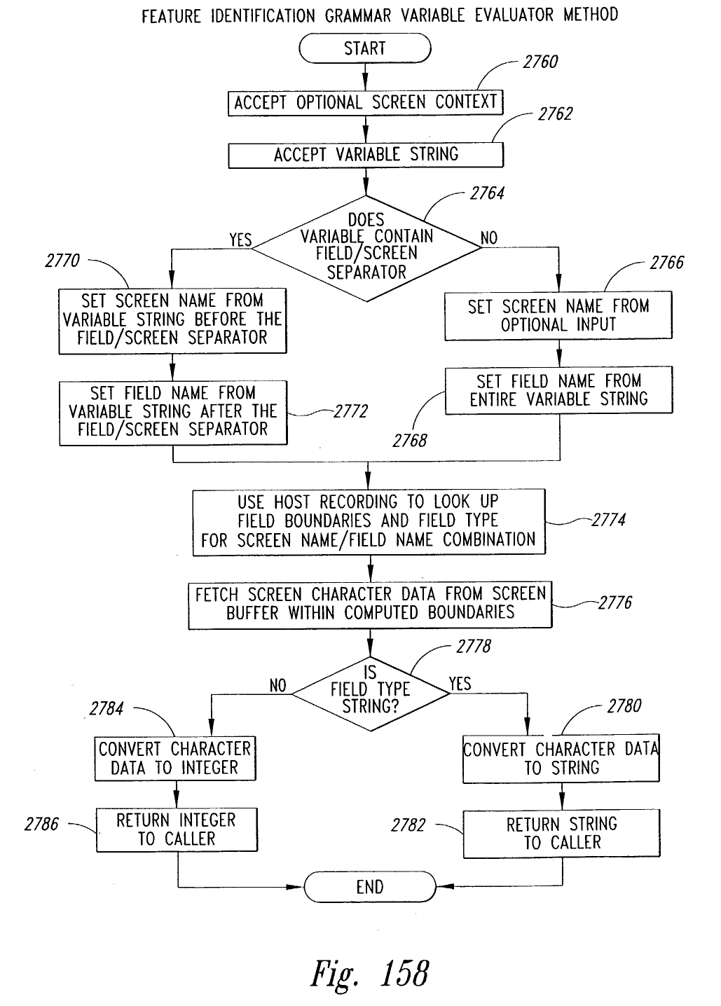

The feature identification grammar variable evaluator 2736 is used to evaluate host-related variables in the expression data structure. Because each host-related variable is set up as a field, the host-related variable needs to be parsed into a screen part and a field part. An example of a method followed by the feature identification grammar variable evaluator 2736 is illustrated in FIG. 158. The feature identification grammar variable evaluator 2736 begins the method by accepting a screen context (step 2760). This screen context is an optional user input and is used in a situation where the variable string does not contain a field/screen separator. The feature identification grammar variable evaluator 2736 then accepts a variable string (step 2762) and looks for the field/screen separator. The field/screen separator can be any character, or group of characters, that is used to separate the field part of the host-related variable from the screen part of the host-related variable. For example, the separator could be a dot (“.”), a slash (“/”), an underscore (“ ”), or a (“:”). If the variable string contains a field/screen separator (“Yes” branch of step 2764), the feature identification grammar variable evaluator 2736 sets the screen name from the portion of the variable string before the field/screen separator (step 2770) and sets the field name from the portion of the variable string following the field/screen separator (step 2772). Otherwise (“No” branch of step 2764), the feature identification grammar variable evaluator 2736 sets the screen name from the optional screen context input (step 2776) and sets the field name from the entire variable string (step 2768).

Once the screen name and field name are set, the feature identification grammar variable evaluator 2736 uses the host recording to look up the field boundaries and the field type for the given screen name and field name combination (step 2774). The feature identification grammar variable evaluator 2736 then fetches screen character data from the screen buffer within the computed boundaries (step 2776). If the field type, as defined by the user during the screen designer process, is a string (“Yes” branch of step 2778), the feature identification grammar variable evaluator 2736 converts the character data to a string (step 2780) and returns the string to the caller (step 2782). Otherwise (“No” branch of step 2778), the character data is converted to an integer (step 2784), and the integer is returned to the caller (step 2786). After the appropriate data is returned to the caller, the feature identification grammar variable evaluator 2736 ends the method.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which aspects of processes and/or systems described herein can be effected (e.g., hardware, software, and/or firmware), and that the preferred vehicle will vary with the context in which the processes and/or systems are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which aspects of the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The foregoing detailed description has set forth various embodiments of the devices and/or processes via the use of block diagrams, flowcharts, and examples. Insofar as such block diagrams, flowcharts, and examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. In one embodiment, the present invention may be implemented via Application Specific Integrated Circuits (ASICs). However, those skilled in the art will recognize that the embodiments disclosed herein, in whole or in part, can be equivalently implemented in standard Integrated Circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure. In addition, those skilled in the art will appreciate that the mechanisms of the present invention are capable of being distributed as a program product in a variety of forms, and that an illustrative embodiment of the present invention applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analogue communication links using TDM or IP based communication links (e.g., packet links).

In a general sense, those skilled in the art will recognize that the various embodiments described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into data processing systems. That is, the devices and/or processes described herein can be integrated into a data processing system via a reasonable amount of experimentation.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A system comprising:
a designer user interface;
a screen connector designer;
a screen connector runtime engine;
a connector configuration management user interface;
a connector configuration management server;
a screen connector runtime engine;
a host computer; and
a user application.

2. The system of claim 1 wherein the designer user interface comprises a grammar selection menu.

3. The system of claim 1 wherein the screen connector runtime engine comprises:
a rules engine;
a screen buffer;
a datastream processor; and
a network communication.

4. The system of claim 3 wherein the rules engine comprises:
an object oriented programming component;
a markup language interface processor;
a task engine;
a table navigation and identification system;
a route processing;
a screen recognizer;
a feature identification system; and
a screen ready discriminator.

5. The system of claim 4 wherein the feature navigation system comprises:
a feature identification expression parser;
a feature identification expression evaluator;
a feature identification grammar function evaluator; and
a feature identification grammar variable evaluator.

6. The system of claim 4 wherein the table navigation and identification system comprises:
a data request processor;
a record processor including a fixed records component, and end of table identifier, a variable records component, and a cascade table record index; and
a cache.

7. The system of claim 1 wherein the screen connector runtime engine comprises:
a configuration communication agent;
a plurality configuration target object relationships;
a plurality of configuration target objects;
a plurality of wizard plugins; and
a plurality a property page plugins.

8. The system of claim 1 wherein the connector configuration management server comprises:
a configuration user interface servlet;
a runtime server table; and
a remote method invoker.

9. The system of claim 1 wherein the connector configuration management user interface comprises:
a configuration node selector;
a property page/wizard display; and
a property page/wizard editing system.

10. The system of claim 1 wherein the screen connector runtime engine comprises:
a plurality of configuration runtime objects; and
a runtime configuration storage.

11. The system of claim 1 wherein the screen connector designer comprises:
a task designer;
a table definition system;
a screen recording engine; and
a screen input extractor.

12. The system of claim 11 wherein the task designer comprises:
a task designer graphical user interface;
an object oriented programming component creation system; and
a markup language creation system.

13. The system of claim 11 wherein the screen recording engine comprises:
a recording workflow manager;
a screen/field recorder;
a default screen group generator;
a custom screen identification system;
a free-form identification system;
an application graph generator; and
an application graph/screen recording verifier.

14. The system of claim 11 wherein the screen input extractor comprises:
a difference engine;
a screen ready discriminator;
a screen buffer;
the datastream processor; and
the network communication.

15. The system of claim 1 wherein the screen connector designer comprises a customized screen connector recording.

16. A method comprising:
a generating a customized screen connector recording;
transmitting the customized screen connector recording to a connector configuration management server;
configuring a selected screen connector runtime engine to be a configured screen connector runtime engine;
transmitting the customized screen connector recording to the selected screen connector runtime engine; and
providing host access to a user application through the configured screen connector runtime engine and the customized screen connector recording.

17. A system comprising:
means for generating a customized screen connector recording;
means for transmitting the customized screen connector recording to a connector configuration management server;
means for configuring a selected screen connector runtime engine to be a configured screen connector runtime engine;
means for transmitting the customized screen connector recording to the selected screen connector runtime engine; and
means for providing host access to a user application through the configured screen connector runtime engine and the customized screen connector recording.
